(19) United States
(12) Patent Application Publication
(10) Pub. No.: US 2024/0059020 A1
(43) Pub. Date: Feb. 22, 2024

(54) CALIBRATION IN THREE-DIMENSIONAL PRINTING

(71) Applicant: Velo3D, Inc., Campbell, CA (US)

(72) Inventors: Erel Milshtein, Cupertino, CA (US); Benyamin Buller, Cupertino, CA (US); Jatinder Randhawa, Milpitas, CA (US); Gregory Ferguson Brown, San Jose, CA (US); Rueben Joseph Mendelsberg, Santa Clara, CA (US)

(21) Appl. No.: 18/228,788

(22) Filed: Aug. 1, 2023

Related U.S. Application Data
(63) Continuation of application No. 18/133,551, filed on Apr. 12, 2023.
Application No. 18/133,551 is a continuation of application No. 18/082,719, filed on Dec. 16, 2022, now abandoned.
Application No. 18/082,719 is a continuation of application No. 17/892,328, filed on Aug. 22, 2022, now abandoned.
Application No. 17/892,328 is a continuation of application No. 17/744,878, filed on May 16, 2022, now abandoned.
Application No. 17/744,878 is a continuation of application No. 17/668,590, filed on Feb. 10, 2022, now abandoned.
Application No. 17/668,590 is a continuation of application No. 17/512,871, filed on Oct. 28, 2021, now abandoned.
Application No. 17/512,871 is a continuation of application No. 17/372,998, filed on Jul. 12, 2021, now abandoned.
Application No. 17/372,998 is a continuation of application No. 17/220,388, filed on Apr. 1, 2021, now abandoned.
Application No. 17/220,388 is a continuation of application No. 17/126,862, filed on Dec. 18, 2020, now abandoned.
Application No. 17/126,862 is a continuation of application No. 17/012,518, filed on Sep. 4, 2020, now abandoned.
Application No. 17/012,518 is a continuation of application No. PCT/US19/14635, filed on Jan. 22, 2019.
(60) Provisional application No. 62/640,518, filed on Mar. 8, 2018.

(51) Int. Cl. B29C 64/393; B33Y 50/02; B33Y 30/00; B29C 64/153

(52) U.S. Cl. CPC B29C 64/393; B33Y 50/02; B33Y 30/00; B29C 64/153; B33Y 10/00

(57) ABSTRACT

The present disclosure provides various apparatuses, systems, software, and methods for three-dimensional (3D) printing. The disclosure delineates various optical components of the 3D printing system, their usage, and their optional calibration. The disclosure delineates calibration of one or more components of the 3D printer.

### CROSS REFERENCE TO RELATED APPLICATIONS

This application is a continuation of U.S. patent application Ser. No. 18/133,551 filed Apr. 12, 2023, which is a continuation of U.S. patent application Ser. No. 18/082,719 filed Dec. 12, 2022, which is a continuation of U.S. patent application Ser. No. 17/892,328 filed Aug. 22, 2022, which is a continuation of U.S. patent application Ser. No. 17/744,878 filed May 16, 2022, which is a continuation of U.S. patent application Ser. No. 17/668,590 filed Feb. 10, 2022, which is a continuation of U.S. patent application Ser. No. 17/512,871 filed Oct. 28, 2021, which is a continuation of Ser. No. 17/372,998 filed Jul. 12, 2021, which is a continuation of U.S. patent application Ser. No. 17/220,388 filed Apr. 1, 2021, which is continuation of U.S. patent application Ser. No. 17/126,862 filed Dec. 18, 2020, which is a continuation of U.S. patent application Ser. No. 17/012,518 filed Sep. 4, 2020, which is a continuation of PCT/US2019/014635 filed Jan. 22, 2019, which claims the benefit of prior-filed U.S. Provisional Application Ser. No. 62/640,518, filed on Mar. 8, 2018, titled “CALIBRATION IN THREE-DIMENSIONAL PRINTING,” each of which is entirely incorporated herein by reference.

### BACKGROUND

Three-dimensional (3D) printing (e.g., additive manufacturing) is a process for making a three-dimensional object of any shape from a design. The design may be in the form of a data source such as an electronic data source, or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed, and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The modeling process of preparing geometric data for 3D computer graphics may be similar to plastic arts, such as sculpting or animating. 3D scanning is a process of analyzing and collecting digital data on the shape and appearance of a real object (e.g., real-life object). Based on these data, 3D models of the scanned object can be produced.

Many additive processes are currently available. They may differ in the manner layers are deposited and/or formed to create the materialized structure. They may vary in the material(s) that are used to generate the designed structure. Some methods melt and/or soften material to produce the layers. Examples of 3D printing methods include selective laser melting (SLM), selective laser sintering (SLS), direct metal laser sintering (DMLS), shape deposition manufacturing (SDM) or fused deposition modeling (FDM). Other methods cure liquid materials using different technologies such as stereo lithography (SLA). In the method of laminated object manufacturing (LOM), thin layers (made inter alia of paper, polymer, metal) are cut to shape and joined together.

A 3D printing system may use an energy beam projected on a material bed to transform a portion of pre-transformed material during formation of the 3D object. At times, a position of the energy beam projected on the material bed may vary from a commanded position of the energy beam on the material bed. The variation in projected (e.g., actual) position compared to commanded position may be uniform or non-uniform across the material bed. The variation in position can cause unexpected variation in the energy delivered to localities of the material bed, which can lead to one or more errors and/or defects in the generated 3D object, including failure to form the desired 3D object for its intended purpose.

### SUMMARY

At times, it may be desirable to calibrate one or more components of a printer. At times, it may be desirable to calibrate one or more components of an optical system. In some instances, it may be desirable to calibrate at least one characteristic of the energy beam that facilitates formation of the three-dimensional object. For example, it may be desirable to calibrate its location with respect to at least one component of the 3D printer (e.g., target surface, a target structure, and/or a calibration mark). It may be desirable to calibrate the speed, power density distribution, and/or focal point. In some embodiments, the present disclosure facilitates the calibration of at least one component of a 3D printer, at least one component of an optical system, and/or at least one characteristic of the energy beam.

The operations of any of the methods, non-transitory computer readable media, and/or controller directions described herein can be in any order. At least two of the operation in any of the methods, non-transitory computer readable media, and/or controller(s) can be performed simultaneously.

In another aspect, a system for printing a three-dimensional object comprises: a platform that includes or that is structured to support a target surface; an energy source that generates an energy beam; a guidance system operatively coupled with the energy source, which guidance system can direct the energy beam across at least a portion of the platform and/or across a portion of the target surface; a detector that can detect a formed marker in or on the target surface; and at least one controller operatively coupled to the detector, the guidance system, and the energy source, which at least one controller is configured to (i) direct the energy source to generate the energy beam, (ii) direct the guidance system to guide the energy beam towards and across the target surface according to a requested position of a requested marker having a requested shape to form a formed marker having a formed shape, which formed marker is disposed at a formed position of the formed marker, (iii) direct the detector to detect (1) a shape of the formed marker to output a detected shape of and/or (2) a position of the formed marker to output a detected position, (iv) direct performing an evaluation comprises deviation between (a) the detected shape of the formed marker and the requested shape of the requested marker and/or (b) the detected position of the formed marker and the requested position of the requested marker respectively, and (v) direct using the evaluation to adjust the guidance system to print the at least one three-dimensional object.

In some embodiments, the platform is structured to support a material bed that comprises an exposed surface that is the target surface. In some embodiments, form comprises illuminate, etch or print. In some embodiments, the formed marker may be an alignment marker. In some embodiments, at least two of (i), (ii), (iii), (iv) and (v) are directed by the same controller. In some embodiments, at least two of (i), (ii), (iii), (iv) and (v) are directed by different controllers. In some embodiments, the target surface comprises a surface adjacent to the platform. In some embodiments, adjacent is laterally adjacent. In some embodiments, adjacent is directly adjacent (e.g., without an intervening structure). In some embodiments, the target surface comprises an exposed surface of an alignment structure. In some embodiments, the target surface comprises an exposed surface of an enclosure. In some embodiments, printing comprises transforming a pre-transformed material to a transformed material to form the three-dimensional object, wherein the enclosure comprises an inert and/or non-reactive atmosphere, which non-reactive is with the pre-transformed material or with the transformed material (e.g., during and/or after printing). In some embodiments, the enclosure comprises an atmosphere maintained at a pressure above ambient pressure. In some embodiments, the marker (e.g., requested, formed and/or detected) is part of a map (e.g., image) composed of a plurality of markers. In some embodiments, the map comprises an array of (e.g., requested, formed and/or detected) markers. In some embodiments, the array spans a processing field of the energy beam. In some embodiments, the processing field and the target surface overlap laterally. In some embodiments, the at least one controller is configured for evaluation of the deviation by comparing the detected position to a position of a calibrated detector (e.g., a calibrated camera) that is position calibrated and/or focus calibrated, with respect to the detected position. In some embodiments, the calibrated detector is calibrated to a dimensional accuracy of at most about 8 microns or a higher accuracy. In some embodiments, the calibrated detector is calibrated to a dimensional accuracy of at most about 2 microns or a higher accuracy. In some embodiments, the detector has a field of view that at least partially overlaps the target surface, wherein calibrated comprises calibration of a scale, rotation, or aberration of the field of view relative to the target surface. In some embodiments, the at least one controller is further configured to calibrate the detector by aligning the detector relative to a pre-formed pattern (e.g., disposed at a position of the target surface, at the target surface, or on the target surface). In some embodiments, the pre-formed pattern is disposed at a focal plane of the target surface relative to the detector and/or energy beam. In some embodiments, the pre-formed pattern overlaps the detected position at least in part. In some embodiments, the pre-formed pattern comprises an etched pattern or a lithographic pattern. In some embodiments, the formed marker is formed in or on: the etched pattern, the platform, or an exposed surface of a material bed disposed on (e.g., and supported by) the platform. In some embodiments, the formed marker is formed (e.g., laterally) adjacent to the etched pattern, the platform, or the exposed surface of the material bed. In some embodiments, the at least one controller is configured for evaluation of the deviation between the detected position and the requested position. In some embodiments, the at least one controller is programed for evaluation of the deviation between the detected shape and the requested shape. In some embodiments, the at least one controller is configured to perform a correlation between a detected marker and the requested marker for the evaluation of the deviation. In some embodiments, the correlation comprises a normalized cross correlation. In some embodiments, the detected position comprises considering data points within about 200 microns to about 1000 microns from a peak detection point of the detected marker, at the target surface. In some embodiments, considering the data points comprises a center of gravity (CoG) evaluation. In some embodiments, the correlation comprises a transformation of the detected marker and/or the requested marker. In some embodiments, the transformation comprises a Hough transformation or a Radon transformation. In some embodiments, prior to (iv), the at least one controller is further configured to modify the detected marker and/or the detected position. In some embodiments, modify comprises data filtering and/or smoothing. In some embodiments, modify comprises removal of outlier data. In some embodiments, outlier data are identified by comparing a detected marker data to a threshold correlation (e.g., value or function). In some embodiments, the threshold correlation comprises a correlation of the detected marker and the requested marker. In some embodiments, modify comprises oversampling the detected marker. In some embodiments, oversampling comprises a spline or a linear interpolation of one or more detected marker values of the detected marker. In some embodiments, the at least one controller is configured to direct the energy beam to form an arrangement of formed markers that comprises the formed marker. In some embodiments, the deviation comprises a deviation in a relative distance between at least two formed markers of the arrangement of formed markers. In some embodiments, the deviation in the relative distance comprises a lattice constant deviation in a (e.g. lateral) direction, which lattice comprises the at least two formed markers. In some embodiments, the deviation in the relative distance comprises a coherence length deviation in a (e.g., lateral) direction of a lattice formed of at least a portion of the arrangement of formed markers. In some embodiments, the at least one controller is configured to direct formation of the arrangement of formed markers as a portion of a formed marker map. In some embodiments, the arrangement of formed markers comprises a grid. In some embodiments, the at least one controller is configured to direct the energy beam to cover at least a portion of a processing field of the energy beam with the arrangement of formed markers. In some embodiments, the arrangement of formed markers covers an entire processing field of the energy beam. In some embodiments, the processing field overlaps at least in part the target surface. In some embodiments, the at least one controller is configured to direct the energy beam to etch form the formed marker. In some embodiments, the at least one controller is configured to direct the energy beam to transform a pre-transformed material to a transformed material to form the formed marker. In some embodiments, the formed marker is a 3D object. In some embodiments, a detected marker and the requested marker correlate in at least one point. In some embodiments, the formed marker comprises at least two partially formed markers that are two different three-dimensional (3D) objects. In some embodiments, the detected marker and the requested marker comprise a scale independent shape. In some embodiments, the formed marker comprises at least two partially formed markers that are formed individually in two separate operations of the energy beam. In some embodiments, the at least one controller is operationally coupled with a layer dispenser, and is configured to direct the dispenser to dispense a layer of the pre-transformed material adjacent to a platform in a direction toward the energy source during generation of the formed marker. In some embodiments, the pre-transformed material is a particulate material. In some embodiments, the pre-transformed material comprises an elemental metal, metal alloy, ceramic, an allotrope of elemental carbon, a polymer, or a resin. In some embodiments, the pre-transformed material comprises an inorganic material. In some embodiments, the pre-transformed material comprises an organic material. In some embodiments, the pre-transformed material comprises a carbon-based or silicon-based material. In some embodiments, to adjust the guidance system comprises a compensation to a data array of directional commands corresponding to guided positions of the energy beam. In some embodiments, the at least one controller is configured to provide compensation to the programmed directions of the at least one controller to the guidance system. In some embodiments, the compensation comprises using a lookup table. In some embodiments, the at least one controller is configured to provide the compensation in situ and/or in real time. In some embodiments, in real time comprises during the printing the at least one three-dimensional object. In some embodiments, the guidance system comprises a scanner. In some embodiments, the guidance system comprises an optical system, wherein to adjust the guidance system comprises an adjustment to one or more components of the optical system. In some embodiments, the at least one controller is configured to adjust the guidance system across at least a portion of a processing field of the energy beam. In some embodiments, the at least the portion of the processing field at least partially overlaps the target surface. In some embodiments, the at least one controller is configured to direct a first adjustment in a first guidance direction (e.g., along an x-axis) and a second adjustment in a second guidance direction (e.g., along a y-axis). In some embodiments, the first guidance direction and the second guidance direction are orthogonal. In some embodiments, an adjustment to the guidance system is to an angular accuracy of at most about 40 micro radians or a higher accuracy. In some embodiments, an adjustment to the guidance system is to an angular accuracy of at most about 15 micro radians or a higher accuracy. In some embodiments, the detector comprises a spectrometer. In some embodiments, the detector comprises an optical detector. In some embodiments, the detector comprises a camera. In some embodiments, the camera is operable to generate a video and/or a still image. In some embodiments, the camera comprises a CCD, a line scan CCD, a line scan CMOS, a video camera, and/or a spectrometer. In some embodiments, the detector comprises a plurality of detection units. In some embodiments, the plurality of detector units is arranged in a pre-determined arrangement. In some embodiments, the plurality of detector units is arranged in an array. In some embodiments, the plurality of detector units is arranged in a grid. In some embodiments, at least one of the detection units comprises a fiber coupled to a single pixel detector. In some embodiments, the target surface is a first target surface, wherein the energy source is a first energy source, wherein the energy beam is a first energy beam, wherein the guidance system is a first guidance system, wherein the platform is structured to support a second target surface, wherein the marker is a first partial marker, wherein the evaluation is a first evaluation, wherein the system further comprises: a second energy source that generates a second energy beam; a second guidance system operatively coupled with the second energy source, which second guidance system can direct the second energy beam across at least a portion of the platform and/or across a portion of the second target surface, and wherein the at least one controller is further operatively coupled to the second guidance system, and the second energy source, which at least one controller is further configured to (vi) direct the second energy source to generate the second energy beam, (vii) direct the second guidance system to guide the second energy beam towards and across the second target surface according to a requested position of a requested second partial marker having a requested shape to form a formed second partial marker having a formed shape, which formed second partial marker is disposed at a formed position of the formed second partial marker, (vii) direct the detector to detect (11) a shape of the formed second partial marker to output a detected shape of the second partial marker and/or (22) a position of the formed second partial marker to output a detected position of the second partial marker, (viii) direct performing a second evaluation comprising deviation between (aa) the detected shape of the second partial marker and the requested shape of the second partial marker and/or (bb) the detected position of the second partial marker and the requested position of the second partial marker respectively, and (ix) direct using the second evaluation and/or the first evaluation to adjust the second guidance system to print the at least one three-dimensional object. In some embodiments, the first energy source and the second energy source are the same. In some embodiments, the first energy beam and the second energy beam are the same. In some embodiments, the first guidance system and the second guidance system are the same. In some embodiments, the first target surface and the second target surface are the same. In some embodiments, the first target surface and the second target surface are different. In some embodiments, the first energy source and the second energy source are different. In some embodiments, the first energy beam and the second energy beam are different. In some embodiments, the first guidance system and the second guidance system are different. In some embodiments, the first energy beam forms a first partial marker and the second energy beam forms a second partial marker and/or wherein the first guidance system guides to form the first partial marker and the second guidance system guides to form the second partial marker. In some embodiments, the system further comprises an image processor operable to combine the at least two partial formed markers to form the detected marker. In some embodiments, the at least one controller comprises the image processor. In some embodiments, the detected shape of the marker comprises a detected shape of the first partial marker and the detected shape of the second partial marker. In some embodiments, the detected shape of the first partial marker and the detected shape of the second partial marker correlate in at least one point. In some embodiments, the at least one controller is configured to direct the platform to lower the first target surface by a given height between formation of the first partial marker and the second partial marker. In some embodiments, the given height corresponds to printing of a layer of the three-dimensional object that is printed layerwise. In some embodiments, the at least one controller is configured to direct deposition of a pre-transformed material layer of the given height over the first target surface to form the second target surface. In some embodiments, the first energy beam and the second energy beam are two of a plurality of energy beams, wherein the first energy source and the second energy source are two of a plurality of energy sources, and wherein the first guidance system and the second guidance system are two of a plurality of guidance systems. In some embodiments, at least two energy beams of the plurality of energy beams are generated by the same energy source. In some embodiments, at least two energy beams of the plurality of energy beams are generated by different energy sources. In some embodiments, at least two energy beams of the plurality of energy beams are guided by the same guidance system. In some embodiments, at least two energy beams of the plurality of energy beams are guided by different guidance systems. In some embodiments, the at least one controller is configured to perform (i) through (iv) for at least two energy beams of the plurality of energy beams. In some embodiments, the at least one controller is configured to use the first evaluation in (iv) to adjust the second guidance system. In some embodiments, the at least one controller is configured to lower the first target surface by a given layer height between (i) and (v). In some embodiments, the system further comprises a material dispenser, wherein the at least one controller is operatively coupled with the material dispenser and is configured to direct the material dispenser to deposit a material layer of the given layer height over the first target surface to form the second target surface. In some embodiments, the requested position comprises a first requested position and a second requested position. In some embodiments, the first requested position overlaps at least in part with the second requested position. In some embodiments, the first requested position is different from the second requested position. In some embodiments, the first requested position is the same as the second requested position. In some embodiments, the first partial marker is the same as the second partial marker (e.g., in shape and/or orientation). In some embodiments, the first partial marker is different than the second partial marker (e.g., in shape and/or orientation). In some embodiments, to form the second formed marker comprises transforming a pre-transformed material to a transformed material. In some embodiments, (ix) is to a dimensional accuracy at the target surface of about 5 microns or a greater accuracy. In some embodiments, the at least one controller is configured to adjust the first guidance system across at least a portion of a first energy beam processing field and/or the second guidance system across at least a portion of a second energy beam processing field. In some embodiments, to adjust the first guidance system and/or the second guidance system is for an overlapping region of the first energy beam processing field and the second energy beam processing field. In some embodiments, at least two of (i)-(ix) are performed by the same controller. In some embodiments, at least two of (i)-(ix) are performed by different controllers.

In another aspect, an apparatus for printing at least one three-dimensional object comprises at least one controller that operatively couples with one or more of an energy source that generates an energy beam, a guidance system operatively coupled with the energy source, the guidance system for directing the energy beam across at least a portion of a platform and/or across a portion of a target surface, a detector that is for detecting a formed marker in or on the target surface, which at least one controller is configured to direct performance of the following operations: using the energy beam to form a formed (e.g., alignment) marker at a formed position at a target surface according to a requested marker and/or a requested position; detecting a representation of the formed marker and/or the position at the target surface to output a detected marker at a detected position; evaluating a deviation between (i) the detected marker and the requested marker and/or (ii) the detected position and the requested position; and using the deviation to adjust the guidance system to print the at least one three-dimensional object.

In some embodiments, the target surface comprises a platform and/or an exposed surface of a material bed. In some embodiments, the platform is structured to support the material bed, wherein the exposed surface is the target surface. In some embodiments, to form comprises illuminate, etch, or print. In some embodiments, the formed marker may be an alignment marker. In some embodiments, the target surface comprises a surface adjacent to a platform. In some embodiments, adjacent is laterally adjacent. In some embodiments, adjacent is directly adjacent (e.g., without any intervening structure). In some embodiments, the target surface comprises an exposed surface of an enclosure or a structural component thereof. In some embodiments, the target surface comprises an exposed surface of an alignment structure. In some embodiments, the target surface is disposed in an enclosure. In some embodiments, printing comprises transforming a pre-transformed material to a transformed material to print the three-dimensional object, wherein the enclosure comprises an inert and/or non-reactive atmosphere, which non-reactive is with the pre-transformed material or with the transformed material (e.g., during and/or after printing). In some embodiments, the enclosure comprises an atmosphere maintained at a pressure above ambient atmosphere. In some embodiments, the deviation comprises a deviation of a detected marker position from a requested marker position. In some embodiments, the deviation comprises a deviation of a detected marker shape from a requested marker shape. In some embodiments, evaluating the deviation comprises oversampling the detected marker. In some embodiments, the oversampling comprises a spline or a linear interpolation of detected marker values of the detected marker. In some embodiments, evaluating the deviation comprises evaluating a correlation between the detected marker and the requested marker. In some embodiments, the correlation is a normalized cross correlation. In some embodiments, the correlation comprises a transformation of the detected marker and/or the requested marker. In some embodiments, the transformation comprises a Hough transformation or a Radon transformation. In some embodiments, the at least one controller is further configured for, prior to (c), modifying the detected marker or the detected position. In some embodiments, modifying comprises data filtering and/or smoothing. In some embodiments, modifying comprises removing outlier data. In some embodiments, outlier data are identified by comparing a detected marker data to a threshold correlation (e.g., value or function). In some embodiments, the threshold correlation comprises a correlation of the detected marker and the requested marker. In some embodiments, evaluating the deviation comprises comparing the detected position to a position of a calibrated detector (e.g., a calibrated camera) that is position calibrated and/or focus calibrated, with respect to the detected position. In some embodiments, the calibrated detector is calibrated to a dimensional accuracy of at most about 8 microns or a higher accuracy. In some embodiments, the calibrated detector is calibrated to a dimensional accuracy of at most about 2 microns or a higher accuracy. In some embodiments, the at least one controller is further configured for calibrating the calibrated detector by aligning a detector relative to a pre-formed pattern (e.g., disposed at a position of the target surface, at the target surface, or on the target surface). In some embodiments, the pre-formed pattern is disposed at a focal plane of the target surface relative to the detector and/or the energy beam. In some embodiments, the pre-formed pattern overlaps the detected position at least in part. In some embodiments, the pre-formed pattern comprises an etched pattern or lithographic pattern. In some embodiments, the formed marker is formed in or on: the etched pattern, a platform, or an exposed surface of a material bed disposed on (e.g., and supported by) the platform. In some embodiments, the formed marker is formed (e.g., laterally) adjacent to the etched pattern, the platform, or the exposed surface of the material bed. In some embodiments, the calibrated detector has a field of view that at least partially overlaps the target surface, wherein calibrated comprises calibration of a scale, rotation, or aberration of the field of view relative to the target surface. In some embodiments, the marker (e.g., requested, formed and/or detected) is a part of a map (e.g., image) composed of a plurality of markers in an arrangement. In some embodiments, the map comprises an array of (e.g., requested, formed and/or detected) markers. In some embodiments, the array spans a processing field of the energy beam. In some embodiments, the processing field and the target surface overlap laterally. In some embodiments, the deviation comprises a deviation in a relative distance between at least two formed markers of the arrangement. In some embodiments, the deviation in the relative distance comprises a lattice constant deviation in a (e.g. lateral) direction, which lattice comprises at least a portion of the at least two formed markers. In some embodiments, the deviation in the relative distance comprises a coherence length deviation in a (e.g. lateral) direction of a lattice formed of at least a portion of the at least two formed markers. In some embodiments, the arrangement is a portion of a formed marker map. In some embodiments, the arrangement comprises a grid. In some embodiments, the arrangement covers at least a portion of a processing field of the energy beam. In some embodiments, the arrangement covers an entire processing field of the energy beam. In some embodiments, the processing field overlaps at least in part the target surface. In some embodiments, to form the formed marker comprises etching. In some embodiments, to form the formed marker comprises transforming a pre-transformed material to a transformed material. In some embodiments, the formed marker is a 3D object. In some embodiments, the detected marker and the requested marker correlate in at least one point. In some embodiments, the formed marker comprises at least two partially formed markers that are two different three-dimensional (3D) objects. In some embodiments, the detected marker and the requested marker comprise a scale independent shape. In some embodiments, the formed marker comprises at least two partially formed markers that are formed individually in two separate operations of the energy beam. In some embodiments, the at least two partially formed markers are combined to form the detected marker by image processing. In some embodiments, the detected marker comprises a first representation of a first partially formed marker and a second representation of a second partially formed marker. In some embodiments, the first representation is of the detected first partially formed marker, and wherein the second representation is of the detected second partially formed marker. In some embodiments, the first representation is the output of the detected shape of the first partially formed marker and/or the output of the detected position of the first partially formed marker, and wherein the second representation is the output of the detected shape of the second partially formed marker and/or the output of the detected position of the second partially formed marker. In some embodiments, the detected marker and the requested marker correlate in at least one point. In some embodiments, the at least one controller is further configured for lowering a first target surface by a given layer height between the forming a first partially formed marker and a second partially formed marker. In some embodiments, the given height corresponds to printing of a layer of the three-dimensional object that is printed layerwise. In some embodiments, the at least one controller is further configured for depositing a pre-transformed material layer of the given layer height over the first target surface to form a second target surface. In some embodiments, a first partially formed marker is formed at a first requested position, and a second partially formed marker is formed at a second requested position. In some embodiments, the pre-transformed material is dispensed adjacent to a platform in a direction toward the energy beam during generation of the formed marker. In some embodiments, the pre-transformed material is a particulate material. In some embodiments, the pre-transformed material comprises an elemental metal, metal alloy, ceramic, an allotrope of elemental carbon, a polymer, or a resin. In some embodiments, the pre-transformed material comprises an inorganic material. In some embodiments, the pre-transformed material comprises an organic material. In some embodiments, the pre-transformed material comprises a carbon-based or silicon-based material. In some embodiments, adjusting the guidance system comprises compensating a data array of directional commands corresponding to guided positions of the energy beam. In some embodiments, the compensating is provided to the programmed directions of at least one controller of a guidance system. In some embodiments, compensating comprises using a lookup table. In some embodiments, compensating is in-situ and/or in real time. In some embodiments, in real time comprises during the printing the at least one three-dimensional object. In some embodiments, the guidance system comprises a scanner, wherein adjusting the guidance system comprises adjusting the scanner. In some embodiments, adjusting the guidance system is to an angular accuracy of at most 40 micro radians or a higher accuracy. In some embodiments, adjusting the guidance system is to an angular accuracy of at most 15 micro radians or a higher accuracy. In some embodiments, the guidance system comprises an optical system, wherein adjusting the guidance system comprises adjusting one or more components of the optical system. In some embodiments, adjusting the guidance system is across at least a portion of a processing field of the energy beam. In some embodiments, the at least the portion of the processing field at least partially overlaps the target surface. In some embodiments, adjusting the guidance system comprises a first adjustment in a first guidance direction (e.g., along an x-axis) and a second adjustment in a second guidance direction (e.g., along a y-axis). In some embodiments, the first guidance direction and the second guidance direction are orthogonal. In some embodiments, the detecting comprises spectroscopically detecting. In some embodiments, the detecting comprises optical detecting. In some embodiments, the optical detecting comprises detecting by a camera. In some embodiments, the detecting comprises recording a video or a still image. In some embodiments, the camera comprises a CCD, a line scan CCD, a line scan CMOS, a video camera, and/or a spectrometer. In some embodiments, the detecting comprises detecting using a plurality of detection units. In some embodiments, the plurality of detecting units is arranged in a pre-determined arrangement. In some embodiments, the plurality of detecting units is arranged in an array. In some embodiments, the plurality of detecting units is arranged in a grid. In some embodiments, at least one of the detecting units comprises a fiber coupled to a single pixel detector. In some embodiments, the at least one controller comprises an electrical circuit. In some embodiments, the at least one controller comprises a socket. In some embodiments, the at least one controller comprises an electronic board. In some embodiments, at least two of (a), (b), (c), and (d), are directed by different controllers that are operatively coupled. In some embodiments, at least two of (a), (b), (c), and (d), are directed by the same controller. n some embodiments, the target surface is a first target surface, wherein the energy source is a first energy source, wherein the energy beam is a first energy beam, wherein the guidance system is a first guidance system, wherein the platform is structured to support a second target surface, wherein the marker is a first partial marker, wherein the evaluating is a first evaluation, wherein the at least one controller operatively couples with a second energy source that generates a second energy beam, and a second guidance system operatively coupled with the second energy source, the second guidance system for directing the second energy beam across at least a portion of the platform and/or across a portion of the second target surface; the at least one controller further configured for: (e) using the second energy beam to form a second formed marker on the second target surface, according to a second requested marker at a second requested position; (f) detecting a second representation of the second formed marker at the second target surface to output a second detected marker at a second detected position; (g) evaluating a second deviation between (i) the second detected marker and the second requested marker and/or (ii) the second detected position and the second requested position; and (h) using the first evaluating from (c) and/or the second evaluating from (g) to adjust the second guidance system to print the at least one three-dimensional object. In some embodiments, the first energy beam and the second energy beam are the same. In some embodiments, the first energy beam and the second energy beam are different. In some embodiments, the first guidance system and a second guidance system are the same. In some embodiments, the first guidance system and a second guidance system are different. In some embodiments, the first target surface and the second target surface are the same. In some embodiments, the first target surface and the second target surface are different. In some embodiments, the first energy beam generates a first partial marker and the second energy beam generates a second partial marker and/or wherein the first guidance system guides to form a first partial marker and a second guidance system guides to form a second partial marker. In some embodiments, the at least one controller is further configured for using the second evaluating in (g) to adjust the first guidance system. In some embodiments, the at least one controller is further configured for lowering the first target surface by a given layer height between (a) and (e). In some embodiments, the at least one controller is further configured for depositing a material layer of the given layer height over the first target surface to form the second target surface. In some embodiments, the requested position of the first formed marker comprises a first requested position that is the same as the second requested position. In some embodiments, the requested position of the first formed marker comprises a first requested position that is different from the second requested position. In some embodiments, the requested position of the first formed marker comprises a first requested position that overlaps at least in part with the second requested position. In some embodiments, the first formed marker is formed according to a first requested marker that is the same as the second requested marker (e.g., in shape and/or orientation). In some embodiments, the first formed marker is formed according to a first requested marker that is different than the second requested marker (e.g., in shape and/or orientation). In some embodiments, a first detected marker and the second detected marker correlate to a point. In some embodiments, to form the second formed marker comprises transforming a pre-transformed material to a transformed material. In some embodiments, (h) is to a dimensional accuracy at the target surface of at most about 50 microns or a greater accuracy. In some embodiments, adjusting the first guidance system is across at least a portion of a first energy beam processing field and adjusting the second guidance system is across at least a portion of a second energy beam processing field. In some embodiments, adjusting is for an overlapping region of the first energy beam processing field and the second energy beam processing field. In some embodiments, the first energy beam and the second energy beam are two of a plurality of energy beams, and wherein the first guidance system and the second guidance system are two of a plurality of guidance systems. In some embodiments, at least two energy beams of the plurality of energy beams are generated by the same energy source. In some embodiments, at least two energy beams of the plurality of energy beams are generated by different energy sources. In some embodiments, at least two energy beams of the plurality of energy beams are guided by the same guidance system. In some embodiments, at least two energy beams of the plurality of energy beams are guided by different guidance systems. In some embodiments, (a)-(d) are performed for at least two energy beams of the plurality of energy beams.

In another aspect, a method for printing at least one three-dimensional object, comprises: using an energy beam to generate a generated (e.g., alignment) marker at a generation position at a target surface according to a requested marker and/or a requested position; detecting a representation of the generated marker and/or the position at the target surface to output a detected marker at a detected position; evaluating a deviation between (i) the detected marker and the requested marker and/or (ii) the detected position and the requested position; and using the deviation to adjust a guidance of the energy beam to print the at least one three-dimensional object.

In some embodiments, the target surface comprises a platform and/or an exposed surface of a material bed. In some embodiments, the platform is structured to support the material bed, wherein the exposed surface is the target surface. In some embodiments, generate comprises illuminate, etch, or print. In some embodiments, the generated marker may be an alignment marker. In some embodiments, the target surface comprises a surface adjacent to a platform. In some embodiments, adjacent is laterally adjacent. In some embodiments, adjacent is directly adjacent (e.g., without any intervening structure). In some embodiments, the target surface comprises an exposed surface of an enclosure or a structural component thereof. In some embodiments, the target surface comprises an exposed surface of an alignment structure. In some embodiments, the target surface is disposed in an enclosure. In some embodiments, printing comprises transforming a pre-transformed material to a transformed material to print the three-dimensional object, wherein the enclosure comprises an inert and/or non-reactive atmosphere, which non-reactive is with the pre-transformed material or with the transformed material (e.g., during and/or after printing). In some embodiments, the enclosure comprises an atmosphere maintained at a pressure above ambient atmosphere. In some embodiments, the deviation comprises a deviation of a detected marker position from a requested marker position. In some embodiments, the deviation comprises a deviation of a detected marker shape from a requested marker shape. In some embodiments, evaluating the deviation comprises oversampling the detected marker. In some embodiments, the oversampling comprises a spline or a linear interpolation of detected marker values of the detected marker. In some embodiments, evaluating the deviation comprises evaluating a correlation between the detected marker and the requested marker. In some embodiments, the correlation is a normalized cross correlation. In some embodiments, the correlation comprises a transformation of the detected marker and/or the requested marker. In some embodiments, the transformation comprises a Hough transformation or a Radon transformation. In some embodiments, the method further comprises, prior to (c), modifying the detected marker or the detected position. In some embodiments, modifying comprises data filtering and/or smoothing. In some embodiments, modifying comprises removing outlier data. In some embodiments, outlier data are identified by comparing a detected marker data to a threshold correlation (e.g., value or function). In some embodiments, the threshold correlation comprises a correlation of the detected marker and the requested marker. In some embodiments, evaluating the deviation comprises comparing the detected position to a position of a calibrated detector (e.g., a calibrated camera) that is position calibrated and/or focus calibrated, with respect to the detected position. In some embodiments, the calibrated detector is calibrated to a dimensional accuracy of at most about 8 microns or a higher accuracy. In some embodiments, the calibrated detector is calibrated to a dimensional accuracy of at most about 2 microns or a higher accuracy. In some embodiments, the method further comprises calibrating the calibrated detector by aligning a detector relative to a pre-formed pattern (e.g., disposed at a position of the target surface, at the target surface, or on the target surface). In some embodiments, the pre-formed pattern is disposed at a focal plane of the target surface relative to the detector and/or the energy beam. In some embodiments, the pre-formed pattern overlaps the detected position at least in part. In some embodiments, the pre-formed pattern comprises an etched pattern or lithographic pattern. In some embodiments, the generated marker is generated in or on: the etched pattern, a platform, or an exposed surface of a material bed disposed on (e.g., and supported by) the platform. In some embodiments, the generated marker is generated (e.g., laterally) adjacent to the etched pattern, the platform, or the exposed surface of the material bed. In some embodiments, the calibrated detector has a field of view that at least partially overlaps the target surface, wherein calibrated comprises calibration of a scale, rotation, or aberration of the field of view relative to the target surface. In some embodiments, the marker (e.g., requested, generated and/or detected) is a part of a map (e.g., image) composed of a plurality of markers in an arrangement. In some embodiments, the map comprises an array of (e.g., requested, generated and/or detected) markers. In some embodiments, the array spans a processing field of the energy beam. In some embodiments, the processing field and the target surface overlap laterally. In some embodiments, the deviation comprises a deviation in a relative distance between at least two of the generated markers of the arrangement. In some embodiments, the deviation in the relative distance comprises a lattice constant deviation in a (e.g. lateral) direction, which lattice comprises at least a portion of the generated markers. In some embodiments, the deviation in the relative distance comprises a coherence length deviation in a (e.g. lateral) direction of a lattice formed of at least a portion of the generated markers. In some embodiments, the arrangement is a portion of a generated marker map. In some embodiments, the arrangement comprises a grid. In some embodiments, the arrangement covers at least a portion of a processing field of the energy beam. In some embodiments, the arrangement covers an entire processing field of the energy beam. In some embodiments, the processing field overlaps at least in part the target surface. In some embodiments, to form the generated marker comprises etching. In some embodiments, to form the generated marker comprises transforming a pre-transformed material to a transformed material. In some embodiments, the generated marker is a 3D object. In some embodiments, the detected marker and the requested marker correlate in at least one point. In some embodiments, the generated marker comprises at least two partially generated markers that are two different three-dimensional (3D) objects. In some embodiments, the detected marker and the requested marker comprise a scale independent shape. In some embodiments, the generated marker comprises at least two partially generated markers that are formed individually in two separate operations of the energy beam. In some embodiments, the at least two partially generated markers are combined to form the detected marker by image processing. In some embodiments, the detected marker comprises a first representation of a first partially generated marker and a second representation of a second partially generated marker. In some embodiments, the first representation is of the detected first partially generated marker, and wherein the second representation is of the detected second partially generated marker. In some embodiments, the first representation is the output of the detected shape of the first partially generated marker and/or the output of the detected position of the first partially generated marker, and wherein the second representation is the output of the detected shape of the second partially generated marker and/or the output of the detected position of the second partially generated marker. In some embodiments, the detected marker and the requested marker correlate in at least one point. In some embodiments, the method further comprises lowering a first target surface by a given layer height between the forming a first partially generated marker and a second partially generated marker. In some embodiments, the given height corresponds to printing of a layer of the three-dimensional object that is printed layerwise. In some embodiments, the method further comprises depositing a pre-transformed material layer of the given layer height over the first target surface to form a second target surface. In some embodiments, a first partially generated marker is generated at a first requested position, and a second partially generated marker is generated at a second requested position. In some embodiments, the pre-transformed material is dispensed adjacent to a platform in a direction toward the energy beam during generation of the generated marker. In some embodiments, the pre-transformed material is a particulate material. In some embodiments, the pre-transformed material comprises an elemental metal, metal alloy, ceramic, an allotrope of elemental carbon, a polymer, or a resin. In some embodiments, the pre-transformed material comprises an inorganic material. In some embodiments, the pre-transformed material comprises an organic material. In some embodiments, the pre-transformed material comprises a carbon-based or silicon-based material. In some embodiments, adjusting the guidance comprises compensating a data array of directional commands corresponding to guided positions of the energy beam. In some embodiments, the compensating is provided to the programmed directions of at least one controller of a guidance system. In some embodiments, compensating comprises using a lookup table. In some embodiments, compensating is in-situ and/or in real time. In some embodiments, in real time comprises during the printing the at least one three-dimensional object. In some embodiments, the guidance comprises a scanner, wherein adjusting the guidance comprises adjusting the scanner. In some embodiments, adjusting the guidance is to an angular accuracy of at most 40 micro radians or a higher accuracy. In some embodiments, adjusting the guidance is to an angular accuracy of at most 15 micro radians or a higher accuracy. In some embodiments, the guidance comprises an optical system, wherein adjusting the guidance comprises adjusting one or more components of the optical system. In some embodiments, adjusting the guidance is across at least a portion of a processing field of the energy beam. In some embodiments, the at least the portion of the processing field at least partially overlaps the target surface. In some embodiments, adjusting the guidance comprises a first adjustment in a first guidance direction (e.g., along an x-axis) and a second adjustment in a second guidance direction (e.g., along a y-axis). In some embodiments, the first guidance direction and the second guidance direction are orthogonal. In some embodiments, the detecting comprises spectroscopically detecting. In some embodiments, the detecting comprises optical detecting. In some embodiments, the optical detecting comprises detecting by a camera. In some embodiments, the detecting comprises recording a video or a still image. In some embodiments, the camera comprises a CCD, a line scan CCD, a line scan CMOS, a video camera, and/or a spectrometer. In some embodiments, the detecting comprises detecting using a plurality of detection units. In some embodiments, the plurality of detecting units is arranged in a pre-determined arrangement. In some embodiments, the plurality of detecting units is arranged in an array. In some embodiments, the plurality of detecting units is arranged in a grid. In some embodiments, at least one of the detecting units comprises a fiber coupled to a single pixel detector. In some embodiments, the energy beam is a first energy beam, wherein the generated marker is a first generated marker, wherein the target surface is a first target surface, wherein the evaluating is a first evaluating, wherein the guidance is a first guidance, wherein the method further comprises: (e) using a second energy beam to generate a second generated marker on a second target surface, according to a second requested marker at a second requested position; (f) detecting a second representation of the second generated marker at the second target surface to output a second detected marker at a second detected position; (g) evaluating a second deviation between (i) the second detected marker and the second requested marker and/or (ii) the second detected position and the second requested position; and (h) using the first evaluating from (c) and/or the second evaluating from (g) to adjust a guidance of the second energy beam to print the at least one three-dimensional object. In some embodiments, the first energy beam and the second energy beam are the same. In some embodiments, the first energy beam and the second energy beam are different. In some embodiments, the first guidance and a second guidance are the same. In some embodiments, the first guidance and a second guidance are different. In some embodiments, the first target surface and the second target surface are the same. In some embodiments, the first target surface and the second target surface are different. In some embodiments, the first energy beam generates a first partial marker and the second energy beam generates a second partial marker and/or wherein the first guidance guides to form a first partial marker and a second guidance guides to form a second partial marker. In some embodiments, the method further comprises using the second evaluating in (g) to adjust a guidance of the first energy beam. In some embodiments, the method further comprises lowering the first target surface by a given layer height between (a) and (e). In some embodiments, the method further comprises depositing a material layer of the given layer height over the first target surface to form the second target surface. In some embodiments, the requested position of the first generated marker comprises a first requested position that is the same as the second requested position. In some embodiments, the requested position of the first generated marker comprises a first requested position that is different from the second requested position. In some embodiments, the requested position of the first generated marker comprises a first requested position that overlaps at least in part with the second requested position. In some embodiments, the first generated marker is generated according to a first requested marker that is the same as the second requested marker (e.g., in shape and/or orientation). In some embodiments, the first generated marker is generated according to a first requested marker that is different than the second requested marker (e.g., in shape and/or orientation). In some embodiments, a first detected marker and the second detected marker correlate to a point. In some embodiments, to generate the second generated marker comprises transforming a pre-transformed material to a transformed material. In some embodiments, (h) is to a dimensional accuracy at the target surface of at most about 50 microns or a greater accuracy. In some embodiments, adjusting the first guidance is across at least a portion of a first energy beam processing field and adjusting a second guidance is across at least a portion of a second energy beam processing field. In some embodiments, adjusting is for an overlapping region of the first energy beam processing field and the second energy beam processing field. In some embodiments, the first energy beam and the second energy beam are two of a plurality of energy beams, and wherein the first guidance and a second guidance are two of a plurality of guidances. In some embodiments, at least two energy beams of the plurality of energy beams are generated by the same energy source. In some embodiments, at least two energy beams of the plurality of energy beams are generated by different energy sources. In some embodiments, at least two energy beams of the plurality of energy beams are guided by the same guidance. In some embodiments, at least two energy beams of the plurality of energy beams are guided by different guidances. In some embodiments, the method comprises performing (a)-(d) for at least two energy beams of the plurality of energy beams.

In another aspect, a system for printing a three-dimensional object comprises: a platform that comprises or that is structured to support a target surface; a first energy source that generates a first energy beam; a second energy source that generates a second energy beam; a first guidance system operatively coupled with the first energy source, which guidance system can direct the first energy beam across at least a first portion of the platform; a second guidance system operatively coupled with the second energy source, which guidance system can direct the second energy beam across at least a second portion of the platform; a detector that can detect a trajectory of the first energy beam and/or the second energy beam (e.g., at the target surface); and at least one controller operatively coupled to the detector, the second guidance system, the first guidance system, the first energy source, and the second energy source, which at least one controller is configured to (i) direct the first energy source to generate the first energy beam, (ii) direct the first guidance system to guide the first energy beam towards the target surface to print a test object at a location, the test object having a detectable border, (iii) direct the second energy source to generate the second energy beam, (iv) direct the second guidance system to irradiate and guide the second energy beam across test object from a position in the location across to the detectable border, (v) direct the detector to detect a trajectory of the second energy beam from the position to the detectable border, (vi) direct performing an evaluation of a length of the trajectory, and (vii) direct using the length of the trajectory to align the first guidance system with the second guidance system to print the at least one three-dimensional object.

In some embodiments, the first energy source and the second energy source are the same. In some embodiments, the first energy beam and the second energy beam are the same. In some embodiments, the first guidance system and the second guidance system are the same. In some embodiments, the first energy source and the second energy source are different. In some embodiments, the first energy beam and the second energy beam are different. In some embodiments, the first guidance system and the second guidance system are different. In some embodiments, the test object is a 3D object. In some embodiments, the at least one controller is further configured, after to detect in (v) and/or before the evaluation in (iv), to determine a length of the trajectory and using the length of the trajectory to align the first guidance system with the second guidance system to print the at least one three-dimensional object. In some embodiments, the length of the trajectory is a shortest length from the position in the location to an overlap of the trajectory of the second energy beam with the detectable border. In some embodiments, the trajectory comprises a line. In some embodiments, the line is a straight line. In some embodiments, the trajectory comprises a hatch. In some embodiments, the trajectory comprises a tile. In some embodiments, the trajectory is a shortest path from the position to the detectable border. In some embodiments, to irradiate in (iv) comprises a plurality of irradiation pulses and a plurality of irradiation intermissions. In some embodiments, the plurality of irradiation pulses are spaced at a constant size along the test object. In some embodiments, the at least one controller is further configured: (aa) to irradiate the target surface at a first position in a first time period to form a first tile, which first position is along a path-of-tiles, wherein the trajectory comprises the path-of-tiles, wherein during the first time period, the second energy beam is stationary or substantially stationary such that it at most undergoes back and forth movement with respect to the first position on the surface; (bb) to translate the second energy beam to a second position of the target surface along the path-of-tiles, which second position is different from the first position, which second energy beam is translated during an intermission of the plurality of intermissions without transforming a pre-transformed material along the path-of-tiles; and (cc) to irradiate the target surface at the second position with the second energy beam at the second position during a second time period to form a second tile, wherein during the second time period, the second energy beam is stationary or substantially stationary such that it at most undergoes back and forth movement with respect to the second position on the target surface. In some embodiments, the at least one controller is configured for moving the second energy beam by one step size between each irradiation pulse of the plurality of irradiation pulses. In some embodiments, the at least one controller is configured for determining a length of the trajectory by a plurality of steps between the position and the detectable border. In some embodiments, a location of the test object is predetermined. In some embodiments, the position is predetermined. In some embodiments, to detect the trajectory of the second energy beam comprises a detection of a signal corresponding to a temperature in a vicinity of a second energy beam footprint. In some embodiments, the detectable border comprises a temperature gradient. In some embodiments, the at least one controller is configured to form the detectable border by causing the first energy beam or another energy beam to irradiate a border trajectory to form a heat signature that forms the detectable border. In some embodiments, the detectable border is detected according to a threshold change in the temperature. In some embodiments, to detect the trajectory of the second energy beam comprises a detection of a signal corresponding to a power output of an energy source that generates the second energy beam. In some embodiments, the at least one controller is configured to adjust the power output considering a detected temperature of a footprint of the second energy beam at the target surface or in a vicinity thereof, to maintain a target temperature threshold (e.g., value). In some embodiments, the at least one controller is configured to detect the detectable border according to a change in the power output during (iv) while seeking to maintain the threshold. In some embodiments, the test object is anchored to the platform. In some embodiments, the test object comprises an auxiliary support structure that is or is not anchored with the platform. In some embodiments, the test object is disposed within a material bed that is supported by the platform. In some embodiments, the material bed comprises pre-transformed material. In some embodiments, the at least one controller is configured to print the test object by causing the energy beam to transform pre-transformed material to transformed material. In some embodiments, the detectable border comprises an edge. In some embodiments, the edge comprises a form transition or a type transition from a material of the target surface to another material form and/or type. In some embodiments, the form transition comprises a transition in a physical form. In some embodiments, the form transition comprises a transition from a solid to a particulate form. In some embodiments, the type transition comprises a transition in a material type. In some embodiments, the type transition comprises a transition between a first material type and a second material type of a plurality of material types, the plurality of material types comprising: a metal; a ceramic; an alloy; an allotrope; an inorganic material; and an organic material. In some embodiments, the edge comprises a transition from a pre-transformed to a transformed material. In some embodiments, the detector comprises a detection field aligned with a second energy beam footprint, the detection field synchronized with a movement of the second energy beam footprint along the trajectory. In some embodiments, the platform comprises an exposed surface of a material bed. In some embodiments, the platform is disposed in an enclosure. In some embodiments, the at least one controller is configured to print by directing the energy beam to transform a pre-transformed material to a transformed material to print the three-dimensional object, wherein the enclosure comprises an inert and/or non-reactive atmosphere, which non-reactive is with the pre-transformed material or with the transformed material (e.g., during and/or after printing). In some embodiments, the enclosure comprises an atmosphere maintained at a pressure above ambient pressure. In some embodiments, to align comprises the at least one controller providing an adjustment to the first guidance system and/or the second guidance system. In some embodiments, to align comprises the at least one controller providing an adjustment to the first guidance system and the second guidance system with respect to each other and/or with respect to a detector. In some embodiments, to align comprises the at least one controller providing compensation for a data array of directional commands corresponding to guided positions of the first energy beam and/or the second energy beam. In some embodiments, the at least one controller is configured for providing the compensation to the programmed directions of at least one controller operatively coupled with the first guidance system or the second guidance system. In some embodiments, the compensation comprises using a lookup table. In some embodiments, compensation is in-situ and/or in real time. In some embodiments, in real time comprises during the printing the at least one three-dimensional object. In some embodiments, the first guidance system and/or the second guidance system comprise a scanner, wherein to align comprises providing an adjustment to the scanner. In some embodiments, to align is to an angular accuracy of at most 40 micro radians or a higher accuracy. In some embodiments, to align is to an angular accuracy of at most 15 micro radians or a higher accuracy. In some embodiments, the first guidance system and/or the second guidance system comprise an optical system, wherein providing the adjustment to comprises the at least one controller providing an adjustment to one or more components of the optical system. In some embodiments, providing the adjustment to the first guidance system is across at least a portion of a first energy beam processing field and providing the adjustment to the second guidance system is across at least a portion of a second energy beam processing field. In some embodiments, providing the adjustment is for an overlapping region of the first energy beam processing field and the second energy beam processing field. In some embodiments, providing the adjustment to the first guidance system or the second guidance system is across an (e.g., entire) processing field of the first energy beam or the second energy beam, respectively. In some embodiments, providing the adjustment to comprises a first adjustment in a first guidance direction (e.g., along an x-axis) and a second adjustment in a second guidance direction (e.g., along a y-axis). In some embodiments, the first guidance direction and the second guidance direction are orthogonal (e.g., and/or lateral). In some embodiments, the at least one controller is further configured for aligning an orthogonal axis of the first guidance system and/or the second guidance system by repeating (i) through (vii) along an orthogonal trajectory. In some embodiments, the at least one controller is further configured for aligning the first guidance system and/or the second guidance system by repeating (i) through (vii) along an anti-parallel trajectory. In some embodiments, the at least one controller is further configured for aligning the first guidance system and/or the second guidance system by repeating (i) through (vii) over a plurality of test objects in a plurality of locations in a first processing field and/or a second processing field. In some embodiments, an alignment from (vii) is different for at least two locations of the plurality of locations. In some embodiments, to align is to a dimensional accuracy at a first processing field or a second processing field of at most about 50 microns or a higher accuracy. In some embodiments, the first energy beam and the second energy beam are two energy beams of a plurality of energy beams. In some embodiments, at least two energy beams of the plurality of energy beams are generated by the same energy source. In some embodiments, at least two energy beams of the plurality of energy beams are generated by different energy sources. In some embodiments, at least two energy beams of the plurality of energy beams are guided by the same guidance system. In some embodiments, at least two energy beams of the plurality of energy beams are guided by different guidance systems. In some embodiments, the system comprises performing (i)-(vii) for at least three energy beams of the plurality of energy beams. In some embodiments, at least two of (i), (ii), (iii), (iv), (v), (vi) and (vii) are directed by different controllers that are operatively coupled. In some embodiments, at least two of (i), (ii), (iii), (iv), (v), (vi) and (vii) are directed by the same controller.

In another aspect, an apparatus for printing at least one three-dimensional object, comprises at least one controller that operatively couples with one or more of a first energy source that generates a first energy beam, a second energy source that generates a second energy beam, a first guidance system operatively coupled with the first energy source, a second guidance system operatively coupled with the second energy source, and a detector that is for detecting a trajectory of the first energy beam and/or the second energy beam (e.g., at a target surface), which at least one controller is configured to direct performance of the following operations: printing a test object having a surface with a detectable border by using the first energy beam that is directed by the first guidance system, which test object is disposed above a platform that comprises or this is structured to support a target surface, which first guidance system guides the first energy beam across at least a portion of the platform that includes the surface; translating the second energy beam across the surface from a position in the surface to the detectable border by using the second guidance system; detecting the trajectory of the second energy beam from the position to the detectable border and outputting a detected trajectory; and using the detected trajectory to align the first guidance system with the second guidance system to print the at least one three-dimensional object.

In some embodiments, the at least one controller is further configured for, after (c) and/or before (d), determining a length of the trajectory and using the length of the trajectory to align the first guidance system with the second guidance system to print the at least one three-dimensional object. In some embodiments, the trajectory comprises a line. In some embodiments, the line is a straight line. In some embodiments, the trajectory comprises a hatch. In some embodiments, the trajectory comprises a tile. In some embodiments, the trajectory is a shortest path from the position to the detectable border. In some embodiments, (b) comprises a plurality of irradiation pulses and a plurality of irradiation intermissions. In some embodiments, the plurality of irradiation pulses are spaced at a constant size along the test object. In some embodiments, the at least one controller is configured for: (aa) irradiating the surface at a first position in a first time period to form a first tile, which first position is along a path-of-tiles, wherein the trajectory comprises the path-of-tiles, wherein during the first time period, the second energy beam is stationary or substantially stationary such that it at most undergoes back and forth movement with respect to the first position on the surface; (bb) translating the second energy beam to a second position of the surface along the path-of-tiles, which second position is different from the first position, which second energy beam is translated during an intermission of the plurality of intermissions without transforming a pre-transformed material along the path-of-tiles; and (cc) irradiating the surface at the second position with the second energy beam at the second position during a second time period to form a second tile, wherein during the second time period, the second energy beam is stationary or substantially stationary such that it at most undergoes back and forth movement with respect to the second position on the surface. In some embodiments, the at least one controller is configured for moving the second energy beam by one step size between each irradiation pulse of the plurality of irradiation pulses. In some embodiments, the at least one controller is configured for determining a length of the trajectory by a plurality of steps between the position and the detectable border. In some embodiments, a location of the test object is predetermined. In some embodiments, the position is predetermined. In some embodiments, detecting the trajectory of the second energy beam comprises detecting a signal corresponding to a temperature in a vicinity of a second energy beam footprint. In some embodiments, the detectable border is detectable as a temperature gradient. In some embodiments, the at least one controller is configured for forming the detectable border by irradiating a border trajectory with the first energy beam or another energy beam to form a heat signature that forms the detectable border. In some embodiments, the detectable border is detected according to a threshold change in the temperature (b). In some embodiments, detecting the trajectory of the second energy beam comprises detecting a signal corresponding to a power output of an energy source that generates the second energy beam. In some embodiments, the at least one controller is configured for adjusting the power output considering a detected temperature of a footprint of the second energy beam at the surface or in a vicinity thereof, to maintain a target temperature threshold (e.g., value). In some embodiments, the at least one controller is configured for detecting the detectable border according to a change in the power output during (b) while seeking to maintain the threshold. In some embodiments, the test object is anchored to the platform. In some embodiments, the test object comprises an auxiliary support structure that is or is not anchored with the platform. In some embodiments, the test object is disposed within a material bed that is supported by the platform. In some embodiments, the material bed comprises pre-transformed material. In some embodiments, the at least one controller is configured for printing the test object by transforming pre-transformed material to transformed material. In some embodiments, the detectable border comprises an edge. In some embodiments, the edge comprises a form transition or a type transition from a material of the surface to another material form and/or type. In some embodiments, the form transition comprises a transition in a physical form. In some embodiments, the form transition comprises a transition from a solid to a particulate form. In some embodiments, the type transition comprises a transition in a material type. In some embodiments, the type transition comprises a transition between a first material type and a second material type of a plurality of material types, the plurality of material types comprising: a metal; a ceramic; an alloy; an allotrope; an inorganic material; and an organic material. In some embodiments, the edge comprises a transition from a pre-transformed to a transformed material. In some embodiments, the at least one controller is configured for detecting the second energy beam by using a detector having a detection field, which detection field is aligned with a second energy beam footprint and is synchronized with a movement of the second energy beam footprint along the trajectory. In some embodiments, the platform comprises an exposed surface of a material bed. In some embodiments, the platform is disposed in an enclosure. In some embodiments, the at least one controller is configured for printing by transforming a pre-transformed material to a transformed material to print the three-dimensional object, wherein the enclosure comprises an inert and/or non-reactive atmosphere, which non-reactive is with the pre-transformed material or with the transformed material (e.g., during and/or after printing). In some embodiments, the enclosure comprises an atmosphere maintained at a pressure above ambient pressure. In some embodiments, to align comprises the at least one controller adjusting the first guidance system and/or the second guidance system. In some embodiments, to align comprises the at least one controller adjusting the first guidance system and the second guidance system with respect to each other and/or with respect to a detector. In some embodiments, to align comprises the at least one controller compensating a data array of directional commands corresponding to guided positions of the first energy beam and/or the second energy beam. In some embodiments, the at least one controller is configured for providing the compensating to the programmed directions of at least one controller operatively coupled with the first guidance system or the second guidance system. In some embodiments, compensating comprises using a lookup table. In some embodiments, compensating is in-situ and/or in real time. In some embodiments, in real time comprises during the printing the at least one three-dimensional object. In some embodiments, the first guidance system and/or the second guidance system comprise a scanner, wherein to align comprises adjusting the scanner. In some embodiments, to align is to an angular accuracy of at most 40 micro radians or a higher accuracy. In some embodiments, to align is to an angular accuracy of at most 15 micro radians or a higher accuracy. In some embodiments, the first guidance system and/or the second guidance system comprise an optical system, wherein adjusting comprises the at least one controller adjusting one or more components of the optical system. In some embodiments, adjusting the first guidance system is across at least a portion of a first energy beam processing field and adjusting the second guidance system is across at least a portion of a second energy beam processing field. In some embodiments, adjusting is for an overlapping region of the first energy beam processing field and the second energy beam processing field. In some embodiments, adjusting the first guidance system or the second guidance system is across an (e.g., entire) processing field of the first energy beam or the second energy beam, respectively. In some embodiments, adjusting comprises a first adjustment in a first guidance direction (e.g., along an x-axis) and a second adjustment in a second guidance direction (e.g., along a y-axis). In some embodiments, the first guidance direction and the second guidance direction are orthogonal (e.g., and/or lateral). In some embodiments, the at least one controller is further configured for aligning an orthogonal axis of the first guidance system and/or the second guidance system by repeating (a) through (d) along an orthogonal trajectory. In some embodiments, the at least one controller is further configured for aligning the first guidance system and/or the second guidance system by repeating (a) through (d) along an anti-parallel trajectory. In some embodiments, the at least one controller is further configured for aligning the first guidance system and/or the second guidance system by repeating (a) through (d) over a plurality of test objects in a plurality of locations in a first processing field and/or a second processing field. In some embodiments, an alignment from (d) is different for at least two locations of the plurality of locations. In some embodiments, adjusting is to a dimensional accuracy at a first processing field or a second processing field of at most about 50 microns or a higher accuracy. In some embodiments, the first energy beam and the second energy beam are two energy beams of a plurality of energy beams. In some embodiments, at least two energy beams of the plurality of energy beams are generated by the same energy source. In some embodiments, at least two energy beams of the plurality of energy beams are generated by different energy sources. In some embodiments, at least two energy beams of the plurality of energy beams are guided by the same guidance system. In some embodiments, at least two energy beams of the plurality of energy beams are guided by different guidance systems. In some embodiments, the apparatus comprises performing (a)-(d) for at least three energy beams of the plurality of energy beams. In some embodiments, the at least one controller comprises an electrical circuit. In some embodiments, the at least one controller comprises a socket. In some embodiments, the at least one controller comprises an electronic board. In some embodiments, at least two of (a), (b), (c), and (d), are directed by different controllers that are operatively coupled. In some embodiments, at least two of (a), (b), (c), and (d), are directed by the same controller.

In another aspect, a method for printing at least one three-dimensional object, comprises: printing a test object having a surface with a detectable border by using a first energy beam that is directed by a first guidance system, which test object is disposed above a platform, which first guidance system guides the first energy beam across at least a portion of the platform that includes the surface; translating a second energy beam across the surface from a position in the surface to the detectable border by using a second guidance system; detecting a trajectory of the second energy beam from the position to the detectable border and outputting a detected trajectory; and using the detected trajectory to align the first guidance system with the second guidance system to print the at least one three-dimensional object.

In some embodiments, the method further comprises after (c) and/or before (d), determining a length of the trajectory and using the length of the trajectory to align the first guidance system with the second guidance system to print the at least one three-dimensional object. In some embodiments, the trajectory comprises a line. In some embodiments, the line is a straight line. In some embodiments, the trajectory comprises a hatch. In some embodiments, the trajectory comprises a tile. In some embodiments, the trajectory is a shortest path from the position to the detectable border. In some embodiments, (b) comprises a plurality of irradiation pulses and a plurality of irradiation intermissions. In some embodiments, the plurality of irradiation pulses are spaced at a constant size along the test object. In some embodiments, the plurality of irradiation pulses comprises: (aa) irradiating the surface at a first position in a first time period to form a first tile, which first position is along a path-of-tiles, wherein the trajectory comprises the path-of-tiles, wherein during the first time period, the second energy beam is stationary or substantially stationary such that it at most undergoes back and forth movement with respect to the first position on the surface; (bb) translating the second energy beam to a second position of the surface along the path-of-tiles, which second position is different from the first position, which second energy beam is translated during an intermission of the plurality of intermissions without transforming a pre-transformed material along the path-of-tiles; and (cc) irradiating the surface at the second position with the second energy beam at the second position during a second time period to form a second tile, wherein during the second time period, the second energy beam is stationary or substantially stationary such that it at most undergoes back and forth movement with respect to the second position on the surface. In some embodiments, the second energy beam is moved by one step size between each irradiation pulse of the plurality of irradiation pulses. In some embodiments, a length of the trajectory is determined by a plurality of steps between the position and the detectable border. In some embodiments, a location of the test object is predetermined. In some embodiments, the position is predetermined. In some embodiments, detecting the trajectory of the second energy beam comprises detecting a signal corresponding to a temperature in a vicinity of a second energy beam footprint. In some embodiments, the detectable border is detectable as a temperature gradient. In some embodiments, the detectable border is formed by irradiating a border trajectory with the first energy beam or another energy beam to form a heat signature that forms the detectable border. In some embodiments, the detectable border is detected according to a threshold change in the temperature (b). In some embodiments, detecting the trajectory of the second energy beam comprises detecting a signal corresponding to a power output of an energy source that generates the second energy beam. In some embodiments, the power output is adjusted considering a detected temperature of a footprint of the second energy beam at the surface or in a vicinity thereof, to maintain a target temperature threshold (e.g., value). In some embodiments, the detectable border is detected according to a change in the power output during (b) while seeking to maintain the threshold. In some embodiments, the test object is anchored to the platform. In some embodiments, the test object comprises an auxiliary support structure that is or is not anchored with the platform. In some embodiments, the test object is disposed within a material bed that is supported by the platform. In some embodiments, the material bed comprises pre-transformed material. In some embodiments, printing the test object comprises transforming pre-transformed material to transformed material. In some embodiments, the detectable border comprises an edge. In some embodiments, the edge comprises a form transition or a type transition from a material of the surface to another material form and/or type. In some embodiments, the form transition comprises a transition in a physical form. In some embodiments, the form transition comprises a transition from a solid to a particulate form. In some embodiments, the type transition comprises a transition in a material type. In some embodiments, the type transition comprises a transition between a first material type and a second material type of a plurality of material types, the plurality of material types comprising: a metal; a ceramic; an alloy; an allotrope; an inorganic material; and an organic material. In some embodiments, the edge comprises a transition from a pre-transformed to a transformed material. In some embodiments, detecting the second energy beam comprises using a detector having a detection field, which detection field is aligned with a second energy beam footprint and is synchronized with a movement of the second energy beam footprint along the trajectory. In some embodiments, the platform comprises an exposed surface of a material bed. In some embodiments, the platform is disposed in an enclosure. In some embodiments, printing comprises transforming a pre-transformed material to a transformed material to print the three-dimensional object, wherein the enclosure comprises an inert and/or non-reactive atmosphere, which non-reactive is with the pre-transformed material or with the transformed material (e.g., during and/or after printing). In some embodiments, the enclosure comprises an atmosphere maintained at a pressure above ambient pressure. In some embodiments, to align comprises adjusting the first guidance system and/or the second guidance system. In some embodiments, to align comprises adjusting the first guidance system and the second guidance system with respect to each other and/or with respect to a detector. In some embodiments, to align comprises compensating a data array of directional commands corresponding to guided positions of the first energy beam and/or the second energy beam. In some embodiments, the compensating is provided to the programmed directions of at least one controller operatively coupled with the first guidance system or the second guidance system. In some embodiments, compensating comprises using a lookup table. In some embodiments, compensating is in-situ and/or in real time. In some embodiments, in real time comprises during the printing the at least one three-dimensional object. In some embodiments, the first guidance system and/or the second guidance system comprise a scanner, wherein to align comprises adjusting the scanner. In some embodiments, to align is to an angular accuracy of at most 40 micro radians or a higher accuracy. In some embodiments, to align is to an angular accuracy of at most 15 micro radians or a higher accuracy. In some embodiments, the first guidance system and/or the second guidance system comprise an optical system, wherein adjusting comprises adjusting one or more components of the optical system. In some embodiments, adjusting the first guidance system is across at least a portion of a first energy beam processing field and adjusting the second guidance system is across at least a portion of a second energy beam processing field. In some embodiments, adjusting is for an overlapping region of the first energy beam processing field and the second energy beam processing field. In some embodiments, adjusting the first guidance system or the second guidance system is across an (e.g., entire) processing field of the first energy beam or the second energy beam, respectively. In some embodiments, adjusting comprises a first adjustment in a first guidance direction (e.g., along an x-axis) and a second adjustment in a second guidance direction (e.g., along a y-axis). In some embodiments, the first guidance direction and the second guidance direction are orthogonal (e.g., and/or lateral). In some embodiments, the method further comprises aligning an orthogonal axis of the first guidance system and/or the second guidance system by repeating (a) through (d) along an orthogonal trajectory. In some embodiments, the method further comprises aligning the first guidance system and/or the second guidance system by repeating (a) through (d) along an anti-parallel trajectory. In some embodiments, the method further comprises aligning the first guidance system and/or the second guidance system by repeating (a) through (d) over a plurality of test objects in a plurality of locations in a first processing field and/or a second processing field. In some embodiments, an alignment from (d) is different for at least two locations of the plurality of locations. In some embodiments, adjusting is to a dimensional accuracy at a first processing field or a second processing field of at most about 50 microns or a higher accuracy. In some embodiments, the first energy beam and the second energy beam are two energy beams of a plurality of energy beams. In some embodiments, at least two energy beams of the plurality of energy beams are generated by the same energy source. In some embodiments, at least two energy beams of the plurality of energy beams are generated by different energy sources. In some embodiments, at least two energy beams of the plurality of energy beams are guided by the same guidance system. In some embodiments, at least two energy beams of the plurality of energy beams are guided by different guidance systems. In some embodiments, the method comprises performing (a)-(d) for at least three energy beams of the plurality of energy beams.

In another aspect, a system for printing a three-dimensional object comprises: a platform that comprises or support a target surface that includes an identifiable border; a first energy source that is structured to generate a first energy beam; a second energy source that is structured to generate a second energy beam; a first guidance system operatively coupled with the first energy source, which first guidance system is structured to direct the first energy beam across at least a first portion of the target surface; a second guidance system operatively coupled with the second energy source, which second guidance system is structured to direct the second energy beam across at least a second portion of the target surface that at least partially overlaps the first portion in an overlap portion, which overlap portion comprise at least a portion of the identifiable border; a detector operable to (a) detect the at least the portion of the identifiable border and (b) follow and detect the first energy beam and the second energy beam as they traverse along a requested trajectory along the target surface in the overlap portion, which requested trajectory comprises the at least the portion of the identifiable border; and at least one controller operatively coupled to the detector, the second guidance system, the first guidance system, the first energy source, and the second energy source, which at least one controller is configured to (i) direct the first energy source to generate the first energy beam, (ii) direct the first guidance system to guide the first energy beam along the requested trajectory and along a direction, (iii) direct the detector to detect the first energy beam as it propagates along the requested trajectory at the target surface from a position in the requested trajectory to the identifiable border and output a first detected trajectory, (iv) direct the second energy source to generate the second energy beam, (v) direct the second guidance system to guide the second energy beam along the requested trajectory and along the direction, (vi) direct the detector to detect the second energy beam as it propagates along the requested trajectory at the target surface from the position in the requested trajectory to the identifiable border and output a second detected trajectory, (vii) direct evaluation of a deviation between the first detected trajectory and the second detected trajectory, and (viii) direct using the deviation to align the first guidance system with the second guidance system to print the at least one three-dimensional object.

In some embodiments, the at least one controller is configured to use the first energy beam and/or the second energy beam in the printing of the three-dimensional object. In some embodiments, the at least one controller is configured to use the first guidance system and/or the second guidance system in the printing of the three-dimensional object. In some embodiments, the identifiable border comprises a detectably different temperature from a surrounding region. In some embodiments, the identifiable border comprises a detectably different reflectivity and/or specularity from a surrounding region. In some embodiments, the identifiable border has a varied temperature profile. In some embodiments, the identifiable border has a thickness that is larger than a FLS of a first footprint, a second footprint, and/or a detector field of view. In some embodiments, the at least one controller is configured for generating the identifiable border by heating the target surface with: the first energy beam, the second energy beam, and/or another energy beam. In some embodiments, the identifiable border has a width that is larger than an FLS of a cross section of the first energy beam and/or the second energy beam. In some embodiments, the identifiable border is coupled with a platform. In some embodiments, the identifiable border comprises a support coupled with a platform. In some embodiments, the identifiable border is disposed on the target surface of a material bed that is supported by a platform. In some embodiments, an initial position of a first requested trajectory is the same as an initial position of a second requested trajectory. In some embodiments, a first requested trajectory and a second requested trajectory are parallel. In some embodiments, a first requested trajectory and a second requested trajectory overlap at least in part. In some embodiments, a first requested trajectory and a second requested trajectory are non-parallel. In some embodiments, during (iii) and (vi), a first detected signal and a second detected signal corresponds with a location of the first detected trajectory and the second detected trajectory respectively, at which the identifiable border is traversed. In some embodiments, the first detected signal comprises the first detected border signal and wherein the wherein the second detected signal comprises the second detected border signal. In some embodiments, the at least one controller is configured to use the evaluation of the deviation by comparing one or more characteristics of an anticipated border signal with one or more respective characteristics of the first detected border signal and/or with the second detected border signal. In some embodiments, the one or more characteristics comprises a shape of at least a portion of a signal (e.g., anticipated border, first detected border and/or second detected border), an intensity of at least a portion of the signal, a location of at least a portion of the signal, or a timing of at least a portion of the signal. In some embodiments, the at least the portion of the signal may correspond to at least a portion of a border width. In some embodiments, the material bed comprises pre-transformed material. In some embodiments, the at least one controller is further configured for aligning an orthogonal axis of the first guidance system and/or the second guidance system by repeating (i) through (viii) along an orthogonal first trajectory and an orthogonal second trajectory. In some embodiments, the at least one controller is further configured for aligning the first guidance system and/or the second guidance system by repeating (i) through (viii) along an anti-parallel first trajectory and an anti-parallel second trajectory. In some embodiments, the at least one controller is further configured to direct aligning the first guidance system and/or the second guidance system by repeating (i) through (viii) over a plurality of identifiable borders in a plurality of locations on the target surface. In some embodiments, an alignment from (viii) is different for at least two locations of the plurality of locations. In some embodiments, to align comprises an adjustment to the first guidance system and/or the second guidance system. In some embodiments, the adjustment comprises adjusting a scanner. In some embodiments, the adjustment comprises adjusting an optical system. In some embodiments, the adjustment comprises altering a setting of at least one element in an optical system of the first guidance system and/or second guidance system. In some embodiments, the adjustment comprises altering at least one direction that directs the manner of using the first guidance system and/or second guidance system. In some embodiments, the adjustment the first guidance system is across at least a portion of a first energy beam processing field and/or adjusting the second guidance system is across at least a portion of a second energy beam processing field. In some embodiments, the adjustment is directed at an overlapping region of the first energy beam processing field and the second energy beam processing field. In some embodiments, the adjustment results in the at least one controller coinciding a traversal of the first energy beam and the second energy beam at least in an overlapping region of their respective processing fields. In some embodiments, the adjustment is across an entire processing field of the first energy beam or the second energy beam. In some embodiments, the adjustment comprises a first adjustment in a first guidance direction (e.g., along an x-axis) and a second adjustment in a second guidance direction (e.g., along a y-axis). In some embodiments, the first guidance direction and the second guidance direction are orthogonal. In some embodiments, the adjustment is in real time. In some embodiments, in real time comprises during the printing the at least one three-dimensional object. In some embodiments, the adjustment is to an angular accuracy of at most 40 micro radians or a greater accuracy. In some embodiments, the adjustment is to a dimensional accuracy at a first processing field or a second processing field of at most 50 microns or a greater accuracy. In some embodiments, the first energy source and the second energy source are the same. In some embodiments, the first energy beam and the second energy beam are the same. In some embodiments, the first guidance system and the second guidance system are the same. In some embodiments, the first energy source and the second energy source are different. In some embodiments, the first energy beam and the second energy beam are different. In some embodiments, the first guidance system and the second guidance system are different. In some embodiments, the first portion of the target surface and the second portion of the target surface are the same. In some embodiments, the first energy beam has a first footprint on the target surface. In some embodiments, the second energy beam has a second footprint on the target surface. In some embodiments, the detector is operable to detect impingement of the first energy beam and the second energy beam on the target surface. In some embodiments, the detector is operable to detect a thermal signal. In some embodiments, the detector comprises a first detector to detect the first detected trajectory, and a second detector to detect the second detected trajectory. In some embodiments, the at least one controller is further configured for, prior to (iii), aligning the first detector with the first energy beam. In some embodiments, the at least one controller is further configured for, prior to (vi), aligning the second detector with the second energy beam. In some embodiments, the first detector is different than the second detector. In some embodiments, the first detector is the same as the second detector. In some embodiments, the first detector and/or second detector comprises a one-pixel detector. In some embodiments, the detector comprises a plurality of detection units. In some embodiments, the plurality of detector units is arranged in a pre-determined arrangement. In some embodiments, the plurality of detector units is arranged in an array. In some embodiments, the plurality of detector units is arranged in a grid. In some embodiments, at least one of the detection units comprises a fiber coupled to a single pixel detector. In some embodiments, the detector comprises a bore-sight view of the target surface, which bore-sight view comprises a shared portion of an energy beam optical path for detecting the trajectory. In some embodiments, the detector comprises a non-direct view of the identifiable border. In some embodiments, the first energy beam and the second energy beam are two energy beams of a plurality of energy beams. In some embodiments, at least two energy beams of the plurality of energy beams are generated by the same energy source. In some embodiments, at least two energy beams of the plurality of energy beams are generated by different energy sources. In some embodiments, at least two energy beams of the plurality of energy beams are guided by the same guidance system. In some embodiments, at least two energy beams of the plurality of energy beams are guided by different guidance systems. In some embodiments, the system comprises performing (i)-(viii) for at least three energy beams of the plurality of energy beams. In some embodiments, at least two of (i), (ii), (iii), (iv), (v), (vi), (vii) and (viii) are directed by different controllers that are operatively coupled. In some embodiments, at least two of (i), (ii), (iii), (iv), (v), (vi), (vii) and (viii) are directed by the same controller.

In another aspect, an apparatus for printing at least one three-dimensional object, comprises at least one controller that operatively couples with one or more of a first energy source that generates a first energy beam, a second energy source that generates a second energy beam, a first guidance system operatively coupled with the first energy source, a second guidance system operatively coupled with the second energy source, and a detector operable to (a) detect the at least a portion of an identifiable border and (b) follow and detect the first energy beam and the second energy beam as they traverse along a requested trajectory along a target surface in an overlap portion, which requested trajectory comprises the at least the portion of the identifiable border, which at least one controller is configured to direct performance of the following operations: using the first guidance system to traverse the first energy beam across the identifiable border along a first trajectory, which identifiable border is disposed on a surface, which first energy beam has a first footprint on the surface; using the detector to detect the first trajectory, which detector is aligned with the first footprint and follows the first footprint along the first trajectory to output a first detected trajectory; using the second guidance system to traverse the second energy beam across the identifiable border along a second trajectory, which second energy beam has a second footprint on the surface; using the detector to detect the second trajectory, which detector is aligned with the second footprint and follows the second footprint along the second trajectory to output a second detected trajectory; evaluating a deviation between the first detected trajectory and the second detected trajectory to produce an evaluation; and using the evaluation to align the first guidance system and/or the second guidance system to print the at least one three-dimensional object.

In some embodiments, the apparatus comprises the at least one controller configured for using the first guidance system and/or the second guidance system in the printing of the three-dimensional object. In some embodiments, the apparatus comprises the at least one controller configured for using the first energy beam and/or the second energy beam in the printing of the three-dimensional object. In some embodiments, the first guidance system is different from the second guidance system. In some embodiments, the first guidance system is the same as the second guidance system. In some embodiments, the identifiable border comprises a detectably different temperature from a surrounding region. In some embodiments, the identifiable border comprises a detectably different reflectivity and/or specularity from a surrounding region. In some embodiments, the at least one controller is configured for generating the identifiable border by heating the surface with: the first energy beam, the second energy beam, and/or another energy beam. In some embodiments, the identifiable border has a width that is larger than the FLS of a cross section of the first energy beam and/or the second energy beam. In some embodiments, the identifiable border is coupled with a platform. In some embodiments, the identifiable border comprises a support coupled with a platform. In some embodiments, the identifiable border is disposed on the surface of a material bed that is supported by a platform. In some embodiments, the material bed comprises pre-transformed material. In some embodiments, the detector comprises a first detector to detect the first trajectory, and a second detector to detect the second trajectory. In some embodiments, the at least one controller is further configured for prior to (b), aligning the first detector with the first energy beam. In some embodiments, the at least one controller is further configured for prior to (d), aligning the second detector with the second energy beam. In some embodiments, the first detector is different than the second detector. In some embodiments, the first detector is the same as the second detector. In some embodiments, the first detector and/or the second detector comprises a one-pixel detector. In some embodiments, the detector comprises a plurality of detection units. In some embodiments, the plurality of detector units is arranged in a pre-determined arrangement. In some embodiments, the plurality of detector units is arranged in an array. In some embodiments, the plurality of detector units is arranged in a grid. In some embodiments, at least one of the detection units comprises a fiber coupled to a single pixel detector. In some embodiments, the detector comprises a bore-sight view of the surface, which bore-sight view comprises a shared portion of an energy beam optical path for detecting the first trajectory and/or the second trajectory. In some embodiments, detecting the first trajectory and/or the second trajectory comprises a non-direct view of the identifiable border. In some embodiments, the detector is operable to detect impingement of the first energy beam and the second energy beam on the target surface. In some embodiments, the identifiable border has a varied temperature profile. In some embodiments, the identifiable border has a thickness that is larger than a FLS the first footprint, the second footprint, and/or a detector field of view. In some embodiments, an initial position of the first trajectory is the same as an initial position of the second trajectory. In some embodiments, the first trajectory and the second trajectory are parallel. In some embodiments, the first trajectory and the second trajectory overlap at least in part. In some embodiments, the first trajectory and the second trajectory are non-parallel. In some embodiments, during (a) and (c), a first detected signal and a second detected signal corresponds with a location of the first trajectory and the second trajectory respectively, at which the identifiable border is traversed. In some embodiments, the first detected signal comprises the first detected border signal and wherein the wherein the second detected signal comprises the second detected border signal. In some embodiments, the at least one controller is configured for evaluating the deviation by comparing one or more characteristics of an anticipated border signal with one or more respective characteristics of the first detected border signal and/or with the second detected border signal. In some embodiments, the one or more characteristics comprises a shape of at least a portion of a signal (e.g., anticipated border, first detected border and/or second detected border), an intensity of at least a portion of the signal, a location of at least a portion of the signal, or a timing of at least a portion of the signal. In some embodiments, the at least the portion of the signal may correspond to at least a portion of a border width. In some embodiments, the at least one controller is further configured for aligning an orthogonal axis of the first guidance system and/or the second guidance system by repeating (a) through (g) along an orthogonal first trajectory and an orthogonal second trajectory. In some embodiments, the at least one controller is further configured for aligning the first guidance system and/or the second guidance system by repeating (a) through (g) along an anti-parallel first trajectory and an anti-parallel second trajectory. In some embodiments, the at least one controller is further configured for aligning the first guidance system and/or the second guidance system by repeating (a) through (g) over a plurality of identifiable borders in a plurality of locations on the surface. In some embodiments, an alignment from (g) is different for at least two locations of the plurality of locations. In some embodiments, to align comprises adjusting the first guidance system and/or the second guidance system. In some embodiments, adjusting comprises adjusting a scanner. In some embodiments, adjusting comprises adjusting an optical system. In some embodiments, adjusting comprises altering a setting of at least one element in an optical system of the first guidance system and/or second guidance system. In some embodiments, adjusting comprises altering at least one direction that directs the manner of using the first guidance system and/or second guidance system. In some embodiments, adjusting the first guidance system is across at least a portion of a first energy beam processing field and/or adjusting the second guidance system is across at least a portion of a second energy beam processing field. In some embodiments, adjusting is directed at an overlapping region of the first energy beam processing field and the second energy beam processing field. In some embodiments, adjusting results in the at least one controller coinciding a traversal of the first energy beam and the second energy beam at least in an overlapping region of their respective processing fields. In some embodiments, adjusting is across an entire processing field of the first energy beam or the second energy beam. In some embodiments, adjusting comprises a first adjustment in a first guidance direction (e.g., along an x-axis) and a second adjustment in a second guidance direction (e.g., along a y-axis). In some embodiments, the first guidance direction and the second guidance direction are orthogonal. In some embodiments, adjusting is in real time. In some embodiments, in real time comprises during the printing the at least one three-dimensional object. In some embodiments, adjusting is to an angular accuracy of at most 40 micro radians or a greater accuracy. In some embodiments, adjusting is to a dimensional accuracy at a first processing field or a second processing field of at most 50 microns or a greater accuracy. In some embodiments, the first energy beam and the second energy beam are two energy beams of a plurality of energy beams. In some embodiments, at least two energy beams of the plurality of energy beams are generated by the same energy source. In some embodiments, at least two energy beams of the plurality of energy beams are generated by different energy sources. In some embodiments, at least two energy beams of the plurality of energy beams are guided by the same guidance system. In some embodiments, at least two energy beams of the plurality of energy beams are guided by different guidance systems. In some embodiments, the apparatus comprises performing (a)-(e) for at least three energy beams of the plurality of energy beams. In some embodiments, the at least one controller comprises an electrical circuit. In some embodiments, the at least one controller comprises a socket. In some embodiments, the at least one controller comprises an electronic board. In some embodiments, at least two of (a), (b), (c), (d), (e), (f), and (g) are directed by different controllers that are operatively coupled. In some embodiments, at least two of (a), (b), (c), (d), (e), (f), and (g) are directed by the same controller.

In another aspect, a method for printing at least one three-dimensional object, comprises: using a first guidance system to traverse a first energy beam across an identifiable border along a first trajectory, which identifiable border is disposed on a surface, which first energy beam has a first footprint on the surface; using a first detector to detect the first trajectory, which first detector is aligned with the first footprint and follows the first footprint along the first trajectory to output a first detected trajectory; using a second guidance system to traverse a second energy beam across the identifiable border along a second trajectory, which second energy beam has a second footprint on the surface; using a second detector to detect the second trajectory, which second detector is aligned with the second footprint and follows the second footprint along the second trajectory to output a second detected trajectory; evaluating a deviation between the first detected trajectory and the second detected trajectory to produce an evaluation; and using the evaluation to align the first guidance system and/or the second guidance system to print the at least one three-dimensional object.

In some embodiments, the method comprises using the first guidance system and/or the second guidance system in the printing of the three-dimensional object. In some embodiments, the method comprises using the first energy beam and/or the second energy beam in the printing of the three-dimensional object. In some embodiments, the first guidance system is different from the second guidance system. In some embodiments, the first guidance system is the same as the second guidance system. In some embodiments, the method further comprises prior to (b), aligning the first detector with the first energy beam. In some embodiments, the method further comprises prior to (d), aligning the second detector with the second energy beam. In some embodiments, the identifiable border comprises a detectably different temperature from a surrounding region. In some embodiments, the identifiable border comprises a detectably different reflectivity and/or specularity from a surrounding region. In some embodiments, the identifiable border is generated by heating the surface with: the first energy beam, the second energy beam, and/or another energy beam. In some embodiments, the identifiable border has a width that is larger than the FLS of a cross section of the first energy beam and/or the second energy beam. In some embodiments, the identifiable border is coupled with a platform. In some embodiments, the identifiable border comprises a support coupled with a platform. In some embodiments, the identifiable border is disposed on the surface of a material bed that is supported by a platform. In some embodiments, the material bed comprises pre-transformed material. In some embodiments, the first detector is different than the second detector. In some embodiments, the first detector is the same as the second detector. In some embodiments, the first detector and/or the second detector comprises a one-pixel detector. In some embodiments, detecting the first trajectory and/or the second trajectory comprises using a bore-sight view of the surface, which bore-sight view comprises a shared portion of an energy beam optical path. In some embodiments, detecting the first trajectory and/or the second trajectory comprises a non-direct view of the identifiable border. In some embodiments, the identifiable border has a varied temperature profile. In some embodiments, the identifiable border has a thickness that is larger than a FLS the first footprint, the second footprint, and/or a detector field of view. In some embodiments, an initial position of the first trajectory is the same as an initial position of the second trajectory. In some embodiments, the first trajectory and the second trajectory are parallel. In some embodiments, the first trajectory and the second trajectory overlap at least in part. In some embodiments, the first trajectory and the second trajectory are non-parallel. In some embodiments, during (a) and (c), a first detected signal and a second detected signal corresponds with a location of the first trajectory and the second trajectory respectively, at which the identifiable border is traversed. In some embodiments, the first detected signal comprises the first detected border signal and wherein the wherein the second detected signal comprises the second detected border signal. In some embodiments, evaluating the deviation comprises comparing one or more characteristics of an anticipated border signal with one or more respective characteristics of the first detected border signal and/or with the second detected border signal. In some embodiments, the one or more characteristics comprises a shape of at least a portion of a signal (e.g., anticipated border, first detected border and/or second detected border), an intensity of at least a portion of the signal, a location of at least a portion of the signal, or a timing of at least a portion of the signal. In some embodiments, the at least the portion of the signal may correspond to at least a portion of a border width. In some embodiments, the method further comprises aligning an orthogonal axis of the first guidance system and/or the second guidance system by repeating (a) through (g) along an orthogonal first trajectory and an orthogonal second trajectory. In some embodiments, the method further comprises aligning the first guidance system and/or the second guidance system by repeating (a) through (g) along an anti-parallel first trajectory and an anti-parallel second trajectory. In some embodiments, the method further comprises aligning the first guidance system and/or the second guidance system by repeating (a) through (g) over a plurality of identifiable borders in a plurality of locations on the surface. In some embodiments, an alignment from (g) is different for at least two locations of the plurality of locations. In some embodiments, to align comprises adjusting the first guidance system and/or the second guidance system. In some embodiments, adjusting comprises adjusting a scanner. In some embodiments, adjusting comprises adjusting an optical system. In some embodiments, adjusting comprises altering a setting of at least one element in an optical system of the first guidance system and/or second guidance system. In some embodiments, adjusting comprises altering at least one direction that directs the manner of using the first guidance system and/or second guidance system. In some embodiments, adjusting the first guidance system is across at least a portion of a first energy beam processing field and/or adjusting the second guidance system is across at least a portion of a second energy beam processing field. In some embodiments, adjusting is directed at an overlapping region of the first energy beam processing field and the second energy beam processing field. In some embodiments, adjusting results in coinciding a traversal of the first energy beam and the second energy beam at least in an overlapping region of their respective processing fields. In some embodiments, adjusting is across an entire processing field of the first energy beam or the second energy beam. In some embodiments, adjusting comprises a first adjustment in a first guidance direction (e.g., along an x-axis) and a second adjustment in a second guidance direction (e.g., along a y-axis). In some embodiments, the first guidance direction and the second guidance direction are orthogonal. In some embodiments, adjusting is in real time. In some embodiments, in real time comprises during the printing the at least one three-dimensional object. In some embodiments, adjusting is to an angular accuracy of at most 40 micro radians or a greater accuracy. In some embodiments, adjusting is to a dimensional accuracy at a first processing field or a second processing field of at most 50 microns or a greater accuracy. In some embodiments, the first energy beam and the second energy beam are two energy beams of a plurality of energy beams. In some embodiments, at least two energy beams of the plurality of energy beams are generated by the same energy source. In some embodiments, at least two energy beams of the plurality of energy beams are generated by different energy sources. In some embodiments, at least two energy beams of the plurality of energy beams are guided by the same guidance system. In some embodiments, at least two energy beams of the plurality of energy beams are guided by different guidance systems. In some embodiments, the method comprises performing (a)-(e) for at least three energy beams of the plurality of energy beams.

In another aspect, a system for printing a three-dimensional object comprises: a target surface comprises a detectable border; an energy source structured to generate an energy beam, which energy beam comprises a footprint at the target surface; a detector that is structured to detect the detectable border and the footprint, and move a field of view of the detector synchronously with the footprint, which field of view at least partially overlaps the target surface; and at least one controller operatively coupled to the detector and the energy source, which at least one controller is configured to (i) direct the energy source generate an energy beam that has a footprint on the target surface, (ii) direct the footprint and the field of view to synchronously translate across the detectable border along a first trajectory in a first direction and output a first signal associated with the first trajectory, (iii) direct the footprint and the field of view to synchronously translate across the detectable border along a second trajectory in a second direction that has at least one directional component opposite to the first direction, and output a second signal associated with the second trajectory (iv) compare the first signal with the second signal to form an evaluation, (v) use the evaluation to align the field of view with the footprint to the footprint to print the at least one three-dimensional object.

In some embodiments, the first trajectory and the second trajectory are the same. In some embodiments, the first trajectory and the second trajectory have a same length. In some embodiments, the first trajectory and the second trajectory are different. In some embodiments, the first trajectory and the second trajectory comprise different initial positions at the target surface. In some embodiments, the second direction is at an acute angle to the first direction. In some embodiments, the second direction is anti-parallel to the first direction. In some embodiments, the at least one directional component comprises a lateral directional component. In some embodiments, the at least one directional component comprises a horizontal directional component. In some embodiments, to compare in (iv) comprises to calculate a deviation between the first signal and the second signal. In some embodiments, to form an evaluation in (iv) comprises to calculate a result. In some embodiments, the detectable border comprises a first portion that is separated by a border from a second portion. In some embodiments, the at least one controller is further configured to direct the footprint and the field of view to synchronously translate from the first portion across the detectable border to the second portion along the first trajectory in the first direction. In some embodiments, the system comprises the at least one controller using the energy beam in the printing of the three-dimensional object. In some embodiments, the at least one controller is further configured for after (i) and/or before (v), determining a length of the first trajectory and/or the second trajectory and using the length of the first trajectory and/or the second trajectory to align the field of view with the footprint to print the at least one three-dimensional object. In some embodiments, to align the field of view comprises the at least one controller comparing one or more characteristics of an anticipated border signal with one or more respective characteristics of the first signal and/or the second signal. In some embodiments, the one or more characteristics comprises a shape of at least a portion of the first and/or the second signal, an intensity of at least a portion of the first and/or the second signal, a location of at least a portion of the first and/or the second signal, or a timing of at least a portion of the first and/or the second signal. In some embodiments, a location of the detectable border is predetermined. In some embodiments, the detector is a point detector. In some embodiments, the detectable border has a detected property that is varied across the detectable border (e.g., in the first direction). In some embodiments, the detectable border has a varied temperature profile. In some embodiments, the detectable border is detected as a temperature gradient. In some embodiments, the at least one controller is configured to direct forming the detectable border by directing the energy beam or another energy beam to irradiate a border trajectory to form a heat signature that forms the detectable border. In some embodiments, the detectable border has a thickness that is larger than the footprint and/or the field of view. In some embodiments, the detector comprises a bore-sight view of the target surface, which bore-sight view comprises a shared portion of an energy beam optical path. In some embodiments, the at least one controller is further configured to align an orthogonal axis of the field of view with the footprint by repeating (i) through (v) along an orthogonal trajectory. In some embodiments, the at least one controller is further configured to align the field of view with the footprint by repeating (i) through (v) along an anti-parallel trajectory. In some embodiments, (i) through (v) are in real time. In some embodiments, in real time comprises during the printing the at least one three-dimensional object. In some embodiments, the detectable border is comprised by an object coupled with a platform that supports the target surface. In some embodiments, the detectable border comprises a support coupled with the platform. In some embodiments, the detectable border is disposed within a material bed supported by a platform. In some embodiments, the material bed comprises pre-transformed material. In some embodiments, the at least one controller is further configured to direct forming the detectable border by directing an energy beam to transform pre-transformed material to transformed material. In some embodiments, the at least one controller is configured to determine a field of view size of the detector based on a characteristic of the first signal and/or the second signal. In some embodiments, the characteristic is a width of the first signal and/or the second signal. In some embodiments, the width is a Full Width at Half Maximum (FWHM) of the signal. In some embodiments, the field of view size is a size along an axis that is orthogonal to the first direction and/or the second direction. In some embodiments, to align the field of view comprises an adjustment to one or more optical elements coupled with the detector. In some embodiments, the at least one controller is further configured to align the field of view with the footprint to an accuracy of at most about 40 microns or a greater accuracy. In some embodiments, at least two of (i), (ii), (iii), (iv), and (v) are directed by different controllers that are operatively coupled. In some embodiments, at least two of (i), (ii), (iii), (iv), and (v) are directed by the same controller.

In another aspect, an apparatus for printing of at least one three-dimensional object comprises at least one controller that operatively couples with one or more of an energy source that generates an energy beam, and a detector that is for detecting a border on a target surface, which at least one controller is configured to direct performance of the following operations: translating the energy beam across a detectable border along a trajectory in a direction, which detectable border is disposed at a surface, which energy beam comprises a footprint on the surface; directing the detector to (i) detect the footprint at least in part by moving a field of view of the detector synchronously with the footprint along the trajectory in the direction and (ii) detect a signal emitted from the surface and output a detected trajectory; and using the detected trajectory to align the field of view with the footprint to print the at least one three-dimensional object.

In some embodiments, the apparatus comprises the at least one controller using the energy beam in the printing of the three-dimensional object. In some embodiments, the at least one controller is further configured for after (b) and/or before (c), determining a length of the trajectory and using the length of the trajectory to align the field of view with the footprint to print the at least one three-dimensional object. In some embodiments, during (b), a first detected signal corresponds with a location of the trajectory at which the field of view has a maximum overlap with the detectable border. In some embodiments, to align the field of view comprises the at least one controller comparing one or more characteristics of an anticipated border signal with one or more respective characteristics of the first detected border signal. In some embodiments, the one or more characteristics comprises a shape of at least a portion of the first detected signal, an intensity of at least a portion of the first detected signal, a location of at least a portion of the first detected signal, or a timing of at least a portion of the first detected signal. In some embodiments, a location of the detectable border is predetermined. In some embodiments, the detector is a point detector. In some embodiments, the detectable border has a detected property that is varied across the detectable border (e.g., in the first direction). In some embodiments, the detectable border has a varied temperature profile. In some embodiments, the at least one controller is configured for detecting the detectable border as a temperature gradient. In some embodiments, the at least one controller is configured for forming the detectable border by irradiating a border trajectory with the energy beam or another energy beam to form a heat signature that forms the detectable border. In some embodiments, the detectable border has a thickness that is larger than the footprint and/or the field of view. In some embodiments, the at least one controller is configured for generating the detectable border by heating the surface with the energy beam or another energy beam. In some embodiments, the detector comprises a bore-sight view of the surface, which bore-sight view comprises a shared portion of an energy beam optical path. In some embodiments, the at least one controller is further configured for aligning the field of view with the footprint by repeating (a) through (c) along an anti-parallel trajectory. In some embodiments, the at least one controller is further configured for aligning an orthogonal axis of the field of view with the footprint by repeating (a) through (c) along an orthogonal trajectory. In some embodiments, the at least one controller is further configured for aligning the field of view with the footprint by repeating (a) through (c) along an anti-parallel trajectory. In some embodiments, (a) through (c) are in real time. In some embodiments, in real time comprises during the printing the at least one three-dimensional object. In some embodiments, the detectable border is comprised by an object coupled with a platform that supports the surface. In some embodiments, the detectable border comprises a support coupled with the platform. In some embodiments, the detectable border is disposed within a material bed supported by a platform. In some embodiments, the material bed comprises pre-transformed material. In some embodiments, the at least one controller is further configured for forming the detectable border by transforming pre-transformed material to transformed material by an energy beam. In some embodiments, the at least one controller is configured for determining a field of view size of the detector based on a characteristic of the signal. In some embodiments, the characteristic is a width of the signal. In some embodiments, the width is a Full Width at Half Maximum (FWHM) of the signal. In some embodiments, the field of view size is a size along an axis that is orthogonal to the direction. In some embodiments, to align the field of view comprises adjusting one or more optical elements coupled with the detector. In some embodiments, the at least one controller is further configured for aligning the field of view with the footprint to an accuracy of at most about 40 microns or a greater accuracy. In some embodiments, the at least one controller comprises an electrical circuit. In some embodiments, the at least one controller comprises a socket. In some embodiments, the at least one controller comprises an electronic board. In some embodiments, at least two of (a), (b), and (c) are directed by different controllers that are operatively coupled. In some embodiments, at least two of (a), (b), and (c) are directed by the same controller.

In another aspect, a method for printing of at least one three-dimensional object, comprises: translating an energy beam across a detectable border along a trajectory in a direction, which border is disposed at a surface, which energy beam comprises a footprint on the surface; directing a detector to (i) detect the footprint at least in part by moving a field of view of the detector synchronously with the footprint along the trajectory in the direction and (ii) detect a signal emitted from the surface and output a detected trajectory; and using the detected trajectory to align the field of view with the footprint to print the at least one three-dimensional object.

In some embodiments, the method comprises using the energy beam in the printing of the three-dimensional object. In some embodiments, the method further comprises after (b) and/or before (c), determining a length of the trajectory and using the length of the trajectory to align the field of view with the footprint to print the at least one three-dimensional object. In some embodiments, during (b), a first detected signal corresponds with a location of the trajectory at which the field of view has a maximum overlap with the detectable border. In some embodiments, to align the field of view comprises comparing one or more characteristics of an anticipated border signal with one or more respective characteristics of the first detected border signal. In some embodiments, the one or more characteristics comprises a shape of at least a portion of the first detected signal, an intensity of at least a portion of the first detected signal, a location of at least a portion of the first detected signal, or a timing of at least a portion of the first detected signal. In some embodiments, a location of the detectable border is predetermined. In some embodiments, the detector is a point detector. In some embodiments, the detectable border has a detected property that is varied across the detectable border (e.g., in the first direction). In some embodiments, the detectable border has a varied temperature profile. In some embodiments, the detectable border is detectable as a temperature gradient. In some embodiments, the detectable border is formed by irradiating a border trajectory with the energy beam or another energy beam to form a heat signature that forms the detectable border. In some embodiments, the detectable border has a thickness that is larger than the footprint and/or the field of view. In some embodiments, the detectable border is generated by heating the surface with the energy beam or another energy beam. In some embodiments, the detector comprises a bore-sight view of the surface, which bore-sight view comprises a shared portion of an energy beam optical path. In some embodiments, the method further comprises aligning the field of view with the footprint by repeating (a) through (c) along an anti-parallel trajectory. In some embodiments, the method further comprises aligning an orthogonal axis of the field of view with the footprint by repeating (a) through (c) along an orthogonal trajectory. In some embodiments, the method further comprises aligning the field of view with the footprint by repeating (a) through (c) along an anti-parallel trajectory. In some embodiments, (a) through (c) are in real time. In some embodiments, in real time comprises during the printing the at least one three-dimensional object. In some embodiments, the detectable border is comprised by an object coupled with a platform that supports the surface. In some embodiments, the detectable border comprises a support coupled with the platform. In some embodiments, the detectable border is disposed within a material bed supported by a platform. In some embodiments, the material bed comprises pre-transformed material. In some embodiments, the method further comprises forming the detectable border by transforming pre-transformed material to transformed material by an energy beam. In some embodiments, the method comprises determining a field of view size of the detector based on a characteristic of the signal. In some embodiments, the characteristic is a width of the signal. In some embodiments, the width is a Full Width at Half Maximum (FWHM) of the signal. In some embodiments, the field of view size is a size along an axis that is orthogonal to the direction. In some embodiments, to align the field of view comprises adjusting one or more optical elements coupled with the detector. In some embodiments, the method further comprises aligning the field of view with the footprint to an accuracy of at most about 40 microns or a greater accuracy.

In another aspect, a system for printing a three-dimensional object comprises: a target surface; an energy source operable to generate an energy beam, which energy beam comprises a footprint on the target surface; a detector having a field of view operable for synchronous movement with the footprint, the detector operable to detect a signal emitted from the footprint; and at least one controller operatively coupled to the detector and the energy source, which at least one controller is configured to (i) direct the energy source to generate the energy beam, (ii) direct the energy beam to translate along a first path in a first direction, (iii) direct the detector to move synchronously with the footprint along the first path in the first direction (iv) direct the detector to detect a first signal emitted from the footprint as the footprint traverses along the first path and to output a first detected path, (v) direct the energy beam to translate along a second path in a second direction that has at least one directional component opposite to the first path, (vi) direct the detector to move synchronously with the footprint along the second path in the second direction (vii) direct the detector to detect a second signal emitted from the footprint as the footprint traverses along the second path and to output a second detected path, (viii) evaluate a deviation between the first detected path and the second detected path to form an evaluation, and (ix) direct using the evaluation to align the field of view with the footprint to print the at least one three-dimensional object.

In some embodiments, the first path or the second path comprises a line. In some embodiments, the line is a straight line. In some embodiments, the first path or the second path comprises a hatch. In some embodiments, the first path or the second path comprises a tile. In some embodiments, the second path is at an acute angle to the first path. In some embodiments, the second path is anti-parallel to the first path. In some embodiments, the deviation comprises a signal magnitude deviation between the first signal and the second signal. In some embodiments, a relatively higher magnitude of (iv) the first signal or (vii) the second signal corresponds with a field of view alignment that is behind the energy beam, with respect to a direction of movement along the first or the second path. In some embodiments, a relatively lower magnitude of (iv) the first signal or (vii) the second signal corresponds with a field of view alignment that is ahead of the energy beam, with respect to a direction of movement along the first or the second path. In some embodiments, the detector comprises a bore-sight view of the target surface, which bore-sight view comprises a shared portion of an energy beam optical path. In some embodiments, to detect the first signal and/or the second signal comprises to detect a temperature of the footprint of the energy beam on the target surface, and/or a vicinity thereof. In some embodiments, the vicinity extends to at most six fundamental length scales of the footprint of the energy beam on the target surface. In some embodiments, to align the field of view comprises an adjustment to one or more optical elements coupled with the detector. In some embodiments, the at least one controller is further configured for aligning the field of view with the footprint to an accuracy of at most 40 microns or a greater accuracy. In some embodiments, the at least one controller is further configured for aligning an orthogonal axis of the field of view with the footprint by repeating (i) through (ix) along an orthogonal direction. In some embodiments, the at least one controller is further configured for aligning the field of view with the footprint by repeating (i) through (ix) along an anti-parallel direction. In some embodiments, the at least one controller is further configured for refining the aligning by repeating (i) through (ix) along a parallel or an anti-parallel direction. In some embodiments, the target surface is at an ambient temperature prior to (i). In some embodiments, the first path and/or the second path has a varied temperature profile. In some embodiments, (i) through (ix) are in real time. In some embodiments, in real time comprises during the printing the at least one three-dimensional object. In some embodiments, the target surface is adjacent to a platform. In some embodiments, the target surface comprises a heat sink. In some embodiments, at least two of (i), (ii), (iii), (iv), (v), (vi), (vii), (viii) and (ix) are directed by different controllers that are operatively coupled. In some embodiments, at least two of (i), (ii), (iii), (iv), (v), (vi), (vii), (viii) and (ix) are directed by the same controller.

In another aspect, an apparatus for printing at least one three-dimensional object comprises at least one controller that operatively couples with one or more of an energy source that generates an energy beam, the energy beam comprises a footprint on a target surface, and a detector that is for detecting a signal emitted from the footprint, which at least one controller is configured to direct performance of the following operations: directing the energy beam to irradiate the target surface along a first path in a first direction; directing (i) a field of view of the detector to move synchronously with the footprint along the first path in the first direction and (ii) the detector to detect a first signal emitted from the footprint along the first path in the first direction to output a first detected path; directing the energy beam to irradiate the target surface and translate along a second path in a second direction that has an opposite vector component as compared with the first direction; directing (iii) the field of view of the detector to move synchronously with the footprint along the second path in the second direction and (iv) the detector to detect a second signal emitted from the footprint along the second direction to output a second detected path; analyzing the first detected path and the second detected path to determine a deviation; and using the deviation to align the field of view with the footprint to print the at least one three-dimensional object.

In some embodiments, the first direction or the second direction comprises a line. In some embodiments, the line is a straight line. In some embodiments, the first direction or the second direction comprises a hatch. In some embodiments, the first direction or the second direction comprises a tile. In some embodiments, the second direction is at an acute angle to the first direction. In some embodiments, the energy beam in (c) is directed along a second path. In some embodiments, the second path is anti-parallel to the first path. In some embodiments, the deviation comprises a signal magnitude deviation between the first signal and the second signal. In some embodiments, a relatively higher magnitude of (ii) the first signal or (iv) the second signal corresponds with a field of view alignment that is behind the energy beam, with respect to a direction of movement along the first or the second path. In some embodiments, a relatively lower magnitude of (ii) the first signal or (iv) the second signal corresponds with a field of view alignment that is ahead of the energy beam, with respect to a direction of movement along the first or the second path. In some embodiments, the detector comprises a bore-sight view of the target surface, which bore-sight view comprises a shared portion of an energy beam optical path. In some embodiments, detecting the first signal and/or the second signal comprises detecting a temperature of the footprint of the energy beam on the target surface, and/or a vicinity thereof. In some embodiments, the vicinity extends to at most six fundamental length scales of the footprint of the energy beam on the target surface. In some embodiments, to align the field of view comprises adjusting one or more optical elements coupled with the detector. In some embodiments, the at least one controller is further configured for aligning the field of view with the footprint to an accuracy of at most 40 microns or a greater accuracy. In some embodiments, the at least one controller is further configured for aligning an orthogonal axis of the field of view with the footprint by repeating (a) through (c) along an orthogonal trajectory. In some embodiments, the at least one controller is further configured for aligning the field of view with the footprint by repeating (a) through (c) along an anti-parallel trajectory. In some embodiments, the at least one controller is further configured for refining the aligning by repeating (a) through (c) along a parallel or an anti-parallel trajectory. In some embodiments, the target surface is at an ambient temperature prior to (a). In some embodiments, the first path and/or the second path has a varied temperature profile. In some embodiments, (a) through (f) are in real time. In some embodiments, in real time comprises during the printing the at least one three-dimensional object. In some embodiments, the target surface is adjacent to a platform. In some embodiments, the target surface comprises a heat sink. In some embodiments, the at least one controller comprises an electrical circuit. In some embodiments, the at least one controller comprises a socket. In some embodiments, the at least one controller comprises an electronic board. In some embodiments, at least two of (a), (b), (c), (d), (e), and (f) are directed by different controllers that are operatively coupled. In some embodiments, at least two of (a), (b), (c), (d), (e), and (f) are directed by the same controller.

In another aspect, a method for printing of at least one three-dimensional object, comprises: directing an energy beam to irradiate a target surface along a first path in a first direction, which energy beam has a footprint on the target surface; directing (i) a field of view of a detector to move synchronously with the footprint along the first path in the first direction and (ii) the detector to detect a first signal emitted from the footprint along the first path in the first direction to output a first detected path; directing the energy beam to irradiate the target surface and translate along a second path in a second direction that has an opposite vector component as compared with the first direction; directing (iii) the field of view of the detector to move synchronously with the footprint along the second path in the second direction and (iv) the detector to detect a second signal emitted from the footprint along the second direction to output a second detected path; analyzing the first detected path and the second detected path to determine a deviation; and using the deviation to align the field of view with the footprint to print the at least one three-dimensional object.

In some embodiments, the first direction or the second direction comprises a line. In some embodiments, the line is a straight line. In some embodiments, the first direction or the second direction comprises a hatch. In some embodiments, the first direction or the second direction comprises a tile. In some embodiments, the second direction is at an acute angle to the first direction. In some embodiments, the energy beam in (c) is directed along a second path. In some embodiments, the second path is anti-parallel to the first path. In some embodiments, the deviation comprises a signal magnitude deviation between the first signal and the second signal. In some embodiments, a relatively higher magnitude of (i) the first signal or (ii) the second signal corresponds with a field of view alignment that is behind the energy beam, with respect to a direction of movement along the first or the second path. In some embodiments, a relatively lower magnitude of (i) the first signal or (ii) the second signal corresponds with a field of view alignment that is ahead of the energy beam, with respect to a direction of movement along the first or the second path. In some embodiments, the detector comprises a bore-sight view of the target surface, which bore-sight view comprises a shared portion of an energy beam optical path. In some embodiments, detecting the first signal and/or the second signal comprises detecting a temperature of the footprint of the energy beam on the target surface, and/or a vicinity thereof. In some embodiments, the vicinity extends to at most six fundamental length scales of the footprint of the energy beam on the target surface. In some embodiments, to align the field of view comprises adjusting one or more optical elements coupled with the detector. In some embodiments, the method further comprises aligning the field of view with the footprint to an accuracy of at most 40 microns or a greater accuracy. In some embodiments, the method further comprises aligning an orthogonal axis of the field of view with the footprint by repeating (a) through (c) along an orthogonal trajectory. In some embodiments, the method further comprises aligning the field of view with the footprint by repeating (a) through (c) along an anti-parallel trajectory. In some embodiments, the method further comprises refining the aligning by repeating (a) through (c) along a parallel or an anti-parallel trajectory. In some embodiments, the target surface is at an ambient temperature prior to (a). In some embodiments, the first path and/or the second path has a varied temperature profile. In some embodiments, (a) through (f) are in real time. In some embodiments, in real time comprises during the printing the at least one three-dimensional object. In some embodiments, the target surface is adjacent to a platform. In some embodiments, the target surface comprises a heat sink.

In another aspect, a system for printing a three-dimensional object comprises: a target surface; an energy source that is structured to generate an energy beam, which energy beam comprises a footprint on the target surface; an optical arrangement comprises one or more optical elements, which optical arrangement is structured to provide a requested focal setting, which optical arrangement has a calibrated (e.g., benchmark) focal setting curve relating the setting of the one or optical elements with respect to a focus of footprint as the energy beam travels though the optical arrangement and impinges on the target surface, wherein a setting of the one or more optical elements forms a sharp focus corresponding to a maximum of the curve; a detector operable to detect a signal emitted from the footprint; and at least one controller operatively coupled to the detector, the optical arrangement and the energy source, which at least one controller is configured to (i) direct the energy source to generate the energy beam, (ii) direct the optical arrangement to provide a first requested focal setting corresponding to a first side of the maximum of the curve having a first requested footprint, (iii) direct the energy beam through the optical arrangement having the first requested focal setting to irradiate the target surface to have a first actual footprint at the target surface, (iv) direct the detector to detect a first detected signal from the first actual footprint (e.g., during a first irradiation; (v) direct the optical arrangement to provide a second requested focal setting corresponding to a second side of the maximum of the curve having a second requested footprint, which second side opposes the first side, (vi) direct the energy beam through the optical arrangement having the second requested focal setting to irradiate the target surface to have a second actual footprint at the target surface, (vii) direct the detector to detect a second detected signal from the second actual footprint (e.g., during the first irradiation); (viii) evaluate a deviation between (I) the first requested footprint and the first detected signal, (II) the second requested footprint and the second detected signal, (Ill) the first detected signal and the second detected signal, and/or (IV) the first requested footprint and the second requested footprint; and (ix) direct using the deviation to adjust a focal setting of the optical arrangement to print the at least one three-dimensional object.

In some embodiments, the first detected signal comprises a first detected footprint. In some embodiments, the second detected signal comprises a second detected footprint. In some embodiments, the first detected signal is generated during a first irradiation. In some embodiments, the second detected signal is generated during a second irradiation. In some embodiments, to adjust in (ix) comprises an evaluation of a deviation in an effective focal length of the optical arrangement while considering the deviation. In some embodiments, to adjust the focal setting comprises an adjustment to the one or more optical elements of the optical arrangement. In some embodiments, prior to (i) at least one of the one or more optical elements of the optical arrangement are distorted. In some embodiments, a distortion of the at least one of the one or more optical elements comprises a change in temperature, a change in a refractive index, misalignment, or accumulation of debris, relative to a non-distorted condition. In some embodiments, the at least one controller is further configured to direct heating one or more elements of the optical arrangement prior to (i). In some embodiments, the at least one controller is further configured to direct varying a thermal condition of the optical arrangement by irradiating a heat sink. In some embodiments, heating comprises an irradiation of the energy beam through the optical arrangement. In some embodiments, the irradiation is at a constant power. In some embodiments, a duration of the irradiation is from about 100 milliseconds to about 2500 milliseconds. In some embodiments, the system comprises a sequence of irradiations at the constant power. In some embodiments, the (a) and (b) are performed between irradiations of the sequence of irradiations. In some embodiments, a benchmark comprises a relationship between a focal characteristic of the optical arrangement and detector signals, the benchmark comprising a first benchmark signal and a second benchmark signal. In some embodiments, the benchmark comprises a focal characteristic of the energy beam in a focal setting span of the optical arrangement. In some embodiments, the benchmark comprises a relationship between (1) an energy beam focus at a distance corresponding to the target surface and (2) a focal setting of the optical arrangement. In some embodiments, the benchmark comprises a maximum corresponding to a maximal focus. In some embodiments, the first detected signal and the second detected signal are at opposing sides of the maximum. In some embodiments, the opposing sides are directly (e.g., symmetrically) opposing sides. In some embodiments, the opposing sides are indirectly (e.g., asymmetrically) opposing sides. In some embodiments, the first requested focal setting and the second requested focal setting are selected such that an effective focal length deviation of the optical arrangement corresponds to a relative increase in (aa) the first detected signal compared to the first benchmark signal or (bb) the second detected signal compared to the second benchmark signal. In some embodiments, the first requested focal setting and the second requested focal setting are selected such that an effective focal length deviation of the optical arrangement corresponds to a relative decrease in (aa) the first detected signal compared to the first benchmark signal or (bb) the second detected signal compared to the second benchmark signal. In some embodiments, an effective focal length deviation of the optical arrangement corresponds to a relative increase in the other one of (aa) or (bb). In some embodiments, to evaluate the deviation in an effective focal length of the optical arrangement comprises a determination of a direction of deviation along an optical path of the optical arrangement. In some embodiments, the determination of the direction of deviation comprises a determination of a convergence or a divergence with respect to the first focal setting and/or the second focal setting. In some embodiments, to evaluate the deviation in an effective focal length of the optical arrangement comprises to an accuracy in a magnitude of the deviation to about 15 microns or a higher accuracy. In some embodiments, the at least one controller is further configured to determine an estimated footprint of the energy beam while considering the deviation in (ix). In some embodiments, an accuracy of a determination of the estimated footprint of the energy beam is to about 8 microns or a higher accuracy. In some embodiments, the at least one controller is further configured to direct maintaining a pressure at or above ambient pressure. In some embodiments, a first benchmark signal and a second benchmark signal are of respective benchmark first and second returning radiations from the target surface or a different surface. In some embodiments, the different surface comprises a benchmark calibration structure. In some embodiments, a benchmark relationship comprises a set of requested footprints on the benchmark calibration structure and an associated set of associated benchmark signals generated from respective returning benchmark radiations from the benchmark calibration structure. In some embodiments, the at least one controller is further configured to direct forming the benchmark calibration structure by directing a transformation of a portion of pre-transformed material at the target surface to transformed material. In some embodiments, forming the benchmark calibration structure is performed in real time during the printing. In some embodiments, the optical arrangement is at or above an ambient temperature while generating the benchmark returning radiations. In some embodiments, the at least one controller is further configured to direct controlling irradiation of the heat sink through the optical arrangement. In some embodiments, controlling comprises controlling a throughput of energy irradiated through the optical arrangement and/or controlling a temperature of the one or more optical elements of the optical arrangement. In some embodiments, (i) through (ix) are performed in real time. In some embodiments, in real time comprises during printing of the three-dimensional object, during printing a plurality of layers as part of the three-dimensional object, or during printing of a layer of a three-dimensional object. In some embodiments, the at least one controller is further configured to direct controlling at least one characteristic of the energy beam having a requested energy beam footprint considering (viii), wherein the at least one characteristic of the energy beam comprises (A) a center position of the requested energy beam footprint, (B) a fundamental length scale of the requested energy beam footprint, (C) a measure of a power density distribution in the requested energy beam footprint, (D) a measure of an average power density in the requested energy beam footprint, or (E) a focal position of the requested energy beam footprint. In some embodiments, the detector comprises a bore-sight view of the target surface, which bore-sight view comprises a shared portion of an energy beam optical path. In some embodiments, the detector comprises a non-direct view of the target surface. In some embodiments, the first detected signal and/or the second detected signal comprises a detection of a temperature of the first requested footprint and/or the second requested footprint of the energy beam on the target surface, and/or a vicinity thereof. In some embodiments, the vicinity extends to at most six fundamental length scales of the first requested footprint and/or the second requested footprint of the energy beam on the target surface. In some embodiments, at least two of (i), (ii), (iii), (iv), (v), (vi), (vii), (viii) and (ix) are directed by different controllers that are operatively coupled. In some embodiments, at least two of (i), (ii), (iii), (iv), (v), (vi), (vii), (viii) and (ix) are directed by the same controller.

In another aspect, an apparatus for printing at least one three-dimensional object comprises at least one controller that operatively couples with one or more of an energy source that generates an energy beam, the energy beam comprises a footprint on a target surface, an optical arrangement comprises one or more optical elements, the optical arrangement structured to provide a requested focal setting, and a detector that is for detecting a signal emitted from the footprint, which at least one controller is configured to direct performance of the following operations: directing the energy beam through the optical arrangement to irradiate the target surface in a first irradiation to have a first footprint having a first irradiation focus at the target surface, which optical arrangement (I) is configured at a first requested focal setting and (II) comprises one or more optical elements, which optical arrangement has a calibrated (e.g., benchmark) focal setting curve relating the setting of the one or optical elements with respect to a focus of energy beam footprint as the energy beam travels though the optical arrangement and impinges on the target surface, wherein a setting of the one or more optical elements forms a sharp focus corresponding to a maximum of the curve; detecting a first signal from the first footprint of the energy beam at the target surface (e.g., during the first irradiation); altering the optical arrangement to have a second requested focal setting; directing the energy beam through the optical arrangement to irradiate the target surface in a second irradiation to have a second footprint having a second irradiation focus at the target surface; detecting a second signal from the second footprint of the energy beam at the target surface (e.g., during the second irradiation); evaluating a deviation in an effective focal length of the optical arrangement while considering a deviation between (i) the first signal and the second signal and/or (ii) the first signal and a first benchmark signal and the second signal and a second benchmark signal; and using the deviation in the effective focal length to adjust the one or more optical elements of the optical arrangement to print the at least one three-dimensional object.

In some embodiments, prior to (a) one or more optical elements of the optical arrangement are distorted. In some embodiments, a distortion of a distorted one or more optical elements comprises a change in temperature, a change in a refractive index, misalignment, or accumulation of debris, relative to a non-distorted condition. In some embodiments, the at least one controller is further configured for heating one or more elements of the optical arrangement prior to (a). In some embodiments, the at least one controller is further configured for varying a thermal condition of the optical arrangement by irradiating a heat sink. In some embodiments, heating comprises an irradiation of the energy beam through the optical arrangement. In some embodiments, the irradiation is at a constant power. In some embodiments, a duration of the irradiation is from about 100 milliseconds to about 2500 milliseconds. In some embodiments, the apparatus comprises a sequence of irradiations at the constant power. In some embodiments, the (a) and (b) are performed between irradiations of the sequence of irradiations. In some embodiments, a benchmark comprises a relationship between a focal characteristic of the optical arrangement and detector signals, the benchmark comprising the first benchmark signal and the second benchmark signal. In some embodiments, the benchmark comprises a focal characteristic of the energy beam in a focal setting span of the optical arrangement. In some embodiments, the benchmark comprises a relationship between (1) an energy beam focus at a distance corresponding to the target surface and (2) a focal setting of the optical arrangement. In some embodiments, the benchmark comprises a maximum corresponding to a maximal focus. In some embodiments, the first signal and the second signal are at opposing sides of the maximum. In some embodiments, the opposing sides are directly (e.g., symmetrically) opposing sides. In some embodiments, the opposing sides are indirectly (e.g., asymmetrically) opposing sides. In some embodiments, the first requested focal setting and the second requested focal setting are selected such that an effective focal length deviation of the optical arrangement corresponds to a relative increase in (i) the first signal compared to the first benchmark signal or (ii) the second signal compared to the second benchmark signal. In some embodiments, the first requested focal setting and the second requested focal setting are selected such that an effective focal length deviation of the optical arrangement corresponds to a relative decrease in (i) the first signal compared to the first benchmark signal or (ii) the second signal compared to the second benchmark signal. In some embodiments, the effective focal length deviation corresponds to a relative increase in the other one of (i) or (ii). In some embodiments, evaluating the deviation in the effective focal length comprises determining a direction of deviation along an optical path of the optical arrangement. In some embodiments, the determining the direction of deviation comprises determining a convergence or a divergence with respect to the first focal setting and/or the second focal setting. In some embodiments, evaluating the deviation in the effective focal length comprises an accuracy in a magnitude of the deviation from about 8 microns to about 15 microns. In some embodiments, the at least one controller is further configured for determining an estimated footprint of the energy beam while considering the deviation in (f). In some embodiments, an accuracy of the determining the estimated footprint of the energy beam is from about 2 microns to about 8 microns. In some embodiments, the at least one controller is further configured for maintaining a pressure at or above ambient pressure. In some embodiments, the first benchmark signal and the second benchmark signal are of respective benchmark first and second returning radiations from the target surface or a different surface. In some embodiments, the different surface comprises a benchmark calibration structure. In some embodiments, a benchmark relationship comprises a set of requested footprints on the benchmark calibration structure and an associated set of associated benchmark signals generated from respective returning benchmark radiations from the benchmark calibration structure. In some embodiments, the at least one controller is further configured for forming the benchmark calibration structure by transforming a portion of pre-transformed material at the target surface to transformed material. In some embodiments, forming the benchmark calibration structure is performed in real time during the printing. In some embodiments, the optical arrangement is at or above an ambient temperature while generating the benchmark returning radiations. In some embodiments, the at least one controller is further configured for controlling irradiating the heat sink through the optical arrangement. In some embodiments, controlling comprises controlling a throughput of energy irradiated through the optical arrangement and/or controlling a temperature of the one or more optical elements of the optical arrangement. In some embodiments, (a) through (f) are performed in real time. In some embodiments, in real time comprises during printing of the three-dimensional object, during printing a plurality of layers as part of the three-dimensional object, or during printing of a layer of a three-dimensional object. In some embodiments, the at least one controller is further configured for controlling at least one characteristic of the energy beam having a requested energy beam footprint considering (e), wherein the at least one characteristic of the energy beam comprises (i) a center position of the requested energy beam footprint, (ii) a fundamental length scale of the requested energy beam footprint, (iii) a measure of a power density distribution in the requested energy beam footprint, (iv) a measure of an average power density in the requested energy beam footprint, or (iv) a focal position of the requested energy beam footprint. In some embodiments, detecting the first signal and/or the second signal comprises using a bore-sight view of the target surface, which bore-sight view comprises a shared portion of an energy beam optical path. In some embodiments, detecting the first signal and/or the second signal comprises a non-direct view of the target surface. In some embodiments, detecting the first signal and/or the second signal comprises detecting a temperature of the first footprint and/or the second footprint of the energy beam on the target surface, and/or a vicinity thereof. In some embodiments, the vicinity extends to at most six fundamental length scales of the first footprint and/or the second footprint of the energy beam on the target surface. In some embodiments, the at least one controller comprises an electrical circuit. In some embodiments, the at least one controller comprises a socket. In some embodiments, the at least one controller comprises an electronic board. In some embodiments, at least two of (a), (b), (c), (d), (e), and (f) are directed by different controllers that are operatively coupled. In some embodiments, at least two of (a), (b), (c), (d), (e), and (f) are directed by the same controller.

In another aspect, a method for printing at least one three-dimensional object, comprises: directing an energy beam through an optical arrangement to irradiate a target surface in a first irradiation to have a first footprint having a first irradiation focus at the target surface, which optical arrangement (I) is configured at a first requested focal setting and (II) comprises one or more optical elements, which optical arrangement has a calibrated (e.g., benchmark) focal setting curve relating the setting of the one or optical elements with respect to a focus of energy beam footprint as the energy beam travels though the optical arrangement and impinges on the target surface, wherein a setting of the one or more optical elements forms a sharp focus corresponding to a maximum of the curve; detecting a first signal from the first footprint of the energy beam at the target surface (e.g., during the first irradiation); altering the optical arrangement to have a second requested focal setting; directing an energy beam through the optical arrangement to irradiate the target surface in a second irradiation to have a second footprint having a second irradiation focus at the target surface; detecting a second signal from the second footprint of the energy beam at the target surface (e.g., during the second irradiation); evaluating a deviation in an effective focal length of the optical arrangement while considering a deviation between (i) the first signal and the second signal and/or (ii) the first signal and a first benchmark signal and the second signal and a second benchmark signal; and using the deviation in the effective focal length to adjust the one or more optical elements of the optical arrangement to print the at least one three-dimensional object.

In some embodiments, prior to (a) one or more optical elements of the optical arrangement are distorted. In some embodiments, a distortion of the distorted one or more optical elements comprises a change in temperature, a change in a refractive index, misalignment, or accumulation of debris, relative to a non-distorted condition. In some embodiments, the method further comprises heating one or more elements of the optical arrangement prior to (a). In some embodiments, the method further comprises varying a thermal condition of the optical arrangement by irradiating a heat sink. In some embodiments, heating comprises an irradiation of the energy beam through the optical arrangement. In some embodiments, the irradiation is at a constant power. In some embodiments, a duration of the irradiation is from about 100 milliseconds to about 2500 milliseconds. In some embodiments, the method comprises a sequence of irradiations at the constant power. In some embodiments, the (a) and (b) are performed between irradiations of the sequence of irradiations. In some embodiments, a benchmark comprises a relationship between a focal characteristic of the optical arrangement and detector signals, the benchmark comprising the first benchmark signal and the second benchmark signal. In some embodiments, the benchmark comprises a focal characteristic of the energy beam in a focal setting span of the optical arrangement. In some embodiments, the benchmark comprises a relationship between (1) an energy beam focus at a distance corresponding to the target surface and (2) a focal setting of the optical arrangement. In some embodiments, the benchmark comprises a maximum corresponding to a maximal focus. In some embodiments, the first signal and the second signal are at opposing sides of the maximum. In some embodiments, the opposing sides are directly (e.g., symmetrically) opposing sides. In some embodiments, the opposing sides are indirectly (e.g., asymmetrically) opposing sides. In some embodiments, the first requested focal setting and the second requested focal setting are selected such that an effective focal length deviation of the optical arrangement corresponds to a relative increase in (i) the first signal compared to the first benchmark signal or (ii) the second signal compared to the second benchmark signal. In some embodiments, the first requested focal setting and the second requested focal setting are selected such that an effective focal length deviation of the optical arrangement corresponds to a relative decrease in (i) the first signal compared to the first benchmark signal or (ii) the second signal compared to the second benchmark signal. In some embodiments, the effective focal length deviation corresponds to a relative increase in the other one of (i) or (ii). In some embodiments, evaluating the deviation in the effective focal length comprises determining a direction of deviation along an optical path of the optical arrangement. In some embodiments, the determining the direction of deviation comprises determining a convergence or a divergence with respect to the first focal setting and/or the second focal setting. In some embodiments, evaluating the deviation in the effective focal length comprises an accuracy in a magnitude of the deviation from about 8 microns to about 15 microns. In some embodiments, the method further comprises determining an estimated footprint of the energy beam while considering the deviation in (f). In some embodiments, an accuracy of the determining the estimated footprint of the energy beam is from about 2 microns to about 8 microns. In some embodiments, the method further comprises maintaining a pressure at or above ambient pressure. In some embodiments, the first benchmark signal and the second benchmark signal are of respective benchmark first and second returning radiations from the target surface or a different surface. In some embodiments, the different surface comprises a benchmark calibration structure. In some embodiments, a benchmark relationship comprises a set of requested footprints on the benchmark calibration structure and an associated set of associated benchmark signals generated from respective returning benchmark radiations from the benchmark calibration structure. In some embodiments, the method further comprises forming the benchmark calibration structure by transforming a portion of pre-transformed material at the target surface to transformed material. In some embodiments, forming the benchmark calibration structure is performed in real time during the printing. In some embodiments, the optical arrangement is at or above an ambient temperature while generating the benchmark returning radiations. In some embodiments, the method further comprises controlling irradiating the heat sink through the optical arrangement. In some embodiments, controlling comprises controlling a throughput of energy irradiated through the optical arrangement and/or controlling a temperature of the one or more optical elements of the optical arrangement. In some embodiments, (a) through (f) are performed in real time. In some embodiments, in real time comprises during printing of the three-dimensional object, during printing a plurality of layers as part of the three-dimensional object, or during printing of a layer of a three-dimensional object. In some embodiments, the method further comprises controlling at least one characteristic of the energy beam having a requested energy beam footprint considering (e), wherein the at least one characteristic of the energy beam comprises (i) a center position of the requested energy beam footprint, (ii) a fundamental length scale of the requested energy beam footprint, (iii) a measure of a power density distribution in the requested energy beam footprint, (iv) a measure of an average power density in the requested energy beam footprint, or (iv) a focal position of the requested energy beam footprint. In some embodiments, detecting the first signal and/or the second signal comprises using a bore-sight view of the target surface, which bore-sight view comprises a shared portion of an energy beam optical path. In some embodiments, detecting the first signal and/or the second signal comprises a non-direct view of the target surface. In some embodiments, detecting the first signal and/or the second signal comprises detecting a temperature of the first footprint and/or the second footprint of the energy beam on the target surface, and/or a vicinity thereof. In some embodiments, the vicinity extends to at most six fundamental length scales of the first footprint and/or the second footprint of the energy beam on the target surface.

In another aspect, a method for printing calibration, comprises: using a transforming agent to transform a pre-transformed material to a transformed material to form a calibration mark on a target surface; sensing the calibration mark; disrupting the calibration mark; and using the transforming agent for printing in at least a portion of the target surface.

In some embodiments, disrupting comprises removing and/or breaking. In some embodiments, the method further comprises using a guidance system to translate the transforming agent along the target surface to form the calibration mark. In some embodiments, the method further comprises using a detector to sense the calibration mark. In some embodiments, the method further comprises using a planarizer or a remover for disrupting the calibration mark. In some embodiments, the target surface comprises (i) an exposed surface of a material bed, (ii) a platform, (iii) at least a portion of a working field of a guidance system that translates the transforming agent along the target surface, and/or (iv) a floor of an enclosure that encloses the target surface. In some embodiments, printing comprises printing a three-dimensional object. In some embodiments, printing comprises three-dimensional printing. In some embodiments, the calibration mark is a first partial calibration marker. In some embodiments, the method further comprises forming a second partial calibration marker. In some embodiments, forming the second partial calibration marker is with the transforming agent. In some embodiments, forming the second partial calibration marker is with another transforming agent. In some embodiments, forming the first partial calibration marker is with a guidance system. In some embodiments, forming the second partial calibration marker is with the guidance system. In some embodiments, an area of the first partial calibration marker relative to the target surface contacts at least a portion of an area of the second partial calibration marker. In some embodiments, an area of the first partial calibration marker relative to the target surface overlaps at least a portion of an area of the second partial calibration marker. In some embodiments, the second partial calibration marker is formed after disrupting the first partial calibration marker. In some embodiments, the second partial calibration marker is formed before disrupting the first partial calibration marker.

In another aspect, an apparatus for printing calibration, comprises: using one or more controllers that are configured to: operationally couple to (i) a guidance system, (ii) a sensor, and (iii) a planarizer and/or a remover; direct the guidance system to guide a transforming agent along a target surface to form a calibration mark; direct the sensor to sense the calibration mark; direct the planarizer and/or the remover to disrupt the calibration mark; and direct the guidance system to guide the transforming agent to print.

In some embodiments, the guidance system comprises an optical system. In some embodiments, the optical system comprises a scanner. In some embodiments, the sensor comprises (a) a charge-coupled device (CCD), (b) a line scan sensor, (c) a camera, (d) a single pixel detector, and/or (e) a spectrometer. In some embodiments, the line scan sensor comprises a CCD, or a complementary metal oxide semiconductor (CMOS). In some embodiments, the one or more controllers are configured to adjust a force exerted by the planarizer and/or the remover, to disrupt the calibration mark. In some embodiments, the one or more controllers are further configured to direct a movement of the planarizer and/or the remover along the target surface. In some embodiments, the planarizer and/or the remover comprises a blade, a knife, a rake, a roller, a squeegee, or an attractive force (e.g., vacuum). In some embodiments, the transforming agent comprises an energy beam, a binder, or a plasma beam. In some embodiments, the energy beam comprises an electron beam or an electromagnetic beam. In some embodiments, the one or more controllers are further configured to operatively couple to a transforming agent source, wherein the transforming agent source is configured to generate and/or to dispense the transforming agent. In some embodiments, the transforming agent source comprises: a binder dispenser, a heater, an electromagnetic radiation generator (e.g., a laser), a charged particle radiation generator (e.g., an electron gun), or a plasma generator. In some embodiments, to print comprises to print at least one three-dimensional object. In some embodiments, to print comprises a transformation of a pre-transformed material to a transformed material. In some embodiments, to print comprises layerwise addition of the transformed material. In some embodiments, to print comprises to project the pre-transformed material toward the target surface. In some embodiments, the calibration mark is a first partial calibration marker, the guidance system is a first guidance system, and the transforming agent is a first transforming agent. In some embodiments, the one or more controllers are further configured to operationally couple to (A) a second guidance system, and to direct the second guidance system to guide a second transforming agent along the target surface to form a second partial calibration marker. In some embodiments, the second transforming agent and the first transforming agent are the same. In some embodiments, the second guidance system and the first guidance system are the same. In some embodiments, the one or more controllers are configured to form the second partial calibration marker that occupies a second area, which second area has at least one contact point with a first area occupied by the first partial calibration marker. In some embodiments, the first area and the second area are parallel to the target surface. In some embodiments, the first partial calibration marker and the second partial calibration marker are disposed above the target surface, wherein above is in a direction opposite to a global vector. In some embodiments, the one or more controllers are configured to form the second partial calibration marker that occupies a second area to overlap at least a portion of a first area occupied by the first partial calibration marker, to form an overlapped area. In some embodiments, the overlapped area is parallel to the target surface. In some embodiments, the one or more controllers are configured to direct the second partial calibration marker to form after sensing of the first partial calibration marker in (c) and/or disruption of the first partial calibration marker in (d). In some embodiments, the one or more controllers are configured to direct the second partial calibration marker to form before sensing of the first partial calibration marker in (c) and/or disruption of the first partial calibration marker in (d). In some embodiments, the one or more controllers are configured to direct the guidance system in (e) following disruption of the second partial calibration marker. In some embodiments, the one or more controllers are configured to direct the sensor to sense the second partial calibration marker before the disruption of the first partial calibration marker. In some embodiments, the target surface is included by and/or supported by a platform. In some embodiments, the platform is configured to support a material bed that comprises an exposed surface. In some embodiments, the calibration mark is formed on the exposed surface of the material bed. In some embodiments, the target surface comprises an exposed surface of an enclosure. In some embodiments, the exposed surface of the enclosure comprises a floor of a processing chamber. In some embodiments, the calibration mark is formed on the floor of the processing chamber. In some embodiments, the calibration mark is formed by a transformation of a pre-transformed material. In some embodiments, the enclosure comprises an inert and/or non-reactive atmosphere, which non-reactive is with a pre-transformed material or with a transformed material (e.g., during and/or after printing). In some embodiments, a pressure of the inert and/or non-reactive atmosphere is above an ambient pressure. In some embodiments, the calibration mark is formed in a processing field of the guidance system. In some embodiments, the target surface comprises a build region to print a three-dimensional object, and wherein the processing field overlaps at least a portion of the build region. In some embodiments, the one or more controllers comprise a closed loop control scheme, which closed loop control comprises a feedback or a feed-forward control scheme. In some embodiments, the closed loop control scheme considers a signal from the sensor. In some embodiments, the signal comprises a sensed property of the calibration mark, which sensed property comprises (A) a luminance, (B) a reflectivity, (C) a specularity, (D) a wavelength, or (E) a contrast, of a material of the calibration mark with respect to an adjacent material. In some embodiments, the wavelength comprises a wavelength range. In some embodiments, the wavelength comprises a color. In some embodiments, the one or more controllers are further configured to direct the guidance system to guide the transforming agent in (b), and to direct the sensor to sense the calibration mark in (c), at least until a threshold value of the sensed property of the calibration mark is sensed by the sensor. In some embodiments, the one or more controllers are further configured to direct the planarizer and/or the remover to disrupt in (d) upon a threshold value of the sensed property of the calibration mark being sensed by the sensor. In some embodiments, the one or more controllers are further configured to direct the planarizer and/or the remover to disrupt in (d) following a threshold value of the sensed property of the calibration mark being sensed by the sensor. In some embodiments, the closed loop control is in real time, wherein real time comprises during printing of at least a portion of a three-dimensional object and/or the calibration mark. In some embodiments, the one or more controllers comprises an electrical circuit. In some embodiments, the one or more controllers comprises a socket. In some embodiments, the one or more controllers comprises an electronic board. In some embodiments, at least two of (b), (c), (d) and (e), are directed by different controllers. In some embodiments, at least two of (b), (c), (d) and (e), are directed by the same controller.

In another aspect, a non-transitory computer-readable medium comprising machine-executable code that, upon execution by one or more processors, implements a method for printing calibration, the machine-executable code having commands comprises: directing a guidance system to guide a transforming agent along a target surface to transform a pre-transformed material to a transformed material to form a calibration mark; directing a sensor to sense the calibration mark; directing a dispenser and/or a remover, to disrupt the calibration mark; and directing the guidance system to guide the transforming agent to print in at least a portion of the target surface.

In some embodiments, the machine-executable code further comprises commands for an adjustment to a force exerted by the dispenser and/or the remover, to disrupt the calibration mark. In some embodiments, the machine-executable code further comprises commands for directing a movement of the dispenser and/or the remover along the target surface. In some embodiments, the machine-executable code further comprises commands for directing a transforming agent source to generate and/or to dispense the transforming agent. In some embodiments, directing the guidance system to guide the transforming agent comprises commands to print at least one three-dimensional object. In some embodiments, directing the guidance system to guide the transforming agent comprises commands for layerwise addition of the transformed material, to print in the at least the portion of the target surface. In some embodiments, directing the guidance system to guide the transforming agent comprises commands for projecting the pre-transformed material toward the target surface, to print in the at least the portion of the target surface. In some embodiments, the guidance system is a first guidance system, the transforming agent is a first transforming agent, and the machine-executable code to form the calibration mark comprises commands to form a first partial calibration marker. In some embodiments, the machine-executable code further comprises commands for directing a second guidance system to guide a second transforming agent along the target surface to form a second partial calibration marker. In some embodiments, the second transforming agent and the first transforming agent are the same. In some embodiments, the second guidance system and the first guidance system are the same. In some embodiments, the machine-executable code for the second guidance system to guide the second transforming agent comprises commands to form the second partial calibration marker to have a second area that contacts at least one point of a first area occupied by the first partial calibration marker. In some embodiments, the machine-executable code for the second guidance system to guide the second transforming agent comprises commands to form the second partial calibration marker having a second area that at least partially overlaps a first area occupied by the first partial calibration marker. In some embodiments, the machine-executable code for the second guidance system to guide the second transforming agent comprises commands to form the second partial calibration marker after sensing of the first partial calibration marker in (b) and/or disruption of the first partial calibration marker in (c). In some embodiments, the machine-executable code for the second guidance system to guide the second transforming agent comprises commands to form the second partial calibration marker before sensing of the first partial calibration marker in (b) and/or disruption of the first partial calibration marker in (c). In some embodiments, the machine-executable code further comprises commands for directing the guidance system in (d) following disruption of the second partial calibration marker. In some embodiments, the machine-executable code further comprises commands for directing the sensor to sense the second partial calibration marker before disruption of the first partial calibration marker. In some embodiments, the machine-executable code comprises commands to form the calibration mark on a floor of a processing chamber. In some embodiments, the machine-executable code comprises commands to form the calibration mark on an exposed surface of a material bed, wherein at least a portion of the target surface overlaps the exposed surface. In some embodiments, the machine-executable code comprises commands to form the calibration mark in a processing field of the guidance system. In some embodiments, the target surface comprises a build region to print a three-dimensional object, and wherein the machine-executable code comprises commands to form the calibration mark in the build region. In some embodiments, the machine-executable code comprises commands to form the calibration mark adjacent to the build region. In some embodiments, the machine-executable code further comprises commands to implement a closed loop control scheme, which closed loop control comprises a feedback or a feed-forward control scheme. In some embodiments, the closed loop control scheme comprises commands to consider a signal from the sensor. In some embodiments, the signal comprises a sensed property of the calibration mark, which sensed property comprises (A) a luminance, (B) a reflectivity, (C) a specularity, (D) a wavelength, or (E) a contrast, of a material of the calibration mark with respect to an adjacent material. In some embodiments, the wavelength comprises a wavelength range. In some embodiments, the wavelength comprises a color. In some embodiments, the machine-executable code further comprises commands for directing the guidance system in (a), and for directing the sensor in (b), at least until a threshold value of the sensed property of the calibration mark is sensed by the sensor. In some embodiments, the machine-executable code further comprises commands for directing the dispenser and/or the remover to disrupt in (c) upon a threshold value of the sensed property of the calibration mark being sensed by the sensor. In some embodiments, the machine-executable code further comprises commands for directing the dispenser and/or the remover to disrupt in (c) following a threshold value of the sensed property of the calibration mark being sensed by the sensor.

In an aspect described herein are methods, systems, and/or apparatuses for detecting one or more characteristics of the forming 3D object and/or its vicinity. Another aspect of the present disclosure describes methods, systems, and/or apparatuses for facilitating irradiation of an elongated energy beam. Another aspect of the present disclosure describes methods, systems, and/or apparatuses for facilitating contemporaneous focusing of the energy beam.

Another aspect of the present disclosure provides a system for effectuating the methods disclosed herein.

Another aspect of the present disclosure provides an apparatus for effectuating the methods disclosed herein.

Another aspect of the present disclosure provides an apparatus comprising a controller that directs effectuating one or more steps in the method disclosed herein, wherein the controller is operatively coupled to the apparatuses, systems, and/or mechanisms that it controls to effectuate the method.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods above or elsewhere herein.

Another aspect of the present disclosure provides an apparatus for printing one or more 3D objects comprises a controller that is programmed to direct a mechanism used in a 3D printing methodology to implement (e.g., effectuate) any of the method disclosed herein, wherein the controller is operatively coupled to the mechanism.

Another aspect of the present disclosure provides a computer software product, comprising a non-transitory computer-readable medium in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism.

Another aspect of the present disclosure provides a non-transitory computer-readable medium comprising machine-executable code that, upon execution by one or more computer processors, implements any of the methods disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.,” “FIGS.,” “FIG.” or “FIGS.” herein), of which:

FIG. 1 shows a schematic side view of a three-dimensional (3D) printing system and its components;

FIG. 2 schematically illustrates a path;

FIG. 3 schematically illustrates various paths;

FIG. 4 schematically illustrates an optical system;

FIG. 5 schematically illustrates a computer control system that is programmed or otherwise configured to facilitate the formation of one or more 3D objects;

FIG. 6 schematically illustrates spatial intensity profiles of irradiating energy;

FIG. 7A schematically illustrates a graph used in a calibration, and FIG. 7B schematically illustrates a plot used in the calibration;

FIG. 8 shows various vertical cross-sectional views of different 3D objects;

FIG. 9 shows a horizontal view of a 3D object;

FIG. 10 schematically illustrates various 3D printer components;

FIG. 11 schematically illustrates a detection system and its components;

FIG. 12 schematically illustrates components of an optical system;

FIG. 13 shows a schematic side view of a 3D printing system and its components;

FIG. 14A schematically illustrates a superposition of a requested image and a projected image, and FIG. 14B schematically illustrates a calibration plate;

FIG. 15 shows a schematic side view of a portion of a 3D printing system and its components;

FIG. 16 shows calibration elements of a 3D printing system;

FIG. 17 illustrates various components used in calibration of a 3D printing system;

FIG. 18 illustrates plots used in calibration;

FIG. 19 illustrates plots used in calibration;

FIGS. 20A-20B schematically illustrate energy beam and optical detection components;

FIG. 21 schematically illustrates an alignment of an energy beam and an optical detection footprint;

FIG. 22A schematically illustrates an alignment calibration and graphs used in the calibration, and FIG. 22B schematically illustrates various paths;

FIG. 23A schematically illustrates various calibration operations, and FIG. 23B schematically illustrates a graph used in the calibration;

FIG. 24 schematically illustrates a graph used in the calibration;

FIG. 25A schematically illustrates an alignment calibration for multiple energy beams of a 3D printing system, and FIG. 25B schematically illustrates a graph used in the alignment calibration;

FIG. 26A schematically illustrates various calibration operations, and FIG. 26B schematically illustrates a graph used in the calibration;

FIGS. 27A-27F schematically depict perspective views depicting various operations used in calibration;

FIGS. 28A-28D schematically depict perspective views depicting various operations used in calibration;

FIGS. 29A-29H schematically depict perspective views depicting various operations used in calibration:

FIG. 30 shows calibration components (e.g., elements or items); and

FIG. 31 illustrates various components used in calibration of a printing system.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

The present disclosure provides apparatuses, systems and methods for controlling aspects of printing 3D objects. In some embodiments, the apparatuses, systems and methods are used to perform an image field calibration. In some embodiments, the apparatuses, systems and methods are used to perform a processing field calibration. The processing field calibration may include alignment of (i) a desired (e.g., commanded) energy beam position at a target surface with (ii) an actual energy beam position at the target surface (as guided by the guidance system). The processing field calibration may comprise a guidance system-specific correction. In some embodiments, the apparatuses, systems and methods are used to perform a beam-to-beam overlay calibration including alignment of a requested (e.g., commanded, second) energy beam position at a target surface with an actual (e.g., first) energy beam position at the target surface (as guided by the guidance system). In some embodiments, the apparatuses, systems and methods are used to perform a detector calibration including alignment of a detector field of view with an energy beam position (e.g., footprint) at a target surface.

The alignment may include generating correction data (e.g., a correction map) for energy beam positions across multiple positions of the target surface, calibrating energy beam positions using detected deviation(s) between commanded positions and actual positions.

Terms such as “a,” “an,” and “the” are not intended to refer to only a singular entity, but include the general class of which a specific example may be used for illustration. The terminology herein is used to describe specific embodiments of the invention, but their usage does not delimit the invention.

When ranges are mentioned, the ranges are meant to be inclusive, unless otherwise specified. The term “between” as used herein is meant to be inclusive unless otherwise specified. For example, between X and Y is understood herein to mean from X to Y. For example, a range between value 1 and value 2 is meant to be inclusive and include value 1 and value 2. The inclusive range will span any value from about value 1 to about value 2.

The term “adjacent” or “adjacent to,” as used herein, includes ‘next to’, ‘adjoining’, ‘in contact with,’ and ‘in proximity to.’ In some instances, adjacent to may be ‘above’ or ‘below.’

The term “operatively coupled” or “operatively connected” refers to a first mechanism that is coupled (or connected) to a second mechanism to allow the intended operation of the second and/or first mechanism, e.g., including a first mechanism that is in signal communication with a second mechanism. The term “configured to” refers to an object or apparatus that is (e.g., structurally) configured to bring about an intended result.

Fundamental length scale (abbreviated herein as “FLS”) can refer herein as to any suitable scale (e.g., dimension) of an object. For example, a FLS of an object may comprise a length, a width, a height, a diameter, a spherical equivalent diameter, or a diameter of a bounding sphere.

The phrase “a three-dimensional object” as used herein may refer to “one or more three-dimensional objects,” as applicable.

“Real time” as understood herein may be during at least part of the printing of a 3D object. Real time may be during a print operation. Real time may be during a print cycle. Real time may comprise: during formation of a 3D object; a layer of hardened material as part of the 3D object; a hatch line; or a melt pool.

The phrase “is/are structured,” when modifying an article, refers to a structure of the article that is able to bring about the enumerated result.

The phrase “a target surface” may refer to (1) a surface of a build plane (e.g., an exposed surface of a material bed), (2) an exposed surface of a platform, (3) an exposed surface of a 3D object (or a portion thereof), (4) any exposed surface adjacent to an exposed surface of the material bed, platform, or 3D object, and/or (5) any other targeted surface. Targeted may be by at least one transforming agent, e.g., an energy beam, or by a light source.

The phrase “a processing field” as used herein may refer to an (e.g., maximum) areal extent achievable by an energy beam directed through one or more controllable (e.g., mechanical and/or optical) angles in an energy beam guidance system (e.g., a galvanometer scanner). At times, the processing field refers to a plane (e.g., comprising a target surface on which the energy beam can be incident). At times, the processing field refers to a spherical surface.

The phrase “a build region” as used herein may refer to a portion of a target surface on which one or more 3D objects may be formed, e.g., in a layerwise manner. At times, the build region refers to an areal extent of the target surface, e.g., beyond which a 3D object is not formed. At times, a build region refers to a surface of material bed that is supported by a platform.

The phrase “a processing field calibration” as used herein may refer to a method of determining any variation in (e.g., an actual) at least one energy beam position within the processing field, from a requested energy beam position (e.g., that is controlled and/or commanded by a guidance system). A processing field calibration may include a correction to reduce any variation between the actual and requested energy beam positions.

Three-dimensional printing (also “3D printing”) generally refers to a process for generating a 3D object. The apparatuses, methods, controllers, and/or software described herein pertaining to generating (e.g., forming, or printing) a 3D object, pertain also to generating one or more 3D objects. For example, 3D printing may refer to sequential addition of material layers or joining of material layers (or parts of material layers) to form a 3D structure, in a controlled manner. The controlled manner may include automated control. In the 3D printing process, the deposited material can be transformed (e.g., fused, sintered, melted, bound, or otherwise connected) to subsequently harden and form at least a part of the 3D object. Fusing (e.g., sintering or melting) binding, or otherwise connecting the material is collectively referred to herein as transforming a pre-transformed material (e.g., powder material) into a transformed material. Fusing the material may include melting or sintering the material. Binding can comprise chemical bonding. Chemical bonding can comprise covalent bonding. Examples of 3D printing may include additive printing (e.g., layer by layer printing, or additive manufacturing). 3D printing may include layered manufacturing. 3D printing may include rapid prototyping. 3D printing may include solid freeform fabrication. The 3D printing may further comprise subtractive printing.

3D printing methodologies can comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition. 3D printing methodologies may comprise a binder that binds pre-transformed material (e.g., binding a powder). The binder may remain in the 3D object, or may be (e.g., substantially) absent from the 3D printing (e.g., due to heating, extracting, evaporating, and/or burning).

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

Pre-transformed material, as understood herein, is a material before it has been first transformed (e.g., once transformed) by an energy beam and/or flux during the 3D printing process. The pre-transformed material may be a material that was, or was not, transformed prior to its use in the 3D printing process. The pre-transformed material may be a material that was partially transformed prior to its use in the 3D printing process. The pre-transformed material may be a starting material for the 3D printing process. The pre-transformed material may be liquid, solid, or semi-solid (e.g., gel). The pre-transformed material may be a particulate material. The particulate material may be a powder material. The powder material may comprise solid particles of material. The particulate material may comprise vesicles (e.g., containing liquid or semi-solid material). The particulate material may comprise solid or semi-solid material particles.

The FLS (e.g., the diameter, spherical equivalent diameter, diameter of a bounding circle, or the largest of height, width and length) of the printed 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. In some cases, the FLS of the printed 3D object may be in between any of the afore-mentioned FLSs (e.g., from about 50 μm to about 1000 m, from about 120 μm to about 1000 m, from about 120 μm to about 10 m, from about 200 μm to about 1 m, or from about 150 μm to about 10 m).

In some instances, it is desired to control the manner in which at least a portion of a layer of hardened material is formed. The layer of hardened material may comprise a plurality of melt pools. In some instances, it may be desired to control one or more characteristics of the melt pools that form the layer of hardened material. The characteristics may comprise the depth of a melt pool, microstructure, or the repertoire of microstructures of the melt pool. The microstructure of the melt pool may comprise the crystalline structure, or crystalline structure repertoire that is included in the melt pool.

In some embodiments, a 3D forming (e.g., printing, or print) cycle refers to printing one or more 3D objects in a 3D printer, e.g., using one printing instruction batch. A 3D printing cycle may include printing one or more 3D objects above a (single) platform and/or in a material bed. A 3D printing cycle may include printing all layers of the one or more 3D objects in a 3D printer. On the completion of a 3D printing cycle, the one or more objects may be removed from the 3D printer (e.g., by sealing and/or removing a build module from the printer) in a removal operation (e.g., simultaneously). During a printing cycle, the one or more objects may be printed in the same material bed, above the same platform, with the same printing system, at the same time span, using the same forming (e.g., printing) instructions, or any combination thereof. A print cycle may comprise printing the one or more objects layer-wise (e.g., layer-by-layer). A layer may have a layer height. A layer height may correspond to a height of (e.g., distance between) an exposed surface of a (e.g., newly) formed layer with respect to a (e.g., top) surface of a prior-formed layer. In some embodiments, the layer height is (e.g., substantially) the same for each layer of a print cycle (e.g., within a material bed). In some embodiments, at least two layers (e.g., of a material bed and/or of a 3D object) in a print cycle have different layer heights. A printing cycle may comprise a collection (e.g., sum) of print operations. A print operation may comprise a print increment, e.g., deposition of a layer of pre-transformed material, and transformation of a portion thereof to form at least a portion of the 3D object. The print operation may comprise forming a layer of hardened material as part of the one or more 3D objects. A forming (e.g., printing) cycle (also referred to herein as “build cycle”) may comprise one or more forming (e.g., formation) laps. The forming lap may be the print increment. A forming lap may comprise the process of forming a formed (e.g., printed) layer in a layerwise deposition to form the 3D object. The printing-lap may be referred to herein as “build-lap” or “print-increment.” In some embodiments, a printing cycle comprises one or more printing laps. The 3D printing lap may correspond with (i) depositing a (planar) layer of pre-transformed material (e.g., as a portion of a material bed) above a platform, and (ii) transforming at least a portion of the pre-transformed material (e.g., by at least one energy beam) to form a layer of a 3D object above the platform (e.g., in the material bed). The printing cycle may comprise a plurality of laps to (e.g., layerwise) form the 3D object. The 3D printing cycle may correspond with (I) depositing a pre-transformed material toward a platform, and (II) transforming at least a portion of the pre-transformed material (e.g., by at least one energy beam) at or adjacent to the platform to form one or more 3D objects above the platform at the same time-window. An additional sequential layer (or portion thereof) can be added to a previous layer of a 3D object by transforming (e.g., fusing and/or melting) a fraction of pre-transformed material that is introduced (e.g., as a pre-transformed material stream) to the prior-formed layer of transformed material. At times, the platform supports a plurality of material beds and/or a plurality of 3D objects. One or more 3D objects may be formed in a single material bed during a printing cycle (e.g., having one or more print jobs). The transformation may connect transformed material of a given layer (e.g., formed during a printing lap) to a previously formed 3D object portion (e.g., of a previous printing lap). The transforming operation may comprise utilizing a transforming agent (e.g., an energy beam or a binder) to transform the pre-transformed (or re-transform the transformed) material. In some instances, the transforming agent is utilized to transform at least a portion of the material bed (e.g., utilizing any of the methods described herein).

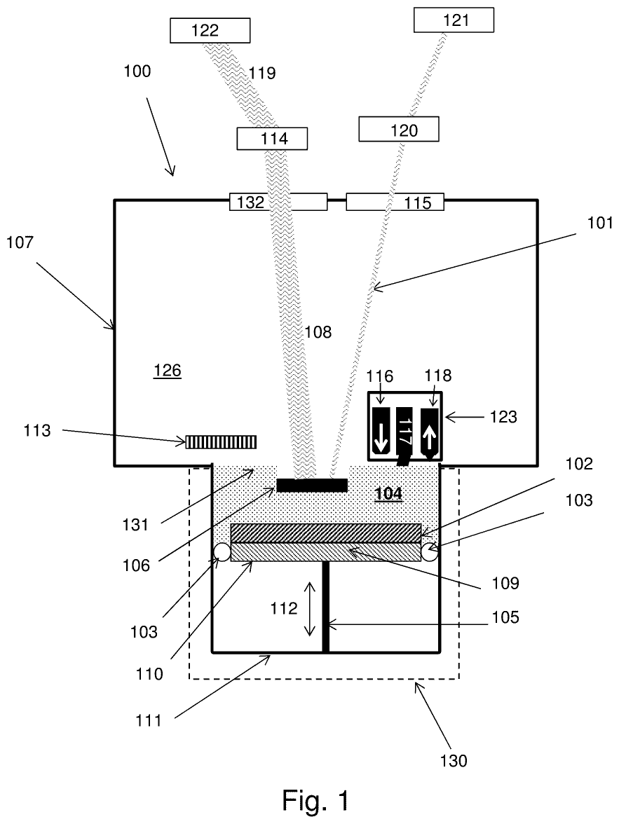

Transforming (e.g., tiling) may comprise heating at least a portion of a target surface (e.g., exposed surface of a material bed), and/or a previously formed area of hardened material using at least one energy source. The energy source may generate an energy beam. The energy source may be a radiative energy source. The energy source may be a dispersive energy source (e.g., a fiber laser). The energy source may generate a substantially uniform (e.g., homogenous) energy stream. The energy source may comprise a cross section (e.g., or a footprint) having a (e.g., substantially) homogenous fluence. The energy generated for transforming a portion of material (e.g., pre-transformed or transformed), by the energy source will be referred herein as the “energy flux.” The energy flux can be provided as an energy beam (e.g., tiling energy beam). The energy flux may heat a portion of a 3D object (e.g., an exposed surface of the 3D object). The energy flux may heat a portion of the target surface (e.g., an exposed surface of the material bed, and/or a deeper portion of the material bed that is not exposed). The target surface may include a pre-transformed material, a partially transformed material and/or a transformed material. The target surface may include a portion of the build platform, for example, the base (e.g., FIG. 1, 102). The target surface may comprise a (surface) portion of a 3D object. The heating by the energy flux may be substantially uniform across its footprint on the target surface.

The energy flux may irradiate (e.g., flash, flare, shine, or stream) a target surface for a period (e.g., a predetermined period). The time in which the energy flux (e.g., beam) irradiates, may be referred to as a dwell time of the energy flux. During this period (e.g., dwell time), the energy flux may be (e.g., substantially) stationary. During that period, the energy may (e.g., substantially) not translate (e.g., neither in a raster form nor in a vector form). Substantially stationary movement may comprise back and forth movement about a point, e.g., pendulum movement. The substantially stationary movement may be smaller than a FLS of the cross-section and/or footprint of the energy flux on the target surface. The substantially stationary movement may be along a direction of the path of the energy flux (e.g., along the path of tiles). The substantially stationary movement may be not along a direction of the path of the energy flux (e.g., perpendicular to the path of tiles).

The energy flux may take the form of an energy stream emitted toward the target surface in a step and repeat sequence. The energy flux may take the form of an energy stream emitted toward the target surface. The energy flux may comprise a radiative heat, an electromagnetic radiation, a charged particle radiation (e.g., an electron beam), or a plasma beam. The energy source may comprise a heater (e.g., a radiator or lamp), an electromagnetic radiation generator (e.g., a laser), a charged particle radiation generator (e.g., an electron gun), or a plasma generator. The energy source may comprise a diode laser. The energy source may comprise an array of energy sources, e.g., a light emitting diode (LED) array.

The energy flux may irradiate a pre-transformed material, a transformed material, or a hardened material (e.g., within the material bed and/or above a platform). The energy flux may irradiate a target surface. The target surface may comprise a pre-transformed material, a transformed material, or a hardened material. The (e.g., tiling) energy source may direct and irradiate an energy flux on the target surface. The energy flux may heat the target surface. The energy flux may transform the target surface (e.g., at least a fraction thereof). The energy flux may preheat the target surface (e.g., to be followed by a scanning energy beam that optionally transforms at least a portion of the preheated surface). The energy flux may post-heat the target surface (e.g., following a transformation of the target surface). The energy flux may post-heat the target surface in order to reduce a cooling rate of the target surface. The heating may be at a specific location (e.g., a tile). The tile may comprise a wide exposure space (e.g., a wide footprint on the target surface). The energy flux may have a long dwell time (e.g., exposure time) that may be at least 1 millisecond, or 1 minute. The energy flux may emit a low energy flux, e.g., to control the cooling and/or heating rate of a position within a layer of transformed material. The low cooling and/or heating rate may control the solidification of the transformed (e.g., molten) material. The low cooling and/or heating rate may allow formation of crystals (e.g., single crystals) at specified location within the layer that is included in the 3D object.

FIG. 1 shows an example of a 3D printing system 100 and apparatuses, a (e.g., first) energy source 122 (e.g., a tiling energy source) that emits an (e.g., first) energy flux 119 (e.g., an energy beam). In the example of FIG. 1 the energy flux travels through an optical system 114 (e.g., comprising an aperture, lens, mirror, beam-splitter, filter, or deflector) and an optical window 132, to heat a target surface. The target surface may be a portion of a hardened material (e.g., 106) that was formed by transforming at least a portion of the target surface of the material bed (e.g., 131) by an energy flux and/or (e.g., scanning) energy beam. In the example of FIG. 1, an energy beam 101 is generated by an (e.g., second) energy source 121. The generated (e.g., second) energy beam may travel through an optical mechanism (e.g., 120) and/or an optical window (e.g., 115). The first energy beam (which can provide the energy flux) and the second (e.g., scanning) energy beam may travel through the same optical window and/or through the same optical system. At times, an energy flux and an energy beam may travel through their respective optical systems and through the same optical window. The energy flux (e.g., first energy beam) and the (e.g., second) energy beam may have at least one characteristic that is the same. The energy flux and the scanning energy beam may have at least one characteristic that is different. An optical window may be a material (e.g., a transparent material) that allows the irradiating energy to travel through it without (e.g., substantial) loss of radiation. The irradiating energy may be an energy beam or an energy flux. Substantial may be relevant to the purpose of the radiation. The optical window can comprise a high thermal conductivity material (e.g., crystal quartz, zinc selenide (ZnSe), magnesium fluoride (MgF₂), calcium fluoride (CaF₂), and/or sapphire) as described herein. In some embodiments, the energy flux and the scanning energy beam both travel through the same optical system, e.g., albeit through different components within the optical system and/or at different instances. In some embodiments, the energy flux, and the (e.g., scanning) energy beam both travel through the same optical system, albeit through different configurations of the optical system and/or at different instances. The emitted radiative energy (e.g., FIG. 1, 108) may travel through an aperture, deflector, and/or other parts of an optical system (e.g., schematically represented as FIG. 1, 114). The aperture may restrict the amount of energy exerted by the (e.g., tiling) energy source. The aperture restriction may redact (e.g., cut off, block, obstruct, or discontinue) the energy beam to form a desired shape of a tile. In some embodiments, the 3D printer comprises an energy beam. In some embodiments, the 3D printing system comprises a plurality of energy beams and/or fluxes.

In the example shown in FIG. 1, a printed part (e.g., hardened material 106) represents a layer of transformed material in a material bed 104. The material bed may be disposed above a platform. The platform may comprise a substrate (e.g., 110) and/or a base (e.g., 102). FIG. 1 shows an example of sealants 103 that prevent the pre-transformed material from spilling from the material bed (e.g., 104) to the bottom 111 of the enclosure 107. The platform may translate (e.g., vertically, FIG. 1, 112) using a translating mechanism—for example, an actuator (e.g., 105, e.g., an elevator). The translating mechanism may travel in the direction to or away from the bottom of the enclosure (e.g., 111) (e.g., vertically). For example, the platform may decrease in height before a new layer of pre-transformed material is dispensed by a material dispensing mechanism (e.g., 116). The target surface (e.g., top surface of the material bed) (e.g., 131) may be planarized (e.g., leveled) using a leveling mechanism (e.g., comprising parts 117 and/or 118). The mechanism may further include a cooling member (e.g., heat sink 113). The interior volume of the enclosure (e.g., 126) may comprise an inert gas, or an oxygen- and/or humidity-reduced atmosphere. The atmosphere may be any atmosphere disclosed in patent application number PCT/US15/36802, titled “APPARATUSES, SYSTEMS AND METHODS FOR THREE-DIMENSIONAL PRINTING” that was filed on Jun. 19, 2015, which is incorporated herein by reference in their entirety.

In some embodiments, the build module and the processing chamber are separate. The separate build module and processing chamber may comprise separate atmospheres. The separate build module and processing chamber may (e.g., controllably) merge. For example, the atmospheres of the build module and processing chamber may merge. In the example of FIG. 1, the 3D printing system comprises a processing chamber which comprises the irradiating energy and the target surface (e.g., comprising the atmosphere in the interior volume of the processing chamber, e.g., 126). For example, the processing chamber may comprise a first (e.g., scanning) energy beam (e.g., FIG. 1, 101) and/or a second energy beam (e.g., energy flux) (e.g., FIG. 1, 108). The enclosure may comprise one or more build modules (e.g., enclosed in the dashed area 130). At times, at least one build module may be disposed in the enclosure that comprises the processing chamber (having an interior volume 126 comprising an atmosphere). At times, at least one build module may engage with the processing chamber (e.g., FIG. 1) (e.g., 107). At times, a plurality of build modules may be coupled to the enclosure. The build module may reversibly engage with (e.g., couple to) the processing chamber. The engagement of the build module may be before or after the 3D printing. The engagement of the build module with the processing chamber may be controlled (e.g., by a controller, such as a microcontroller). The controller may be any controller disclosed in: patent application serial number PCT/US17/18191, titled “ACCURATE THREE-DIMENSIONAL PRINTING” that was filed on Feb. 16, 2017; patent application serial number U.S. Ser. No. 15/435,065, titled “ACCURATE THREE-DIMENSIONAL PRINTING” that was filed on February 16; patent application serial number EP17156707, titled “ACCURATE THREE-DIMENSIONAL PRINTING” that was filed on Feb. 17, 2017; each of which is incorporated herein by reference in its entirety. The controller may direct the engagement and/or dis-engagement of the build module. The control may be automatic and/or manual. The engagement of the build module with the processing chamber may be reversible. In some embodiments, the engagement of the build module with the processing chamber may be non-reversible (e.g., stable). The FLS (e.g., width, depth, and/or height) of the processing chamber can be at least about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m, or 5 m. The FLS of the processing chamber can be at most about 50 millimeters (mm), 60 mm, 70 mm, 80 mm, 90 mm, 100 mm, 200 mm, 250 mm, 400 mm, 500 mm, 800 mm, 900 mm, 1 meter (m), 2 m, or 5 m. The FLS of the processing chamber can be between any of the afore-mentioned values (e.g., 50 mm to about 5 m, from about 250 mm to about 500 mm, or from about 500 mm to about 5 m).

In one example of additive manufacturing, a layer of pre-transformed material (e.g., powder material) is disposed adjacent to the platform using a material dispensing mechanism (e.g., FIG. 1, 116); the layer is planarized using a leveling mechanism and a material removal mechanism (e.g., FIGS. 1, 117 and 118 respectively); an energy beam (e.g., FIG. 1, 101) and/or an energy flux (e.g., FIG. 1, 108) may be directed towards the target surface, e.g., to transform at least a portion of the pre-transformed material to form a transformed material (e.g., 106); the platform is lowered (e.g., comprising 109 and/or 102); a new layer of pre-transformed material is disposed into the material bed (e.g., 104); that new layer is planarized and subsequently irradiated. The process may be repeated sequentially (e.g., layerwise) until the desired 3D object is formed from a successive generation of layers of transformed material. The portion may be a surface, layer, multiplicity of layers, portion of a layer, and/or portion of a plurality of layers. The layer of hardened material within the 3D object may comprise a plurality of melt pools. The layers' characteristic(s) may comprise planarity, curvature, or radius of curvature of the layer (or a portion thereof). The characteristic(s) may comprise the thickness of the layer (or a portion thereof). The characteristic(s) may comprise the smoothness (e.g., planarity) of the layer (or a portion thereof).

The methods, systems, apparatuses, and/or software described herein may comprise providing a first layer of pre-transformed material (e.g., powder) in an enclosure (e.g., FIG. 1, comprising a build module and a processing chamber) to form a material bed comprising a target surface (e.g., the exposed surface of the material bed). The first layer may be provided on a substrate or a base. The first layer may be provided on a previously formed material bed. At least a portion of the first layer of pre-transformed material may be transformed by using an energy beam and/or flux (collectively referred to herein as irradiating energy). For example, an irradiating energy may heat the at least a portion of the first layer of pre-transformed material to form a first transformed material. The first transformed material may comprise a fused material. The methods, systems, apparatuses, and/or software may further comprise disposing a second layer of pre-transformed material adjacent to (e.g., above) the first layer. At least a portion of the second layer may be transformed (e.g., with the aid of the energy beam) to form a second transformed material. The second transformed material may at least in part connect to the first transformed material to form a multi-layered object (e.g., a 3D object). Connect may comprise fuse, weld, bond, and/or attach. The first and/or second layer of transformed material may comprise a first and/or second layer of hardened material respectively. The first and/or second layer of transformed material may harden into a first and/or second layer of hardened material respectively.

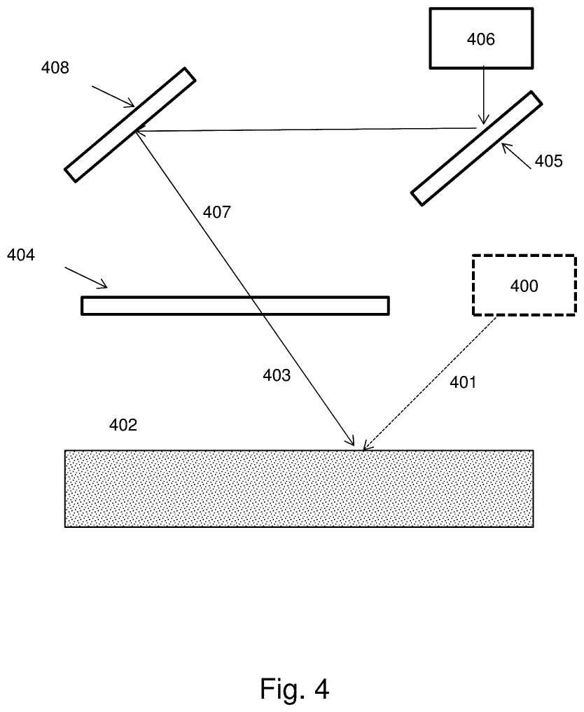

FIG. 4 shows an example of an optical mechanism in a 3D printing system: an energy source 406 irradiates energy (e.g., emits an energy beam) that travels between mirror 405 and mirror 408, that direct it along beam path 407 through an optical window 404 to a position on the exposed surface 402 of a material bed. An optical window can include a coating (e.g., an anti-reflective coating) to pass a selected portion of an incident energy source to form a modified directed energy beam (e.g., along path 403). The energy that passes through the optical window (e.g., with an anti-reflective coating) can be measured as one or more characteristics, which may comprise wavelength, power, amplitude, flux, footprint, intensity, fluence, energy, or charge. In some cases, the (e.g., anti-reflective) coating can allow (e.g., substantially) all of a selected portion of an incident energy source to pass therethrough. Substantially all can correspond to at least about 80%, 85%, 90%, 95%, or 100% of the selected portion of energy. Substantially all can correspond to between any of the afore-mentioned values (e.g., from about 80% to about 100%, from about 80% to about 90%, or from about 90% to about 100% of selected portion of energy). The energy beam may also be directly projected on the exposed surface, for example, an energy beam (e.g., 401) can be generated by an energy source (e.g., 400) (e.g., that may comprise an internal optical mechanism, such as within a laser) and be directly projected onto the target surface.

In some embodiments, an energy flux source is the same as an energy beam source. In some embodiments, a tiling energy source may be the same as a scanning energy source. The tiling energy source may be different than the scanning energy source. FIG. 1 shows an example where the tiling energy source 122 is different from the scanning energy source 121. The energy flux generated by the energy flux source may travel through an identical, or a different, optical window from that of the energy beam generated by the energy beam source. FIG. 1 shows an example where the energy flux 119 (e.g., from energy source 122) travels through one optical window 132, and the (e.g., scanning) energy 101 travels through a second optical window 115 that is different. The energy flux source and/or energy beam source can be disposed within the enclosure, outside of the enclosure (e.g., as in FIG. 1), or within at least one wall of the enclosure. The optical mechanism through which the energy flux and/or the energy beam travel can be disposed within the enclosure, outside of the enclosure, or within at least one wall of the enclosure (e.g., as in FIGS. 1, 132 and 115). In some embodiments, the optical mechanism is disposed within its own (optical) enclosure. The optical enclosure may optionally be coupled with the processing chamber. The optical mechanism and any of its components (e.g., including an optical enclosure and/or optical window) may be any optical mechanism and respective components disclosed in patent application number PCT/US17/60035, titled “GAS FLOW IN THREE-DIMENSIONAL PRINTING” that was filed on Nov. 3, 2017, which is incorporated herein by reference in its entirety.

The system and/or apparatus may comprise an energy profile alteration device that evens out (e.g., is configured to smooth, planarize, or flatten) any irregularities in the energy flux profile. The system and/or apparatus may comprise an energy profile alteration device that creates a more uniform energy flux profile. The energy profile alteration device may comprise an energy flux (e.g., beam) homogenizer. The homogenizer can comprise a mirror. The mirror may be multifaceted. The mirror may comprise square facets. The mirror may reflect the energy flux at various (e.g., different) angles to create a beam with a more uniform power across at least a portion of the (e.g., the entire) beam profile (e.g., resulting in a “top hat” profile), as compared to the original (e.g., incoming) energy flux. The energy profile alteration device may output a substantially evenly distributed power/energy of the energy flux (e.g., energy flux profile) instead of its original energy flux profile shape (e.g., a Gaussian shape). The energy profile alteration device may comprise an energy flux profile shaper (e.g., beam shaper). The energy profile alteration device may generate a certain shape to the energy flux profile. The energy profile alteration device may spread a central concentrated energy within the energy flux profile among the energy flux cross section (e.g., FLS of the energy flux, or FLS of the tile (a.k.a. “stamp”)). The energy profile alteration device may output a grainy energy flux profile. The energy profile alteration device may comprise a dispersive, diffusive, or partially transparent glass. The glass can be a frosted, milky, or murky glass. The energy profile alteration device may generate a blurry energy flux. The energy profile alteration device may generate a defocused energy flux, after which the energy flux that entered the energy profile alteration device will emerge as an energy flux having a more homogenized energy flux profile.

The apparatus and/or systems disclosed herein may include an optical diffuser. The optical diffuser may diffuse light substantially homogenously. The optical diffuser may remove a high intensity energy distribution (e.g., high intensity light) and form a more even distribution of light across the footprint of the energy beam and/or flux. The optical diffuser may reduce the intensity of the energy beam and/or flux (e.g., may act as a screen). For example, the optical diffuser may alter an energy beam with Gaussian profile to an energy beam having a top-hat profile. The optical diffuser may comprise a diffuser wheel assembly.

An energy flux may comprise (i) an extended exposure area, (ii) extended exposure time, (iii) low power density (e.g., power per unit area) or (iv) an intensity profile that can fill an area with a flat (e.g., tophead) energy profile. The extended exposure time may be at least about 1 millisecond and at most 100 milliseconds. In some embodiments, an energy profile of the tiling energy source may exclude a Gaussian beam or round top beam. In some embodiments, an energy profile of the tiling energy source may include a Gaussian beam or round top beam. In some embodiments, the 3D printer comprises a plurality of (e.g., scanning and/or tiling) energy beams. A plurality of energy beams can be at least 2, 3, 4, 5, 6, 7, 8, 9, 10, 11, 12, 13, 14, 15, 16, 17, 18, 19, or 20 energy beams. A plurality of energy beams can be at most 20, 19, 18, 17, 16, 15, 14, 13, 12, 11, 10, 9, 8, 7, 6, 5, 4, 3 or 2 energy beams. A multiplicity of energy beams can be between any number of the afore-mentioned number of energy beams, for example, from 2 to 20 energy beams, from 10 to 20 energy beams, or 2 to 10 energy beams. In some embodiments, an energy profile of a scanning energy beam may comprise a Gaussian energy beam. In some embodiments, an energy profile of a scanning energy may exclude a Gaussian energy beam. The scanning energy may have any cross-sectional shape comprising an ellipse (e.g., circle), or a polygon (e.g., as disclosed herein). The (e.g., scanning) energy beam may have a cross section with a FLS (e.g., at a target surface) of at least about 10 micrometers (μm), 50 μm, 10 μm, 150 μm, 200 μm, 250 μm, 300 μm, 350 μm, 400 μm, 450 μm, 500 μm, 550 μm, 600 μm or 650 μm. The scanning energy beam may have a cross section with a FLS of at most about 650 micrometers (μm), 600 μm, 550 μm, 500 μm, 450 μm, 400 μm, 350 μm, 300 μm, 250 μm, 200 μm, 150 μm, 100 μm, or 50 μm. The scanning energy beam may have a cross section with a diameter of any value between the aforementioned values (e.g., from about 10 μm to about 650 μm, from about 10 μm to about 350 μm, or from about 350 μm to about 650 μm). The FLS may be a diameter of a diameter equivalent.

In some embodiments, the (e.g., tiling) energy flux (e.g., beam) has an extended cross section. For example, the (e.g., tiling) energy flux has a FLS (e.g., cross sectional diameter) may be larger than the (e.g., scanning) energy beam. The FLS of a cross section of the (e.g., tiling) energy flux may be at least about 0.05 millimeters (mm), 0.1 mm, 0.2 mm, 0.3 mm, 0.4 mm, 0.5 mm, 0.8 mm, 1 mm, 1.5 mm, 2 mm, 2.5 mm, 3 mm, 3.5 mm, 4 mm, 4.5 mm, or 5 mm. The FLS of a cross section of the (e.g., tiling) energy flux may be between any of the afore-mentioned values (e.g., from about 0.05 mm to about 5 mm, from about 0.05 mm to about 0.2 mm from about 0.3 mm to about 2.5 mm, or from about 2.5 mm to about 5 mm). The cross section of the energy flux can be at least about 0.1 millimeter squared (mm²), or 0.2 mm². The diameter of the energy flux can be at least about 50 micrometers (μm), 70 μm, 80 μm, 100 μm, 150 μm, 200 μm, 250 μm, 300 μm, 350 μm, 400 μm, 500 μm, or 600 μm. The distance between the first position and the second position can be at least about 50 micrometers (μm), 70 μm, 80 μm, 100 μm, 200 μm, or 250 μm. The FLS may be measured at full width half maximum intensity of the energy flux (e.g., beam). In some embodiments, the (e.g., tiling) energy flux is a focused energy beam. In some embodiments, the (e.g., tiling) energy flux is a defocused energy beam. The energy profile of the (e.g., tiling) energy flux may be (e.g., substantially) uniform (e.g., in the beam cross sectional area that forms the tile).

The power density (e.g., power per unit area) of the scanning energy beam may at least about 10000 Watts per millimeter square (W/mm²), 20000 W/mm², 30000 W/mm², 50000 W/mm², 60000 W/mm², 70000 W/mm², 80000 W/mm², 90000 W/mm², or 100000 W/mm². The power density of the scanning energy beam may be at most about 10000 W/mm², 20000 W/mm², 30000 W/mm², 50000 W/mm², 60000 W/mm², 70000 W/mm², 80000 W/mm², 90000 W/mm², or 100000 W/mm². The power density of the scanning energy beam may be any value between the aforementioned values (e.g., from about 10000 W/mm² to about 100000 W/mm², from about 10000 W/mm² to about 50000 W/mm², or from about 50000 W/mm² to about 100000 W/mm²). The power per unit area of the (e.g., tiling) energy flux may be at least about 100 W/mm², 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², or 7000 W/mm². The power per unit area of the (e.g., tiling) energy flux may be at most about 100 W/mm², 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², 8000 W/mm², 9000 W/mm², or 10000 W/mm². The power per unit area of the (e.g., tiling) energy flux may be any value between the afore-mentioned values (e.g., from about 100 W/mm² to about 3000 W/mm², from about 100 W/mm² to about 5000 W/mm², from about 100 W/mm² to about 9000 W/mm², from about 100 W/mm² to about 500 W/mm², from about 500 W/mm² to about 3000 W/mm², from about 1000 W/mm² to about 7000 W/mm², or from about 500 W/mm² to about 8000 W/mm²). The (e.g., tiling) energy flux may emit energy stream towards the target surface in a step and repeat sequence.

The scanning speed of the scanning energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the scanning energy beam may be at most about 50 mm/sec, 100 mm/sec, 500 mm/sec, 1000 mm/sec, 2000 mm/sec, 3000 mm/sec, 4000 mm/sec, or 50000 mm/sec. The scanning speed of the scanning energy beam may be any value between the aforementioned values (e.g., from about 50 mm/sec to about 50000 mm/sec, from about 50 mm/sec to about 3000 mm/sec, or from about 2000 mm/sec to about 50000 mm/sec). The scanning energy beam may be continuous or non-continuous (e.g., pulsing). The scanning energy beam may compensate for heat loss at the edges of the target surface after a heat tiling process. The energy profile of the (e.g., tiling) energy flux may be (e.g., substantially) uniform during the exposure time (e.g., also referred to herein as tiling time, or dwell time). The exposure time (e.g., at the target surface) of the (e.g., tiling) energy flux may be at least about 0.1 milliseconds (msec), 0.5 msec, 1 msec, 10 msec, 20 msec, 30 msec, 40 msec, 50 msec, 60 msec, 70 msec, 80 msec, 90 msec, 100 msec, 200 msec, 400 msec, 500 msec, 1000 msec, 2500 msec, or 5000 msec. The exposure time (e.g., at the target surface) of the (e.g., tiling) energy flux may be at most about 10 msec, 20 msec, 30 msec, 40 msec, 50 msec, 60 msec, 70 msec, 80 msec, 90 msec, 100 msec, 200 msec, 400 msec, 500 msec, 1000 msec, 2500 msec, or 5000 msec. The exposure time may be between any of the above-mentioned exposure times (e.g., from about 0.1 msec to about 5000 msec, from about 0.1 to about 1 msec, from about 1 msec to about 50 msec, from about 50 msec to about 100 msec, from about 100 msec to about 1000 msec, from about 20 msec to about 200 msec, or from about 1000 msec to about 5000 msec). The exposure time (e.g., irradiation time) may be the dwell time.

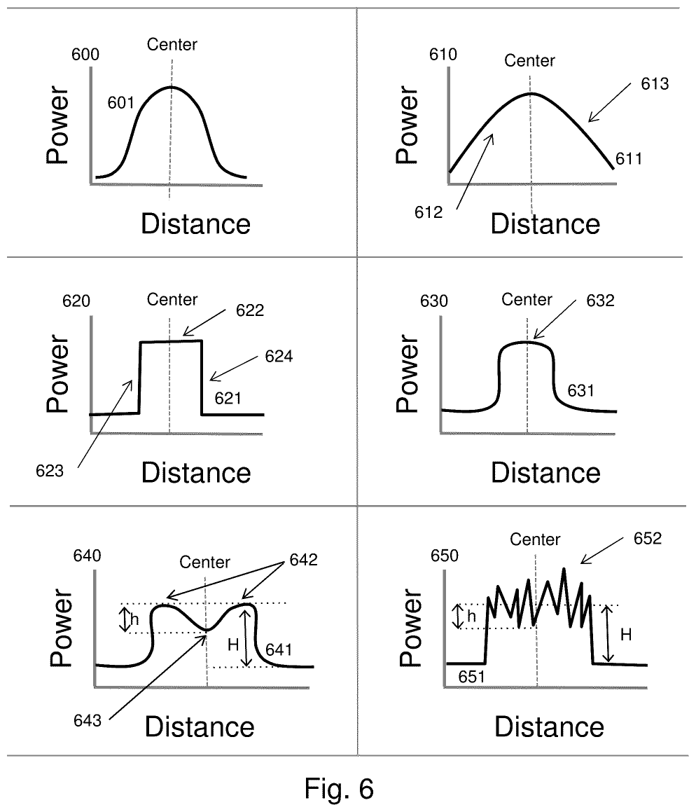

The profile of the energy flux (e.g. beam) may represent the spatial intensity profile of the energy flux (e.g., beam) at a particular plane transverse to the beam propagation path. FIG. 6 shows examples of energy flux profiles (e.g., energy as a function of distance from the center of the energy flux and/or beam). The energy flux profile (e.g., energy beam profile) may be represented as the power or energy of the energy flux plotted as a function of a distance within its cross section (e.g., that is perpendicular to its propagation path). The energy flux profile of the energy flux may be substantially uniform (e.g., homogenous). The energy flux profile may correspond to the energy flux. The energy beam profile may correspond to the first scanning energy beam and/or the second scanning energy beam.

The irradiating energy (e.g., energy beam) may have any of the energy flux profiles in FIG. 6, wherein the “center” designates the center of the energy beam footprint on the target surface. In some embodiments, the “center” designates the center of the energy beam cross-section. The energy beam (e.g., energy flux) profile may be (e.g., substantially) uniform. The energy beam profile may comprise a (e.g., substantially) uniform section. The energy beam profile may deviate from uniformity. The energy beam profile may be non-uniform. The energy beam profile may have a shape that facilitates (e.g., substantially) uniform heating of at least the horizontal cross section of a tile (e.g., substantially every point within the horizontal cross section of the tile (e.g., including its rim)). The energy beam profile may have a shape that facilitates (e.g., substantially) uniform heating of the melt pools within the tile (e.g., substantially every melt pool within the tile (e.g., including its rim)). The energy beam profile may have a shape that facilitates (e.g., substantially) uniform temperature of at least the horizontal cross section of the tile (e.g., substantially every point within the horizontal cross section of the tile (e.g., including its rim)). The energy flux profile may have a shape that facilitates (e.g., substantially) uniform temperature of the melt pools that form the tile (e.g., substantially every melt pool within the tile (e.g., including its rim)). The energy beam profile may have a shape that facilitates formation of a (e.g., substantially) uniform phase (e.g., solid or liquid) of the tile (e.g., substantially every point within the tile (e.g., including its rim)). The energy beam profile may have a shape that facilitates (e.g., substantially) uniform phase of the melt pools within (e.g., that form the) the tile (e.g., substantially every melt pool within the tile (e.g., including its rim)). Substantially uniform may be substantially similar, even, homogenous, invariable, consistent, or equal. At times, the tile may comprise a melt pool.

The energy beam (e.g., flux) profile of the energy beam (e.g., flux) may comprise a square shaped beam. In some instances, the energy beam profile may deviate from a square shaped beam. In some examples, the energy beam profile may exclude a Gaussian shaped beam (e.g., FIG. 6, energy beam profile 600 having Gaussian profile 601). The shape of the beam may be the energy profile of the beam with respect to a distance from the center. The center can be a center of the energy footprint, cross section, and/or tile, which it projects (e.g., through an aperture) onto the target surface. The energy profile of the energy beam may comprise one or more planar sections. FIG. 6, 622 shows an example of a planar section of energy profile 621. FIG. 6, 630 shows an example of a planar section 632 of energy profile 631. FIG. 6, 640 shows an example of two planar sections 642 of energy profile 641. The energy flux profile may comprise of a gradually increasing and/or decreasing section. FIG. 6, 610 shows an example of an energy profile 611 comprising a gradually increasing section 612, and a gradually decreasing section 613. The energy flux profile may comprise an abruptly increasing and/or decreasing sections. FIG. 6, 620 shows an example of an energy profile 621 comprising an abruptly increasing section 623 and an abruptly decreasing section 624. The energy flux profile may comprise a section wherein the energy flux profile deviates from planarity. FIG. 6, 640 shows an example of an energy profile 641 comprising an energy flux profile comprising a section 643 that deviates from planarity (e.g., by a distance “h” of average flux profile 640). The energy flux profile may comprise a section of fluctuating energy flux. The fluctuation may deviate from an average planar surface of the energy flux profile. FIG. 6, 650 shows an example of an energy flux profile 651 comprising a fluctuating section 652. The fluctuating section 652 deviates from the average flat surface. The average flat surface may be measured by the average power of that surface from a baseline (e.g., FIG. 6, “H” of energy flux profile 650), by a +/− distance of “h” of energy flux profile 850.

The cross section of the tiling energy flux may comprise a vector shaped scanning beam (VSB). The energy flux may comprise a variable energy flux profile shape. The energy flux may comprise a variable cross-sectional shape. The energy flux may comprise a substantially non-variable energy flux profile shape. The energy flux may comprise a substantially non-variable cross-sectional shape. The energy flux (e.g., VSB) may translate across the target surface (e.g., directly) to one or more locations specified by vector coordinates. The energy flux (e.g., VSB) may irradiate once over those one or more locations. The energy flux (e.g., VSB) may substantially not irradiate (or irradiate to a considerably lower extent) once between the locations. In some examples, the scanning energy beam may have energy flux profile characteristics of the energy flux (e.g., as delineated herein).

The shape of the energy flux cross section may be the shape of the energy flux footprint. The shape of the energy flux footprint may (e.g., substantially) correspond to the sample of a horizontal cross section of the tile. The shape of the energy flux cross section (e.g., its circumference, also known as the edge of its cross section, or beam edge) may substantially exclude a curvature. The shape of an edge of the energy flux may substantially comprise a non-curved circumference. The shape of the energy flux edge may comprise non-curved sides on its circumference. The energy flux edge can comprise a flat top beam (e.g., a top-hat beam). The energy flux may have a (e.g., substantially) uniform energy density within its cross section. The beam may have a (e.g., substantially) uniform fluence within its cross section. Substantially uniform may be nearly uniform. The beam may be formed by at least one (e.g., a multiplicity of) diffractive optical element, lens, deflector, aperture, or any combination thereof. The energy flux that reaches the target surface may originate from a Gaussian beam. The target surface may be an exposed surface of the material bed and/or an exposed surface of a 3D object (or a portion thereof). The target surface may be an exposed surface of a layer of hardened material. The energy flux may comprise a beam used in laser drilling (e.g., of holes in printed circuit boards). The energy flux may be similar to (e.g., of) the type of energy beam used in high power laser systems (e.g., which use chains of optical amplifiers to produce an intense beam). The energy flux may comprise a shaped energy beam such as a vector shaped beam (VSB). The energy flux may be similar to (e.g., of) the type used in the process of generating an electronic chip (e.g., for making the mask corresponding to the chip).

The energy source may emit an energy flux that may slowly heat a tile within the exposed surface of a 3D object (e.g., FIG. 1, 106). The tile may correspond to a cross section (e.g., footprint) of the energy flux. The footprint may be on the target surface. The radiative energy source may emit radiative energy that may substantially evenly heat a tile within the target surface (e.g., of a 3D object, FIG. 1, 106). Heating may comprise transforming.

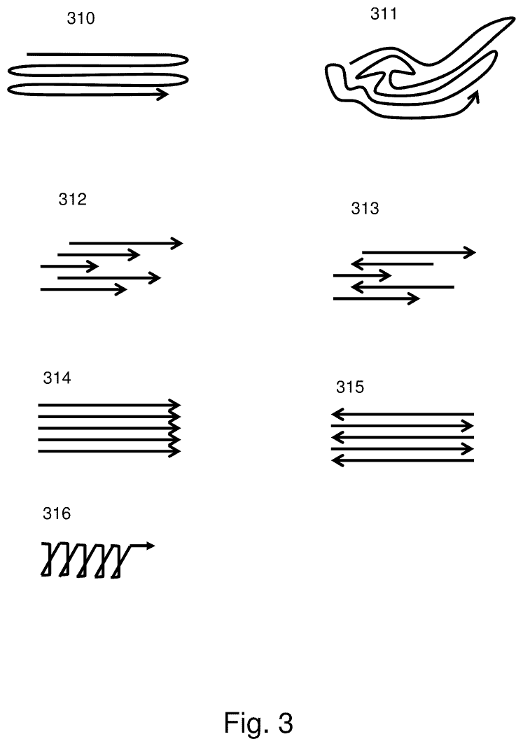

In some embodiments, the energy beam and/or flux is a substantially collimated beam. The energy beam and/or flux may not be a substantially dispersed and/or diffused beam. The scanning energy beam and/or flux may follow a path. The path may follow a spiraling shape, or a random shape (e.g., FIG. 3, 311). The path may be overlapping (e.g., FIG. 3, 316) or non-overlapping. The path may comprise at least one overlap. The path may be substantially devoid of overlap (e.g., FIG. 3, 310). The path may comprise a hatch line or a tile (e.g., irradiation stamp).

FIG. 3 shows various examples of paths. The energy beam and/or flux may travel in each of these types of paths. The path may substantially exclude a curvature (e.g., 312-315). The path may include a curvature (e.g., 310-311). The path may comprise hatching (e.g., 312-315). The progression of the energy beam and/or flux along the path may be directed in the same direction (e.g., 312 or 314). Every adjacent path may be directed in an opposite direction (e.g., 313 or 315). The paths may have the same length (e.g., 314 or 315). The paths may have varied length (e.g., 312 or 313). The spacing between two adjacent path sections may be substantially identical (e.g., 310) or non-identical (e.g., 311). The path may comprise a repetitive feature (e.g., 310), or be substantially non-repetitive (e.g., 311). The path may comprise non-overlapping sections (e.g., 310), or overlapping sections (e.g., 316). The path may comprise a spiraling progression (e.g., 316).

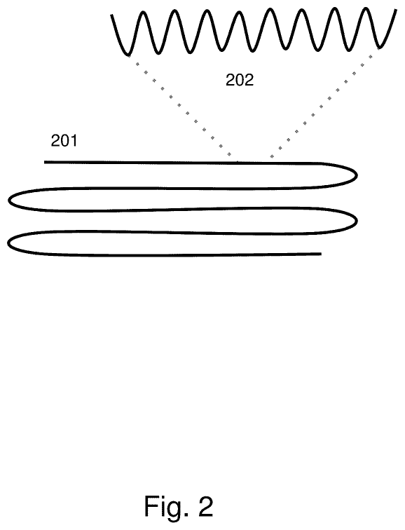

The path of the energy beam and/or flux may comprise a finer path. The finer path may be an oscillating path. FIG. 2 shows an example of a path of the scanning energy beam 201. The path 201 is composed of an oscillating sub-path 202. The oscillating sub path can be a zigzag or sinusoidal path. The finer path may include or substantially exclude a curvature.

In some embodiments, an energy beam and/or flux irradiates the material bed to below the transformation point of the pre-transformed material that composes it (e.g., below melting point), e.g., to heat the irradiated pre-transformed material. The heating can be done by an energy flux (e.g., beam) generated by the one or more energy sources. At least two of the energy sources may heat the target surface (e.g., and form tiles) simultaneously, sequentially, or a combination thereof.

The methods for generating one or more 3D objects described herein may comprise: depositing a layer of pre-transformed material (e.g., powder) in an enclosure; providing energy to a portion of the layer of material (e.g., according to a path); transforming at least a section of the portion of the layer of material to form a transformed material by utilizing the energy; optionally allowing the transformed material to harden into a hardened material; and optionally repeating the above steps to generate the one or more 3D objects. The enclosure may comprise a platform (e.g., a substrate and/or base). The enclosure may comprise a container. The 3D object may be printed adjacent to (e.g., above) the platform. The pre-transformed material may be deposited in the enclosure by a material dispensing system to form a layer of pre-transformed material within the enclosure. The deposited material may be leveled by a leveling mechanism. The deposition of pre-transformed material in the enclosure may form a material bed or be deposited on a platform. The leveling mechanism may comprise a leveling step where the leveling mechanism does not contact the exposed surface of the material (e.g., powder) bed. The material dispensing system may comprise one or more dispensers. The material dispensing system may comprise at least one material (e.g., bulk) reservoir. The material may be deposited by a layer dispensing mechanism (e.g., recoater). The layer dispensing mechanism may level the dispensed material without contacting the powder bed (e.g., the top surface of the powder bed). The layer dispensing mechanism may level the dispensed material while contacting the powder bed (e.g., the top surface of the powder bed).

The system, apparatuses and/or method may comprise a layer dispensing mechanism (e.g., recoater) that dispenses a layer of pre-transformed (e.g., powder) material comprising an exposed surface that is substantially planar. The layer dispensing mechanism can be any layer dispensing mechanism disclosed in Patent Application Serial No. PCT/US15/36802, which is incorporated herein by reference in its entirety. The 3D printer may include a layer forming device (e.g., FIG. 1, 123) (also referred to herein as a “layer dispenser”). The layer forming device may include a powder dispenser 116 and/or a leveler 117. The leveler can include a blade or roller that contacts the powder bed to provide a level (e.g., planar) surface for the powder bed. In some embodiments, the 3D printer includes a container for holding a supply of powder (e.g., a reservoir). The translating of the layer dispenser can be in directions (e.g., substantially) perpendicular to a translation direction (e.g., FIG. 1, 112) of the platform. In some embodiments, the layer dispenser is configured to provide a layer of powder having a thickness ranging from about 20 micrometers (μm) to about 500 μm. FIG. 1 shows an example of a layer dispensing mechanism comprising a material dispensing mechanism 116, a leveling (e.g., planarization) mechanism 117, and a material removal mechanism 118 (the white arrows in 116 and 118 designate the direction in which the pre-transformed material flows into/out of the material bed (e.g., 104).

In some instances, one, two, or more 3D objects are generated in a material bed (e.g., a single material bed; the same material bed). The plurality of 3D objects may be generated in the material bed simultaneously or sequentially. At least two 3D objects may be generated side by side. At least two 3D objects may be generated one on top of the other. At least two 3D objects generated in the material bed may have a gap between them (e.g., gap filled with pre-transformed material). At least two 3D objects generated in the material bed may contact (e.g., not connect to) each other. In some embodiments, the 3D objects may be independently built one above the other. The generation of a multiplicity of 3D objects in the material bed may allow continuous creation of 3D objects.

A pre-transformed material within the enclosure can be in the form of a powder, wires, sheets, or droplets. The material (e.g., pre-transformed, transformed, and/or hardened) may comprise elemental metal, metal alloy, ceramics, an allotrope of elemental carbon, polymer, and/or resin. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding. The pre-transformed material may be pulverous. The printed 3D object can be made of a single material (e.g., single material type) or multiple materials (e.g., multiple material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

The material may comprise a powder material. The material may comprise a solid material. The material may comprise one or more particles or clusters. The term “powder,” as used herein, generally refers to a solid having fine particles. The powder may also be referred to as “particulate material.” Powders may be granular materials. The powder particles may comprise micro particles. The powder particles may comprise nanoparticles. In some examples, a powder comprising particles having an average fundamental length scale of at least about 5 nanometers (nm), 10 nm, 20 nm, 30 nm, 40 nm, 50 nm, 100 nm, 200 nm, 300 nm, 400 nm, 500 nm, 1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. The particles comprising the powder may have an average fundamental length scale of at most about 100 μm, 80 μm, 75 μm, 70 μm, 65 μm, 60 μm, 55 μm, 50 μm, 45 μm, 40 μm, 35 μm, 30 μm, 25 μm, 20 μm, 15 μm, 10 μm, 5 μm, 1 μm, 500 nm, 400 nm, 300 nm, 200 nm, 100 nm, 50 nm, 40 nm, 30 nm, 20 nm, 10 nm, or 5 nm. In some cases, the powder may have an average fundamental length scale between any of the values of the average particle fundamental length scale listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm).

The powder can be composed of individual particles. The individual particles can be spherical, oval, prismatic, cubic, or irregularly shaped. The particles can have a fundamental length scale. The powder can be composed of a homogenously shaped particle mixture such that all of the particles have substantially the same shape and fundamental length scale magnitude within at most 1%, 5%, 8%, 10%, 15%, 20%, 25%, 30%, 35%, 40%, 50%, 60%, or 70%, distribution of fundamental length scale. In some cases, the powder can be a heterogeneous mixture such that the particles have variable shape and/or fundamental length scale magnitude.

At least parts of the layer can be transformed to a transformed material that may subsequently form at least a fraction (also used herein “a portion,” or “a part”) of a hardened (e.g., solidified) 3D object. At times a layer of transformed or hardened material may comprise a cross section of a 3D object (e.g., a horizontal cross section). At times a layer of transformed or hardened material may comprise a deviation from a cross section of a 3D object. The deviation may include vertical or horizontal deviation. A pre-transformed material may be a powder material. A pre-transformed material layer (or a portion thereof) can have a thickness (e.g., layer height) of at least about 0.1 micrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A pre-transformed material layer (or a portion thereof) can have a thickness of at most about 1000 μm, 900 μm, 800 μm, 700 μm, 60 μm, 500 μm, 450 μm, 400 μm, 350 μm, 300 μm, 250 μm, 200 μm, 150 μm, 100 μm, 75 μm, 50 μm, 40 μm, 30 μm, 20 μm, 10 μm, 5 μm, 1 μm, or 0.5 μm. A pre-transformed material layer (or a portion thereof) may have any value in between the aforementioned layer thickness values (e.g., from about 0.1 μm to about 1000 μm, from about 1 μm to about 800 μm, from about 20 μm to about 600 μm, from about 30 μm to about 300 μm, or from about 10 μm to about 1000 μm).

The material composition of at least one layer within the material bed may differ from the material composition within at least one other layer in the material bed. The difference (e.g., variation) may comprise difference in crystal or grain structure. The variation may comprise variation in grain orientation, variation in material density, variation in the degree of compound segregation to grain boundaries, variation in the degree of element segregation to grain boundaries, variation in material phase, variation in metallurgical phase, variation in material porosity, variation in crystal phase, or variation in crystal structure. The microstructure of the printed object may comprise planar structure, cellular structure, columnar dendritic structure, or equiaxed dendritic structure.

The pre-transformed materials of at least one layer in the material bed may differ in the FLS of its particles (e.g., powder particles) from the FLS of the pre-transformed material within at least one other layer in the material bed. A layer may comprise two or more material types at any combination. For example, two or more elemental metals, two or more metal alloys, two or more ceramics, two or more allotropes of elemental carbon. For example, an elemental metal and a metal alloy, an elemental metal and a ceramic, an elemental metal and an allotrope of elemental carbon, a metal alloy and a ceramic, a metal alloy, and an allotrope of elemental carbon, a ceramic and an allotrope of elemental carbon. All the layers of pre-transformed material deposited during the 3D printing process may be of the same material composition. In some instances, a metal alloy is formed in situ during the process of transforming at least a portion of the material bed. In some instances, a metal alloy is not formed in situ during the process of transforming at least a portion of the material bed. In some instances, a metal alloy is formed prior to the process of transforming at least a portion of the material bed. In a multiplicity (e.g., mixture) of pre-transformed (e.g., powder) materials, one pre-transformed material may be used as support (e.g., supportive powder), as an insulator, as a cooling member (e.g., heat sink), or as any combination thereof.

In some cases, a layer within the 3D object comprises a single type of material. In some examples, a layer of the 3D object may comprise a single elemental metal type, or a single (e.g., metal) alloy type. In some examples, a layer within the 3D object may comprise several types of material (e.g., an elemental metal and an alloy, an alloy and a ceramic, an alloy and an elemental carbon). In certain embodiments each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than member of a type of material. In some examples the material bed, platform, enclosure, or a combination of the material bed, platform and enclosure comprise the material. The material may be any material disclosed in International Patent Application number PCT/US17/18191,” European Patent Application number EP 17156707.6 filed on Feb. 17, 2017, titled “ACCURATE THREE-DIMENSIONAL PRINTING,” U.S. Patent Application Publication number US 2017/0239891, or International Patent Application number PCT/US17/60035 filed Nov. 3, 2017, titled “GAS FLOW IN THREE-DIMENSIONAL PRINTING,” or in Patent Application serial number PCT/US15/36802 filed on Jun. 19, 2015, titled “APPARATUSES, SYSTEMS AND METHODS FOR THREE-DIMENSIONAL PRINTING,” each of which is entirely incorporated herein by reference in its entirety.

In some examples the material (e.g., powder material) comprises a material wherein its constituents (e.g., atoms or molecules) readily lose their outer shell electrons, resulting in a free-flowing cloud of electrons within their otherwise solid arrangement. In some examples the material is characterized in having high electrical conductivity, low electrical resistivity, high thermal conductivity, or high density (e.g., as measured at ambient temperature (e.g., R.T., or 20° C.)). The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the aforementioned electrical conductivity values (e.g., from about 1*10⁵ S/m to about 1*10⁸ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the aforementioned electrical resistivity values (e.g., from about 1*10⁻⁵ Ω*m to about 1*10⁻⁸ Ω*m). The high thermal conductivity may be at least about 20 Watts per meters times Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the aforementioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the aforementioned density values (e.g., from about 1 g/cm³ to about 25 g/cm³).

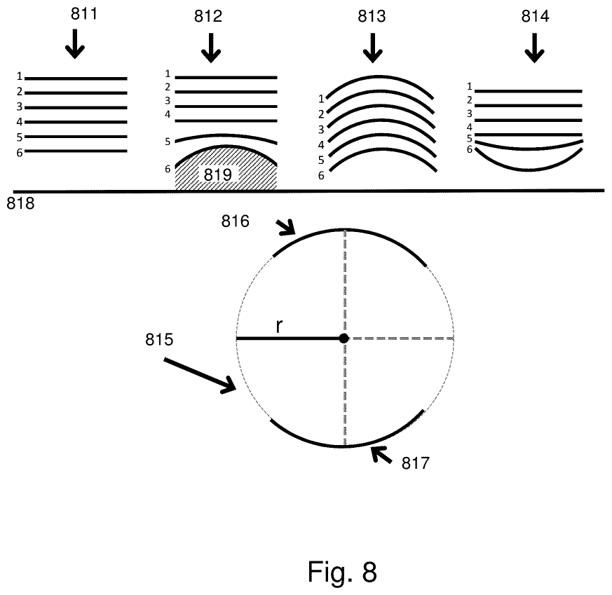

The one or more layers within the 3D object may be (e.g., substantially) planar (e.g., flat). The planarity of the layer may be (e.g., substantially) uniform. The height of the layer at a particular position may be compared to an average plane. The average plane may be defined by a least squares planar fit of the top-most part of the surface of the layer of hardened material. The average plane may be a plane calculated by averaging the material height at each point on the top surface of the layer of hardened material. The deviation from any point at the surface of the planar layer of hardened material may be at most 20% 15%, 10%, 5%, 3%, 1%, or 0.5% of the height (e.g., thickness) of the layer of hardened material. The (e.g., substantially) planar one or more layers may have a large radius of curvature. An example of a layering plane can be seen in FIG. 8 showing a vertical cross section of a 3D object 811 that comprises layers 1 to 6, each of which are substantially planar. FIG. 8 shows an example of a vertical cross section of a 3D object 812 comprising planar layers (layers numbers 1-4) and non-planar layers (e.g., layers numbers 5-6) that have a radius of curvature. The curvature can be positive or negative with respect to the platform and/or the exposed surface of the material bed. For example, layered structure 812 comprises layer number 6 that has a curvature that is negative, as the volume (e.g., area in a vertical cross section of the volume) bound from the bottom of it to the platform 818 is a convex object 819. Layer number 5 of 812 has a curvature that is negative. Layer number 6 of 812 has a curvature that is more negative (e.g., has a curvature of greater negative value) than layer number 5 of 812. Layer number 4 of 812 has a curvature that is (e.g., substantially) zero. Layer number 6 of 814 has a curvature that is positive. Layer number 6 of 812 has a curvature that is more negative than layer number 5 of 812, layer number 4 of 812, and layer number 6 of 814. Layer numbers 1-6 of 813 are of substantially uniform (e.g., negative curvature). FIGS. 8, 816 and 817 are super-positions of curved layer on a circle 815 having a radius of curvature “r.” The one or more layers may have a radius of curvature equal to the radius of curvature of the layer surface. The radius of curvature may equal infinity (e.g., when the layer is flat). The radius of curvature of the layer surface (e.g., all the layers of the 3D object) may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the layer surface (e.g., all the layers of the 3D object) may have a value of at most about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, 100 m, or infinity (i.e., flat, or planar layer). The radius of curvature of the layer surface (e.g., all the layers of the 3D object) may have any value between any of the afore-mentioned values of the radius of curvature (e.g., from about 10 cm to about 90 m, from about 50 cm to about 10 m, from about 5 cm to about 1 m, from about 50 cm to about 5 m, from about 5 cm to infinity, or from about 40 cm to about 50 m). In some embodiments, a layer with an infinite radius of curvature is a layer that is planar. In some examples, the one or more layers may be included in a planar section of the 3D object, or may be a planar 3D object (e.g., a flat plane). In some instances, part of at least one layer within the 3D object has the radius of curvature mentioned herein.

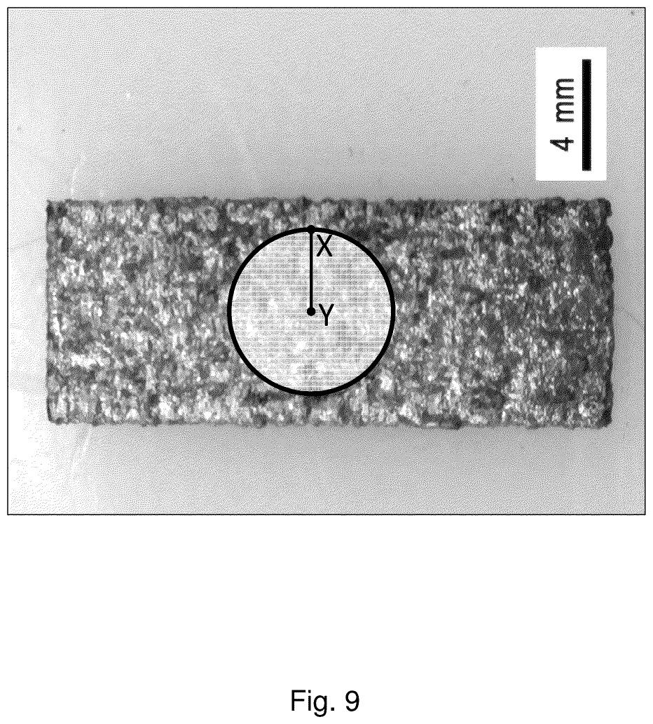

The 3D object may comprise a layering plane N of the layered structure. The 3D object may comprise points X and Y, which reside on the surface of the 3D object, wherein X is spaced apart from Y by at least about 10.5 millimeters or more. FIG. 9 shows an example of points X and Y on the surface of a 3D object. In some embodiments, X is spaced apart from Y by the auxiliary feature spacing distance. A sphere of radius XY that is centered at X lacks one or more auxiliary supports or one or more auxiliary support marks that are indicative of a presence or removal of the one or more auxiliary support features. In some embodiments, Y is spaced apart from X by at least about 10.5 millimeters or more. An acute angle between the straight line XY and the direction normal to N may be from about 45 degrees to about 90 degrees. The acute angle between the straight line XY and the direction normal to the layering plane may be of the value of the acute angle alpha. When the angle between the straight line XY and the direction of normal to N is greater than 90 degrees, one can consider the complementary acute angle. The layer structure may comprise any material(s) used for 3D printing described herein. Each layer of the 3D structure can be made of a single material or of multiple materials. Sometimes one part of the layer may comprise one material, and another part may comprise a second material different than the first material. A layer of the 3D object may be composed of a composite material. The 3D object may be composed of a composite material. The 3D object may comprise a functionally graded material.

The height uniformity of a layer of hardened material may persist across a portion of the layer surface that has a width or a length of at least about 1 mm, 2 mm, 3 mm, 4 mm, 5 mm, or 10 mm, have a height deviation of at least about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm. The height uniformity of a layer of hardened material may persist across a portion of the target surface that has a width or a length of most about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80, 70 μm, 60 μm, 50 μm, 40 μm, 30 μm, 20 μm, or 10 μm. The height uniformity of a layer of hardened material may persist across a portion of the target surface that has a width or a length of or of any value between the afore-mentioned width or length values (e.g., from about 10 mm to about 10 μm, from about 10 mm to about 100 μm, or from about 5 mm to about 500 μm).

Various distances relating to the chamber can be measured using any of the following measurement techniques. Various distances within the chamber can be measured using any of the following measurement techniques. For example, the gap distance (e.g., from the cooling member to the exposed surface of the material bed) may be measured using any of the following measurement techniques. The measurements techniques may comprise interferometry and/or confocal chromatic measurements. The measurements techniques may comprise at least one motor encoder (rotary, linear). The measurement techniques may comprise one or more sensors (e.g., optical sensors and/or metrological sensors). The measurement techniques may comprise at least one inductive sensor. The measurement techniques may include an electromagnetic beam (e.g., visible or IR). The measurements may be conducted at ambient temperature (e.g., R.T.).

The methods described herein can provide surface uniformity across the exposed surface of the material bed (e.g., top of a powder bed) such that portions of the exposed surface that comprises the dispensed material, which are separated from one another by a distance of from about 1 mm to about 10 mm, have a height deviation from about 100 μm to about 5 μm. The methods described herein may achieve a deviation from a planar uniformity of the layer of pre-transformed material (e.g., powder) in at least one plane (e.g., horizontal plane) of at most about 20%, 10%, 5%, 2%, 1% or 0.5%, as compared to the average plane (e.g., horizontal plane) created at the exposed surface of the material bed (e.g., top of a powder bed). The height deviation can be measured by using one or more sensors (e.g., optical sensors).

The 3D object can have various surface roughness profiles, which may be suitable for various applications. The surface roughness may be the deviations in the direction of the normal vector of a real surface, from its ideal form. The surface roughness may be measured as the arithmetic average of the roughness profile (hereinafter “Ra”). The 3D object can have a Ra value of at least about 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The formed object can have a Ra value of at most about 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The 3D object can have a Ra value between any of the aforementioned Ra values (e.g., from about 30 nm to about 50 μm, from about 5 μm to about 40 μm, from about 3 μm to about 30 μm, from about 10 nm to about 50 μm, or from about 15 nm to about 80 μm). The Ra values may be measured by a contact or by a non-contact method. The Ra values may be measured by a roughness tester and/or by a microscopy method (e.g., any microscopy method described herein). The measurements may be conducted at ambient temperatures (e.g., R.T.). The roughness may be measured by a contact or by a non-contact method. The roughness measurement may comprise one or more sensors (e.g., optical sensors). The roughness measurement may comprise a metrological measurement device (e.g., using metrological sensor(s)). The roughness may be measured using an electromagnetic beam (e.g., visible or IR).

The pre-transformed material within the material bed (e.g., powder) can be configured to provide support to the 3D object. For example, the supportive powder may be of the same type of powder from which the 3D object is generated, of a different type, or any combination thereof. In some instances, a low flowability powder can be capable of supporting a 3D object better than a high flowability powder. A low flowability powder can be achieved inter alia with a powder composed of relatively small particles, with particles of non-uniform size or with particles that attract each other. The powder may be of low, medium, or high flowability. The powder material may have compressibility of at least about 1%, 2%, 3%, 4%, 5%, 6%, 7%, 8%, 9%, or 10% in response to an applied force of 15 kilo Pascals (kPa). The powder may have a compressibility of at most about 9%, 8%, 7%, 6%, 5%, 4.5%, 4.0%, 3.5%, 3.0%, 2.5%, 2.0%, 1.5%, 1.0%, or 0.5% in response to an applied force of 15 kilo Pascals (kPa). The powder may have basic flow energy of at least about 100 milli-Joule (mJ), 200 mJ, 300 mJ, 400 mJ, 450 mJ, 500 mJ, 550 mJ, 600 mJ, 650 mJ, 700 mJ, 750 mJ, 800 mJ, or 900 mJ. The powder may have basic flow energy of at most about 200 mJ, 300 mJ, 400 mJ, 450 mJ, 500 mJ, 550 mJ, 600 mJ, 650 mJ, 700 mJ, 750 mJ, 800 mJ, 900 mJ, or 1000 mJ. The powder may have basic flow energy in between the above listed values of basic flow energy (e.g., from about 100 mJ to about 1000 mJ, from about 100 mj to about 600 mJ, or from about 500 mJ to about 1000 mJ). The powder may have a specific energy of at least about 1.0 milli-Joule per gram (mJ/g), 1.5 mJ/g, 2.0 mJ/g, 2.5 mJ/g, 3.0 mJ/g, 3.5 mJ/g, 4.0 mJ/g, 4.5 mJ/g, or 5.0 mJ/g. The powder may have a specific energy of at most 5.0 mJ/g, 4.5 mJ/g, 4.0 mJ/g, 3.5 mJ/g, 3.0 mJ/g, 2.5 mJ/g, 2.0 mJ/g, 1.5 mJ/g, or 1.0 mJ/g. The powder may have a specific energy in between any of the above values of specific energy (e.g., from about 1.0 mJ/g to about 5.0 mJ/g, from about 3.0 mJ/g to about 5 mJ/g, or from about 1.0 mJ/g to about 3.5 mJ/g).

In some embodiments, the 3D object includes one or more auxiliary features. The auxiliary feature(s) can be supported by the material (e.g., powder) bed. The term “auxiliary feature” or “support structure” as used herein, generally refers to a feature that is part of a printed 3D object, but is not part of the desired, intended, designed, ordered, modeled, or final 3D object. Auxiliary feature(s) (e.g., auxiliary support(s)) may provide structural support during and/or subsequent to the formation of the 3D object. The 3D object can have auxiliary feature(s) that can be supported by the material bed (e.g., powder bed) and not touch and/or anchor to the base, substrate, container accommodating the material bed, or the bottom of the enclosure. The 3D part (3D object) in a complete or partially formed state can be completely supported by the material bed (e.g., without touching the substrate, base, container accommodating the powder bed, or enclosure). The 3D object in a complete or partially formed state can be completely supported by the powder bed (e.g., without touching anything except the powder bed). The 3D object in a complete or partially formed state can be suspended anchorlessly in the powder bed without resting on and/or being anchored to any additional support structures. In some cases, the 3D object in a complete or partially formed (e.g., nascent) state can freely float (e.g., anchorlessly) in the material bed. Auxiliary feature(s) may enable the removal or energy from the 3D object that is being formed. In some instances, the auxiliary support is a scaffold that encloses the 3D object or part thereof. The scaffold may comprise lightly sintered or lightly fused powder material. In some examples, the 3D object may not be anchored (e.g., connected) to the platform and/or walls that define the material bed (e.g., during formation). The 3D object may not touch (e.g., contact) to the platform and/or walls that define the material bed (e.g., during formation). The 3D object be suspended (e.g., float) in the material bed. The scaffold may comprise a continuously sintered (e.g., lightly sintered) structure that is at most 1 millimeter (mm), 2 mm, 5 mm or 10 mm. The scaffold may comprise a continuously sintered structure that is at least 1 millimeter (mm), 2 mm, 5 mm or 10 mm. The scaffold may comprise a continuously sintered structure having dimensions between any of the aforementioned dimensions (e.g., from about 1 mm to about 10 mm, or from about 1 mm to about 5 mm). In some examples, the 3D object may be printed without a supporting scaffold. The supporting scaffold may engulf the 3D object. The supporting scaffold may float in the material bed. The printed 3D object may be printed without the use of auxiliary features, may be printed using a reduced number of auxiliary features, or printed using spaced apart auxiliary features. The auxiliary support structure can be any auxiliary support structure disclosed in Patent Application Serial No. PCT/US15/36802 that is incorporated herein by reference in its entirety. The printed 3D object may comprise a single auxiliary support mark. The single auxiliary feature (e.g., auxiliary support or auxiliary structure) may be a platform (e.g., a building platform such as a base or substrate), or a mold. The auxiliary support may be adhered to the platform or mold. In some embodiments, the 3D object comprises a layered structure indicative of 3D printing process that is devoid of one or more auxiliary support features or one or more auxiliary support feature marks that are indicative of a presence or removal of the one or more auxiliary support features. Examples of auxiliary features comprise heat fins, wires, anchors, handles, supports, pillars, columns, frame, footing, scaffold, flange, projection, protrusion, mold (a.k.a. mould), or other stabilization features.

The system and/or apparatus described herein may comprise at least one energy source (e.g., the energy source generating the scanning energy beam, and/or the tiling energy flux). The first energy source may project a first irradiating energy (e.g., a first energy beam). The first energy beam may travel (e.g., scan) along a path. The path may be predetermined (e.g., by the controller). The apparatuses may comprise at least a second energy source. The second energy source may comprise the tiling energy source and/or the second scanning energy source. The second energy source may generate a second irradiating energy (e.g., second energy beam). The first and/or the second energy may transform at least a portion of the pre-transformed material in the material bed to a transformed material. In some embodiments, the first and/or second energy flux (e.g., beam) may heat but not transform at least a portion of the pre-transformed material in the material bed. In some cases, the system can comprise 1, 2, 3, 4, 5, 6, 7, 8, 9, 10, 30, 100, 300, 1000 or more energy fluxes (e.g., beams) and/or sources. The system can comprise an array of energy sources (e.g., laser diode array). Alternatively, or additionally the target surface, material bed, 3D object (or part thereof), or any combination thereof may be temperature controlled, e.g., heated by a heating mechanism and/or cooled by a cooling mechanism. The heating mechanism may comprise dispersed energy beams. In some cases, the at least one energy source is a single (e.g., first) energy source.

The energy beam may include a radiation comprising an electromagnetic, or charged particle beam. The energy beam may include radiation comprising electromagnetic, electron, positron, proton, plasma, or ionic radiation. The electromagnetic beam may comprise microwave, infrared, ultraviolet, or visible radiation. The energy beam may include an electromagnetic energy beam, electron beam, particle beam, or ion beam. An ion beam may include a cation or an anion. A particle beam may include radicals. The electromagnetic beam may comprise a laser beam. The energy beam may comprise plasma. The energy source may include a laser source. The energy source may include an electron gun. The energy source may include an energy source capable of delivering energy to a point or to an area. In some embodiments, the energy source can be a laser source. The laser source may comprise a CO₂, Nd:YAG, Neodymium (e.g., neodymium-glass), an Ytterbium, or an excimer laser. The laser may be a fiber laser. The energy source may include an energy source capable of delivering energy to a point or to an area. The energy source (e.g., first scanning energy source) can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source (e.g., first scanning energy source) can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source (e.g., scanning energy source) can provide an energy beam having an energy density of a value between the afore-mentioned values (e.g., from about 50 J/cm² to about 5000 J/cm², from about 200 J/cm² to about 1500 J/cm², from about 1500 J/cm² to about 2500 J/cm², from about 100 J/cm² to about 3000 J/cm², or from about 2500 J/cm² to about 5000 J/cm²). In an example a laser (e.g., scanning energy source) can provide electromagnetic (e.g., light) energy at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, 400 nm, or 100 nm. The laser can provide light energy at a peak wavelength between any of the afore-mentioned peak wavelength values (e.g., from about 100 nm to about 2000 nm, from about 500 nm to about 1500 nm, or from about 1000 nm to about 1100 nm). The energy beam (e.g., laser) may have a power of at least about 0.5 Watt (W), 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy beam may have a power of at most about 0.5 W, 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500, 2000 W, 3000 W, or 4000 W. The energy beam may have a power between any of the afore-mentioned laser power values (e.g., from about 0.5 W to about 100 W, from about 1 W to about 10 W, from about 100 W to about 1000 W, or from about 1000 W to about 4000 W). The first energy source (e.g., producing the first scanning energy beam) may have at least one of the characteristics of the second energy source (e.g., producing the second scanning energy beam). The energy flux may have the same characteristics disclosed herein for the energy beam. The energy flux may be generated from the same energy source or from different energy sources. The energy flux may be of a lesser power as compared to the scanning energy beam. Lesser power may be by about 0.25, 0.5, 0.75, or 1 (one) order of magnitude. The scanning energy beam may operate independently with the energy flux. The scanning energy beam and the energy flux may be generated by the same energy source that operates in two modules (e.g., different modules) respectively. The characteristics of the irradiating energy may comprise wavelength, power, amplitude, trajectory, footprint, intensity, energy, fluence, Andrew Number, hatch spacing, scan speed, or charge. The charge can be electrical and/or magnetic charge. Andrew number is proportional to the power of the irradiating energy over the multiplication product of its velocity (e.g., scan speed) by the its hatch spacing. The Andrew number is at times referred to as the area filling power of the irradiating energy.

An energy beam from the energy source(s) can be incident on, or be directed perpendicular to, the target surface. An energy beam from the energy source(s) can be directed at an acute angle within a value of from parallel to perpendicular relative to the target surface. The energy beam can be directed onto a specified area of at least a portion of the source surface and/or target surface for a specified time period. The material in target surface (e.g., powder material such as in a top surface of a powder bed) can absorb the energy from the energy beam and, and as a result, a localized region of the solid material can increase in temperature. The energy beam can be moveable such that it can translate relative to the source surface and/or target surface. The energy source may be movable such that it can translate relative to the target surface. The energy beam(s) can be moved via a scanner (e.g., as disclosed herein). At least two (e.g., all) of the energy sources can be movable with the same scanner. A least two (e.g., all) of the energy beams can be movable with the same scanner. At least two of the energy source(s) and/or beam(s) can be movable (e.g., translated) independently of each other. In some cases, at least two of the energy source(s) and/or beam(s) can be translated at different rates (e.g., velocities). In some cases, at least two of the energy source(s) and/or beam(s) can be comprise at least one different characteristic. The characteristics may comprise wavelength, power, amplitude, trajectory, footprint, intensity, energy, or charge. The charge can be electrical and/or magnetic charge.

The energy source can be an array, or a matrix, of energy sources (e.g., laser diodes). Each of the energy sources in the array, or matrix, can be independently controlled (e.g., by a control mechanism) such that the energy beams can be turned off and on independently. At least a part of the energy sources in the array or matrix can be collectively controlled such that the at least two (e.g., all) of the energy sources can be turned off and on simultaneously. The energy per unit area or intensity of at least two energy sources in the matrix or array can be modulated independently (e.g., by a control mechanism or system). At times, the energy per unit area or intensity of at least two (e.g., all) of the energy sources in the matrix or array can be modulated collectively (e.g., by a control mechanism). The energy source can scan along the source surface and/or target surface by mechanical movement of the energy source(s), one or more adjustable reflective mirrors, or one or more polygon light scanners. The energy source(s) can project energy using a DLP modulator, a one-dimensional scanner, a two-dimensional scanner, or any combination thereof. The energy source(s) can be stationary. The target and/or source surface can translate vertically, horizontally, or in an angle (e.g., planar or compound). Translation of the target and/or surface can be manual, automatic, or a combination thereof. Translation can be controlled by at least one controller which at least one controller can operate to maintain a selected focus (or de-focus) of an energy source at or near the target and/or surface. Translation control can be local or remote (e.g., controlled over a network connection). The selected focus can be a variable focus.

The energy source can be modulated. The energy flux (e.g., beam) emitted by the energy source can be modulated. The modulator can include amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an acousto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

An energy beam from the first and/or second energy source can be incident on, or be directed to, a target surface (e.g., the exposed surface of the material bed). The energy beam can be directed to the pre-transformed or transformed material for a specified period. That pre-transformed or transformed material can absorb the energy from the energy source (e.g., energy beam, diffused energy, and/or dispersed energy), and as a result, a localized region of that pre-transformed or transformed material can increase in temperature. The energy source and/or beam can be moveable such that it can translate relative to the surface (e.g., the target surface). In some instances, the energy source may be movable such that it can translate across (e.g., laterally) the top surface of the material bed. The energy beam(s) and/or source(s) can be moved via a scanner. The scanner may comprise a galvanometer scanner, a polygon, a mechanical-stage (e.g., X-Y-stage), a piezoelectric device, gimbal, or any combination of thereof. The galvanometer may comprise a mirror. The scanner may comprise a modulator. The scanner may comprise a polygonal mirror. The scanner can be the same scanner for two or more energy sources and/or beams. At least two (e.g., each) energy sources and/or beams may have a separate scanner. The energy sources can be translated independently of each other. In some cases, at least two energy sources and/or beams can be translated at different rates, and/or along different paths. For example, the movement of the first energy source may be faster (e.g., at a greater rate) as compared to the movement of the second energy source. The systems and/or apparatuses disclosed herein may comprise one or more shutters (e.g., safety shutters). The energy beam(s), energy source(s), and/or the platform can be moved by the scanner. The galvanometer scanner may comprise a two-axis galvanometer scanner. The scanner may comprise a modulator (e.g., as described herein). The energy source(s) can project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) can be modulated. The scanner can be included in an optical system that is configured to direct energy from the energy source to a predetermined position on the target surface (e.g., exposed surface of the material bed). The controller can be programmed to control a trajectory of the energy source(s) with the aid of the optical system. The controller can regulate a supply of energy from the energy source to the material (e.g., at the target surface) to form a transformed material. The optical system may be enclosed in an optical enclosure. An optical enclosure may be any optical enclosure disclosed in patent application number PCT/US17/64474, titled “OPTICS, DETECTORS, AND THREE-DIMENSIONAL PRINTING” that was filed Dec. 4, 2017, which is incorporated herein by reference in its entirety.

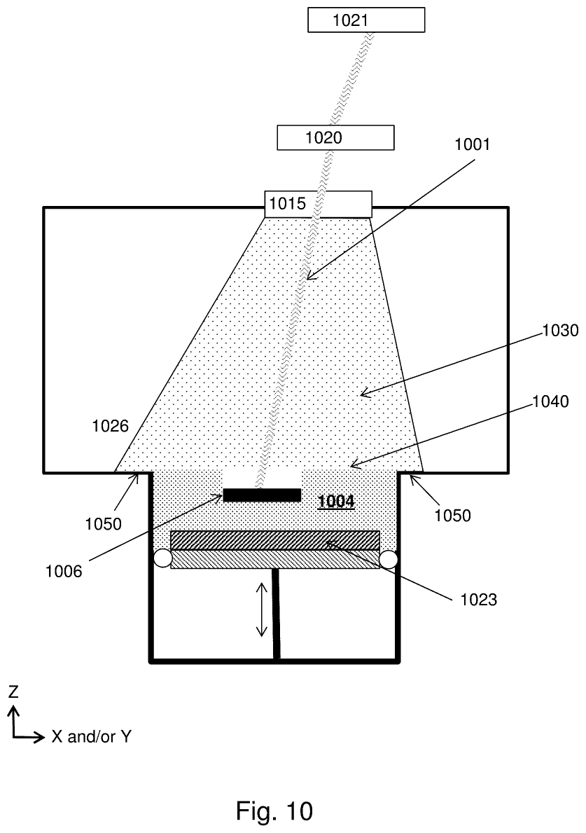

In some embodiments, a plurality of energy beams are directed at the target surface for printing a 3D object. At least one optical element may direct the irradiating energy from an energy source to a scanner (e.g., a X-Y scanner, a galvanometer scanner) to direct the energy beams. The scanner may be any scanner disclosed herein. The irradiating energy may be directed (e.g., by the at least one optical element) to one or more scanners. The scanner may direct irradiating energy on a position at the target surface. An energy beam may travel through one or more filters, apertures, or optical windows on its way to the target surface (e.g., as depicted in FIGS. 1 and 10).

In some embodiments, one or more (e.g., a multiplicity of) scanners directs a plurality of energy beams, respectively, to the target surface (e.g., to different positions of the target surface). The guidance system of the energy beam may comprise an optical mechanism. The guidance system of the energy beam may comprise a scanner. A given scanner may direct a plurality of energy beams from the same energy source. A given scanner may direct a plurality of energy beams from more than one (e.g., at least two) energy sources. A given scanner may direct one energy beam from a respective energy source. The plurality of energy beams may be of the same or of different characteristics (e.g., large vs. small cross section) and/or functions (e.g., hatching vs. tiling) in the 3D printing process. A scanner may be controlled manually and/or by at least one controller. For example, at least two scanners may be directed by the same controller. For example, at least two scanners may be directed each by its own different controller. The plurality of controllers may be operatively coupled to each other. The plurality of energy beams may irradiate the surface simultaneously or sequentially. The plurality of energy beams may be generated by the same energy source. The plurality of energy beams may be generated by at least two energy sources (e.g., a respective energy source for each energy beam). The plurality of energy beams may be directed towards the same position at the target surface, or to different positions at the target surface. The plurality of energy beams may comprise the energy flux, or scanning energy beam. The one or more scanners may be positioned at an angle (e.g., tilted) with respect to the material bed. The one or more sensors may be disposed adjacent to the material bed. At least one of the one or more sensors may be disposed in an indirect view of the target surface. At least one of the one or more sensors may be disposed in a direct view of the target surface (e.g., a camera viewing the target surface). The one or more sensors may be configured to have a field of view of at least a portion of the target surface (e.g., an exposed surface of the material bed).

A portion of the enclosure that is occupied by the energy beam (e.g., the energy flux or the scanning energy beam) can define a processing cone. The energy beam(s) may travel through a region of the processing chamber referred to as a processing cone region (also referred the herein as a “processing cone”). One or more scanners can be configured to move the energy beam (e.g., by deflection) in accordance with a predetermined path along the target surface. Movement of the energy beam(s) during a printing operation can cause the energy beam(s) to potentially occupy a volume extending from the area or point of entry of the energy beam into the processing chamber and the area of the target surface (e.g., exposed surface of the material bed)—referred to as the processing cone. The height of processing cone can span a distance between the interior surface of an optical window and the surface of the target surface. In some embodiments, the processing cone has a height ranging from about 10 centimeters (cm) to about 5000 cm. The processing cone can have a height of at least 10 cm, 50 cm, 100 cm, 500 cm, 1000 cm, or 5000 cm. The processing cone can have a height of any value between the aforementioned values (inclusive). In some cases, the processing cone includes at least a portion of the exposed surface of a material bed. The shape of the processing cone region may vary (e.g., by adjusting the target surface's and/or optical window's height). In some embodiments, the shape of the processing cone region may comprise at least a portion of a cone, a conical frustum (cut-off cone), a pyramid (e.g., square pyramid), a frustum (cut-off pyramid), a cylinder, a tetrahedron, a cube or a prism (e.g., triangular prism, hexagonal prism or pentagonal prism). In some embodiments, the processing cone region has a symmetric shape (e.g., substantially symmetric about a central axis). In some embodiments, the processing cone region has an asymmetric shape. The processing cone may have a shape depending on the motion range of the laser(s), that may depend on the shape of the platform, optical window, and/or energy beam guidance system (e.g., scanner).

An intersection of a processing cone with a target surface can define a processing field. The processing field of a given energy beam may cover an area of the target surface (e.g., as measured at a build plane). The area can be the target surface or a portion thereof. The area (e.g., of a target surface) may be irradiated by an energy beam (e.g., one energy beam). The processing field of a given energy beam may overlap (e.g., at least in part) with a processing field of another (e.g., at least one) energy beam. For example, the processing field of a first energy beam may overlap (e.g., at least in part) with a processing field of a second energy beam. An overlap may be an overlapping area (e.g., of a target surface). The overlap area may be irradiated by both (e.g., all) of the energy beams. As measured at a build plane, an overlapping region may include a portion or a totality of a target surface (e.g., of the material bed and/or the build plate). An overlapping region of the processing cones at a target surface may be at most about 100%, 80%, 60%, 40%, 20%, 10%, 5% or 1% of the target surface area. An overlapping region of the processing cones at the target surface may be any value between the aforementioned area percentage values. For example, an overlapping region may be about 100%, from about 1% to about 100%, from about 40% to about 100%, or from about 1% to about 40% of the area of the target surface. At times, the overlapping region may have a greater extent than the target surface (e.g., extend beyond the target surface). The irradiation by at least two of a plurality of the energy beams may occur sequentially or simultaneously. The irradiations by at least of a plurality of the energy beams may occur separately. For example, separate irradiations may include a first irradiation by a first energy beam at a first time, and a second irradiation by a second energy beam at a second time (e.g., where the second time follows the first time).

A processing field of a first energy beam may at least partially overlap a processing field of a second energy beam. An overlap may include a (e.g., shared) region including a (e.g., shared) portion of the processing field of the first energy beam and a (e.g., shared) portion of the processing field of the second energy beam. The non-overlapping region may include a portion of a processing field of the first energy beam that is (e.g., mutually) distinct from a portion of a processing field of the second energy beam. As understood herein, total (e.g., complete) overlapping includes at least one processing field that is entirely shared with (e.g., by) another (e.g., at least one) processing field. A total overlapping may be mutual, for example, a first energy beam having the same (e.g., shared) processing field as a second energy beam. A total overlapping may be non-mutual, for example, a first processing field that is entirely within a second processing field, which second processing field includes an area distinct from the first processing field. Overlapping may include a first processing field of a first energy beam that is (e.g., entirely or completely) shared with (e.g., a portion of) a second processing field of a second energy beam. For example, partial overlapping such that a portion of the second processing field is distinct from the first processing field (e.g., the first processing field is entirely encompassed by the second processing field). Characteristics of overlapping regions for a given energy beam can vary between respective overlapping energy beams regions. For example, a first processing field of a first energy beam may be partially overlapping with a second processing field of a second energy beam and totally overlapping with a third processing field of a third energy beam. Other combinations of (e.g., partial, total, and none) overlapping are possible for a plurality of energy beams.

In some embodiments, usage of a plurality energy beams increases (i) the (e.g., total) processing field available for printing (e.g., in a X-Y plane) and/or (ii) the rate for completing a given print cycle (as compared to using a single energy beam). A plurality of energy beams (e.g., at least two energy beams) may be useful in providing a relatively larger processing area in which one or more 3D objects may be generated. A relatively larger processing area may be useful in generating a larger 3D object, or a plurality of (laterally) adjacent 3D objects. The larger 3D object may be larger in at least one dimension (e.g., in a X-Y plane), compared to a 3D object formed using a single energy beam. The platform and/or material bed may be larger in at least one dimension (e.g., in a X-Y plane), compared to platform and/or material bed used for 3D printing with a single energy beam. A relatively larger processing field may be larger in relation to a 3D printing system that includes a single energy beam, which processing area is limited to the areal extent (e.g., the processing field) of the single energy beam (e.g., as guided by a guidance system), which is not arbitrarily sized. The time for 3D printing may be shortened when two or more of the plurality of energy beam operate in simultaneously (e.g., in parallel).

Printing a dimensionally-accurate 3D object using a plurality of energy beams may require calibration of the energy beams and/or their guiding system (e.g., an associated guidance system directing the energy beam). Printing a 3D object using a plurality of non-calibrated energy beams may result in one or more defects in the printed 3D object. The defects may comprise (internal) material defects and/or structural effects. The structural defect may comprise variation in surface roughness (e.g., Ra value) of the printed object. For example, a first 3D object portion printed using a first energy beam may have a first roughness, and a second 3D object portion printed using a second energy beam may have a second roughness. The structural defect may comprise an un-requested step or un-requested ledge, e.g., in a requested planar surface. The defect may comprise a seam (e.g., a stitch) in a generated 3D object. The seam may comprise a (internal) material defect. The material defect may comprise microstructure variations, cracks, or pores. The microstructure variation may arise from variation in hardening (e.g., crystallization) rates to form the hardened material of the 3D object. The seam may be at one or more portions of the 3D object that are generated at an interface of a first energy beam and another (e.g., at least a second) energy beam (e.g., in an overlapping region). For example, a surface of the 3D object that is intended to be (e.g., substantially) smooth and/or planar may include a disjunction (e.g., a raised or lowered region) at a location where processing by a first energy beam transitions to processing by a second (e.g., overlapping) energy beam. A seam may generate a deleterious effect in the 3D object (e.g., such as a reduced mechanical property of the 3D object, e.g., due to one or more internal material defects). Calibration of the plurality of energy beams of a 3D printing system may improve the dimensional accuracy of 3D objects generated with multiple energy beams. The improvement may comprise reducing occurrences of defect(s) (e.g., by reducing the incidence of stitches in the 3D objects). Calibration of the energy beams may comprise calibration of the guidance system(s) of the energy beams.

In some embodiments, a respective guidance of the energy beams is calibrated. A calibration may include a comparison of a commanded energy beam position (e.g., at the target surface) compared with an actual (e.g., measured) energy beam position at the target surface. A variation of the measured energy beam position from the commanded energy beam position (e.g., at the target surface) may be termed a “distortion.” A variation of the measured energy beam position of a first energy beam with respect to a measured energy beam position of a second energy beam, compared to a commanded first energy beam position with respect to a commanded second energy beam position, may be termed an “overlay offset” or a “beam-to-beam overlay offset.” A calibrated energy beam position (e.g., regarding distortion and/or overlay offset, e.g., at a target surface) may include a measured position that may be at most about 350 microns (μm), 250 μm, 150 μm, 100 μm, 50 μm, 40 μm, 30 μm, 20 μm, 10 μm, 5 μm, or 2 μm from a commanded position of the energy beam. The measured position of the energy beam may be at least about 2 μm, 5 μm, 10 μm, 20 μm, 30 μm, 40 μm, 50 μm, 150 μm, 250 μm or 350 μm from a commanded position of the energy beam. The measured position may be any value between the aforementioned values (e.g., from about 2 μm to about 350 μm, from about 150 μm to about 350 μm, or from about 2 μm to about 150 μm). A calibrated energy beam position may include a measured angular position of a guidance system element (e.g., a mirror). The guidance system element may be an optical system element. The measured angular position may deviate from a requested angular position by (e.g., comprise an error of) at most about 40 micro-radians (μRads), 30 μRads, 20 μRads, 15 μRads, or 10 μRads from a commanded angular position of the guidance system element. A deviation of the measured angular position from a requested angular position may be any value between the afore-mentioned values (e.g., from about 10 μRads to about 50 μRads, from about 30 μRads to about 50 μRads, or from about 10 μRads to about 30 μRads). These angular position accuracies may correspond to position accuracies at the target surface (e.g., an X-Y position accuracy at a build plane) from about 2 μm to about 350 μm, from about 150 μm to about 350 μm, or from about 2 μm to about 150 μm.

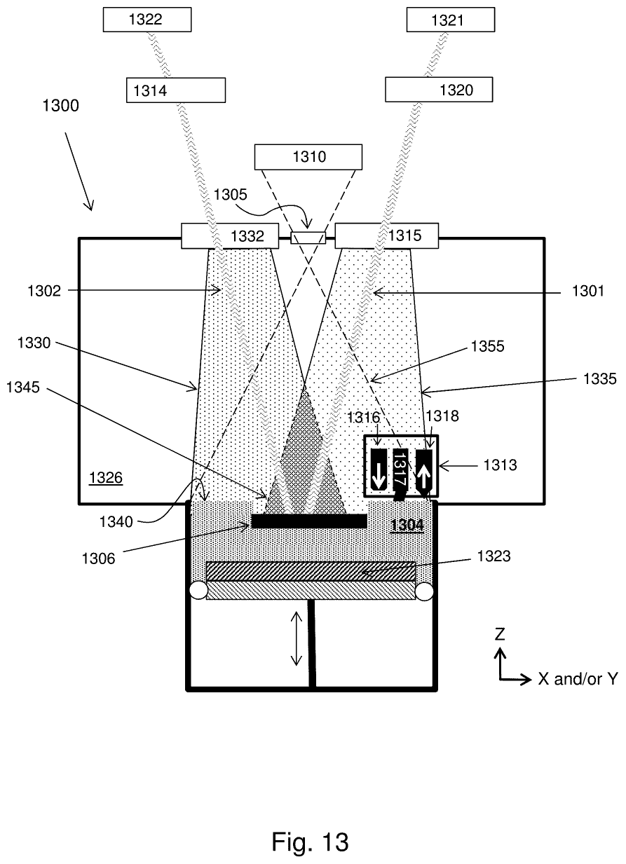

FIG. 13 shows an example of a 3D printing system 1300 and apparatuses, including a (e.g., first) energy source 1321 that emits a (e.g., first) energy beam 1301 and a (e.g., second) energy source 1322 that emits a (e.g., second overlapping) energy beam 1302. In the example of FIG. 13 the energy from energy source 1321 travels through an (e.g., first) optical system 1320 (e.g., comprising a scanner) and an optical window 1315 to be incident upon a target surface 1340 within an enclosure 1326. The guidance system of the energy beam may comprise an optical system. FIG. 13 shows the energy from the energy source 1322 travels through an optical system 1314 (e.g., comprising a scanner) and an optical window 1332 to be incident upon the target surface 1340. The energy from the (e.g., plurality of) energy sources may be directed through the same optical system and/or the same optical window. At times, energy from the same energy source is directed to form a plurality of energy beams by one or more optical systems. In the example of FIG. 13, the energy beam 1302 trajectory defines a processing cone 1330, the energy beam 1301 trajectory defines a processing cone 1335, and the processing cones 1330 and 1335 have an overlapping region 1345. A processing cone may have a corresponding processing field defined by the intersection of the processing cone with the target surface. The target surface may include a (e.g., portion of) hardened material (e.g., FIG. 13, 1306) formed via transformation of material within a material bed (e.g., FIG. 13, 1304). In the example of FIG. 13, a layer forming device 1313 includes a (e.g., powder) dispenser 1316, a leveler 1317, and material removal mechanism 1318. The material bed may be supported by a (e.g., movable) platform, which platform may include a base (e.g., FIG. 13, 1323). A hardened material may be anchored to the base (e.g., via supports and/or directly), or un-attached to the base (e.g., floating anchorlessly in the material bed, e.g., suspended in the material bed). At times, a (e.g., optical) detection system is disposed to detect one or more characteristics of the printing process. In the example of FIG. 13, a detection system 1310 is disposed adjacent to (e.g., above) the enclosure, having a field of view 1355 via an opening (e.g., comprising a (transparent) window) 1305.

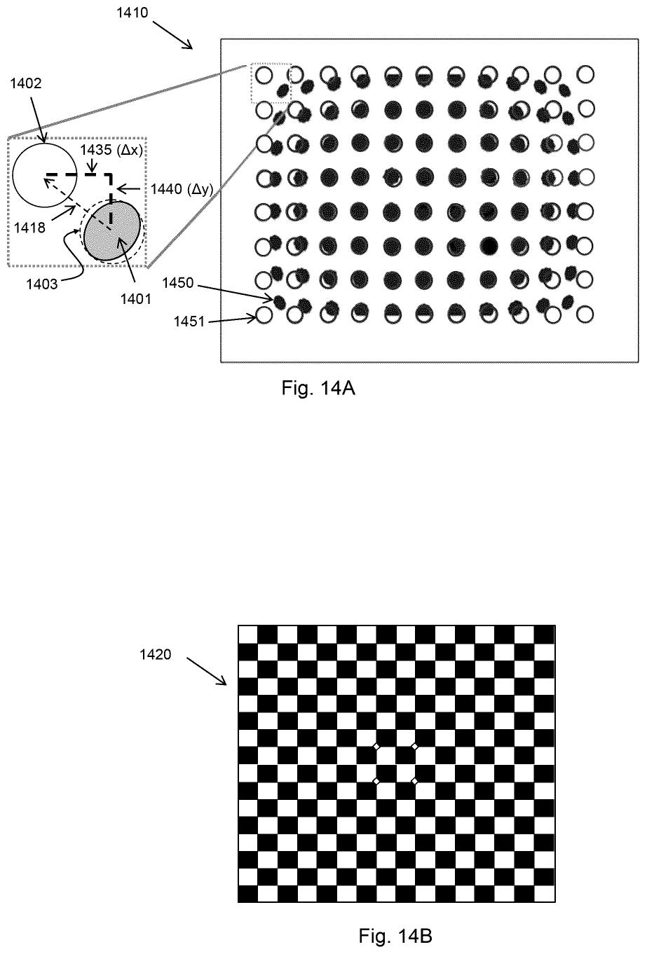

In some embodiments, the target surface is detected by a detection system. The detection system (e.g., FIG. 13, 1310) may include a light source operable to illuminate a portion of the 3D printing system enclosure (e.g., the target surface). The light source may be configured to illuminate onto a target surface such that objects in the field of view of the detector are illuminated with (e.g., substantial) uniformity. For example, sufficient uniformity may be uniformity such that at most a threshold level (e.g., 25 levels) of variation in grayscale intensity exists (for objects), across the build plane. Examples of illumination apparatuses include a lamp (e.g., a flash lamp), a LED, a halogen light, an incandescent light, a laser, or a fluorescent light. The detection system may comprise a camera system, CCD, CMOS, detector array, or line-scan CCD (or CMOS). A detection system may be calibrated (e.g., using an accurate target pattern), e.g., as described herein. FIG. 14B shows an example of an accurate target pattern 1420. An accurate target pattern may comprise a lithographically formed grid of alternating light and dark squares. The accurate target pattern may be formed with an accuracy of at most about 1 μm, 2 μm, 3 μm, 4 μm, or 5 μm.

In some embodiments, an energy beam calibration (e.g., distortion and/or overlay offset) is performed in real time during the 3D printing (e.g., before, during, and/or following transformation of the pre-transformed material to form the 3D object). In some embodiments, at least one energy beam calibration is performed in situ and/or in real-time. In some embodiments, a number of energy beam calibrations are performed during generation of a 3D object (e.g., at various times during the generation of the 3D object). Periodic (e.g., and real time and/or in situ) energy beam calibration may deliver a high(er) accuracy 3D printing of one or more 3D objects (e.g., higher than an infrequently and/or non-calibrated energy beam(s)). The higher accuracy may be due to a reduced distortion of the energy beam across at least a portion of (e.g., entire) its processing field, and/or reduced overlay offset (for at least two overlapping energy beams). The reduced distortion of the energy beam may comprise a reduced distortion of a footprint shape and/or position at the target surface. The position may comprise an interface and/or overlapping region between two or more energy beams. The position may comprise an outskirts of the processing field. Real time may be during the 3D printing (e.g., during a cycle of 3D printing to complete a print job). For example, an energy beam calibration can be performed in every layer. For example, an energy beam calibration can be performed every n^{th} layer of a 3D object. Values of layers ‘n’ for which an energy beam calibration is performed may be equal to at least 1, 2, 5, 10, 20, 100, 300, 500, 1000, or 5000. Values of ‘n’ may be any value between the afore-mentioned values (e.g., from about 1 to about 5000, from about 1000 to about 5000, or from about 1 to about 1000. In some embodiments, an energy beam calibration is performed between formation of a first 3D printing cycle and a second 3D printing cycle (e.g., between build cycles). A 3D printing cycle may comprise forming one or more 3D objects above a platform (e.g., and/or in a material bed). In some embodiments an energy beam calibration includes generation (e.g., printing) of one or more alignment markers. The one or more alignment markers may be generated on a target surface (e.g., across a material bed). The one or more alignment markers may be generated in one or more selected portions of a target surface. For example, the selected portion(s) may correspond to an area(s) devoid of one or more 3D objects (e.g., that are being generated, e.g., respective layers thereof). The alignment markers may be formed in a remainder of a layer of pre-transformed material that is not used to generate the requested 3D object. A layer of pre-transformed material may be used to (1) generate a layer of hardened material as part of the 3D object and (2) one or more (e.g., partial) alignment markers. In some embodiments, the material bed may be utilized to formed stacked 3D objects that are separated by one or more layers of pre-transformed material (referred herein as “buffer layers”). The (e.g., partial) alignment markers may be formed in the one or more buffer layers. In some embodiments some of the (e.g., marker) layers may be formed in buffer layer(s) and some of the alignment markers may be formed in a remainder of a layer of pre-transformed material during a build cycle. The selected remainder portions may change from layer to layer. In some embodiments the energy beam calibration comprises image processing and/or image analysis of the one or more alignment markers. Image processing may be performed every m^{th} layer of a 3D object. The image processing and/or analysis may be performed along with each generation of the one or more alignment markers (e.g., m=n).

At times, image processing is performed when other layers of the 3D object are generated. For example, image processing may be performed to compare or to combine alignment markers of two or more layers. A combination of alignment markers may be of “partial” alignment markers, described below. Values of layers ‘m’ for which image processing is performed may comprise at least about 2, 10, 20, 50, 100, 300, 500, 1000, 5000. Values of ‘m’ may be any value between the afore-mentioned values (e.g., from about 2 to about 5000, from about 1000 to about 5000, or from about 2 to about 1000. In some embodiments, compensation data is provided to a guidance system (e.g., a scanner) following the image processing of the m^{th} layers. In some embodiments, monitoring is performed for any patterns or trends in changes to the energy beam (e.g., distortion and/or overlay offset). The monitoring may consider the image processing (e.g., every m^{th} layer). At times (e.g., periodically during formation of the 3D object), compensation data is derived from a detected trend and/or pattern (e.g., from historical data showing a trend and/or pattern rather than directly from generation of one or more alignment markers and image processing thereof). The pattern and/or trend may be of change in energy beam distortion and/or overlay offset. A detected trend and/or pattern may be indicative of a portion (e.g., one or more optical elements, an energy source, or a material dispenser) of the system that is causing a change. A detected trend and/or pattern may be used to direct performance of an operation comprising maintenance, corrective, or replacement procedure, on the identified portion of the system that is causing the change in energy beam operation. In some embodiments, a threshold value of change in energy beam distortion and/or overlay offset may be identified. The threshold value may correspond to a deviation from a commanded position of the energy beam at a target surface (e.g., on a material bed). The threshold value may be at least about 2 microns (μm), 5 μm, 10 μm, 30 μm, 60 μm, 100 μm, 200 μm, or 300 μm. The threshold value may be between any of the afore-mentioned values (e.g., from about 2 μm to about 300 μm, from about 100 μm to about 300 μm, or from about 2 μm to about 100 μm. Performance of a maintenance, corrective, and/or replacement procedure may be initiated considering the threshold value.

At times, an energy beam calibration includes formation of the one or more alignment markers using at least one energy beam directed at a target surface. The one or more alignment markers may form an arrangement (e.g., a pattern). The position(s) of the marker(s) may be according to a requested (e.g., pre-determined) arrangement (e.g., a reference pattern). Requested may be according to a commanded arrangement as directed by commands to a guidance system for directing the energy beam(s). The arrangement (e.g., position(s)) of the one or more alignment markers may be detected by a detection system (e.g., FIG. 13, 1310). The detected position(s) (e.g., measured position(s)) of the alignment marker(s) may be compared to the commanded position(s). The energy beam calibration may include correction (e.g., compensation) of any deviation of the detected position(s) from the commanded position(s). Following application of the (e.g., initial) compensation to the energy beam (e.g., to the guidance system directing the energy beam), further (e.g., additional) calibration may be performed. Further calibration may (e.g., iteratively) improve the compensation of the any deviation between the detected position(s) from the commanded position(s) of the energy beam at the target surface. The deviation between the commanded position to the actual position of the energy beam at the target surface may arise due to the optical system that guides the energy beam to the target surface and/or to the commander (e.g., controller). The deviation may be constant and/or vary in time. The deviation may depend on the amount of irradiation transmitted through the optical system. The deviation may depend on the nature and/or geometry of one or more optical elements of the optical system. The calibration may comprise altering the one or more elements (e.g., position thereof) of the optical system. The calibration may comprise altering a command to one or more elements of the optical system and/or to the energy source.

In some embodiments the energy beam is guided by a guidance system. The guidance system for the at least one energy beam may include one or more forms of distortion. The distortion can be generated due to the arrangement of the elements of the guidance system with respect to a target surface toward which an energy beam is directed by the guidance system. The distortion may arise due to spherical aberration, e.g., due to an optical element in the optical system (e.g., a spherical mirror and/or lens). For example, a pin-cushion distortion can be a distortion in a (e.g., galvanometer) scanning system. The distortion can arise because the energy beam is directed according to controlled (e.g., spherical) scanning angles of a (e.g., planar or curved) optical element in the optical guidance system, onto a planar target surface. For example, the distortion can arise because the energy beam is directed according to controlled (e.g., spherical) scanning angles of a (e.g., planar or curved) mirror in the scanning system, onto a planar target surface. The directed energy beam (e.g., using a scanner) may be controlled according to a spherical coordinate system, while the processing area may be defined according to a Cartesian (e.g., X-Y) coordinate system.

FIG. 14A shows an example of a processing field distortion 1410 at a target surface in which black ellipses (e.g., 1450) represent actual footprints of the energy beam on the target surface, and empty circles (e.g., 1451) represent requested footprints of the energy beam at the target surface. The energy beam may transform the material in the footprint to form an object (e.g., substantially) in the shape of the footprint, and the black ellipses (e.g., 1450) would then represent transformed material (e.g., objects). The transformed material may be used as an alignment marker. In the example of FIG. 14A, a requested position for an object 1402 (e.g., as directed by a guidance system) is located in a corner of the processing field. In some embodiments, the requested positions and/or actual positions (of the energy beam footprint) are sensed by a detector. The expected position may be a commanded position of an energy beam. The expected position (e.g., 1451) may correspond to sensing elements (e.g., pixels) of a (e.g., calibrated) detector. In the example of FIG. 14A an energy beam footprint, or an (e.g., actual) object 1401 is located at an actual position (e.g., measured) position. A measured position may be a measured (e.g., actual) position of an energy beam (or an object formed by the energy beam) on a target surface (e.g., prior to calibration). A measured position may correspond to sensing elements (e.g., pixels) of a (e.g., non-calibrated) detector. The measured position may deviate from the commanded position. A magnitude and/or direction of the deviation may be detected and/or measured. In the example of FIG. 14A the deviation 1418 is the difference between the measured position 1401 and the expected position 1402. In the example of FIG. 14A the deviation 1418 includes a deviation 1435 in an X-axis, and a deviation 1440 in a Y-axis. At times, a distortion in the processing field includes a (e.g., astigmatic) distortion (e.g., primarily) along a given direction. For example, astigmatic distortion at a given position on the processing field may be in a direction parallel to a line from the given position to a point on the target surface on which an energy beam is normally incident. The astigmatic distortion at the given position may exhibit distortion in a perpendicular direction. The astigmatic distortion at the given position may exhibit (e.g., substantially) no distortion in a perpendicular direction. At times, the distortion may generate a footprint and/or an object that is dimensionally accurate in some portions while being dimensionally inaccurate in other portions. In the example of FIG. 14A the footprint and/or object 1401 is an ellipse, which exhibits a (e.g., astigmatic) distortion from an expected circular shape 1403.

At times, differences between coordinate systems (e.g., spherical as compared to Cartesian) lend themselves to a (e.g., mathematical) calculated compensation. For example, a calculated compensation may include an estimated position compensation based on a transformation of a position in a Cartesian coordinate (e.g., in an X-Y plane of a target surface) to a position in a spherical coordinate (e.g., a position of a mirror and/or a focus of a variable optical axis element). As used herein, a compensation based (e.g., solely) on a coordinate system transformation may be termed a “baseline” or a “gross” compensation. A baseline compensation may be generic, that is, may not be representative of system-specific distortion (or overlay) errors.

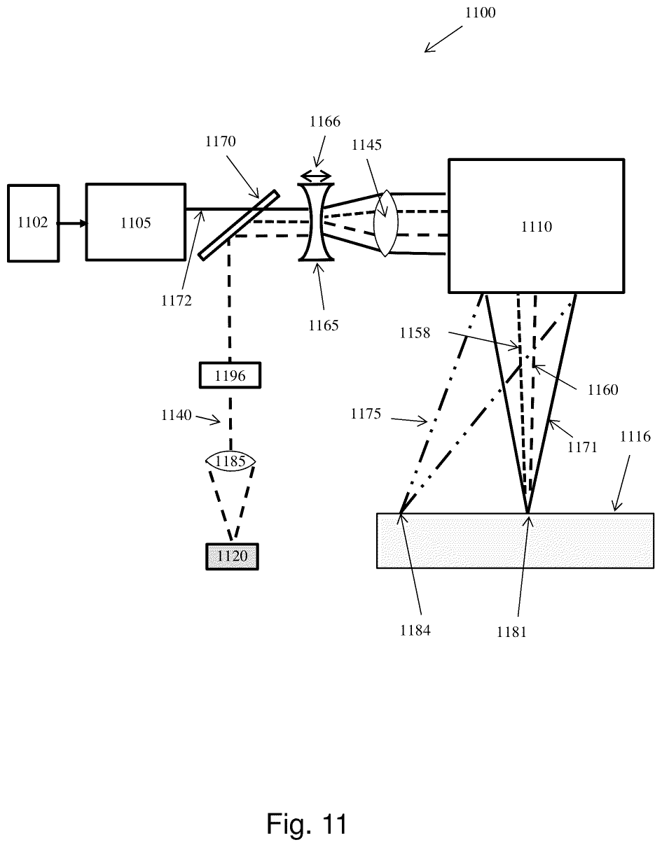

In some embodiments the systems, apparatuses, software and/or methods described herein provide system-specific compensation of processing field distortion and beam-to-beam overlay offset. In some embodiments, a (e.g., energy beam position) calibration system is operatively coupled to (e.g., included in) the 3D printer. The calibration system may comprise a guidance system (e.g., included in FIGS. 13, 1320 and/or 1314), sensor, detector, and/or one or more controllers. The sensor may be any sensor described herein. The detector may be any detector described herein. The calibration system may calibrate one or more components of the energy beam guidance system and/or the optical system (e.g., the irradiating energy). The calibration system may calibrate one or more characteristics of the irradiating energy (e.g., energy flux). For example, the calibration system may calibrate (i) the position at which the irradiating energy contacts a surface (e.g., the target surface), (ii) the shape of the footprint of the energy beam at the (e.g., target) surface, (iii) the XY offset of a first energy beam position at the (e.g., target) surface with a second energy beam position at the (e.g., target) surface, and/or (iv) the XY offset of the energy beam with respect to the (e.g., target) surface. The characteristics of the irradiating energy may be calibrated along a field of view of the optical system (e.g., and/or detector). The field of view (e.g., FIG. 10, 1040) may be described as the maximum area of target surface that is covered (e.g., intersected, or accessed) by the optical system. A field of view may be (e.g., substantially) similar to a processing field of the irradiating energy. A field of view may be greater than a processing field of the irradiating energy. The field of view may be indirect (e.g., devoid of a direct view). The field of view may be constrained, constricted or otherwise limited, for example, to increase a resolution of an image, to reduce contrast, to exclude a portion of the field of view. The field of view may be (e.g., substantially) concentric with a location of the irradiating energy on a surface (e.g., a calibration structure, and/or the target surface) (e.g., FIGS. 11, 1158 to 1181). The field of view may include one or more dimensions (e.g., horizontal plane, XY plane, or lateral plane). The field of view may include an angle of coverage.

In some embodiments, the alignment marker arrangement is generated in a manner that allows detection of the positions and/or size of alignment markers of the arrangement by the detection system. The marker may comprise a transformed material. The alignment markers may be disposed on the transformed material. The alignment marker may be 3D objects. The alignment marker arrangement may be located within the processing chamber (e.g., FIG. 13, having the internal volume 1326). The alignment marker arrangement may be generated within the enclosure. For example, the alignment marker arrangement may be generated at or adjacent to the platform (e.g., the base 1323). The alignment marker arrangement may be generated at or adjacent to the target surface (e.g., FIG. 13, the exposed surface of the material bed 1304). The alignment marker arrangement may comprise transformed (and hard) material (e.g., FIG. 13, 1306). The arrangement of the alignment marker may be located outside of, or at an edge of, the build module (e.g., in the processing chamber). The alignment marker arrangement may be located outside of the processing chamber (e.g., in the build module).

The target surface (e.g., comprising the pre-transformed material, transformed material, build platform, or enclosure floor) may comprise at least one detectable property. The detectable property may be a physically detectable property (e.g., protrusions, indentations, roughness, smoothness, regularity, or planarity). The detectable property may be an optically detectable property (e.g., via reflectivity, absorption, and/or image analysis). Images from the detector system may be processed to determine a topography, and/or reflectivity of at least a fraction of the target surface. The at least the fraction of the target surface may comprise a pre-transformed material or a transformed material (e.g., an alignment marker).

In some embodiments, the pre-transformed material and/or transformed material are diffusive (e.g., and dispersive). In some embodiments, the pre-transformed material and/or transformed material are specular. The pre-transformed material (e.g., in an exposed surface of a material bed) may be at least about 50%, 60%, 70%, 80%, or 90% diffusive, relative to its total reflection. The pre-transformed material (e.g., in an exposed surface of a material bed) may be diffusive in any percentage between the afore-mentioned percentages, relative to its total reflection (e.g., from 50% to 90%). In some embodiments, the transformed material (e.g., an exposed surface thereof) is at least about 50%, 60%, 70%, 80%, 90%, or 95% specular, relative to its total reflection. The transformed material (e.g., an exposed surface thereof) may be specular in any percentage between the afore-mentioned percentages, relative to its total reflection (e.g., from 50% to 95%).

The alignment marker arrangement may comprise one or more alignment markers. The arrangement may be characterized by a coherence length in a direction of the arrangement. The marker may be characterized by an actual shape (e.g., as deviating from a requested shape). The alignment marker may comprise hardened (e.g., transformed) material, pre-transformed material, or a combination thereof. The alignment marker may be an area (e.g., at the target surface) comprising an embossing, depression, protrusion, line, and/or point. The alignment marker arrangement may comprise an alignment marker type having a (e.g., optically) detectable shape. The shape may be at least a two dimensional shape. The shape may be a 3D shape. Detectable may include use of an illumination source (e.g., a light source, a projector). The alignment marker arrangement may comprise two or more alignment markers. The alignment marker arrangement may include two different alignment markers. The alignment marker arrangement may include two different alignment marker types. The two different mark types may differ in at least one detectable property. The detectable property may comprise a geometry, absorption spectrum, reflection spectrum (e.g., color), reflectivity, or diffusivity.

In some embodiments, the alignment marker comprise a (e.g., 2D or 3D) shape. Alignment markers may be of a shape that correlates (well) to points. Examples of shapes of alignment markers comprise an octagon, a square, a hexagon, a heptagon, a triangle, a nonagon, an ellipse (e.g., circle), a pentagon, or any other polygon, a plus (+), a slash “/,” an asymmetric letter (e.g., “E,” or “F,”) or “X.” The alignment marker may be irregularly shaped. The alignment mark may be symmetric or asymmetric. The symmetry may be a mirror or rotational symmetry. The symmetry may be a point symmetry (e.g., inversion symmetry). The alignment marker may comprise a line. The line may comprise a curvature. The line may be straight. At least two of the lines in the (e.g., requested) alignment marker arrangement may be (e.g., substantially) equal in width, length, line-shape, or any combination thereof. At least two of the lines in the (e.g., actual) alignment marker arrangement may differ in width, length, line-shape, or any combination thereof. At least one line in the alignment marker arrangement may be straight. At least one line in the alignment marker arrangement may comprise a curvature. At least two lines in the alignment marker arrangement may intersect, and/or overlap. The alignment marker arrangement may form a grid (e.g., having a pitch or a coherence length). The manhattan distance may be between two (e.g., center) alignment marker points in the grid, based on a strictly horizontal and/or vertical path (e.g., the distance between two points measured along axes at right angles). At times, at least two manhattan distances in the grid is (e.g., substantially) equal. At times, at least two manhattan distances in the grid differ from each other. The alignment marker may have a regular surface (e.g., smooth surface). The alignment marker may have an irregular surface (e.g., comprising a protrusion or indentation). The alignment marker may have one or more colors (e.g., two tone colors). The alignment marker may have at least one varied physical property that is measurable (e.g., varied reflectivity, variable roughness, specular reflection, diffuse reflection, diffused absorption). The varied physical property may comprise a range of the physical property. The alignment marker may be of a small size (e.g., size of the smallest footprint and/or cross-section of the energy beam and/or energy flux). The small size may be small relative to the target surface. For example, the FLS of the marker may be at most about 1%, 5%, 10%, or 30% of the FLS of the target surface.

In some embodiments, the (lateral) area of the alignment marker is at least equal to the cross section and/or footprint of the irradiating energy beam (e.g., energy flux) on the exposed surface. For example, the area of the alignment marker may be greater by at least 1.5*, 2*, 5*, 10*, 15* or 20* the cross-sectional area and/or footprint of the irradiating energy beam on the exposed surface. The area of the alignment marker may be of any value between the afore-mentioned values (e.g., from about 1.5* to about 20* the cross-sectional area and/or footprint of the irradiating energy on the exposed surface). The symbol “*” designates the mathematical operation “times”. In some embodiments, the FLS (e.g., width and/or depth) of the alignment marker is at least equal to the cross section and/or footprint of the irradiating energy beam on the exposed surface. For example, the FLS of the alignment marker may be greater by at least 1.5*, 2*, 5*, 10*, 15* or 20* the FLS of the cross-section and/or footprint of the irradiating energy beam on the exposed surface. The FLS of the alignment marker may be of any value between the afore-mentioned values (e.g., from about 1.5* to about 20* the FLS of the cross section and/or footprint of the irradiating energy beam on the exposed surface).

In some embodiments, an alignment marker is made up of a plurality of transformed material portions (e.g., plurality of 3D objects). In some embodiments, the alignment marker arrangement may include alignment markers located at different layers that form the material bed. At least one of the plurality of transformed material portions may be located at a different material layer than another of the plurality of transformed material portions. The layers may be layers of a material bed. For example, a first subset of alignment markers of the alignment marker arrangement may be located at a first layer and a second (e.g., remainder) subset of alignment markers of the alignment marker arrangement may be located at a second layer. The first layer may be (e.g., directly) below the second layer. The first layer may be (e.g., directly) above the second layer. The first and the second layer may be (e.g., directly) adjacent layers (e.g., sequential layers). At times, the first and the second layers may have one or more intervening layers. The one or more intervening layers may comprise pre-transformed material, transformed material, or a combination thereof. The calibration marks may be formed during the 3D printing, e.g., in locations of the target surface that are not occupied with the requested 3D object that is being built. The calibration markers may be formed in layers that are or that are not occupied by a requested 3D object.

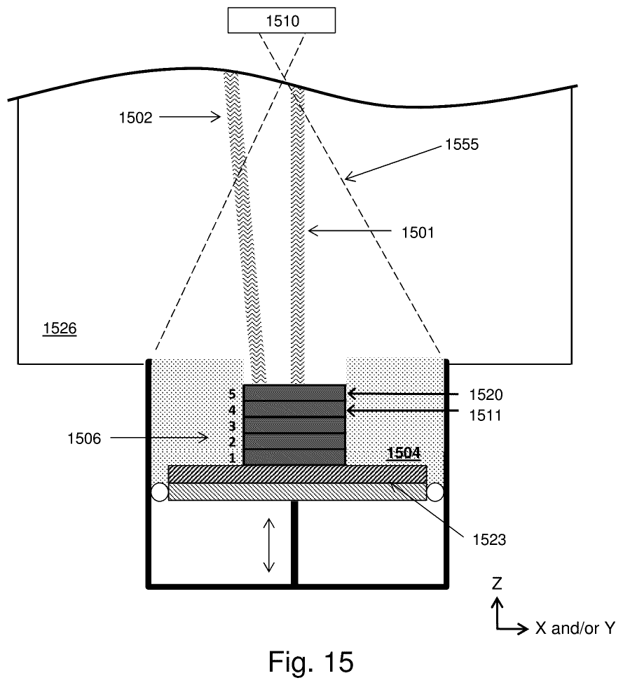

FIG. 15 shows an example of a portion of a calibration system in a 3D printing system. In the example of FIG. 15 a (e.g., first) energy beam 1501 and a (e.g., second) energy beam 1502 are propagating within an enclosure 1526 to be incident on a hardened material 1506 in a material bed 1504. In the example of FIG. 15, the material bed is supported by a (e.g., vertically movable) platform, which platform includes a base 1523. FIG. 15 shows the hardened material 1506 includes a number of layers (e.g., layers 1-5). In the example of FIG. 15, a detection system 1510 has a field of view 1555 within the enclosure 1526 (e.g., of the target surface). A detection system may be configured to capture an image (and/or a video) of the target surface. The detection system may be operatively coupled with one or more apparatuses of the 3D printing system (e.g., a controller and/or optical system). The detection system may be operable to capture images at various times during a calibration process. For example, the detection system may be operable to capture a first image following generation of a first set of alignment markers (e.g., a first alignment marker arrangement, a first subset of alignment markers). The first image may be an image of a first layer of alignment markers (e.g., FIG. 15, 1511). The detection may be operable to capture a second image following generation of a second set of alignment markers. The second image may be an image of a second layer of alignment markers (e.g., FIG. 15, 1520).

At times, an alignment marker arrangement includes alignment markers that are formed from one or more partial alignment markers (e.g., “partial markers”). A partial marker may correspond to an alignment marker that is split to form scale-independent (e.g., partial) markers. For example, the partial markers may correlate to each other at least one point. A first set of partial alignment markers may be generated on a first layer, and a second (e.g., corresponding) set of partial alignment markers may be generated on a second layer. A combination of partial markers may be used to form a (e.g., complete) alignment marker in an alignment marker arrangement. A combination of the first set and the second set of partial alignment markers may form the (e.g., complete) alignment marker arrangement. A combination of partial markers may reduce a variability in the combined alignment marker. A reduction in variability can be with respect to a shape, position (e.g., on the target surface), and/or a dimension of the combined alignment marker, as compared to a (e.g., full) alignment marker generated in one processing step.

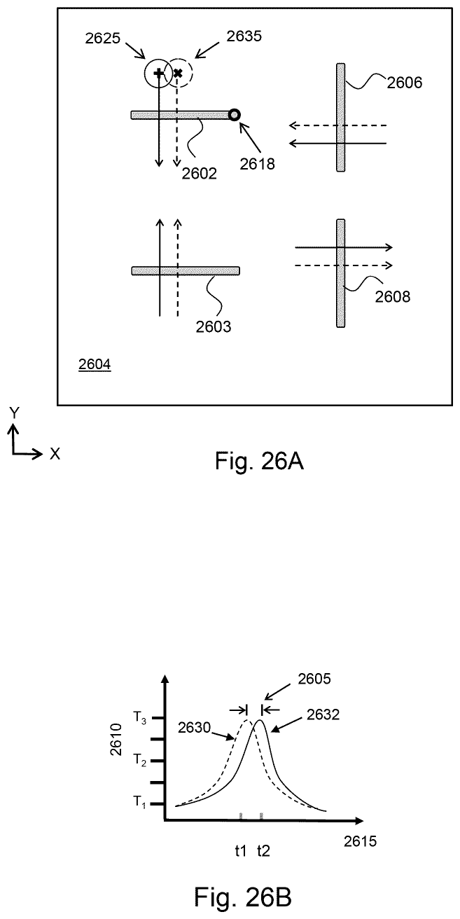

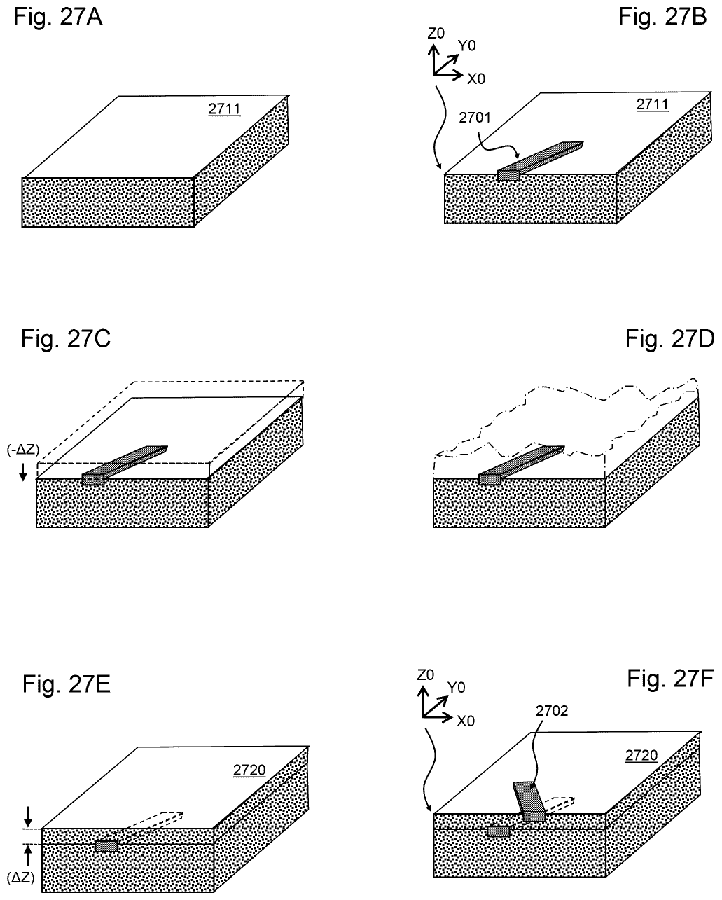

As an example, a (e.g., first) partial marker may comprise a forward-slash (“/”). For example, a (e.g., second) partial marker may form a back-slash (“\”). The first and the second partial markers may be combined to form a (e.g., complete) alignment marker (e.g., an “X” marker). The partial markers may form an arrangement that is (e.g., substantially) similar in form to the alignment marker arrangement (e.g., placement on a grid, pitch, and/or coherence length). The combination of the first and the second (e.g., arrangements of the) partial markers may be performed via image processing. The combination of the first and the second (e.g., arrangements of the) partial markers may be performed via superposition of their two respective images. The (e.g., image processing) combination may be based on data captured by a detection system (e.g., a still image and/or a video). A (e.g., complete) alignment marker that is formed from a combination of partial markers may advantageously reduce variability in the alignment marker. A source of variability in a (e.g., completely) generated alignment marker may be one or more regions of the alignment marker that overlap. For example, a center portion of an alignment marker (e.g., an “X”) may be subject to two transformations (e.g., from overlapping build portions). For example: (a) a first layer of pre-transformed material (e.g., FIG. 26B, 2711) may be deposited above a platform; (b) a first partial marker (e.g., or first set of partial markers) may be formed (e.g., FIG. 27B, 2701) using transformation of respective areas of the layer by a first energy beam; (c) a first image of the first marker is taken by the detector; (d) a second layer of pre-transformed material may be deposited above the first layer (e.g., FIG. 27D); (e) a second marker (e.g., or a second set of partial markers) may be formed using transformation of respective areas of the layer by a second energy beam (e.g., FIG. 27F); (f) a second image of the second marker is taken by the detector; (g) superposition of the first image and the second image is performed to form a third image; and (h) the image of the markers (formed using the superposition) is analyzed. At times, only one markers (e.g., set of markers) is generated; in that case, after operation (c) the image of the marker (or set thereof) is analyzed. The analysis may be with respect to a benchmark location (e.g., or grid of locations) and/or calibrated detector. In some embodiments, a guidance system causes an energy beam to generate corresponding partial alignment markers at the same XYZ position in the 3D printing system, but at different layers (e.g., FIG. 15, layer 1511 and layer 1520 shown as vertical cross sections) in the material bed (e.g., FIG. 27B, 2711 and FIG. 27F, 2720 shown as perspective views). The partial alignment markers may be generated at the same Z position as the platform on which the material bed is supported recedes between processing of subsequent layers (e.g., FIG. 27C, −ΔZ), and the prior layer of partial alignment markers may be (e.g., completely) covered (e.g., by using the layer dispensing system) (e.g., FIG. 27E). Therefore, separate layers (e.g., build layers) may be used for a (e.g., each) given set of partial alignment markers. In this manner the guidance system of the energy beam may be calibrated across its processing field using (e.g., combinations of) partial alignment markers formed at different material layers.

At times, an alignment marker that is generated for a calibration operation is disruptive to one or more operations of the 3D printer. The disruption may occur before, during, and/or after at least a portion (e.g., a printing lap) of the printing. The disruption may comprise (i) increasing a complexity of, (ii) increasing a time to complete, (iii) decreasing a reliability of, (iv) reducing an uptime of, or (v) halting, one or more operations of the 3D printer. The disruption may comprise damage (e.g., incurred) (a) to one or more apparatuses of the 3D printer, or (b) to a (e.g., 3D) object formed by the printer. Damage to the 3D object may comprise (i) alteration in surface roughness, (ii) alteration in dimensional accuracy, (iii) a deformation, and/or (iv) a dislocation. A deformation may be with respect to a requested geometry of the 3D object. The damage may be caused due to adherence of at least a portion of an alignment marker to at least a portion of the 3D object, e.g., surface adherence, and/or being integrated in the interior of the 3D object. The adherence to the surface may comprise anchoring and/or connection to the surface. A dislocation may comprise a crack, or delamination, e.g., of a 3D object. The alignment marker may comprise a transformed (e.g., bound and/or fused) material. The fused (e.g., sintered and/or melted) material may comprise a (e.g., fully) hardened material. In some embodiments, a disruption comprises an alignment marker that binds to an apparatus of the 3D printer. In some embodiments, at least two alignment markers of an alignment marker arrangement may bind (e.g., together). In some embodiments, an alignment marker may be disruptive to a planarization operation and/or planarization apparatus (e.g., layer forming mechanism), of the 3D printer. In some embodiments, an alignment marker (or at least a portion thereof) may be disruptive to a material conveyance operation and/or apparatus, of the 3D printer (or that is operatively coupled to the 3D printer). For example, the alignment marker may reduce a material flow (e.g., clog) in at least a portion of the material conveyance system (e.g., a recycling system). The recycling system may comprise a separator (e.g., a sieve). The recycling system may be any recycling system as disclosed in patent application number PCT/US18/24667, titled “MATERIAL MANIPULATION IN THREE-DIMENSIONAL PRINTING” that was filed on Mar. 27, 2018, which is incorporated herein by reference in its entirety. In some embodiments, an alignment marker (or at least a portion thereof) may be disruptive to a layer forming device. Disruption to the layer forming device may comprise adherence of the at least a portion of the calibration marker to a planarizer (e.g., a blade, roller, and/or squeegee) of the layer forming device, e.g., forming furrows in an exposed surface of a material bed as a consequence. Disruption to the layer forming device may comprise disrupting an attraction of pre-transformed material from an exposed surface of a material bed (e.g., due to clogging), which attraction is using the layer forming device.

In some embodiments, an alignment marker is formed such that it can be erasable (e.g., an erasable alignment marker). In some embodiments, alignment markers are generated by an energy beam, e.g., as guided by a guidance system. For example, the alignment markers may be generated over (e.g., on top of) and/or as part of a material bed. For example, the alignment markers may be generated over a target surface (e.g., a platform). The energy beam may impinge upon a (e.g., pre-transformed) material to generate the (e.g., detectable property of the) alignment marker, e.g., that is erasable. The pre-transformed material can be on a target surface and/or projected towards a target surface. For example, the energy beam may alter a luminance, reflectivity, specularity, and/or contrast of a material, in a vicinity of an impingement of the energy beam on the material. The energy beam may fuse, ablate, or promote a chemical reaction (e.g., surface treatment) of the pre-transformed material, to form the alignment marker. In some embodiments, the energy beam effectuates formation of the alignment marker without binding the impinged material. For example, the alignment marker may comprise material that is unbound (e.g., not fused). For example, the alignment marker may comprise material in which particulates of the pre-transformed material become lightly bound to each other. Lightly binding the particulates (e.g., via at least one connection point) may allow their connection point(s) to be easily disrupted (e.g., broken), e.g., by a recoater. The easily disrupted markers may be fragile markers. For example, the alignment marker may comprise material in which particulates of the pre-transformed material become bound to each other, which binding persists along a small coherence length (e.g., forming small agglomerates of particles). Such small agglomerates may be easily removed, e.g., by a recoater and/or a remover (e.g., comprising an attractive force, or an air knife). For example, the energy beam may effectuate a surface treatment on the impinged material. For example, the energy beam may oxidize and/or ablate the impinged (e.g., pre-transformed) material. In some embodiments, the energy beam effectuates the formation of the erasable alignment marker by binding (e.g., fusing) at least two particles of impinged material. For example, the energy beam may sinter and/or melt at least two particles of impinged material (e.g., to form agglomerates).

In some embodiments, an alignment marker that is erasable, is formed such that it is detectable by a detection system, e.g., any detection system as described herein. Detectable by the detection system may include a material having a detectable property, e.g., a luminance, a reflectivity, a specularity, a color, a shade, and/or a contrast (e.g., to an adjacent material). For example, a well-defined contrast to an adjacent (e.g., surrounding) material on the target surface. For example, a well-defined reflectivity in relation to a reflectivity of an adjacent material on the target surface. The adjacent material on the target surface may comprise a (e.g., unconsolidated) pre-transformed material, a platform material, or an enclosure material. The enclosure material may comprise a surface material, e.g., of a floor of a processing chamber. The type of the material may be any material disclosed herein. The detectable property of the alignment marker may comprise a repeatable property. Repeatable may comprise a repeatable property (e.g., that is detectable) of at least two alignment markers of a given arrangement of alignment markers.

The alignment markers may be generated at conditions other than those utilized for generating a transformed material structure (e.g., to form the requested 3D object). For example, the conditions for generating an (e.g., erasable) alignment marker may be different than processing conditions that are used to generate a hatch and/or a tile of transformed material, e.g., as part of a 3D object. The conditions for generating an erasable alignment marker may comprise (A) a power output of an energy source (e.g., that generates the energy beam), (B) an energy beam characteristic, or (C) an atmosphere (e.g., of an enclosure). The energy beam characteristic may comprise (i) a power density, (ii) dwell time, (iii) translational velocity, (iv) beam cross-section, or (v) propagation scheme, of the energy beam. In some embodiments, the conditions for generating an (e.g., erasable) alignment marker may be insufficient to effectuate a transformation of pre-transformed material, e.g., to a fused and/or hardened material. In some embodiments, the conditions for generating an erasable alignment marker are sufficient to alter an optical property and/or bind (e.g., fuse) the pre-transformed material (e.g., lightly bind and/or form small agglomerates). The small agglomerates may include at most 2, 3, 4, 5, 6, 7, 8, 9, 10, 20, or 50 particulates. The small agglomerates may include any number of particulates between the afore-mentioned values (e.g., from about 2 particulates to about 50 particulates, from about 2 particulates to about 20 particulates, or from about 20 particulates to about 50 particulates). Lightly bound material may comprise sintered or at least partially-melted (e.g., fully molten) material. Lightly bound material may comprise material which may be readily separated. The lightly bound particulates may comprise a weak bond. The lightly bound material may comprise a strong bond that extends over a small area (e.g., and is thus easily broken). Disruption of the lightly bound material may be by a mechanism, e.g., a planarization and/or a removal mechanism. The mechanism may comprise a blade, a (e.g., air, hard, or flexible) knife, a rake, a recoater, a roller, a squeegee, or an attractive force (e.g., vacuum).

In some embodiments, a power output for generating an alignment marker may be at most about 40 Watts (W), about 50 W, about 60 W, about 80 W, or about 100 W. The power output for generating the alignment marker may be any value between the afore-mentioned values (e.g., from about 40 W to about 100 W, from about 40 W to about 60 W, or from about 60 W to about 100 W). In some embodiments, a translational velocity of an energy beam used for generating an alignment marker may be at most about 500 millimeters/second (mm/s), about 1 meter/second (m/s), about 2 m/s, about 3 m/s, about 4 m/s, or about 5 m/s. The translational velocity for generating an alignment marker may be any value between the afore-mentioned values (e.g., from about 500 mm/s to about 5 m/s, from about 500 mm/s to about 2 m/s, or from about 2 m/s to about 5 m/s). In some embodiments, an FLS of a cross-section (e.g., diameter) of an energy beam used for generating an alignment marker may be at most about 70 microns (μm), about 90 μm, about 110 μm, about 130 μm, about 150 μm, or about 250 μm. The FLS of the cross-section of the energy beam used for generating the alignment marker may be any value between the afore-mentioned values (e.g., from about 70 μm to about 250 μm, from about 70 μm to about 110 μm, or from about 110 μm to about 250 μm). The alignment marker may be an erasable alignment marker.

A given (e.g., erasable) alignment marker may require a plurality of (e.g., energy beam) operations for its formation. For example, a single energy beam operation may be insufficient to generate the detectable property of the alignment marker. In some embodiments, a plurality of (e.g., repeated) operations may increase a likelihood of detection of the detectable property. At least two operations of the plurality of operations may be different (e.g., in at least one energy beam characteristic, e.g., as disclosed herein). At least two operations of the plurality of operations may be the same (e.g., at least two repetitions of the same operation). The (e.g., energy beam) operations for forming a given alignment marker may be repeated until a threshold level of a given detectable property is attained. For example, energy beam impingement in a given location at which an alignment marker is formed, may be repeated until a threshold contrast of the alignment marker is achieved, e.g., threshold contrast relative to an adjacent material. A (e.g., single) operation of the energy beam to form a (e.g., single) alignment marker may comprise (i) guiding the energy beam along a path, at (ii) the conditions for generating the (e.g., erasable) alignment marker. The path (e.g., trajectory) may correspond with (e.g., a geometry of) the alignment marker, e.g., at a given area on the target surface. In some embodiments, an alignment marker of an alignment marker arrangement is formed using a plurality of operations. In some embodiments, at least two operations of the plurality of (e.g., energy beam) operations comprise the same conditions for generating the given alignment marker. In some embodiments, at least two operations of the plurality of operations comprise different conditions for generating the given alignment marker.

In some embodiments, a method (e.g., process) for forming an arrangement of (e.g., erasable) alignment markers comprises a plurality of operations. The plurality of operations may comprise (i) directing (e.g., by a control system) an energy beam to impinge on a (e.g., pre-transformed) material at a plurality of locations of a target surface, e.g., for generating a plurality of alignment markers, (ii) repeating the directing the energy beam in (i) until a (e.g., threshold) detectable property is achieved for the plurality of alignment markers, (iii) generating (e.g., capturing) an image of the plurality of alignment markers, and (iv) removing the plurality of alignment markers. In some embodiments, the alignment marker comprises a partial marker. In some embodiments, operations (i)-(iv) are repeated for each partial marker (e.g., portion) of the (e.g., complete) alignment marker. In some embodiments, a (e.g., complete) set of alignment markers are generated by a combination of at least two images of partial markers.

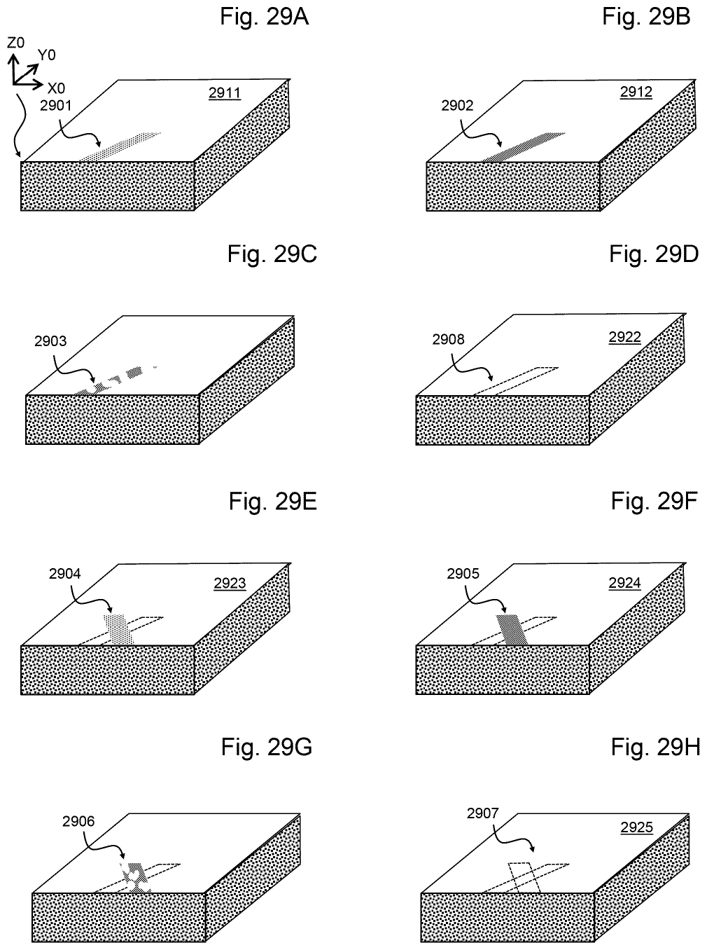

FIGS. 29A-29H show examples of various possible operations in a method for forming an (e.g., erasable) alignment marker (e.g., arrangement). In the example of FIG. 29A, a first (e.g., partial) marker (e.g., 2901), is formed, e.g., by impinging a (e.g., first) transforming agent on a target surface (e.g., 2911). The first (e.g., partial) marker may be a portion of a first set of (e.g., partial) markers. The first marker can be disruptable (e.g., erasable). The first marker may be a first alignment marker. The target surface may comprise (e.g., one or more layers of) pre-transformed material forming a material bed. The exposed surface of the material bed may be planarized, e.g., prior to formation of the first marker (or first marker set). In some embodiments, impingement of the transforming agent (e.g., energy beam) is repeated until a (e.g., threshold) detectable property is achieved. FIG. 29B shows an example in which impingement of the transforming agent was repeated until the first marker (e.g., 2902) attained a threshold detectable property (e.g., on target surface 2912). Upon (e.g., following) attainment of a threshold detectable property, a first signal (e.g., image) of the first marker may be taken by a detector (e.g., a sensor and/or a camera). Following capture of the first signal, the first marker may be disrupted (e.g., FIG. 29C, 2903). Disruption may comprise displacement and/or removal of at least a portion of the first marker relative to and/or from the target surface. Disrupting the first marker may comprise cracking and/or breaking at least a portion of the first marker. Disruption may be by a layer dispenser, a planarization and/or a removal mechanism, e.g., as described herein. The first marker may or may not be disrupted prior to formation of a second (e.g., partial) marker. In some embodiments, a second marker is formed on the target surface on which the first marker was formed, e.g., whether the first marker was disrupted prior to the formation of the second marker. In some embodiments, the first marker is formed on a first target surface, and the second marker is formed on a second target surface that is different than the first target surface. For example, the first target surface, e.g., containing a disrupted or the non-disrupted first marker, may be covered by pre-transformed material, e.g., prior to generating a second (e.g., partial) marker. The pre-transformed material may form a second exposed surface that is the second target surface. The pre-transformed material disposed on the first target surface may be planarize and form a planar exposed surface that forms the second target surface. Dispensing the pre-transformed material on the first target surface may comprise lowering of a platform, e.g., that supports the material bed. The disruption of the first marker may be devoid of (i) lowering a platform and/or (ii) addition of (e.g., further) pre-transformed material layers. FIG. 29D depicts an example of a target surface 2922 in which disrupted alignment marker is (e.g., completely) removed, e.g., a dotted line 2908 depicts the circumference of an area of the first marker on the target surface 2922 prior to its removal. In some embodiments, the pre-transformed material of the target surface is planarized during and/or following disruption of the first marker. In some embodiments, at least two (e.g., partial) alignment markers (e.g., that are erasable) are generated for a processing field calibration operation. FIG. 29E depicts a second (e.g., partial) marker 2904. The second marker may be formed by impinging a transforming agent on target surface 2923. The second marker may be erasable. The second marker may be part of a second set of partial markers. In the example of FIG. 29F, the impingement of the transforming agent on a target surface 2924 is repeated until the second marker 2905 attains a (e.g., threshold) detectable property. Following the formation of the second marker (e.g., or a second marker set), a second sensed signal (e.g., data, and/or image) may be taken by the detector. Following capture of the second signal, the second (e.g., erasable) marker may be disrupted, e.g., FIG. 29G, 2906, showing an example of a second marker 2906 with missing portions of the second marker. FIG. 29H depicts an example of a target surface 2925 in which the first and second alignment markers 2907 are (e.g., completely) removed, with the dotted lines depicting the circumference of an area of the first and second markers on the target surface 2925 prior to their disruption (e.g., removal). In some embodiments, a target surface (e.g., build region) from which (e.g., erasable) alignment markers have been (e.g., completely) removed may be suitable for forming a portion of a 3D object, e.g., of a print increment. In some embodiments, a superposition of the first sensed signal (e.g., image) and the second sensed signal (e.g., image) is performed to generate a third sensed signal (e.g., third image). The (e.g., third) sensed signal of the (e.g., erasable) markers (formed using the superposition) may be analyzed as a part of a processing field calibration operation.

In some embodiments, an (e.g., erasable) alignment marker is formed such that it is readily removable. Ready removal may comprise removal of the alignment marker from a target surface, e.g., from where it was formed, disposed, and/or detected. Removal of the alignment marker(s) may be performed following their imaging, e.g., by a detection device. An alignment marker may be (i) breakable, (ii) brittle, (iii) frail (e.g., fragile), and/or (iv) frangible. Removal of the alignment marker may comprise disruption of the alignment marker structure and/or location. Disruption may comprise fracturing, fragmenting, and/or breaking up, the material from which the alignment marker is formed, e.g., by pushing, and/or attracting the alignment marker. Pushing may be in a horizontal and/or vertical direction (e.g., relative to a global vector and/or to the platform). For example, the alignment marker may be pushed downwards by a roller to be crushed. For example, the alignment marker may be pushed laterally by a blade, a roller, and/or a gas knife. For example, the alignment markers may be attracted by an attractive force (e.g., magnetic, electrostatic, and/or vacuum). Disrupted alignment markers may be (A) readily removed from a target surface, (B) accommodated by a material conveyance system, and/or (C) incorporated by and/or attached to a forming 3D object, of the 3D printer. In some embodiments, an alignment marker comprises an alignment marker that is erasable to the extent that it can be readily removed by a mechanism of the 3D printer. The mechanism may comprise a surface planarization mechanism, or a powder bed planarizer. The mechanism may comprise a blade, a (e.g., air) knife, a rake, a recoater, a roller, or an attractive force (e.g., vacuum). The mechanism may comprise a removal mechanism of the 3D printer. In some embodiments, the alignment marker(s) are removable by a recoater. The recoater may comprise a planarizer. The recoater may comprise a non-contact recoater. The layer forming device may comprise a recoater. The non-contact recoater may comprise dispensing, removing, or planarizing (e.g., leveling) using an attractive and/or a repulsive force. The attractive and/or repulsive force may be generated by a fluid (e.g., gas) flow. The recoater may comprise a mechanical component, e.g., a roller, a rake, a squeegee, and/or a blade. A “global vector” may be (a) a (e.g., local) gravitational field vector, (b) a vector in a direction opposite to the direction of a layerwise 3D object formation, and/or (c) a vector normal to a surface of a platform that supports the 3D object, in a direction opposite to that of the 3D object.

In some embodiments, at least two sets of partial (e.g., erasable) alignment markers are generated at a same height (e.g., z height), e.g., height along a vertical direction. For example, a first set of partial (e.g., erasable) alignment markers may be disrupted following generation (e.g., an imaging). A second set of partial (e.g., erasable) alignment markers may be generated following the disruption, e.g., without movement of a platform (e.g., elevator).

In some embodiments, an alignment marker arrangement is used to calibrate one or more properties of the energy beam guidance system (e.g., scanner), the optical system and/or the detection system. Calibrating may include benchmarking, certifying, and/or evaluating the detectable property. In some embodiments, an energy beam (e.g., guidance system) calibration system includes forming (e.g., partial) alignment marker(s) on a target surface of a build plane (e.g., exposed surface of a material bed), an exposed surface of a platform, and/or adjacent to an exposed surface of the material bed. The energy beam position calibration process may include applying a (e.g., recoating) layer of pre-transformed material above the platform. The recoat layer may be, for example, formed by lowering the platform a given amount (e.g., between about 20 to 500 microns). The particular (e.g., recoat) layer height may be sufficient to cover (e.g., any) previous parts and/or alignment marker(s) present in a previously formed layer, for example so as not to merge alignment markers of different layers. The particular height may be determined (e.g., via a detector, metrology, a model, or a combination thereof).

The energy beam position calibration process may include generation of alignment markers (or partial markers) in an arrangement (e.g., on an evenly-spaced grid) on the (e.g., recoated) layer using the energy beam (e.g., a first energy beam). In some embodiments, the alignment markers are disposed without auxiliary supports in the material bed. The alignment markers may be suspended anchorlessly in the material bed (e.g., during their formation). In some embodiments the alignment markers are disposed with auxiliary supports in the material bed. The auxiliary support(s) may or may not be anchored to the platform. In some embodiments, the alignment markers float (e.g., anchorlessly) above the platform.

At times, the alignment markers are generated by an irradiation of an energy beam at processing conditions (e.g., power density, translational velocity, and/or beam cross-section) that generate a transformed material structure (e.g., hatch or tile) that is detectable by the detection system. Detectable by the detection system may include a transformed material having a repeatable, well-defined contrast to surrounding target surface (e.g., comprising unconsolidated pre-transformed). Detectable by the detection system may include use of an illumination source (e.g., a light source, a projector) to illuminate the alignment markers. The detection system may be any detection system as disclosed in patent application number PCT/US15/65297, titled “FEEDBACK CONTROL SYSTEMS FOR THREE-DIMENSIONAL PRINTING” that was filed on Dec. 11, 2015, which is incorporated herein by reference in its entirety.

In some embodiments, the alignment marker arrangement forms a grid covering an area of interest (e.g., a processing field) of the energy beam. The area of interest may be the total available processing area (e.g., total exposed surface of a material bed), e.g., the build area. The area of interest may be larger than the total available processing area, e.g., larger than the build area. The area of interest may be smaller than the total available processing area. The area of interest (e.g., intent) may comprise an overlap between two or more energy beams. The alignment marker arrangement may align a processing field of a guidance system (e.g., scanner) with a surface of a build region, e.g., an exposed surface of a material bed, and/or a platform. In some embodiments, an alignment marker arrangement comprises at least two alignment markers that are (e.g., fully) hardened. In some embodiments, an alignment marker arrangement comprises at least two alignment markers that are erasable. In some embodiments, at least two alignment markers of an alignment marker arrangement are different. For example, the alignment marker arrangement may comprise a fully hardened alignment marker and an erasable marker.

At times, it may be difficult for to generate an alignment marker (e.g., that is fully hardened) for performing a calibration operation in certain regions of a processing field (e.g., target field). For example, it may be difficult to generate an alignment marker in a region of the processing field that is outside of (e.g., beyond a perimeter of) a build region, e.g., FIG. 10, 1040 depicts an example of a build region which is an exposed surface of a material bed 1004. A region of a processing field that is outside of a build region may be termed herein an “excluded region.” FIG. 10, shows examples of excluded regions 1050 that are near the exposed surface 1040 of the material bed 1004. An excluded region may comprise a vicinity of a (e.g., perimeter of a) build region. In some embodiments, there is a size difference between the build region, a detection field of a detector (e.g., of a calibration system), and/or the processing field of the energy beam (e.g., as directed by its guidance system). The vicinity of the perimeter of the build region may comprise a region that is within at most about 20 mm, 15 mm, 10 mm, 5 mm, or 1 mm of the perimeter of the build region. The vicinity of the perimeter of the build region may be any value between the afore-mentioned values (e.g., from about 1 mm to about 20 mm, from about 1 mm to about 10 mm, or from about 10 mm to about 20 mm). In some embodiments, an excluded region comprises a portion of a target surface (e.g., processing field) that is not above a platform that supports a 3D object, e.g., during and/or after its formation. In some embodiments, an excluded region comprises insufficient (e.g., layer height, or volume of) material to generate a (e.g., fully) hardened alignment marker.

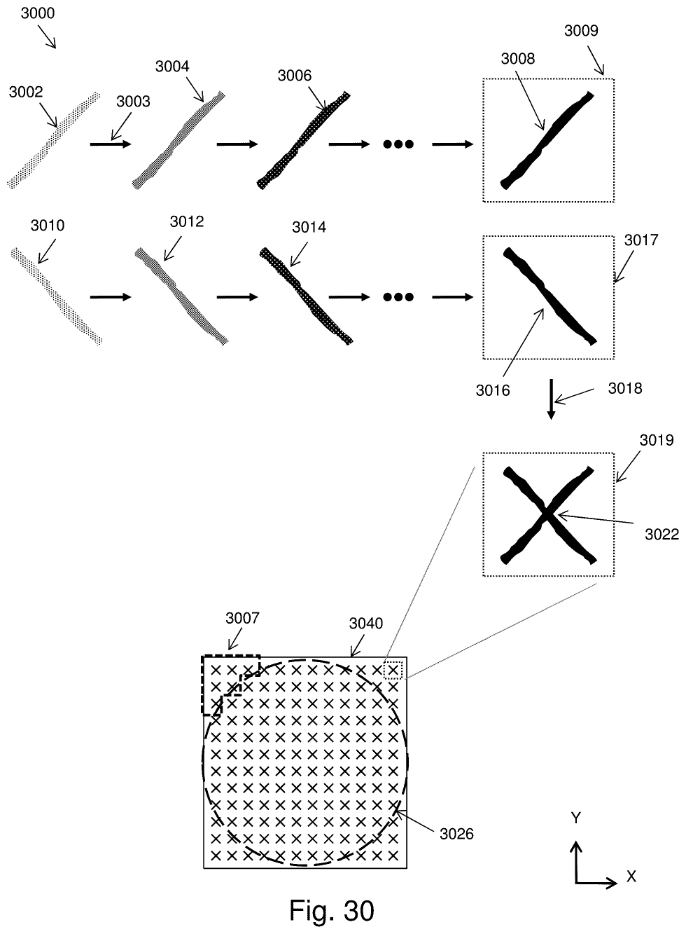

In some embodiments, an accuracy of a processing field calibration is improved by an alignment marker arrangement that covers (e.g., a full extent of) the area of the processing field. The (e.g., full extent of the) area of the processing field may comprise an excluded region. A transforming agent guidance system (e.g., scanner) may have a processing field (e.g., work field). The work field of the scanner may be an area encompassing the full extent of area to which the scanner can direct the energy beam onto a target surface. The processing field may include the (e.g., entire) work area of a scanner. The processing field may include at least a portion of the work area of the scanner. The processing filed may extend beyond the build area (e.g., exposed surface of a material bed) to an area that (i) is included in the work area of the scanner, and (ii) is beyond the build area. Improvement in the calibration may be with respect to a processing field calibration in which at least one region (e.g., an excluded region) of the processing field is devoid of generated alignment markers, e.g., an area beyond the build area, e.g., the excluded region. The improved accuracy of the processing field calibration may be to a certain portion of the processing field. An alignment marker arrangement that covers an excluded region may reduce (e.g., eliminate) a need for one or more calculations in the processing field calibration process. For example, eliminate a need for extrapolation of one or more calibration values for the excluded region. In some embodiments, an improved accuracy comprises improvement in a vicinity of a (e.g., perimeter of a) build region of a 3D printer. The improved accuracy may be an improvement for at least one axis, e.g., along an x axis and/or along a y axis. In some embodiments, one or more (e.g., erasable) alignment markers are generated in an excluded region of a 3D printer for performing a processing field calibration operation. For example, one or more alignment markers (e.g., that are erasable) may be generated in a processing field that comprises an area that is outside of a build region of the 3D printer. For example, one or more (e.g., erasable) alignment markers may be generated in a processing field that comprises a vicinity of a perimeter of a build region. The one or more (e.g., erasable) alignment markers generated in an excluded region may improve the accuracy of the processing field calibration, e.g., in a vicinity of the perimeter of the build region. For example, in some embodiments, the build region (e.g., surface), e.g., exposed surface of a material bed, is smaller and is encompassed in the working field of the guidance system. For example, in some embodiments, the build surface (e.g., exposed surface of a material bed) is round, and a working field of the scanner is rectangular and exceeds the circular build surface (e.g., FIG. 30). If the alignment markers would be formed only on the build surface, extrapolation may have been required to complete a calibration of the guidance system, which includes alignment of area(s) of the working field that are not encompassed by the build surface (e.g., excluded surface(s)). The one or more (e.g., erasable) alignment markers may be formed of pre-transformed material. The alignment marker(s) may be formed of planarized (e.g., pre-transformed) material. The planarized material may be (i) within a build region, and/or (ii) within an excluded region. The alignment marker(s) may be formed to be readily removed (e.g., erasable). The alignment marker(s) may be formed without incurring (e.g., detectable) damage to a 3D printer and/or printing process. For example, without damage to (i) a floor of a processing chamber, (ii) a layer forming device, and/or (iii) a material conveyance apparatus, e.g., of the 3D printer. The (e.g., erasable) alignment marker(s) may be formed outside (e.g., beyond a perimeter) of a build region, e.g., without damage to the 3D printer (e.g., floor of the processing chamber). For example, the alignment markers may not attach and/or anchor to the floor of the processing chamber, e.g., when they are formed above the floor of the processing chamber.

FIG. 30 shows an example 3000 of forming multiple (e.g., partial) alignment markers (e.g., that are erasable), to form an alignment marker arrangement. An alignment marker may be formed by a plurality of (e.g., energy beam) operations. In the example of FIG. 30, a first transforming agent (e.g., energy beam) operation forms a (e.g., first) partial alignment marker 3002. In the example of FIG. 30, a detectable property of the (e.g., first) partial alignment marker is increased by additional (e.g., repeated) operations (e.g., 3003). Each of the additional operations may increase a likelihood of detection of the detectable property (e.g., 3004 and 3006), until a threshold level of the detectable property is attained (e.g., 3008). Following formation of the first (e.g., set of) alignment marker, a (e.g., first) image may be captured, e.g., by a detection system. The first (e.g., set of) alignment marker(s) may be removed (e.g., disrupted and/or erased) following the image capture. In some embodiments, one or more (e.g., further) partial alignment markers (e.g., that are erasable) may be (e.g., subsequently) formed. In the example of FIG. 30 a (e.g., second) partial alignment marker (e.g., FIG. 30, 3016) is formed similarly, e.g., to the first alignment marker. In some embodiments, one or more (e.g., erasable) alignment markers may be formed in an excluded region (e.g., FIG. 30, 3007). In some embodiments, one or more (e.g., erasable) alignment markers may be formed in a vicinity of a perimeter of a build region (e.g., FIG. 30, 3026). A combination (e.g., FIG. 30, 3018) of partial alignment markers to (e.g., virtually) form a complete alignment marker may be based on corresponding regions of interest, e.g., in the respective images. The virtual complete alignment marker may be formed by superposition of images of the partial alignment markers. In the example of FIG. 30, a first region of interest 3009 and a second region of interest 3017 comprise their respective partial alignment markers (e.g., 3008 and 3016), which in region of interest 3019 in the combined image form the (e.g., complete) alignment marker 3022. The example of FIG. 30 depicts a (e.g., complete) alignment marker arrangement 3040 that is formed by a (e.g., image processing, e.g., superposition) combination of partial alignment marker arrangements. A region of interest may be pre-determined (e.g., based on a coarse correction). The images of the first and second alignment markers may be combined into one image using an image overlay. The image overlay may (i) assume that the detection system that captured the images did not move between image captures, (ii) take into account a movement of the detection system (e.g., by a known amount), and/or (iii) is aligned based on the structure and/or relative position of the captured images of the partial alignment markers.

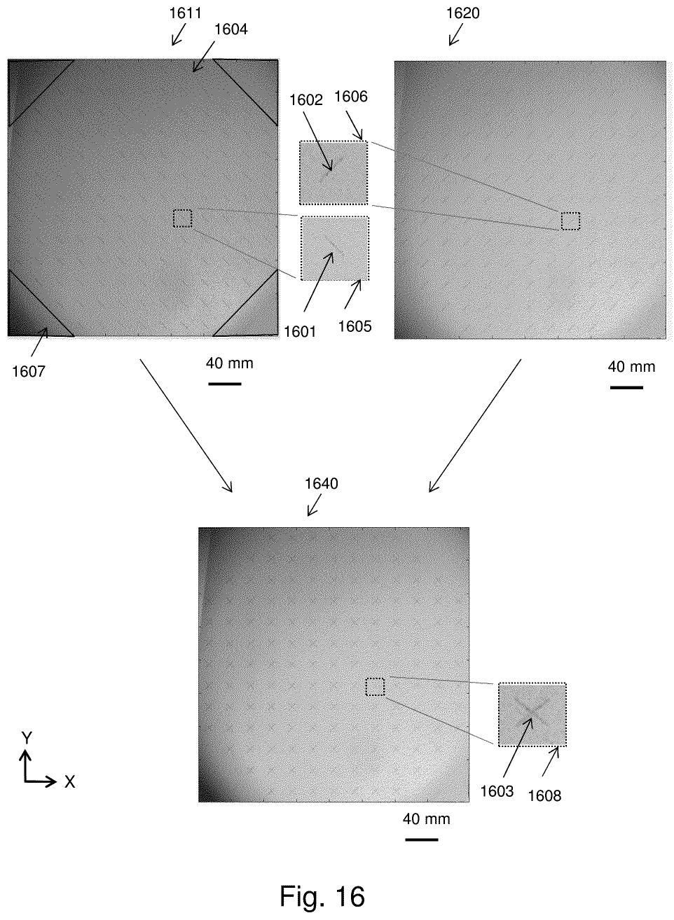

FIG. 16 shows an example of multiple partial alignment marker layers in an alignment marker arrangement. In the example of FIG. 16 a (e.g., first) layer 1611 includes an arrangement 1604 (e.g., grid) of partial alignment markers 1601. In the example of FIG. 16 a (e.g., second) layer 1620 includes an arrangement (e.g., grid) of partial alignment markers 1602. The example of FIG. 16 depicts the (e.g., complete) alignment marker arrangement 1640 formed by a (e.g., image processing, e.g., superposition) combination of the partial alignment marker arrangements. The example of FIG. 16 depicts the combined alignment marker 1603 as a combination of the partial markers 1601 and 1602. A combination of partial alignment markers to form a complete alignment marker may be based on corresponding regions of interest in the respective images. In the example of FIG. 16, a first region of interest 1605 and a second region of interest 1606 comprise their respective partial alignment markers (e.g., 1601 and 1602), which in region of interest 1608 in the combined image form the (e.g., complete) alignment marker 1603. A region of interest may be pre-determined (e.g., based on a coarse correction). The partial alignment marker images may be combined into one image using an image overlay. The image overlay may (i) assume that the detection system that captured the images did not move between image captures and/or (ii) take into account a movement of the detection system (e.g., by a known amount).

The detector system may include (e.g., be operatively coupled with) an illumination source. An illumination source may be used during an image capture to provide a (e.g., substantially) uniform illumination level across the detector field of view. In some embodiments the detector system is a calibrated detector system. A calibrated detector system may be a detector system (e.g., FIG. 13, 1310; FIG. 15, 1510) that has (i) negligible (e.g., below a threshold level of) distortion across its field of view (e.g., corresponding to the processing field of the energy beam) or a (ii) known distortion across its field of view that can be taken into account (e.g., and corrected).

At times, a sensor array (e.g., a camera, and/or an imaging calibration sensor) is calibrated for use in the energy beam position calibration. The sensor array may be a detecting unit (e.g., camera). The sensor array may be a pixel array. The camera may be used to measure one or more locations of a calibration target (e.g., FIG. 14B, 1420) as part of its own calibration process. The one or more locations of the calibration target can be correlated to transitions between the pixels (e.g., calibrating which pixels correspond to given regions in the detector field of view). Following calibration, the detection system may comprise a positional accuracy (e.g., at the target surface) of from about 2 microns to about 5 microns. The sensor array (e.g., camera) may be calibrated in terms of image distortion. The image distortion may comprise scaling, rotation, position, spherical distortion, or position offset (e.g., shift). The pixels may be (e.g., substantially) identical. The transition between pixels may be detectable (e.g., which pixel of a pixel array is detecting an alignment marker). A pixel transition detection may allow calibration of an alignment marker position for the energy beam calibration system. The detection unit (e.g., camera) may record the detected reflected signals (e.g., an image and/or video of the reflected signal may be recorded by the camera). The camera may comprise an imaging sensor, a row of the imaging sensor, a line of the imaging sensor, a pixel of the imaging sensor, or a set of pixels of the imaging sensor. Calibration of the detection system (e.g., camera) may be performed manually and/or automatically. Calibration of the detection system may be performed before, during, and/or following generation of a 3D object. Calibration of the detection system may be performed periodically (e.g., following several 3D printing cycles).

The detection system may be configured for characterizing the target surface. Characterizing may include measuring protrusions, indentations, (e.g., average) roughness, planarity, reflectivity, or smoothness of a surface (and/or a portion of pre-transformed and/or transformed material thereon). At times, a target surface comprises at least two materials (e.g., pre-transformed and transformed material) having (e.g., substantially) different optical qualities. Different optical qualities can include specularity, reflectivity, absorptivity, and/or scattering. Substantially different optical qualities of materials within a field of view of a detector can create sufficient contrast for the detector to be (e.g., readily) detectable. For example, a target surface may comprise a specularity that is based on a (e.g., average) roughness, material composition, material state (e.g., pre-transformed, molten, solidified). For example, a target surface in a material bed may comprise pre-transformed material and/or transformed (e.g., hardened) material. A pre-transformed material may exhibit detectably different (e.g., optical) characteristics from a transformed material, for example, based on specularity. For example, a surface uniformity across the exposed surface of the material bed (e.g., top of a powder bed) may be such that portions of the exposed surface that comprise the dispensed material, that are separated from one another by a distance of from about 1 mm to about 10 mm, have a height deviation from about 100 μm to about 5 μm. For example, a deviation from a planar uniformity of the layer of pre-transformed material (e.g., powder) in at least one plane (e.g., horizontal plane) may be at most about 20%, 10%, 5%, 2%, 1% or 0.5%, as compared to the average plane (e.g., horizontal plane) created at the exposed surface of the material bed (e.g., top of a powder bed). The height deviation can be measured by using one or more sensors (e.g., optical sensors).

In some embodiments, the pixels that detect the alignment marker arrangement are collectively analyzed, facilitating the positioning of the alignment markers in the processing field of the energy beam. For example, the actual (e.g., measured) location of the energy beam on the target surface may be determined by analyzing the pixels which detect the alignment marker(s). In an example, the measured location (e.g., of the alignment marker(s)) may be compared to the expected location of the alignment markers (e.g., based on a reference alignment marker arrangement). The measured location may deviate from the expected (e.g., requested) location. The deviation may be calculated. The calculation may be done by a controller and/or processor. The controller may be any controller described herein. Compensation for the positioning of the energy beam may be derived from the deviation of the measured location from the commanded location (e.g., at a given position within the processing field). Compensation may include aligning (e.g., bringing into coincidence) the location of the energy beam with the expected location at the target surface (e.g., based on generated and reference alignment markers, respectively). In some embodiments, the alignment is used to coincide a requested position of an energy beam at the target surface with an actual position of the energy beam at eth target surface.

At times, the energy beam position calibration includes image processing. Image processing may include comparing an image of the alignment marker arrangement against a reference, to determine any distortion in the energy beam (e.g., guidance system) positioning (e.g., across its processing field). The alignment marker arrangement may comprise alignment markers formed completely (e.g., in one step by the energy beam). The alignment marker arrangement may comprise combined (e.g., partial) alignment markers (e.g., FIG. 16, 1640). The image processing may include recognition of alignment marker locations. Recognition of alignment marker locations may be performed on a one-by-one basis (e.g., per-alignment marker). Recognition of alignment marker positions may be performed image-wide (e.g., all alignment markers at once). Recognition of alignment marker positions may be performed on subsets of the image (e.g., for groups of alignment markers).

In some embodiments, a 3D printing system includes an image processor operatively coupled with the detection system. The image processor may be operatively coupled or included in a controller. The controller and/or processor may be in coupled with (e.g., in communication with) a guidance system for directing an energy beam. An image processor may perform image processing to determine a deviation between a given (e.g., measured) alignment marker position and its corresponding (e.g., commanded) reference position (e.g., from the reference image and/or image data). The deviation may be determined based on a correlation (e.g., a normalized cross correlation) between the measured and the reference positions. A cross correlation may be to a reference shape (e.g., a generated “X” to a reference “X”). The deviation may be determined (i) using a transformation of the image data translating lines of the image, into points, and (ii) recognizing peaks (e.g., portions of overlap) (e.g., a Hough transformation, and/or Radon transformation). The deviation may be determined by (a) a transformation of the image into its constituent frequency components (e.g., Fourier Transform, Fast Fourier Transform, and/or Discrete Fourier Transform) and (b) comparing the alignment marker arrangement image with the reference image. The deviation may include blob detection and a combination to determine the alignment marker shape. The image processing may comprise finding a center of gravity (CoG) of a given alignment marker (e.g., considering the alignment marker as a single blob), and determining the (e.g., measured) position of the given alignment marker while considering the CoG. A CoG may include identifying a center (e.g., peak) pixel and including a number (e.g., 4) of pixels located in the vicinity of the peak pixel.

At times, the image processing (e.g., image recognition) includes one or more (e.g., initial) modification (e.g., filtering) operations. For example, an edge detection filter may be applied to the image data to determine the locations of the edges of the alignment markers. For example, a median filter may be applied to remove (e.g., outlier) data in the image. For example, the image may undergo a color palette transformation (e.g., conversion to black and white, or conversion to duotone such as grayscale).

The image modification may include smoothing (e.g., to reduce process variation). A process variation may include a non-uniformity in the (e.g., pre-transformed) material in the material bed. A process variation may include a non-uniformity in the generated (e.g., printed) alignment marker (e.g., variation in one or more dimensions of the printed alignment marker).

At times, the reference image is modified (e.g., smoothed), for example, to correlate a location more precisely. A modified reference image may include a simulated reference marker (e.g., having a same shape as the (partial) alignment marker). A modified reference image may include a simulated reference grid (e.g., having a same number of reference markers as in the generated alignment marker arrangement).

At times, decoupling a resolution with which the alignment markers are located from a (e.g., imaging) resolution of a detection system enables an improved calibration. At times, the resolution at which the alignment markers (and reference markers) are located may vary from the resolution of the detection system used to capture the image of the alignment marker arrangement. A varied resolution may be a lower resolution. A lower resolution may improve the calibration in terms of a period that is required to perform the calibration. A varied resolution may be a higher resolution. A higher resolution may improve the calibration in terms of a positional accuracy with which the alignment markers are located. A higher resolution may be attained by application of a sub-pixel location registration. A sub-pixel location registration may include a correlation of the image across the image field. For example, determining a location of (e.g., each of) the alignment markers in the image by calculating a peak correlation (e.g., with the reference markers) while considering a CoG of the alignment marker. The peak correlation may be determined to have a location that is between pixels (e.g., at a sub-pixel resolution). At times, a transformation of the image (e.g., using a Hough transform) may be used to find one or more characteristic features (e.g., line segments) in the image. The transformation may include locating one or more intersections of line segments. The transformation may include comparing those location to (e.g., corresponding) reference marker positions (e.g., in the reference image). A sub-pixel location registration may include oversampling of the (e.g., original) image. Oversampling may include adding pixel values to the detected pixel values. Added pixel values may be generated based on an interpolation. The interpolation may include evaluating a range of possible pixel values and locating which pixel represents the (e.g., best) correlation. For example, the interpolation may include a spline or a linear interpolation. For example, the interpolation may comprise a cubic interpolation (e.g., a bi-cubic interpolation). Based on the interpolation, the pixel providing the (e.g., best) correlation may be a generated (e.g., interpolated) pixel. The generated pixel may be a sub-pixel. In this manner oversampling of the image data may provide a correlation resolution that is greater than the pixel resolution of the detection system.

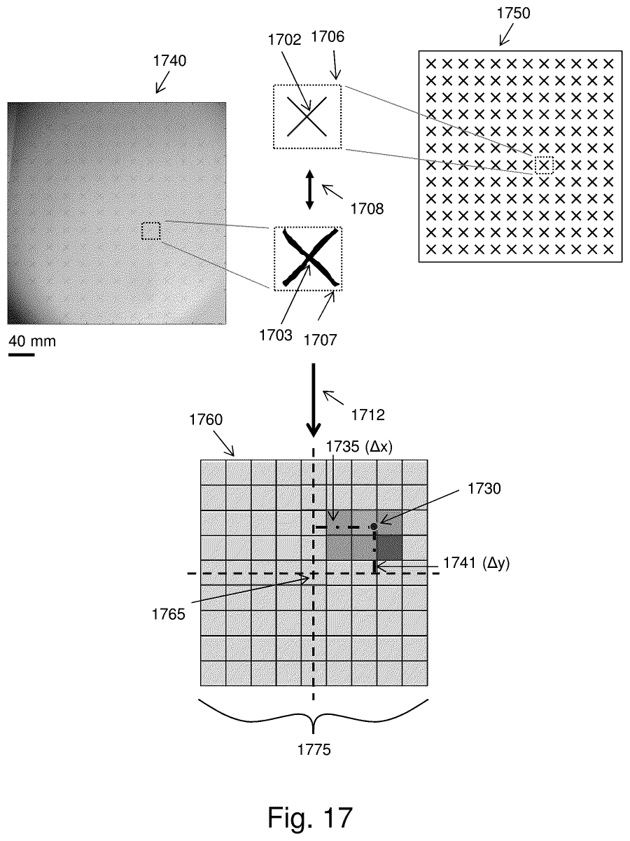

FIG. 17 depicts an example of the energy beam position calibration including image processing. In the example of FIG. 17 an (e.g., measured) alignment marker arrangement 1740 is compared with a reference image 1750. FIG. 17 depicts that a region of interest 1707 includes an alignment marker 1703, which is compared 1708 with a reference marker 1702 in a region of interest 1706 of the reference image. FIG. 17 depicts that a result 1712 of the region of interest comparison is given by array 1760. The comparison may result in locating a region (e.g., a pixel or a sub-pixel) of best correlation between the (e.g., generated) alignment marker and the reference marker. The region may correspond with a location on the target surface (e.g., a location in the processing field of the energy beam). In the example of FIG. 17, the array 1760 includes an array having a size 1775 (e.g., a 9-by-9 pixel array), which is centered around an expected (e.g., reference) position 1765. In the example of FIG. 17 the position of best correlation between the measured alignment marker position and the reference marker position is given by 1730 (including x-axis deviation 1735 and y-axis deviation 1741). As shown in the example of FIG. 17, the position 1730 (which is not centered on an integer pixel) is determined using sub-pixel registration (e.g., CoG) analysis, as depicted by shading of the pixels. In the example of FIG. 17, darker shading corresponds to a higher correlation of the alignment marker with the reference marker. In the example of FIG. 17, a peak correlation pixel is represented by the darkest pixel, with relatively lower correlation values represented by brighter (e.g., less dark) surrounding pixels. Correction (e.g. compensation) of the energy beam positioning at the given location of the alignment marker (e.g., in the processing field) may be determined, based on the measured position (e.g., FIG. 17, 1730). For example, the compensation may include correcting the positioning based on the values of the deviated location (e.g., the values of FIG. 17, 1735, 1741).

In some embodiments, the energy beam position calibration includes correction (e.g., compensation) data that corrects for any distortion in the (e.g., given) energy beam across its processing field (e.g., across a target surface). An energy beam position calibration may be performed for a plurality of (e.g., all) energy beams in a 3D printing system (e.g., an independent calibration for each energy beam of the plurality). The correction may consider a comparison (e.g., evaluation) of an actual (e.g., measured) distance between alignment markers (e.g., in an alignment marker arrangement) versus an expected distance between alignment markers (e.g., of the alignment marker arrangement). The correction may consider a comparison (e.g., evaluation) between an actual (e.g., measured) distance of alignment markers (e.g., in an alignment marker arrangement) and an expected position of the alignment markers. The correction may consider a comparison (e.g., evaluation) of an actual (e.g., measured) distance of alignment markers (e.g., in an alignment marker arrangement) from reference markers positions (e.g., in a reference image) versus an expected (e.g., commanded) distance of the alignment markers from the reference markers positions. The correction may consider a comparison (e.g., evaluation) of a (e.g., measured) shape of alignment markers (e.g., in an alignment marker arrangement) compared with a requested shape of reference markers (e.g., in a reference image).

In some embodiments, the energy beam position calibration includes comparison of an alignment marker arrangement (e.g., grid) to a reference marker arrangement (e.g., grid). The reference marker arrangement may be considered a “perfect ruler.” The reference marker arrangement may correspond to the positions in the energy beam processing field on which the alignment markers are commanded to be generated (e.g., with no detectable positioning error). The marker arrangement (e.g., alignment and/or reference) may divide the processing field into discrete portions. For example, for a processing field (e.g., completely) covering a square target surface (e.g., build plane) having 300 millimeter sides, a 10-by-10 marker arrangement divides the processing field into 30-by-30 millimeter (e.g., discrete) regions. Each region may have an associated alignment marker. Each region may have an associated correction (e.g., compensation) value. For example, a 10-by-10 marker arrangement grid may generate 100 correction data points (e.g., one data point per region) across the processing field. The marker arrangement may include known (e.g., evenly) spaced regions. The marker arrangement may include markers with varied spacing. The correction data points (e.g. compensation) may be provided to a guidance system (e.g., including and/or operatively coupled with a controller) of the energy beam. The compensation may be implemented at a hardware, firmware, and/or software level (e.g., of the controller). The compensation may be implemented as a lookup table. The compensation may be implemented in situ and/or in real time. Real time may comprise during operation of the 3D printer, or during operation of the energy beam energy beam (e.g., during a transformation operation).

In some embodiments, a guidance system (e.g., an optical system comprising a scanner) controls motion along independent axes. For example, control is independent for an x-axis and a y-axis. At times, (e.g., distortion) compensation data for (e.g., each) independent axes may be provided to the guidance system. For example, first compensation data may be generated to correct for energy beam positions in the x-axis (e.g., across the processing field), and second compensation data may be generated to correct for energy beam positions in the y-axis (e.g., across the processing field). The data values of the compensation may be in pixel values (e.g., units of pixels). The data values of the compensation may be in distance values (e.g., distance along the processing field). The data values of the compensation may be in angular values (e.g., rotation angle of a (e.g., scanning) mirror). The compensation data may include a combination of pixel, distance, and/or angular values.

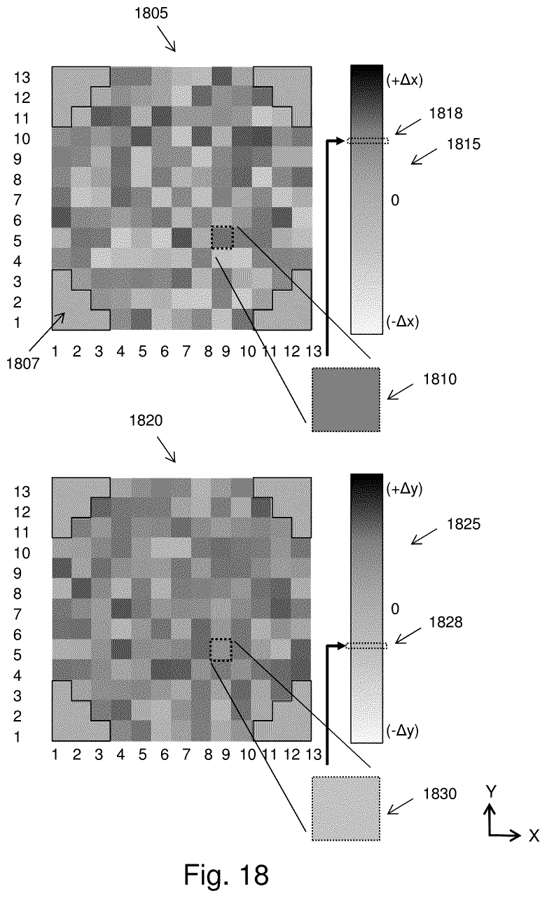

At times, each data point in the compensation data has an associated (e.g., pixel) shift value. FIG. 18 depicts examples of compensation data generated by an energy beam position calibration. The compensation data may comprise x-axis compensation 1805 or y-axis 1820. The compensation data can correspond to the processing field of the energy beam. The processing field of the energy beam may equal to, larger than, or smaller than a build area (e.g., target surface over the material bed) of the 3D printing system. In some embodiments, the processing field of the energy beam is the base of the processing cone. As shown in the example FIG. 18, each of the x-axis compensation and the y-axis compensation include a 13-by-13 grid (e.g., 169 data points each). In the example shown in FIG. 18, exclusion zones 1807 exist at each corner of the (e.g., x-axis and y-axis) grid. In some embodiments, an exclusion zone is a portion of the processing field in which a correction is given minimal weight, or in which the correction (e.g., position calibration) is not performed (e.g., which is excluded from a correction operation or which is given significantly reduced weight in the correction operation). Minimal weight and/or significantly reduced weight may correspond to insignificant, no-material, and/or non-detected variation by considering or omitting the data (e.g., of the exclusion zone). FIG. 18 depicts a compensation value for each compensation region according to a grayscale level, where a magnitude and direction are provided by a scale at the right (e.g., 1815 and 1825 for x-axis and y-axis, respectively). In the example of FIG. 18 the scales are centered about value 0 (e.g., no correction required), with positive correction values being represented by darker grayscale values and negative correction values being represented by lighter grayscale values.

FIG. 18 depicts an x-axis correction value for a data point 1810 of the compensation data that is located at a position 9 rows over from the left, and 5 columns up from the bottom, of the processing field. In the example of FIG. 18, the data point 1810 has an associated x-axis correction value 1818, the correction having a positive (e.g., x-axis) value. In the example of FIG. 18 a y-axis correction value is shown for a (e.g., corresponding) data point 1830 of the compensation data (e.g., a data point that is located at a position 9 rows over from the left, and 5 columns up from the bottom, of the processing field). In the example of FIG. 18, the data point 1830 has an associated y-axis correction value 1828, the correction having a negative (e.g., y-axis) value. Together, a correction of the given location in the processing field includes compensating a commanded position (e.g., by the guidance system) of the energy beam by a positive-x value, and by a negative-y value. As described herein, the magnitude and direction of the compensation at the given location can consider (e.g., be based on) the comparison performed between the alignment marker and the reference marker.

In some embodiments, the compensation data (e.g., of the guidance system) is generated on a per-alignment marker basis (e.g., one correction data (e.g., pair) per alignment marker). At times, the compensation data may be modified (e.g., to reduce occurrence of outlier data points). An outlier may be a data value that is significantly different than data values (e.g., of neighboring correction data points) in the compensation data. A modification of the compensation data may include application of a smoothing function to the data. A modification of the compensation data may include application of a filter (e.g., a median filter) to the data. In some embodiments, a plurality of energy beams is calibrated to correct for any errors in energy beam-to-energy beam positioning (e.g., energy beam overlay offset), with respect to a target surface. As described herein, regions of a target surface that include overlapping processing fields of (e.g., at least two) energy beams may be advantageous for generation of a 3D object. The usage of a plurality of energy beam may afford quicker printing and/or relatively larger 3D object may be produced (e.g., relative to an object produced by only one energy beam). By aligning the plurality of energy beams, the 3D object may be generated more accurately (e.g., devoid of a feature typical of a misalignment of at least two of the plurality of energy beams, e.g., a seam). In some embodiments, an energy beam positioning calibration includes generation of correction (e.g., compensation) data for one or more overlay offsets (e.g., overlapping regions) across the build plane. The overlay offsets may correspond to each of two or more energy beams (e.g., guidance systems thereof). As an example, an overlay offset may provide correction data for positions of the energy beam(s) within an overlapping region. The alignment marker arrangements (e.g., first and/or second) may divide the processing field into (discrete) portions. The overlay offset correction may be based on a comparison (e.g., evaluation) of a (e.g., measured) distance between a first alignment marker (e.g., in a first alignment marker arrangement) versus positions of a respective second alignment marker (e.g., in a second alignment marker arrangement). The correction may be based on a comparison (e.g., evaluation) of an actual (e.g., measured) shape of first alignment markers compared to an actual (e.g., measured) shape of second alignment markers. In some embodiments, a requested accuracy of a 3D object requires high fidelity calibration of the energy beam with respect to the target surface.

In some embodiments, overlay offset correction data for two or more (e.g., at least 2, 4, 8, 12, 16, or 20) energy beams is based on (e.g., respective) energy beam position calibrations (e.g., compensation for energy beam distortion at the target surface). For example, an energy beam position calibration (e.g., distortion compensation) may be performed for each of the plurality of (e.g., two) energy beams (e.g., the energy beams configured to irradiate within an overlapping region of the target surface). For example, respective alignment marker arrangements may be generated for each of the multiple energy beams and compared against reference marker arrangements in the manner described herein. In some embodiments, the overlay offset correction data is determined by comparing the respective distortion compensation data of (e.g., each of) the multiple energy beams with one another. For example, each compensation data point within the (e.g., matrix of) compensation data of a first energy beam (e.g., guidance system thereof) may be compared against a corresponding data point within the (e.g., matrix of) compensation data of a second energy beam (e.g., guidance system thereof). The comparison may generate a detected variation (e.g., difference). An overlay offset data point may be generated based on the detected variation. The generated overlay offset data point may be associated with a given location on the target surface, for example, within an overlapping region (e.g., of the processing fields of the energy beams). Comparisons may be made for at least one (e.g., for a selected set, or for each) data point in the respective distortion compensation data of the multiple energy beams (e.g., at each location in the processing field). Comparisons may be made for data point(s) in the respective distortion compensation data corresponding with the overlapping region(s) of the plurality of energy beams.

At times, overlay compensation data are generated based on a direct comparison between (e.g., respective) alignment markers (e.g., arrangements) of the plurality of energy beams. For example, an overlay offset calibration may include generation of alignment marker (e.g., arrangement) by a first energy beam, and an image capture by a detection system (e.g., such as described herein). The overlay offset calibration may include (e.g., a subsequent) generation of alignment marker (e.g., arrangement) by a second (e.g., overlapping) energy beam, and an image capture by the detection system. The image of the (e.g., first) alignment marker arrangement and the (e.g., second) alignment marker arrangement may be compared (e.g., via image processing, as described herein), as depicted in example operations shown in FIGS. 27A-27F.

At times, the detection system used to image the alignment marker (e.g., arrangement) for the overlay offset compensation is a calibrated detection system. At times, the detection system used to image the alignment marker (e.g., arrangement) for the overlay offset compensation is not a calibrated detection system. At times, a non-calibrated detection system may provide accurate energy beam positioning within the overlapping region. For example, an overlay offset calibration may include generation of alignment marker (e.g., arrangement) by a first energy beam, and an image generation by a non-calibrated detection system. The overlay offset calibration may include (e.g., a subsequent) generation of alignment marker (e.g., arrangement) by a second (e.g., overlapping) energy beam, and an image generation by the non-calibrated detector. The image of the (e.g., first) alignment marker arrangement and the (e.g., second) alignment marker arrangement may be compared (e.g., via image processing). Assuming the non-calibrated detection system did not move its position (e.g., experience a change in its field of view) between generation of the first and the second images, any distortion present in the field of view of the detection system will be canceled out during the comparison of the first and the second images. In some cases, the images may be compared to a detected calibration structure (using the detector) disposed at a position of the target surface.

At times, improved accuracy of the overlay offset calibration is attained by performing multiples overlay offset calibration operations (e.g., iteratively). For example, multiple measurements (e.g., cycles) may be performed (e.g., generating alignment markers, imaging, comparison using image processing, and/or generating compensation data). The compensation data may be averaged over the multiple calibrations, and this (e.g., averaged) compensation data may be provided to the (e.g., respective) guidance systems. In some embodiments, outliers in the measurement data are removed (e.g., to improve compensation quality). For example, outliers may be identified for removal using a (e.g., median) filter. For example, outliers may be removed by (e.g., adjusting) using a smoothing filter.

In some embodiments, the overlay offset correction data points (e.g. compensation) are provided to a guidance system (e.g., including in and/or operatively coupled with a controller) of the energy beam. The compensation may be implemented at a hardware, firmware, and/or software level (e.g., of the controller). The compensation may be implemented as a lookup table. The compensation may be implemented in situ and/or in real time (e.g., during operation of the energy beam). In some embodiments, a guidance system (e.g., a scanner) controls motion along independent axes. For example, the control is independent for an x-axis and a y-axis. At times, (e.g., overlay) compensation data for (e.g., each) independent axes may be provided to the guidance system. For example, a first compensation data may be generated to correct for multiple energy beam overlay offset positions (e.g., in an overlapping processing region) in the x-axis, and a second compensation data may be generated to correct for multiple energy beam offset positions (e.g., in the overlapping processing region) in the y-axis. The data values of the overlay offset compensation may be represented as (i) pixel values (e.g., units of pixels), (ii) distance values (e.g., distance along the processing field), (iii) angular values (e.g., rotation angle of a (e.g., scanning) mirror), or (iv) any combination thereof.

At times, a guidance system (e.g., scanner) for an energy beam requires correction data (e.g., distortion and/or overlay offset data) over a full range (e.g., full matrix) of possible positions toward which the guidance system may guide the energy beam (e.g., the entirety of the processing field). The full range of possible positions may correspond to a rectangular (e.g., square) matrix. In some embodiments, there are size differences between the target surface, the detection field of the detector, and/or the processing field of the energy beam (e.g., as directed by its guidance system). For example, a respective area of extent may differ between the target surface, the detection field, and/or the processing field of an energy beam. At times, an energy beam position calibration may be performed over a processing field that may be larger than the detection field and/or target surface. For example, an alignment marker arrangement may be generated over a target surface that is smaller than the entirety of the energy beam processing field. In such a situation, regions on which no alignment markers are generated outside of a target surface (e.g., excluded regions) may lack compensation data points. In some embodiments, a guidance system (e.g., a controller thereof) requires a full matrix of correction data, and additional data (e.g., padding data) may be required to fill in the portions of the data correction matrix that lack compensation data. The portions of the data correction matrix provided to the guidance system may correspond to excluded regions, e.g., excluded corners from the alignment marker arrangement. For example, the alignment marker arrangement may comprise a grid, for example, a ‘N’×‘M’ grid of generated alignments markers. N may be the same number as M (e.g., a square grid). N may be a different number than M. The grid may exclude corners of the processing chamber (e.g., regions of the target surface outside of the material bed) (e.g., FIG. 16, 1607). The grid may be non-rectangular (e.g., elliptical). A non-rectangular alignment marker arrangement may correspond to a non-rectangular processing area (e.g., material bed). Excluded portions may be due to a non-rectangular build region, e.g., a circular build region. The portions of the data correction matrix provided to the guidance system may correspond to an alignment marker arrangement calibrating a subset of the processing area. The padding data may be based on an extrapolation of the correction data generated by the energy beam position calibration process. For example, the padding data may be a linear extrapolation of one or more neighbors of the padded data point. For example, the padding data may be based on linearizing from a (e.g., best) point along a given row and/or column of the compensation data grid.

In some embodiments, padding data are generated considering an estimation from a measured position(s) (e.g., compensation data point) of one or more generated alignment markers. The estimation may comprise an interpolation or an extrapolation. An extrapolation may comprise a linear extrapolation, tensor (e.g., single-variable) cubic extrapolation, or binomial cubic extrapolation. Estimated (e.g., extrapolated) calibration values for one or more locations (e.g., in an excluded region) may be used in a calibration of a guidance system. For example, estimated calibration values may be used to calibrate a full extent of the processing field of the guidance system. In some embodiments, estimated calibration values may improve an accuracy of the guidance system calibration, e.g., at or near a perimeter of the build region. The (e.g., extrapolated) calibration values may consider (e.g., generated) calibration markers formed near (e.g., within) a build area boundary (e.g., edge of a platform). For example, calibration values may be generated by extrapolation from value(s) of one or more neighboring alignment markers. In some embodiments, an estimated (e.g., extrapolated) calibration value considers (e.g., positions of) a plurality of compensation data points. In some embodiments, at least two data points of the plurality of compensation data points comprise (i) a (e.g., measured) alignment marker, (ii) an estimated calibration value, or (iii) a combination of the above.

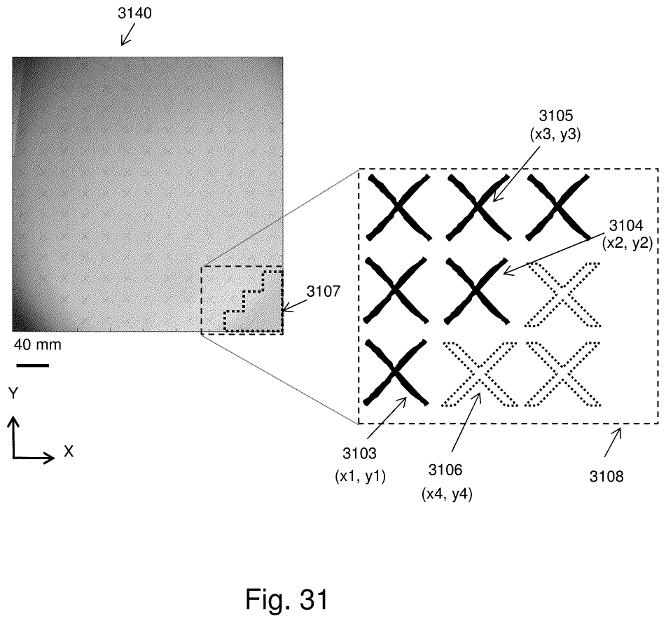

FIG. 31 depicts an example of a processing field calibration that includes estimated (e.g., extrapolated) calibration values. In the example of FIG. 31, an alignment marker arrangement 3140 is generated, e.g., on a build region. In some embodiments, an alignment marker arrangement is devoid of (e.g., generated) alignment markers for one or more regions of a processing field. In the example of FIG. 31, the alignment marker arrangement is devoid of generated alignment markers in an excluded region, 3107. In some embodiments, a processing field calibration estimates one or more calibration values, e.g., for an excluded region. The estimation may comprise extrapolation. The extrapolation may comprise uniaxial or bi-axial extrapolation. For example, the extrapolation may comprise extrapolation from x-axis value(s), y-axis value(s), or a combination of x-axis and y-axis values. The extrapolation may be one dimensional (e.g., X axis or Y axis extrapolation) or two dimensional. The two dimensional (2D) extrapolation may comprise the one dimensional (1D) extrapolation. For example, the two dimensional extrapolation may comprise one dimensional X axis extrapolation and one dimensional Y axis extrapolation (e.g., that are superimposed). The two dimensional extrapolation may be a direct two dimensional extrapolation (e.g., devoid of one dimensional extrapolation). The extrapolation may comprise a shape, area, or position extrapolation. For example, the extrapolation may comprise a positional extrapolation. In the example of FIG. 31, a region 3108 of a processing field (e.g., calibration) comprises measured calibration values (e.g., from alignment markers) and estimated (e.g., extrapolated) values. The extrapolation may comprise consideration of at least two (e.g., neighboring) values, e.g., measured values of generated alignment markers. FIG. 31 depicts an extrapolated calibration value 3106, having (e.g., extrapolated) position (x4, y4). In the example of FIG. 31, the x-axis value (e.g., “x4”) of 3106 is extrapolated from the x-axis position of the neighboring measured (e.g., alignment marker, 3103) position, (x1, y1). In the example of FIG. 31, the y-axis value (e.g., “y4”) of 3106 is extrapolated from the y-axis positions of two neighboring measured (e.g., alignment markers, 3104 and 3105) positions, e.g., (x2, y2) and (x3, y3). In some embodiments, an estimated (e.g., extrapolated) calibration value comprises an average of at least two estimations. In some embodiments, the average calibration value comprises at least two estimations from a same axis (e.g., x-axis). In some embodiments, the average calibration value comprises at least two estimations considering different axes.

In some embodiments, the image processing generates correlation data between at least one (e.g., each) alignment marker (e.g., in the alignment marker) arrangement and its corresponding reference marker in the reference image. At times, the correlation data may have associated quality metric data (e.g., a correlation quality measure for each of the at least one alignment marker). The quality metric data may be used as a threshold to determine whether the correction data of a corresponding correlation should be used. For example, a maximum value of the correlation between the generated alignment marker and the reference marker may be determined. For example, a summation value of the correlation between the generated alignment marker and the reference marker may be determined. The (e.g., maximum and/or summation) value may be compared to a threshold value to determine the quality of the correlation. The value may be a numerical value or a value function. The threshold value may be based on a normalized correlation value (e.g., where a perfect correlation is equal to 1, and no correlation is equal to 0). For example, a threshold value may be a correlation value of at least about 0.5, 0.6, 0.7, 0.8, or above.

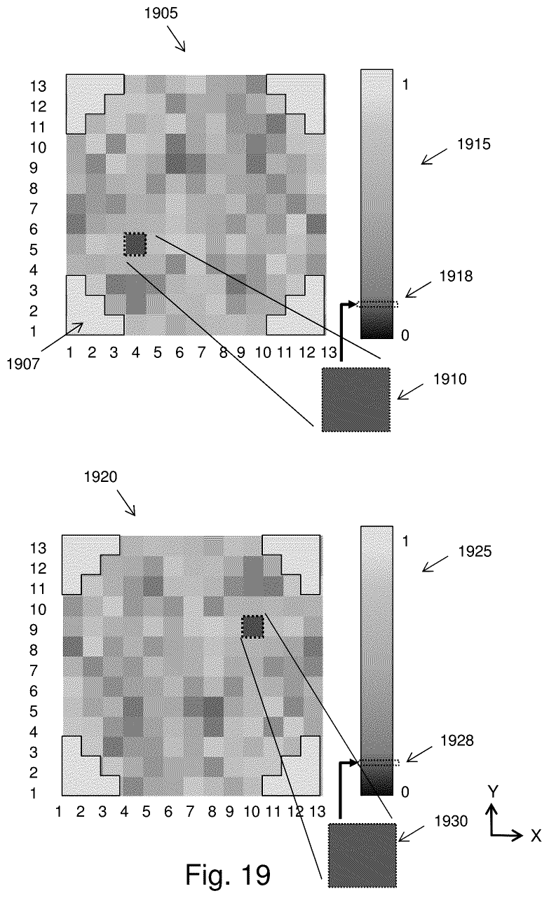

FIG. 19 depicts an example of quality metric data 1905 corresponding to an energy beam position calibration. In the example of FIG. 19, discrete compensation regions of the energy beam processing field are depicted by the shaded squares. In the example shown in FIG. 19, the processing region compensation includes a 13-by-13 grid of compensation (e.g., quality metric) values, with exclusion zones 1907 depicted at each corner of the grid. An exclusion zone may be a portion of the processing field in which a correction (e.g., position calibration) is not performed. The example shown in FIG. 19 depicts a quality of each compensation region according to a grayscale level, as provided by a scale 1915 at the right. In this example, the scale 1915 represents a quality of the correction based on a normalized correlation, with maximum quality being represented by a value of 1 and minimal quality being represented by a value of 0. Quality metric data may be used to determine whether a correction data at a location (e.g., of the processing field) is trustworthy, or whether it is no-trustworthy, may be ignored, and/or may be altered (and in what way). This determination may be based on a threshold value (e.g., level) of the quality metric data. In the example of FIG. 19, a low-quality region 1910 for x-axis correction is located at row 5, column 4. In the example, the low-quality region 1910 is determined considering a low quality value 1918 (e.g., near zero correlation). For example, a low-quality region may be determined based on a threshold level of a quality value. In the example of FIG. 19, a low-quality region 1930 for y-axis correction is located at row 9, column 10. In the example, the low-quality region 1930 is determined considering a low quality value 1928.

In some embodiments, the alignment marker arrangement is generated before, after, and/or during at least a portion of the 3D printing (e.g., when the irradiating energy is not used to form the 3D object). The guidance system may be controlled before, after, and/or during at least a portion of the 3D printing (e.g., when the irradiating energy is not used to form the 3D object). The control may be manual and/or automatic (e.g., using a controller). The calibration system may comprise a detector, sensor, or a processor (e.g., an image processor). The calibration system may comprise a detector. The detector may comprise an optical or an on-optical detector. The detector may comprise a single pixel detector. The detector may comprise one or more detection units. The detection units may be arranged in a pre-determined arrangement (e.g., a grid). For example, the calibration system may comprise a camera (e.g., capturing stills or video), or a non-imaging sensor (e.g., performing a point measurement, e.g., a silicon detector, or a spectrometer). In some embodiments, the resolution of the calibration is not limited by the resolution of the detector. In some embodiments, the resolution of the calibration is determined by the steps of the irradiating energy (e.g., pulse frequency steps, tiling steps, or other translational steps).

At times, calibration is performed before, during, and/or after at least a portion of the 3D printing. For example, calibration may be performed after at least one (e.g., after every) 3D printing cycle. The calibration may be performed before, during, and/or after performing an engagement of the build module with the processing chamber.

At times, a layer dispenser includes a non-contact planarizer. At times, a layer dispenser may include a planarizer that is configured to contact the target surface (e.g., exposed surface of the material bed). The layer dispenser may be configured to dispense a (e.g., pre-transformed) material at a variable height (e.g., sufficient to cover the alignment marker arrangement). The layer dispenser may dispense pre-transformed material at a given planarity.

At times, generation of a first alignment marker arrangement on a first layer is followed by generation of a second alignment marker arrangement on a subsequent layer. In some embodiments, a guidance system causes an energy beam to generate a subsequent alignment marker arrangement at the same XYZ position in the 3D printing system as a prior (e.g., first) alignment marker arrangement, but at a different layer. The subsequent layer may have one or more intervening layers between it and the first layer. The subsequent layer may be adjacent to the first layer. At times, a layer dispenser is configured to deposit sufficient pre-transformed material such that the (e.g., first) alignment marker arrangement is covered by the deposited material layer (e.g., a first layer of partial markers is covered). At times, a layer dispenser is configured to deposit material such that the (e.g., first) alignment marker arrangement is at least partially (e.g., fully) covered by the deposited material layer. In some embodiments a covered alignment marker arrangement does not interfere with generation and detection of a subsequent (e.g., second) alignment marker arrangement on a subsequent layer. Alignment markers that are partially covered may be at least partially dislodged during a leveling process of the (e.g., newly deposited) material in the material bed, e.g., when the planarizer contacts the exposed surface during planarization. At least partially dislodged (e.g., partial) alignment markers may be moved a sufficient distance away from an initial position (e.g., in the alignment marker arrangement) that the dislodged (e.g., first) partial markers do not interfere with partial markers of a subsequent (e.g., second) partial alignment marker arrangement. A sufficient distance may depend upon a scale (e.g., size) of the partial markers, and a spacing between partial markers in the alignment arrangement.

In some embodiments, alignment markers are formed on a target surface that includes a platform. At times, the target surface is other than an exposed surface of a material bed. For example, an alignment marker arrangement may be formed on a platform. The markers may be full alignment marker (e.g., formed in one irradiation operation), or a partial alignment marker. The alignment marker on the build plate may be detected (e.g., imaged), and a calibration based on a comparison of the alignment marker arrangement with the reference image may be performed.

In some embodiments, the energy beam(s) emitted by the energy source(s) is modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator (e.g., external to the 3D printer), and/or a modulator integrated in the 3D printer. The modulator can comprise an acousto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

In some embodiments, energy (e.g., heat) is transferred from the material bed to a cooling member (e.g., heat sink FIG. 1, 113). The cooling member may be in the enclosure, at an enclosure wall, or external to the enclosure. The cooling member may be coupled with at least one mechanism of the 3D printer. The cooling member can facilitate transfer of energy away from a least a portion of a pre-transformed material layer (e.g., before, during and/or after the at least a portion of the printing). In some cases, the cooling member can be a thermally conductive plate. The cooling member can be passive. Examples of cooling members and/or cooling mechanisms are disclosed in Patent Application Serial No. PCT/US15/36802 that is incorporated herein in its entirety.

In another aspect, the 3D printer comprises a detection system. In some embodiments, the detection system detects one or more characteristics and/or features of the irradiating energy (e.g., detecting its footprint at the target surface). In some embodiments, the detection system detects one or more characteristics and/or features caused by the irradiating energy (e.g., on the target surface). In some embodiments, the detection system detects one or more characteristics and/or features of an electromagnetic radiation. In some embodiments, the detection system detects one or more characteristics and/or features of a black body radiation. FIG. 11 shows an example of a (e.g., optical) detection system (e.g., FIG. 11, 1100) as part of a 3D printer. The detection system may be operatively coupled to at least one component of the processing chamber. The at least one component of the processing chamber may comprise the irradiating energy, the controller, the target surface, or the platform. The detection system may be operatively coupled to the build module. The detection system may be a part of or separate from the optical system. The detection system may be operatively coupled to an energy source (e.g., FIG. 11, 1102). The energy source may be any energy source disclosed herein (e.g., tiling energy source and/or scanning energy source). The energy source may irradiate with transforming energy (e.g., beam or flux). The irradiated transforming energy may heat (e.g., and transform) a material at the target surface, and subsequently emit an electromagnetic radiation of a different wavelength (e.g., a thermal radiation, e.g., a black body radiation) and/or be reflected (e.g., away from the material). The different wavelength may be a larger wavelength as compared to the wavelength of the irradiating energy by the energy source. For example, a laser may emit laser energy towards the target surface at a position, which irradiation will cause the irradiated position to heat (e.g., and melt). The laser irradiation may be reflected from the target surface (e.g., exposed surface of a material bed). The heating of the position at the target surface may cause emittance of heat radiation. The heat radiation may have a larger wavelength as compared to the laser irradiation wavelength. At times, the irradiating energy may illuminate the enclosure environment. At times, the target surface may be illuminated by the irradiating energy (e.g., direct or reflected) or the produced black body radiation. At times, the enclosure environment may include a separate illumination source (e.g., a light-emitting diode (LED)). The back reflected irradiating energy, and/or the electromagnetic radiation of a different wavelength may be referred to herein as “the returned energy beams.” The returned energy beams may be detected via one or more detectors. The detection may be performed in real-time (e.g., during at least a portion of the 3D printing). For example, the real-time detection may be during the transformation of the pre-transformed material (e.g., using the energy beam). The irradiating energy may be focused on a position at the target surface. The returned energy beams may be focused on their respective detectors. In some embodiments, the irradiating energy is focused on a position at the target surface as at least a portion of the returned energy beams are focused on at least one of their respective detectors. The returned energy beam can provide energy at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm 3000 nm, or 3500 nm. The returned energy beam can provide energy at a peak wavelength of at most about 3500 nm, 3000 nm, 2900 nm, 2800 nm, 2700 nm, 2600 nm, 2500 nm, 2400 nm, 2300 nm, 2200 nm, 2100 nm, 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, 400 nm, or 100 nm. The returned energy beam can provide energy at a peak wavelength between any of the afore-mentioned peak wavelength values (e.g., from about 100 nm to about 3500 nm, from about 1000 nm to about 1500 nm, from about 1700 nm to about 2600 nm, or from about 1000 nm to about 1100 nm). In some embodiments, the detection system may comprise aberration—correcting optics (e.g., spherical aberration correcting optics, chromatic aberration correcting optics, achromatic optics, apochromatic optics, superachromatic optics, f-theta achromatic optics, or any combinations thereof). In some embodiments, the aberration-correcting optics is devoid of an f-theta lens. In some embodiments, the aberration corrective optics is devoid of f-theta achromatic optics. The detector of the returned energy beam may detect the energy at the above mentioned peak wavelengths. The peak wavelength may be a wavelength at full width at half maximal of the energy profile of the returned energy beam.

In some embodiments, a detector is arranged to follow the processing location of the directed energy beam to the target material. For example, the detector (e.g., a field of view thereof) may move along with a point at which the energy beam is incident upon the target material. The processing location may comprise (i) a footprint of the energy beam on a target surface, (ii) a transformed portion that comprises the target surface, or (iii) a heated portion that comprises the target surface. In an embodiment, an optical system includes a detector (e.g., FIG. 11, 1120) operable to detect one or more characteristics of the target surface (e.g., comprising a material). For example, the detector may be operable to detect one or more characteristics of the target surface (or a portion thereof). The detector can be operated continuously or controlled to operate at a selected time (e.g., selected time intervals). The detector may operate before, during, and/or after processing of the target material (at the target surface). The detector can be formed with at least one radiation-sensitive detector. The detector can be adapted to detect a selected wavelength (e.g., wavelength span) of radiation. The radiation may be an electromagnetic radiation. The wavelength of the electromagnetic radiation may comprise a wavelength in the ultraviolet band, visible band, or infrared (IR) band. According to some embodiments, different radiation detectors detect different wavelengths, respectively. For example, a near-IR wavelength for a first radiation detector, and an IR wavelength for a second radiation detector.

FIG. 11 shows an example of a (e.g., optical) detection system 1100 that may be operatively coupled to a platform. The platform may be a part of a (e.g., 3D) printing system. In the example of FIG. 11 an energy source 1102 provides an energy beam to a collimator 1105, and the collimated energy beam 1172 is incident on a beam splitter 1170. In the example of FIG. 11, the energy beam passes through optical elements 1165 (e.g., a diverging lens, capable of translating 1166) and 1145 (e.g., a converging lens) to a scanner 1110 (e.g., any scanner described herein). In some embodiments, one or more optical elements (e.g., lenses, FIG. 11, 1185) may be placed preceding the one or more detectors, and along the path of the returning energy beam. Optionally, there may be one or more filter elements (e.g., 1196) placed before each of the optical element. The optical element may maintain the focus of the detector energy beam on each detector (e.g., simultaneously with maintaining the focus of the transforming energy beam on the target surface). An arrangement of the one or more lenses may comprise a variable optical axis focusing arrangement. While not depicted in the example of FIG. 11, it should be appreciated that more than one or more optical elements can be present between the optical element (e.g., 1165) and the scanner (e.g., 1110) (e.g., a second converging lens). The scanner (e.g., 1110) can be operable to direct an energy beam onto a material, for example, via optical paths (e.g., 1171 and 1175) toward target positions (e.g., 1181 and 1184, respectively) of a target surface (e.g., 1116). Irradiation of the target surface can generate characteristic radiation (e.g., electromagnetic radiation) at or near the targeted position of the target material. Near the targeted position may be at most 2, 3, 4, 5, 6, 7, or 10 FLS of the energy beam (e.g., cross sectional diameter of the energy beam, or diameters of the footprint of the energy beam on the target surface).

Detector may be any detector disclosed in patent application number PCT/US15/65297, titled “FEEDBACK CONTROL SYSTEMS FOR THREE-DIMENSIONAL PRINTING” that was filed on Dec. 11, 2015, which is incorporated herein by reference in its entirety. The detectors can comprise one or more sensors. The one or more detectors (e.g., sensors) can be configured to measure one or more properties of the 3D object and/or the pre-transformed material (e.g., powder). The detector can collect one or more signals from the 3D object and/or the target surface (e.g., by using the returning energy beams). In some cases, the detectors can collect signals from one or more optical sensors (e.g., as disclosed herein), e.g., respectively. The detectors can collect signals from one or more vision sensors (e.g. camera), thermal sensors, acoustic sensors, vibration sensors, spectroscopic sensor, radar sensors, and/or motion sensors. The detectors may comprise an InGaAs and/or Gallium sensor. The optical sensor may include an analogue device (e.g., CCD). The optical sensor may include a p-doped metal-oxide-semiconductor (MOS) capacitor, charge-coupled device (CCD), active-pixel sensor (APS), micro/nano-electro-mechanical-system (MEMS/NEMS) based sensor, or any combination thereof. The APS may be a complementary MOS (CMOS) sensor. The MEMS/NEMS sensor may include a MEMS/NEMS inertial sensor. The MEMS/NEMS sensor may be based on silicon, polymer, metal, ceramics, or any combination thereof. The detector (e.g., optical detector) may be coupled to an optical fiber.

In some embodiments, the detector includes a temperature sensor. The temperature sensor may sense the temperature directly or indirectly (e.g., though signal interpretation, analysis, and/or manipulation). The temperature sensor (e.g., thermal sensor) may sense an IR radiation (e.g., photons). The thermal sensor may sense a temperature of at least one melt pool. The metrology sensor may comprise a sensor that measures the FLS (e.g., depth) of at least one melt pool. The transforming energy beam and the detector energy beam (e.g., thermal sensor beam and/or metrology sensor energy beam) may be focused on substantially the same position. The transforming energy beam and the detector energy beam (e.g., thermal sensor beam and/or metrology sensor energy beam) may be confocal.

In some embodiments, the detector includes an imaging sensor. The imaging sensor can image a surface of the target surface comprising untransformed (e.g., pre-transformed) material and at least a portion of the 3D object. The imaging sensor may be coupled to an optical fiber. The imaging sensor can image (e.g. using the returning energy beam) a portion of the target surface comprising transforming material (e.g., one or more melt pools and/or its vicinity). The optical filter or CCD can allow transmission of background lighting at a predetermined wavelength or within a range of wavelengths.

In some embodiments, the detector includes a reflectivity sensor. The reflectivity sensor may include an imaging component. The reflectivity sensor can image the material surface at variable heights and/or angles relative to the (target) surface. In some cases, reflectivity measurements can be processed to distinguish between the exposed surface of the material bed and a surface of the 3D object. For example, the untransformed (e.g., pre-transformed) material in the target surface can be a diffuse reflector and the 3D object (or a melt pool, a melt pool keyhole) can be a specular reflector. Images from the detectors can be processed to determine topography, roughness, and/or reflectivity of the surface comprising the untransformed (e.g., pre-transformed) material and the 3D object. The detector may be used to perform thermal analysis of a melt pool and/or its vicinity (e.g., detecting keyhole, balling and/or spatter formation). The surface can be sensed (e.g., measured) with dark-field and/or bright field illumination and a map and/or image of the illumination can be generated from signals detected during the dark-field and/or bright field illumination. The maps from the dark-field and/or bright field illumination can be compared to characterize the target surface (e.g., of the material bed and/or of the 3D object). For example, surface roughness can be determined from a comparison of dark-field and/or bright field detection measurements. In some cases, analyzing the signals can include polarization analysis of reflected or scattered light signals.

In some cases, one or more of the detectors are movable. For example, the one or more detectors can be movable along a plane that is parallel to the target surface (e.g., to the exposed surface of the material bed. The one or more detectors can be movable horizontally, vertically, and/or in an angle (e.g., planar or compound). The one or more detectors can be movable along a plane that is parallel to a surface of the target surface. The one or more detectors can be movable along an axis this is orthogonal to the target surface and/or a surface of the material bed. The one or more detectors can be translated, rotated, and/or tilted at an angle (e.g., planar or compound) before, after, and/or during at least a portion of the 3D printing.

The one or more detectors can be disposed within the enclosure, outside the enclosure, within the structure of the enclosure (e.g., within a wall of the enclosure), or any combination thereof. The one or more detectors can be oriented in a location such that the detector can receive one or more signals in the field of view of the detector. A viewing angle and/or field of view of at least one of the one or more detectors can be maneuverable via a scanner. In some cases, the viewing angle and/or field of view can be maneuverable relative to an energy beam that is employed to additively generate the 3D object. In some cases, the variable focus mechanism may synchronize the movement of the transforming energy beam to be within the range of the detectors that may be detecting the detecting energy beam. In some cases, movement (e.g., scanning) of the energy beam and maneuvering of the viewing angle and/or field of view of one or more detectors can be synchronized.

In some embodiments, a controller receives signals from the detector. The controller may comprise a processor (e.g., a computer). The controller may be a part of a high-speed computing environment. The computing environment may be any computing environment described herein. The computing environment may comprise any computer and/or processor described herein. The controller may control (e.g., alter, adjust) the parameters of the components of the 3D printer (e.g., before, after, and/or during at least a portion of the 3D printing). The control (e.g., open loop control) may comprise a calculation. The control may comprise using an algorithm (e.g., operation sequence, and/or equation). The control may comprise feedback loop control. In some examples, the control may comprise (i) open loop (e.g., empirical calculations), or (ii) closed loop (e.g., feed forward and/or feedback loop) control. In some examples, the feedback loop(s) control comprises one or more comparisons with an input parameter and/or threshold value (e.g., function, or setpoint). The setpoint may comprise calculated (e.g., predicted) setpoint value. The setpoint may comprise adjustment according to the closed loop and/or feedback control. The controller may use metrological and/or temperature measurements of at least one position of the target surface (e.g., melt pool). The controller may use power and/or energy beam intensity measurements. The controller may use porosity and/or roughness measurements (e.g., of a portion of the 3D object). The controller may direct adjustment of one or more systems and/or apparatuses in the 3D printing system. For example, the controller may direct adjustment of the force exerted by the material removal mechanism (e.g., force of vacuum suction). For example, the controller may direct adjustment of a spot size and/or focus of a detected energy beam by adjusting the optical elements. At least one element of the detector system may be controlled manually and/or automatically (e.g., using a controller). The control may be before, after, and/or during the operation of the energy beam. Controlling can be before, during, or after at least a portion of the printing. At times, measurements from a first detector (e.g., the system of FIG. 11, 1120) can be correlated with measurements of a second detector (not shown) to determine at least one characteristic of, for example, the (i) a target material surface, (ii) a processing beam (e.g., an energy beam), (iii) a processing area (e.g., a position where the irradiating energy beam is incident on a surface), (iv) a calibration structure, and/or (v) a portion of a forming 3D object.

In some embodiments, a beam collimator collimates (e.g., narrow, parallelize, and/or align along a specific direction) the irradiating energy (e.g., the energy beam or the energy flux). The collimator may be an optical collimator (e.g., may comprise a curved lens or mirror and a light source). The collimator may include a fiducial marker (e.g., an image) to focus on. The fiducial marker may assist in collimating the energy beam to a specific focus. The collimator may include one or more filters (e.g., wavelength filters, gamma ray filters, neutron filters, X-ray filters, and/or electromagnetic radiation filters). The collimator may comprise parallel hole collimator, pinhole collimator, diverging collimator, converging collimator, fanbeam collimator, or slanthole collimator.

At times, the optical path(s) diverge or converge the irradiating energy. The divergence or convergence of the irradiating energy may comprise a lens. The lens may be a converging lens or a diverging lens. At least one lens may be movable (e.g., laterally) relative to the target surface. The optical path may be controlled manually and/or by a controller. The control may be real-time control during at least a portion of the 3D printing. The at least the portion of the 3D printing may comprise a time in which the energy beam is irradiating or a time at which the energy beam is not irradiating (e.g., to process the target surface). The controller may control the positions of the optical elements to adjust the optical path. The controller may control the positions of the optical elements to adjust the intensity and/or focus of the beam on the target surface and/or on the detector(s). The one or more optical elements may be translatable. The one or more optical elements may be stationary. The optical element may be a negative optical element (e.g., a concave lens or a diverging lens). The optical element may be a positive optical element (e.g., a convex lens or a converging lens). The optical element may be a beam splitter (e.g., 1170). The optical elements in the optical path may be arranged achromatically (e.g., to allow simultaneous focus on at least one detector and on a position on the target surface). The achromatic optics may keep the optical detectors and/or an imaging device (e.g., a fiber optics coupled to a single detector) in focus. Optionally, a portion of the collimated energy beam may be deflected or reflected from a target surface (not shown). The deflected and/or reflected energy beam may be optionally filtered by a filter. The deflected and/or reflected energy beam may be directed to a detector. The detector may be an optical detector. The detector may comprise a spectrometer. The detector can be an imaging detector. The detector may be an intensity reflection detector. The detector may contribute to analyzing (e.g., visual, and/or reflective analysis) of an irradiated position at the target surface (e.g., a melt pool).

In some embodiments, an energy flux focus change calibration provides a measurement of any change from an expected (e.g., setpoint, commanded) value of an energy flux focus to an actual (e.g., measured) value of the energy flux focus. The energy flux focus change calibration may be an energy beam focus calibration. The energy beam may be directed by a guidance system (e.g., a scanner). An energy beam may be directed by one or more optical elements in an optical system that is operationally coupled with the guidance system. The guidance system may include the one or more optical elements. The optical system may include a variable focusing mechanism (e.g., a variable optical axis) for altering a focus (e.g., along an optical z-axis) of the energy beam (e.g., at the target surface). The energy beam focus may be measured as a footprint (e.g., at a target surface). The energy beam focus may be measured as a beam waist (e.g., region of an energy beam that has a minimal cross-sectional area).

Without wishing to be bound by theory, a focus change for the one or more optical elements may cause a focus change in a given direction. A focus change in a given direction may correspond to a focus change that tends to converge the energy beam to a certain extent (e.g., as a positive lens). A focus change in a given (e.g., opposite) direction may correspond to a focus change that tends to diverge the energy beam to a certain extent (e.g., as a negative lens). The focus change (e.g., convergence or divergence) may correspond to a given direction along a focus optical axis (e.g., along an optical z axis). As used herein, “positive lensing” may refer to a focus change corresponding to an increased focus with respect to a focus setpoint. As used herein, “negative lensing” may refer to a focus change corresponding to a decreased focus with respect to a focus setpoint.

In some embodiments, a focus change calibration provides a resolution for detecting a focus change. Focus change calibration may refer to the degree of change applied to the optical system that affords a resulting focal length, wherein the optical system is at stable and/or optical environmental conditions. The change in the optical system may be carried out by altering a position and/or an optical response of one or more element of the optical system in a controlled manner. The focus change may have a focal variability of at most about 50 μm, 25 μm, 15 μm, 10 μm, 5 μm, 3 μm, or 2 μm. The focus change may have a focal variability between any of the afore-mentioned values (e.g., from about 50 μm to about 2 μm, or from about 15 μm to about 2 μm (e.g., referring to a focus of the energy beam footprint on a target surface). In some embodiments a focus change calibration provides a measurement detecting a direction of focus change (e.g., in an optical z-axis, in a vertical axis, and/or in an axis perpendicular to the target surface). In some embodiments a target surface (e.g., an exposed surface of a material bed and/or calibration structure) may be used in the focus change calibration of one or more characteristics of the energy beam. The calibration can comprise calibration of (i) the energy beam footprint on the target surface, (ii) the Z offset of the energy beam focus with respect to the target surface (e.g., Z position of maximal focus), (iii) the focus of the energy beam at the target surface, and/or (iv) a numerical aperture (e.g., curve of spot sizes as a function of focus). The calibration of the footprint may comprise calibration of the footprint characteristics comprising area, FLS, or shape. Any (e.g., each) of the footprint characteristics may vary over time (e.g., due to a thermal lensing focus change) for the optical system of the 3D printing system.

At times, an optical arrangement focus corresponding to a given focal setting drifts over time. A focus drift may be a change in a focus (e.g., z-focus, energy beam footprint) away from a setpoint focus. A focus drift may cause a reduction in the quality of a generated 3D object formed, or a failure to form the 3D object. At times, a (e.g., benchmark) focus calibration curve is generated for the focus change calibration. A focus calibration curve may include a relationship between a (characteristic) detector signal and a focal length (e.g., z-axis focus), which detected signal is of an energy beam irradiation on a target surface. A focus calibration curve may provide a baseline operation characterization of one or more (e.g., all) optical elements in an optical system (of a 3D printing system). The baseline characterization can represent the performance of the optical element(s) at one or more nominal focus conditions (e.g., a condition devoid of deleterious effects such as, for example, thermal lensing). The benchmark calibration curve can be used in a process of monitoring a focus change state (e.g., a condition thereof, for example, a magnitude) of the optical element(s). A focus change state may be determined via the measured detector signal relationship to the one or more irradiating energy beam characteristics (e.g., energy beam footprint, variable optical axis focus). The focus change calibration may be performed on a target surface (e.g., a heat sink, a calibration target, exposed surface of a material bed, an edge target). The focus change state (e.g., via focus change calibration) may be detected during, before, and/or after a 3D printing process. For example, the focus change calibration may be performed in real time. For example, a focus change calibration may be performed periodically during formation of a 3D object. Periodically may be every ‘p’ layers of a 3D object that is formed in a layerwise manner. Values of layers ‘p’ for which a focus change calibration is performed may be p at least 1, 2, 5, 10, 20, 100, 300, 500, 1000, or 5000. Values of ‘p’ may be any value between the afore-mentioned values (e.g., from about 1 to about 5000, from about 1000 to about 5000, or from about 1 to about 1000). In some embodiments, a focus change calibration is performed between formation of a first 3D printing cycle and a second 3D printing cycle (e.g., between build cycles). A 3D printing cycle may comprise forming one or more 3D objects above a platform (e.g., and/or in a material bed). A period to perform a focus change calibration and/or measurement may be of sufficiently short duration so as not to have a significant reduction in a throughput capability of the 3D printing system. A short duration may be from about 45 seconds to about 300 seconds. A significant reduction in throughput capability may be with respect to a volume of 3D printed objects generated by the 3D printing system at a given period (e.g., 24 hours).A focus change calibration and/or measurement may be performed after every given number of layers (e.g., every 30, 50, 80, or 100 layers) of generation of one or more 3D objects by the 3D printing system. A focus change calibration and/or measurement may be performed in situ. A focus change calibration and/or measurement may be performed on one or more calibration structures surrounding a build area and/or on a build area (e.g., a material bed). In some embodiments, monitoring is performed for any patterns or trends in focus drift. The monitoring may consider the focus change calibration (e.g., every p^{th} layer). A detected trend and/or pattern may be indicative of a particular portion (e.g., one or more optical elements, an energy source) of the system that is causing a change. A detected trend or pattern may be used to direct performance of a maintenance, corrective, or replacement procedure on the identified portion of the system that is causing the focus drift.

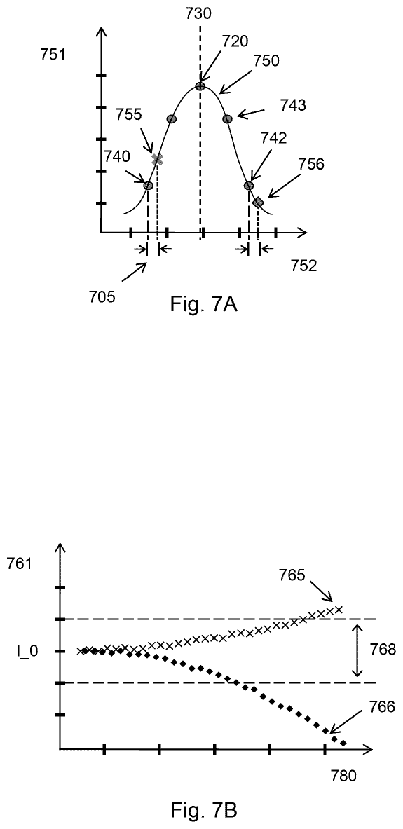

In some embodiments, a (e.g., benchmark) characterization of the at least one component of the optical setup and the detector in a nominal focusing condition (e.g., a non-thermal lensing condition) comprises irradiating a position on a target surface (e.g., on a target structure) at several known (e.g., commanded) focal positions (e.g., various footprints and/or variable foci). The irradiation of the energy beam may be a steady pulse (e.g., a tile). A steady pulse may comprise a stationary or a substantially stationary irradiation. A substantially stationary irradiation may comprise a movement about a point such as a back and forth pendulum movement and/or circular movement. The length of the movement may be at most equal to a fundamental length scale (e.g., diameter) of the footprint of the energy beam on the target surface and/or of a cross section of the energy beam. The irradiation of the energy beam may be during its movement over the target surface (e.g., a hatch). The (e.g., benchmark) characterization may include measuring a signal (e.g., intensity thereof) by the detector at the known focal position(s). The measured signal may be a voltage and/or a detected intensity (e.g., of received radiation). The measured signal may be analyzed (e.g., a normalized standard deviation of the detector signal, an optical transfer function and/or a modulation transfer function). A characteristic relationship between the detector signal (e.g., intensity and/or voltage) and the focus setpoint for the at least one component of the optical setup at the focus setpoint may be generated. Data regarding the relationship of the detector signal to the focus setpoint for the several known focal positions may be characterized by data fitting (e.g., fitting the data to a Gaussian curve). The (e.g., fitted) data may be represented in a graph form, for example, a benchmark focus curve (e.g., FIG. 7A, 750). In some embodiments, a plurality of characteristic measurements (e.g., benchmark measurements) are performed, and average data values are determined for the (e.g., each) focus setpoints.

In some embodiments a benchmark focus curve comprises a (e.g., substantially) symmetrical shape (e.g., a Gaussian, e.g., a bell-shaped curve) having a line of symmetry (e.g., intersecting a peak of the curve). For example, a maximal focus may correspond to a line of symmetry for the benchmark focus curve (e.g., FIG. 7A (720)). The energy beam may defocus by a movement (e.g., along an optical axis, variable optical axis focus) in a (e.g., either) direction away from the line of symmetry (e.g., mirror symmetry line). A given detector signal may be produced by (e.g., two) differing focus positions (e.g., FIG. 7A, 740, 742). The differing focus positions may be along opposite directions in the optical axis (e.g., optical z axis). The two differing focus positions may (e.g., be selected to) have a similar magnitude of change from the focus position for maximal focus.

In some embodiments, a target surface includes a calibration structure. The calibration structure may be any structure described in patent application number PCT/US18/12250, titled “OPTICS IN THREE-DIMENSIONAL PRINTING” that was filed Jan. 3, 2018, which is incorporated herein by reference in its entirety. In some embodiments, a target surface may include a structure (e.g., an edge target). An energy beam may be directed to translate across the edge target (e.g., a “knife edge”), and a detector may detect one or more detector signals during the translation. The detector signals may be represented as a curve (e.g., depicting a relation between signal over time). The detected signal curve may reveal the transition point between a first region of the edge target and a second region of the edge target. For example, a derivative of the detected signal curve may facilitate finding the transition position between a first region and a second region (e.g., a transition over an edge). One or more characterizations of the modified detected signal (e.g., the derivative of the detected signal curve) can be made. For example, a full width at half maximum (FWHM) measurement can be indicative of a transition point between a first region and a second region of an edge target.

At times, calibrating the optical property comprises measuring (e.g., at least one) detected signal at varying irradiating energy beam values. For example, measuring a detected signal as a magnification, focus, and/or spot size of the irradiating energy beam (e.g., controllably and/or dynamically) varies. The spot size may be the size of the footprint of the energy beam on a target surface. One or more graphical representations of the varying irradiating energy beam value measurements may be generated. One or more graphical representations of the detected signal as a function of the varying irradiating energy beam value may comprise a curve representing (e.g., a maximum value of) a derivative of the detected signal. In some embodiments, a characteristic of the (e.g., derivative) curve (e.g., a maximum value thereof) may facilitate determination of one or more conditions of the varying irradiating energy beam (e.g., a magnification, focus, and/or spot size thereof).

In some embodiments, a target surface comprises a material (e.g., powder) bed. The material bed may comprise particulate material of one or more sizes. As an example, to calibrate a focus shift of the irradiating energy, the irradiating energy may be directed on one or more positions on the target surface. The energy irradiated onto the target surface (e.g., exposed surface of the material bed) may be dispersed. The target surface may exert a reflected signal. The reflected signal may include diffused signals (e.g., due to the particulate material). The reflected signal may be specular. The reflected signal may have a percentage of specular reflection. For example, the reflected signal may comprise a white noise signal and/or a specular reflectivity signal. Some of the dispersed energy may be detected by a detector (e.g., that is located at a known position). The known position may comprise a fixed position. The known position may alter in time. In some embodiments the larger the footprint of the irradiating energy, the smaller the changes that are detected as the energy beam scans the target surface. In some embodiments the smaller the footprint of the irradiating energy, the larger the changes that are detected as the energy beam scans the target surface. Without wishing to be bound to theory, the smaller the diameter of the irradiated beam projection (e.g., footprint), the higher a rate of variability in its detected intensity (e.g., amplitude of change) from the target surface may be (e.g., keeping the velocity of the scanning irradiating energy constant). The amplitude of the standard deviation of the change of intensity may be calculated. For example, for “I” being the detector signal, the normalized standard deviation (e.g., normalized change in detected intensity) may be calculated (e.g., by Std(I)/mean(I)). The normalized standard deviation may be calibrated for a roughness of the target surface. The roughness may be a mean, or average roughness. The roughness may be a typical and/or characteristic roughness. The normalized standard deviation may be calibrated for a certain particular material that constitutes the material bed (e.g., the target surface being an exposed surface thereof). The detection may allow derivation of the footprint size and/or shape (e.g., astigmatism), the focus of the footprint, and/or the measure of the power density distribution of the irradiating energy. A selected focus shift may be determined from the one or more measured focus shifts at different focal offsets. The selected focus shift may be the region (e.g., spot) that has the highest intensity in the reflected signal. At times a characteristic (e.g., standard deviation) of a detector signal corresponds with a surface characteristic (e.g., material size, surface roughness) of the target surface. In some embodiments, as the energy beam is translated across a target surface of a given roughness (e.g., material feature size), an increase in energy beam focus generates a corresponding increase in a variation of a detector signal. The variation in the detector signal may be analyzed as a standard deviation.

At times, a focus change occurs due to accumulation of energy (e.g., due to heating) one or more optical elements of an optical system. The accumulation of energy may result in energy absorbance by the one or more optical elements. The energy may absorb directly by the one or more optical elements. The energy may be absorbed indirectly by an agent disposed adjacent to the one or more optical elements and being emitted from the agent to the one or more optical elements. The agent may be a coating of the optical element, or debris accumulated adjacent to (e.g., on) the optical element. The debris may comprise dust, soot, pre-transformed material, or transformed material (e.g., that become gas borne). The accumulation of energy by the one or more optical elements may be transferred to the optical element(s) via debris (e.g., contaminants) disposed on a surface of the optical element(s). The accumulation of energy by the one or more optical elements may cause a change in an effective focal length (e.g., thermal lensing) of the one or more optical elements. The thermal lensing may cause a change in an optical property of the optical element, for example, in an index of refraction of the optical element.

In some embodiments, prolonged unadjusted (e.g., un-serviced) operation of a 3D printing system is sustained via prevention of or compensation for thermal lensing. In some embodiments, prolonged unadjusted operation comprises a throughput of the energy beam to form at least 1000 cubic centimeters (cm\hat{ }3) of transformed material. Unadjusted may comprise without requirement for maintenance, calibration, or service. In some embodiments, prolonged operation comprises a throughput of the energy beam of at least about 50 cubic centimeters (cm\hat{ }3) to at most 1000 cm\hat{ }3 of transformed material. In some embodiments, prolonged operation comprises a throughput of the energy beam of at least 2000 cm\hat{ }3 of transformed material. In some embodiments, the energy source is operable to controllably generate the energy beam having an average power density of from about 10000 Watts per square millimeter (W/mm\hat{ }2) (e.g., to about 100000 W/mm\hat{ }2) at the target surface. In some embodiments, prolonged operation comprises directing an energy beam that comprises energy of at least about 3 kilowatt hours (kWh). In some embodiments, prolonged operation comprises directing the energy beam having an energy of at least about 0.5 kWh and at most about 3 kWh. In some embodiments, prolonged operation comprises a throughput of the energy beam comprising energy of at least about 50 kWh. In some embodiments, the one or more optical elements comprises a lens, mirror, or a beam splitter.

At times, one or more optical elements in an optical system of the 3D printing system comprise (e.g., are formed of) a composition and/or material such that it may be characterized as having a (e.g., relatively) high thermal conductivity, a (e.g., relatively) low optical absorption coefficient, and/or a (e.g., relatively) low temperature coefficient of the refractive index (dn/dT). An optical element such as this may exhibit a reduced thermal lensing effect (e.g., over the time required for 3D printing). An optical element having high thermal conductivity may include a thermal conductivity of at least about 20 Watts per meters times degrees Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. An optical element having a low optical absorption coefficient can be at most about 10 ppm, 50 ppm, 100 ppm, or 250 ppm per centimeter at the wavelength of the irradiating energy beam. A low temperature coefficient of refractive index can refer to an optical element that has a refractive index deviation (e.g., at the wavelength of the irradiating energy beam) of at most about 2%, 5%, 8%, 10%, 12% or 15%, in a temperature range at least about 10° C. to at most about 140° C. A low temperature coefficient of refractive index can be a relative change in refractive index, for example at a temperature change from 20° C. to 40° C. at the irradiating wavelength (e.g., 1060 nm), from about 1.5*10⁻⁶/Kelvin (K) to about 2.2*10⁻⁶/K, from about 2* 10⁻⁶/K to about 3*10⁻⁶/K, or from about 3*10⁻⁶/K to about 4.5*10⁻⁶/K. The low temperature coefficient of refractive index may be measured at ambient pressure (e.g., of one (1) atmosphere). Materials that may exhibit a reduced thermal lensing effect include calcium fluoride (CaF₂), magnesium fluoride (MgF₂), crystal quartz, sapphire, zinc selenide (ZnSe), zinc sulfide (ZnS), potassium fluoride (KF), barium fluoride (BaF₂), gallium arsenide (GaAs), germanium, lithium fluoride (LiF), magnesium fluoride (MgF₂), potassium bromide (KBr), potassium chloride (KCl), and/or crystalline silicon. The optical element having the reduced thermal lensing effect can be an optical window, a mirror, a lens, a filter and/or a beam splitter. The optical element (having the reduced thermal effect) can comprise any of the materials exhibiting the reduced thermal lensing effect.

At times, a focus change measurement includes measuring a detector signal (e.g., of a detector operatively coupled with the energy beam) during an irradiation of a target surface by the energy beam. The irradiation of the target surface may be at a given (e.g., setpoint) energy beam focus (e.g., footprint at the target surface and/or variable optical axis-focus). The (e.g. measured) detector signal may be compared with an expected (e.g., nominal, benchmark) detector signal for irradiation of the target surface at the given energy beam focus. Any deviation between the expected (e.g., benchmark) detector signal and the actual (e.g., measured) detector signal for the irradiation at the given energy beam focus may be measured. Based on the measured deviation, any change in the energy beam focus from the expected (e.g., commanded) value to an actual (e.g., measured, changed) value may be calculated. A determined change in focus may include a determined direction (e.g., positive lensing or negative lensing) and/or a magnitude (e.g., microns of change). At times, the irradiation of the target surface may (e.g., closely) follow a period of (e.g., extended) irradiation (e.g., a burn-in irradiation). A burn-in irradiation may serve to heat one or more optical elements directing the energy beam (e.g., generate a thermal lensing condition). The generated thermal lensing condition may be controlled. For example, the amount of energy transmitted through the optical system (e.g., per given time) may be controlled. The simulation of thermal lensing condition may comprise irradiating a sacrificial structure and/or area.

At times, a focus change is induced in the optical system, such that a focus of the one or more optical elements (e.g., of an optical system) changes along one direction of an optical axis (e.g., optical z axis). The focus change may be a change in an effective focal length of the optical element (or optical system). In some embodiments, the irradiation of the target surface may include (e.g., at least) two irradiations. The at least two irradiations may be of differing focus setpoints (of the optical system). Differing focus setpoints may include focus setpoints that are on opposing sides from a reference focus (e.g., a maximum focus, FIG. 7A, 720 along the symmetry line 730). The focus setpoints may be symmetric about the reference focus (e.g., FIG. 7A, 740, 742). The focus setpoints may be asymmetric about the reference focus (e.g., FIG. 7A, 740, 743). The differing focus setpoints may have a similar characteristic detector signal at a benchmark irradiation (e.g., a similar detector signal magnitude and/or intensity). A focus change in the one or more optical elements may cause a corresponding change along an optical axis direction to the differing focus setpoints. A corresponding change for a first focus setpoint may be an altered (e.g., increased) detector signal of a given (e.g., first) magnitude. A focus change in the one or more optical elements may cause a corresponding change for a second focus setpoint that results in an altered (e.g., reduced) detector of a given (e.g., second) magnitude. In some embodiments, the first and the second setpoints are selected such that for a given focus change in an optical axis (e.g., optical z axis) direction, a detector signal corresponding to one (e.g., the first) focus setpoint may increase (e.g., FIG. 7A, 755), while a detector signal corresponding to another (e.g., the second) focus setpoint may decrease (e.g., FIG. 7A, 756). A magnitude of change (e.g., footprint and/or optical axis) from the first and the second focus setpoints (e.g., FIG. 7A, 705) may be similar. A magnitude of change (e.g., footprint and/or optical axis) for the first and the second focus setpoints may be different.

FIG. 7A depicts an example of a focus change calibration and measurement. In the example of FIG. 7A a relationship between a detector signal 751 and an energy beam focus 752 is depicted by (e.g., benchmark) curve 750. The energy beam focus may be a spot size of the energy beam at a target surface (e.g., a footprint). The energy beam focus may be a position of a variable focus element of an optical system (e.g., z position of a variable optical axis focus). The detector signal may be a signal intensity or voltage, or value derived from a detector signal intensity or voltage. For example, a value derived from a detector signal may be a standard deviation of a detector signal during an energy beam irradiation (e.g., translation across a material bed). For example, a value derived from a detector signal may be a (e.g., maximum) derivative of detector signal during an energy beam irradiation (e.g., translation across an edge target). At times, a characteristic shape of a relationship between the detector signal and the energy beam focus is a bell-shaped curve (e.g., a Gaussian), having a peak 720 (e.g., maximum focus). The shape of the calibration curve may be formed by several energy beam irradiations on a target surface at varying focus setpoints (e.g., along 752).

At times, a focus change measurement includes comparing an expected (e.g., benchmark) detector signal for an energy beam irradiation at a given setpoint with an actual (e.g., measured) detector signal. A focus change measurement may include (e.g., at least two) energy beam irradiations (e.g., at differing focus setpoints). In the example of FIG. 7A, a focus change measurement includes a (e.g., first) energy beam irradiation at a (e.g., first) focus setpoint 740 having a measured (e.g., increased) detector signal corresponding to an energy beam focus at 755. In the example of FIG. 7A, a focus change measurement includes an (e.g., second) energy beam irradiation at a (e.g., second) focus setpoint 742 having a measured (e.g., decreased) detector signal corresponding to an energy beam focus at 756. The measured detector signal(s) may be compared to the expected detector signal(s) to determine a focus change (e.g., FIG. 7A, 705). An increased detector signal may correspond to a more focused energy beam (e.g., positive lensing). A decreased detector signal may correspond to a more de-focused energy beam (e.g., negative lensing).

In some embodiments, a sequence of focus change measurements is made (e.g., to determine a thermal lensing condition). FIG. 7B depicts an example of a relationship between a change in detector signal 761 and a sequence 780 of focus change measurements for a given focus setpoint(s). A change in detector signal 761 may be a change from an expected detector signal to a measured detector signal at a given focus setpoint (e.g., FIG. 7A, 740 to 755). In the example of FIG. 7B, two sequences of focus change measurements are depicted for two focus setpoints, corresponding to a first curve 765 (x marks) and a second curve 766 (diamond marks). In the example of FIG. 7B, at an initial focus change measurement for the first and the second focus setpoints has a similar detector signal, exhibiting little (e.g., no) change in the measured detector signal from the expected detector signal for the first and second focus setpoints. As a sequence of irradiations (e.g., burn-in irradiations) continues, a focus change may be induced (e.g., thermal lensing condition may occur). In the example of FIG. 7B, the sequence of irradiations for the first and the second focus setpoints exhibits increasing changes in the detector signal 761. As shown in FIG. 7B, the first focus setpoint exhibits a positive (e.g., increasing) detector signal change, of increasing magnitude with the sequence progression (e.g., along 780). As shown in FIG. 7B, the second focus setpoint exhibits a negative (e.g., decreasing) detector signal change, of increasing (e.g., negative) magnitude with the sequence progression (e.g., along 780). As related to FIG. 7A, the first focus setpoint may correspond to 740, and the altered focus measured (e.g., by one irradiation of the sequence of irradiations thereof) by the focus change measurement may correspond to 755. FIG. 7A, 755 depicts a focus change from a focus setpoint having increased focus (e.g., movement toward maximal focus 720), as determined from a corresponding increased detector signal 751. As related to FIG. 7A, the second focus setpoint may correspond to 742, and the altered focus measured (e.g., by one irradiation of the sequence of irradiations thereof) by the focus change measurement may correspond to 756 (e.g. with respect to the benchmark focus setpoint signal). FIG. 7A, 756 depicts a focus change from a focus setpoint having decreased focus (e.g., movement away from maximal focus 720), as determined from a corresponding decreased detector signal 751 (e.g. with respect to the benchmark focus setpoint signal).

At times, an amplitude and/or sign of a difference in detector signal for the focus setpoints altered by the focus change is determined. For example, a voltage difference between the detector signals of differing focus setpoints may be determined (e.g., ΔV=M2−M1). For example, a difference in the (e.g., measured) detector voltage of FIG. 7A, 755 (e.g., M2) and the (e.g., expected) detector voltage of FIG. 7A, 740 (e.g., M1). In some embodiments, the difference may be normalized (e.g., ΔV=(M2−M1)/(M1+M2)). In some embodiments, for a focus change curve calibrated for change in energy beam footprint size, a conversion to a change in optical axis shift (e.g., optical z axis shift) may be made. For example, for a given change in detector voltage, an optical (e.g., z) axis change may be ΔS=k*ΔV/(Z2−Z1), where k is a calibration factor (e.g., k=(m\hat{ }2)/V).

In some embodiments, a focus change measurement for which no (e.g., detectable) focus change has occurred results in a low amplitude detector signal change. At times, a focus change measurement for which a positive lensing (e.g., converging) focus change has occurred results in a (e.g., high) amplitude detector signal change, having a positive sign. At times, a focus change measurement for which a negative lensing (e.g., diverging) focus change has occurred results in a (e.g., high) amplitude detector signal change, having a negative sign.

In some embodiments, a sensitivity of focus change detection varies according to one or more measurement conditions (e.g., focus setpoint of the irradiating energy beam). For example, a focus change sensitivity can be (e.g., relatively) high when performing focus change measurements corresponding to a portion (or portions) of the benchmark focus curve that are near a “shoulder” of the curve. A shoulder may correspond to a region of the curve having an inflection point (for example, a point at 1/e\hat{ }2*peak value). An inflection point on the benchmark focus curve can correspond to (i) a relatively large change in a detected signal intensity for (ii) a relatively small change in irradiating energy spot size on the benchmark calibration structure. At times calibration measurements are taken at conditions corresponding to at least 2, 3, or 5 regions of the benchmark calibration curve.

At times, a focus change measurement comprises a sequence of irradiations (e.g., burn-in irradiations, heating) through the optical system (e.g., to induce energy accumulation in the optical system). The sequence of irradiations may follow focus setpoint irradiations on a target surface. At times, a focus change measurement comprises a sequence of power irradiations (e.g., burn-in irradiations, heating) with following focus setpoint irradiations on a target surface. The power irradiations may be of a high-power density and/or over a prolonged time sufficient to induce a requested change in the optical system (e.g., a change in a refractive index in the one or more elements that are included in the optical system). A burn-in irradiation may correspond to an irradiation at a given (e.g., constant) power over time (e.g., from about 100 milliseconds to about 2500 milliseconds). A burn-in irradiation may be directed to a thermally resilient structure (e.g., a heat sink, such as described herein). The focus setpoint irradiations may follow each (e.g., every) burn-in irradiation (e.g., focus setpoint irradiation(s) for each burn-in irradiation). The focus change measurement may comprise a measurement of a detector signal during the focus setpoint irradiations. The measured detector signal may be compared against an expected (e.g., benchmark) detector signal for the focus setpoint (e.g., corresponding to the footprint and/or the variable optical axis position). A deviation in the measured focus (e.g., with respect to the setpoint) may be determined, based on a detector signal difference. The deviation may include a magnitude (e.g., microns of change in footprint size and/or variable optical axis position), and/or a direction (e.g., positive and/or negative lensing).

At times, an energy beam power density and/or dwell time used for the focus change measurement(s) is selected such that a detector signal relationship to energy beam focus change has a symmetric shape. The symmetric shape may be a bell-curve shape (e.g., a Gaussian). For example, an energy source power (generating the energy beam) may be between about 80 W to about 350 W. The cross section of the energy beam may be any cross section disclosed herein, for example, of at least about 50 micrometers to at most about 500 micrometers. For example, a dwell time of the irradiating energy beam may be from about 1 millisecond to about 25 milliseconds (e.g., at the focus setpoint(s)). The focus setpoint irradiations may be (i) on a target surface (e.g., on a material bed, on pre-transformed material), and a characteristic detector signal thereof may comprise a standard deviation of the detector signal (e.g., as described herein). The focus setpoint irradiations may be (ii) on a target calibration structure (e.g., on an edge target comprising a first region and second region separated by a detectably sharp transition) (e.g., a knife edge target), and a characteristic detector signal thereof may comprise a derivative of the detector signal (e.g., as described herein). The focus setpoint irradiations may be (iii) on a target calibration structure (e.g., on a heat sink, on transformed material), and a characteristic (e.g., thermal) detector signal thereof may comprise an intensity of the detector signal (e.g., as described herein). The focus setpoint irradiations may include a combination of (i), (ii) and/or (iii). The focus setpoint irradiations may be performed having alternating (e.g., burn-in irradiation) times, to prevent sequence effects. In some embodiments, a focus change measurement sequence of burn-in irradiations and focus setpoint irradiations has a minimized duration to prevent (e.g., substantial) cooling of the optical element(s) in the optical path (e.g., to prevent reduction of any thermal lensing condition). In some embodiments, error reduction in data captured (e.g., detector signal data) during a focus change calibration and/or measurement includes applying a filter. A filter may be a smoothing filter, and/or a median filter applied to the detector signal (e.g., intensity and/or voltage) data.

In some embodiments, the irradiation at the target structure is for a period. The period can be at least about 50 microseconds (μsec), 100 μsec, 500 μsec, 1 milliseconds, 50 msec, or 90 msec. The period can be at most about 100 μsec, 500 μsec, 1 milliseconds (msec), 10 msec, 25 msec, 50 msec, or 100 msec. The period can be between any of the afore-mentioned period time spans (e.g., from about 50 μsec to about 100 msec, from about 50 μsec to about 25 msec, or from 10 msec to about 90 msec). The power density of the energy beam may be chosen to not invoke (e.g., substantial) thermal lensing in the at least one component of the optical setup. The power density of the energy beam may be any power density described herein. The target structure may comprise any geometric shape (e.g., as described herein).

In some embodiments, a 3D printing system comprises a controller configured to generate an alert, message, and/or to initiate a purging and/or cleaning cycle in response to detecting a focus change (e.g., a thermal lensing) condition. A thermal lensing condition may be a condition as described in patent application number PCT/US18/12250 which is incorporated by reference herein in its entirety. The alert, message, initiated (gas) cleaning cycle and/or purging cycle may consider (e.g., be based on) a threshold level of focus change. A threshold level of focus change may correspond with a (e.g., change in) spot size of the beam at the target surface. The change may be referenced against a nominal (e.g., benchmark, and/or controlled) value. For example, a threshold change in a spot size of the irradiating energy beam at the target surface may be a change from about 3 microns to about 10 microns; from about 10 microns to about 30 microns; from about 30 microns to about 100 microns; or from about 100 microns to about 150 microns.

In some embodiments, a focus change (e.g., from a setpoint value) is quantified based at least in part on the focus change calibration and/or measurement. The focus change calibration and/or measurement may be performed in-situ and/or in real time (e.g., during the printing of a 3D object). For example, the focus change calibration and/or measurement may be performed during generation of an ‘n^{th}’ layer of the 3D object. For example, the focus change calibration and/or measurement may be performed in between the generation of an ‘n^{th}’ layer and an ‘n+1’ layer of the 3D object. The (e.g., quantified) change may be used to control one or more characteristics of the irradiating energy beam (e.g., in real time or before the printing), such as the beam spot size (e.g., footprint) at the target surface. A focus change (e.g., thermal lensing) condition can be determined (e.g., to be present) based on the quantified change in the detected signal. The quantified change in the detected signal may consider the detector signal at a first focus measurement (e.g., absent thermal lensing), and the detected signal at a second focus (e.g., later, during a focus change sequence) measurement. The quantified change may be compared against a threshold value. A threshold value may be indicative of a focus change condition that alters one or more characteristics of the formed 3D object. The threshold value may consider a magnitude of deviation. For example, for a first focus measurement T1 and a second focus measurement T2, the threshold may be (T2−T1)≈0.1*T2 (where “*” is the mathematical multiplication operation and “≈” is the mathematical symbol for “equal to about”). The threshold value may be a minimum or a maximum threshold value. In the example of FIG. 7B, a threshold change in focus change is depicted by dashed lines 768. Based on the determined change (e.g., at or beyond the threshold value), the focus change (e.g., thermal lensing) condition can be controlled (e.g. mitigated). For example, a position of one or more optical elements (e.g., of an optical system) may be altered to adjust the (e.g., cross-section of) the energy beam. For example, the position of one or more optical elements may be altered to adjust a footprint of the energy beam and/or its focus on the target surface. A determined focus change may be mitigated, for example, by varying at least one parameter of the printing. For example, by varying at least one component of the printer. For example, by varying the temperature, cleanliness, and/or position of the at least one optical element, varying the power of the energy source, and/or varying at least one characteristic of the energy beam. The cleanliness may comprise adjusting a gas flow that flows adjacent to the one or more optical elements. The gas flow may comprise a gas clean of debris and/or residues that adhere to the one or more optical elements. The residues may be organic residues (e.g., oil). Materials and approaches for maintaining or cleaning an optical arrangement may such as those described in patent application number PCT/US18/12250, which is incorporated by reference herein in its entirety.

In some embodiments, a calibrated energy beam focus is used to measure one or more characteristics of a target surface. For example, a calibrated energy beam focus may be use in a metrology of a target surface (e.g., of a material bed). As described herein, at times a characteristic (e.g., standard deviation) of a detector signal corresponds with a surface characteristic (e.g., material size, surface roughness) of a target surface. For example, the detector may detect a reflectivity and/or specularity of a target surface. In some embodiments, as the energy beam is translated across a target surface of a given roughness (e.g., material feature size), an increase in energy beam focus generates a corresponding increase in a variation of a detector signal. The variation in the detector signal may be analyzed as a standard deviation. Without wishing to be bound by theory, at times, for an energy beam translating over a target surface at a given energy beam focus, an increase in a detector signal (e.g., standard deviation) may correspond to an increase in variability of the surface. At times, the increase in detector signal may correspond with a region of the target surface. At times, the increase in detector signal may correspond with a change (e.g., over time) of the target surface (for example, a surface characterized by a first energy beam translation and a second (e.g., later) energy beam translation at a given focus).

In some embodiments, a material feature size corresponds to a pre-transformed material (e.g., powder) size. For example, a powder feature size may be from about 5 microns to about 30 microns, or from 30 microns to about 60 microns. In some embodiments, a maximum focus may determine a minimum feature size that may be detected by a detector signal variability (e.g., standard deviation of a detector signal). For example, a (e.g., spot size) corresponding to a maximum focus may be between about 4* to about 8* a minimum feature size (where ‘*’ denotes multiplication).

In some embodiments, a target surface variability is measured using a calibrated energy beam focus. An energy beam focus may be measured and/or calibrated, as described herein. A target surface of a known feature size and/or roughness may be characterized according to the energy beam detector signal for a given energy beam focus. Thereafter, the target surface may be characterized by one or more energy beam translating irradiations (e.g., at the given energy beam focus) with corresponding measurements of a detector signal. An increase in (e.g., standard deviation) of the detector signal during a translation over the target surface may indicate an increasing roughness of the target surface, with respect to the initial measurement. A decrease in (e.g., standard deviation) of the detector signal during a translation over the target surface may indicate a decreasing roughness of the target surface, with respect to the initial measurement. An initial measurement of the target surface characterization by detector signal at a given energy beam focus may be made before, during, or after printing a 3D object by the 3D printing system. That the energy beam focus remains at a setpoint (e.g., has not change, such as by thermal lensing) may be validated by one or more focus change calibrations and/or measurements, as described herein. A variation in a material feature size (e.g., roughness) may be compaction of powder. At times, causes of a variation in target surface variability may be an introduction of spatter (e.g., melted material expelled from a reaction area), protrusions from the material bed (e.g., from hardened material), and/or soot (oxidized metal particles).

In some instances, the methods, systems and/or apparatuses comprise measuring the temperature and/or the shape of the transformed (e.g., molten) fraction within the irradiated area of the target surface (e.g., a tile). The temperature measurement may comprise real time temperature measurement. The temperature measurements may be used to control (e.g., regulate and/or direct) the energy irradiating to a portion of the target surface. Controlling the irradiating energy may comprise its power density, dwell time, or footprint on the exposed surface. The control may comprise reducing (e.g., halting) the irradiating energy on reaching a target depth. The dwell time (e.g., exposure time) may be at least a few tenths of a millisecond (msec) (e.g., from about 0.1 msec), or at least a few milliseconds (e.g., from about 1 msec). The control may comprise reducing (e.g., halting) the irradiating energy while considering the rate at which the irradiated portion(s) cool down. The temperature at the heated (e.g., heat tiled) area may be measured (e.g., visually) (e.g., with a direct or indirect view of the heated area). The measurement may comprise using a detector (e.g., CCD camera, video camera, fiber array coupled to a single pixel detector, fiber array coupled to a plurality of pixel detectors, and/or a spectrometer). The visual measurements may comprise using image processing. The transformation of a heated tile may be monitored (e.g., visually, and/or spectrally). The shape of the transforming fraction of the heated area may be monitored (e.g., visually, and/or in real-time). The FLS of the transformed(ing) fraction may be used to indicate the depth and/or volume of the transformed material (e.g., melt pool). The monitoring (e.g., of the heat and/or FLS of the transformed fraction within the heated area) may be used to control one or more parameters of the energy source, energy flux, energy source, and/or scanning energy beam. The parameters may comprise (i) the power generated by the tiling energy source (e.g., energy source of the energy flux) and/or scanning energy source, (ii) the dwell time of energy flux, or (iii) the speed of the scanning energy beam.

The control may comprise turning the energy beam and/or flux on and off. The control may comprise altering (e.g., reducing) at least one characteristic of the energy beam. The at least one characteristic of the energy beam may comprise its power per unit area, cross section, focus, or power of the energy beam and/or flux. The control may comprise altering a property of the energy beam and/or flux. The property may comprise the power of an energy source generating the energy beam, power per unit area, cross section, energy profile, focus, scanning speed, pulse frequency (when applicable), or dwell time of the energy beam and/or flux, respectively. During the “off” times (e.g., intermission), the power of an energy source generating the energy flux and/or power per unit area of the energy flux may be substantially reduced as compared to its value at the “on” times (e.g., dwell times). During the intermission, the energy beam and/or flux may relocate away from the area which was irradiated (e.g., tiled), to a different area in the target surface that is substantially distant from area which was tiled. During the dwell times, the energy beam and/or flux may relocate back to the position adjacent to the area which was just tiled (e.g., as part of the path-of-tiles).

In some embodiments, the control comprises closed loop control or open loop control (e.g., considering energy calculations comprising a calculation). The closed loop control may comprise feed-back and/or feed-forward control. The calculation may consider one or more temperature measurements (e.g., as disclosed herein), metrological measurements, a geometry of at least part of the 3D object, and/or a heat depletion/conductance profile of at least part of the 3D object. A controller may modulate the irradiative energy and/or the energy beam. The control may be any control disclosed in Patent Application Serial No. PCT/US16/34857 filed on May 27, 2016, titled “THREE-DIMENSIONAL PRINTING AND THREE-DIMENSIONAL OBJECTS FORMED USING THE SAME,” or in Patent Application Serial No. PCT/US17/18191,” each of which is incorporated herein by reference in its entirety.

At times, a single sensor and/or detector is used to sense and/or detect (respectively) a plurality of physical parameters (e.g., attributes), for example, power density and/or temperature over time of an energy beam, and/or energy source power over time. At times, a single pixel sensor and/or detector may be used to sense and/or detect (respectively) a physical attribute (e.g., power density (e.g., over time) of an energy beam, temperature (e.g., over time) of an energy beam, and/or energy source power (e.g., over time). A position of the energy beam may be measured as a function of time, e.g., as the oscillating (e.g., retro scan) energy beam performs oscillations, or as the non-oscillating energy beam travel along its path.

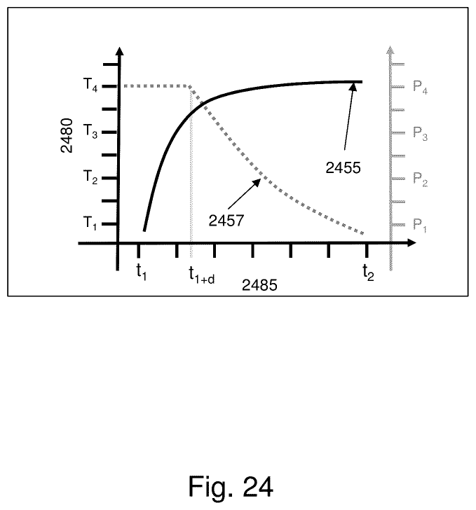

FIG. 24 illustrates an example that depicts temperature measurements 2480 as a function of time 2485 (e.g., while forming a tile). For example, the power of the energy source that generates the energy beam may be kept (e.g., substantially) constant during a time period (e.g., from t₁ to t_{1+d}), until the temperature approaches a (e.g., predetermined) value (e.g., FIG. 24, T₄); the power of the energy source decreases in order to keep the temperature at a (e.g., substantially) constant value during a following time period (e.g., from t_{1+d} to t₂). One or more detectors may measure the temperature distribution along the path (e.g., of the scanning and/or non-scanning energy beam), by detecting the temperature.

In some embodiments, the footprint of the oscillation energy beam on the target surface translates back and forth around a position of the target surface (e.g., center of the tile). The amplitude of the oscillation may be smaller than, or equal to the FLS (e.g., diameter) of a tile. In some embodiments, at least one characteristic of the energy beam is held at a (e.g., substantially) constant value using close loop control during the oscillation, using a measured value (e.g., of the same, or another characteristics). For example, the power of the energy source that generates the energy beam may be held at a constant value, using measurements of temperature at one or more locations at the target surface (e.g., at a location and/or as the energy beam travels along the path). For example, the temperature at the irradiation location (e.g., energy beam footprint) is held at a (e.g., substantially) constant maximum value (e.g., using a controller), and the power of the energy source generating the energy beam is measured and/or observed. The temperature may be held at a constant maximum value by altering the power of the energy source. The energy source power may be held at a constant value, resulting in an alteration of the temperature at the target surface location of the energy beam footprint. The areal extent of the heated area may be extrapolated from (e.g., fluctuations of) the power and/or temperature measurements. The heated area may comprise a melt pool or its vicinity. In some embodiments, the oscillating energy beam that is held in closed loop control may facilitate controlling at least one characteristic of the melt pool (e.g., temperature and FLS).

In some embodiments, the control system adjusts at least one characteristic of the energy source generating the energy beam (e.g., its power) to maintain the threshold temperature by comparing a monitored temperature to the threshold temperature. The variation in power of the energy source generating the energy beam (e.g., using closed loop control) may cycle and/or drop during the irradiation of the energy beam (e.g., during the 3D printing) at the target surface. A threshold temperature (e.g., temperature to be maintained at the target surface) may be specified. The threshold temperature may be kept (e.g., substantially) constant. The sensor/detector may monitor the temperature at discrete time points. The control system may adjust at least one characteristic of the energy beam to maintain the threshold temperature by comparing a monitored temperature to the threshold temperature. For example, the control system may adjust the power of the energy source and/or the power density of the energy beam to maintain the threshold temperature by comparing a monitored temperature to the threshold temperature. Thus, the power over time may vary to maintain a threshold temperature value. FIG. 24 shows an example of both a power profile over time 2457 and its respective temperature provided over time 2455 of a non-oscillating energy beam, that aims to maintain the temperature value at T₄. At times, one or more physical properties (e.g., melt pool characteristics) of the target surface may be sensed and/or detected by a single sensor and/or detector respectively. For example, the control system may adjust the at least one characteristic of the energy beam and/or energy source by comparing (i) a monitored temperature to the threshold temperature, (ii) a monitored power density to a threshold power density, (iii) a monitored power to a threshold power, (iv) or any combination thereof. The power may be of the energy source that generates the energy beam. The power density may be of the energy beam. The temperature may be of a position at the target surface (e.g., at the footprint of the energy beam).

At times, a feedback control system is used in a processing field calibration of two or more energy beams. The feedback control system can be a closed loop control system (e.g., as described herein). The feedback control system can include a thermal detection system (e.g., such as described herein). The feedback control system may adjust an energy source power (e.g., for an energy beam) to maintain a (e.g., setpoint) temperature at a target surface. In some embodiments, the processing field calibration includes a beam overlay calibration. The beam overlay calibration can include utilizing (e.g., thermal signals from) the thermal detection system to locate (e.g., calibrate) the position of one or more energy beams (e.g., a thermal detection energy beam overlay calibration). An energy beam overlay calibration can include characterization of an overlay offset of at least two energy beams (e.g., an energy beam-to-energy beam offset). The (e.g., beam-to-beam) overlay calibration can be performed at a target surface of the 3D printing system. The beam-to-beam overlay offset can be performed in situ (e.g., in real time, during processing of a 3D object). The beam-to-beam overlay offset can be performed before, during, and/or after processing of a 3D object. The beam-to-beam overlay offset can be performed several times (e.g., before, during, and/or after processing of a 3D object).

In some embodiments, a beam-to-beam processing field calibration includes formation of a target structure (e.g., a target tile) by a first energy beam (e.g., controlled by a guidance system). The target structure can be formed at a predetermined location at a target surface (e.g., on a material bed). The predetermined location can include a controlled position (e.g., a predetermined center position) toward which the first energy beam is directed (e.g., by the guidance system) to generate the target structure. The target structure can be formed by transformation of a pre-transformed material to a transformed material (e.g., via hatching). In some embodiments, the target structure does not include any support structures. In some embodiments, the target structure includes support structures (e.g., auxiliary structures). The auxiliary supports may or may not be anchored to the platform. In some embodiments, the target structure is supported on a build platform.

In some embodiments, the target structure is of a predetermined shape (e.g., a polygonal solid) and size. A size of the target structure may be from about 0.5 mm to about 10 mm, or from about 10 mm to about 20 mm. In some embodiments, the target structure has a well-defined edge. A well-defined edge may be a material transition (e.g., from transformed material to pre-transformed material). A well-defined edge may be a transition from the target structure to a surrounding region (e.g., of the material bed). A well-defined edge may be characterized by a roughness of the target structure at or along the edge (e.g., along a side face of the edge. For example, a target structure edge roughness (e.g., arithmetic average of the roughness profile Ra value) may be from about 2 microns to about 30 microns, or from about 30 microns to about 100 microns.

In some embodiments, the energy beam overlay calibration includes a second energy beam directed toward the target structure. A guidance system (e.g., a scanner) may command the second energy beam to begin an irradiation sequence with a target (e.g., commanded) initial position at a center of the target structure. The irradiation sequence may include a (e.g., stepwise) movement of the second energy beam across the surface of the target structure (e.g., in steps toward the edge thereof). The irradiation sequence may be along (e.g., perpendicular to) a given axis (e.g., an x axis or a y axis). The irradiation sequence may irradiate at a given frequency (e.g., number of irradiation steps/second). The second energy beam may irradiate in a controlled manner. For example, a feedback control system may include a target (e.g., setpoint) surface temperature (e.g., as measured by the synchronized detector of the second energy beam) at which the target surface is to be maintained. The feedback control system may adjust one or more (e.g., second) energy beam parameters (e.g., an output power of energy source thereof) in the maintaining of the target surface temperature.

In some embodiments, an (e.g., second) energy directed at the target structure generates an increased temperature in the target structure at the location of the energy irradiation (e.g., and its vicinity). For a given energy density over time of the irradiating energy beam, a rate at which the target surface (e.g., target structure) increases in temperature may be based in part on the material of the target surface and/or on a conduction path of the heat within the target surface. For example, a target surface comprising (e.g., hardened) transformed material may have an increased (e.g., greater) heat conduction path in relation to a target surface comprising pre-transformed material. For example, a target surface comprising a material with a heat conduction path to a heat sink (e.g., a build plate) may have an increased (e.g., greater) heat conduction path in relation to a target surface comprising a material that does not have a heat conduction path to a heat sink. A target surface having a (e.g., relatively) increased heat conduction path may dissipate energy (e.g., heat) away from the surface more quickly than if the target surface has a reduced heat conduction path. For a given energy flux (e.g., of an irradiating energy beam), a target surface having an increased conduction path may increase in temperature relatively more slowly and/or to a lesser extent (e.g., peak temperature) than a target surface having a reduced conduction path. A feedback control system (e.g., such as described herein) may be configured to maintain a (e.g., setpoint) temperature at the target surface based (e.g., at least in part) on controlled power of an energy source. The feedback control system may reduce an output (e.g., setpoint) power of the energy beam in response to a detected temperature at the target surface that is at or above the (e.g., setpoint) temperature. The timeframe and/or rate for which the feedback control system reduces the output power may depend on the material properties (e.g., conduction path) of the material(s) comprised by the target surface. For example, the feedback control system may reduce power relatively more slowly when the energy beam is irradiating a target surface comprising a transformed (e.g., hardened) material (e.g., which may dissipate heat energy more quickly and consequently rise in temperature more slowly). For example, the feedback control system may reduce power relatively more quickly when the energy beam is irradiating a target surface comprising a pre-transformed material (e.g., which may dissipate heat energy more slowly and consequently rise in temperature more quickly).

In some embodiments, a beam overlay calibration is used to align a plurality of energy beams (e.g., a first energy beam and a second energy beam) with respect to each other. The beam overlay calibration may include determination of a (e.g., measured) position (e.g., on the target surface) at which the second energy beam transitions over the edge of the target structure. The beam overlay calibration may include determination of a (e.g., calculated) distance over the target structure that the second energy beam travelled from an initial (e.g., commanded) position to the target structure edge. The transition of the second energy beam over the target structure edge may be determined based on a signal from a (e.g., synchronized) detector coupled with the second energy beam (e.g., a thermal signal). The coupled detector may be a calibrated detector (e.g., calibrated for alignment between the detector field of view and the second energy beam footprint, as described herein). The detector may provide an input to a feedback control system (e.g., closed loop control). The transition of the second energy beam over the target structure edge may be determined based on an output power (e.g., of the second energy beam) parameter of the feedback control system. For example, the transition of the second energy beam over the target structure edge may be determined based on a (e.g., sharp) drop in the output power of the feedback control system (e.g., elapsed time to power OFF).

In some embodiments, the beam overlay calibration considers the regular progression of the energy beam. The beam overlay calibration may include determination of any deviation between the expected (e.g., commanded) initial position (e.g., center of the target structure) of the second energy beam irradiation and the actual (e.g., measured) initial position of the second energy beam irradiation on the target structure. The deviation between the expected (e.g., commanded) initial position and the actual (e.g., measured) initial position of the second energy beam may be based on a deviation between an expected distance traveled and the calculated distance traveled by the second energy beam-for example, from an initial (e.g., commanded) position to the target structure edge. An expected distance may be based on the size of the target structure. For example, an expected distance may be based on the distance between a center of the target structure (as controlled by the guidance system of the first energy beam) and an edge of the structure. For example, for a target structure that is a solid rectangle having 5 mm sides, an expected distance may be 2.5 mm (e.g., shortest distance between a center of the target structure and the edge). A calculated distance may be determined by the number of irradiations (e.g., steps) completed by the second energy beam from an initial position to the detected edge of the target structure. The steps may have a (e.g., substantially) constant (e.g., predetermined) value (e.g., distance therebetween). The step may be a tile. The step may be a distance between two tile centers. The beam overlay calibration may include continuing irradiation steps from an initial irradiation position until a transition (e.g., target structure edge) is detected. A calculated distance traveled may indicate an (e.g., actual) initial position of the second energy beam. For example, for a given step size (e.g., 25 microns (□m)) and a given number of steps (e.g., 103 steps) between an initial radiation and the (e.g., detected) edge of the target structure, a calculated distance traveled may be determined (e.g., 25□□m*103=2575 □m). A deviation between the expected distance traveled and the calculated distance traveled may indicate an overlay offset between the first energy beam positioning (e.g., of the guidance system) and the second energy beam positioning (e.g., of the guidance system). For example, an overlay offset may be calculated based on a given deviation between the calculated distance and the expected distance (e.g., in microns) (e.g., 2575 μm−2500 μm=75 μm).

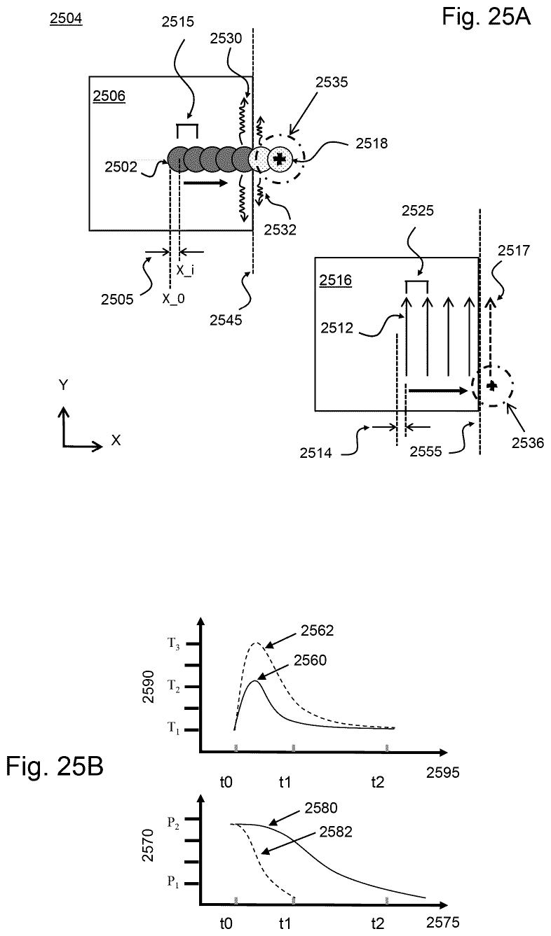

In some embodiments, a deviation (e.g., FIG. 25A; 2505, 2514) of the detected (e.g., measured) initial position of the (e.g., second) energy beam with respect to the (e.g. expected) position is calculated. The deviation may be calculated in at least one dimension (e.g., horizontal direction (X), or vertical direction (Y)). The calculation may be done manually and/or automatically (e.g., by a controller), before, after and/or during at least a portion of the 3D printing. The calculation may be done in real-time (e.g., during build of at least a portion of the 3D object). The calculation may be done when performing calibration (e.g., before, and/or, after build of the 3D object). Based on the calculated deviation, the guided position of the (e.g., second) energy beam with respect to a first energy beam (e.g., at an intersection an overlapping processing thereof) may be adjusted (e.g., before, after and/or during the 3D printing; manually, and/or automatically). Adjusting may include coinciding (e.g., calibrating) (i) the (e.g., measured) initial position of the second energy beam on the target structure, with (ii) the expected position. Adjusting may include altering the projection position and/or angle of the second energy beam on the target structure and/or target surface. Adjusting may be done during, before, or after build of the 3D object. Adjusting may be performed manually or automatically, e.g., by a controller. At times, calculating and adjusting may be performed by the same controller. At times, calculating and adjusting may be performed by different controllers. At least one controller may be a control system. The controller may include a processing unit. Controller may be programmable. The controller may operate upon request. The controller may be any controller described herein.

FIG. 25A depicts a portion of a target surface 2504 on which a beam overlay calibration is performed. As shown in the example of FIG. 25A, the target surface includes a target structure 2506 (e.g., generated at a predetermined location by a first energy beam). As depicted in the example of FIG. 25A, the beam overlay calibration includes a sequence of irradiations (e.g., by the second energy beam) beginning at an initial irradiation (e.g., tile) 2502 at an initial position x_i, and ending at irradiation 2518. The initial position of the second energy beam irradiation may be commanded (e.g., by a guidance system) to be coincident with a center position of the target structure (e.g., x_0). In some embodiments the actual (e.g., measured) location of the initial position (e.g., x_i) is determined (e.g., calculated) as a result of the beam overlay calibration. In the example of FIG. 25A, the sequence of irradiations (e.g., to form tiles, e.g., 2502) has a step size 2515 by which the second energy beam progresses from the initial position x_i toward the edge 2545 of the target structure. A (e.g., synchronized) detector (e.g., FIG. 25A, 2535) may monitor (e.g., thermal) emissions of the target surface that are generated by the second energy beam irradiations (e.g., during formation of the tiles). For example, detector signals (e.g., thermal data) may be captured for a multitude of (e.g., every) second energy beam step irradiations (e.g., tile formations). The detector and second energy beam may form a part of a feedback control system. The detector may monitor a temperature of the target surface. The temperature of the target surface may depend, in part, on the thermal conduction path of the heat at a given location of the target surface.

At times, the second energy beam sequence of irradiations comprises a sequence of tiling irradiation steps (e.g., formation of tiles). At times, the second energy beam sequence of irradiations comprises a sequence of hatching irradiation steps. In the example of FIG. 25A, a beam overlay calibration includes a target structure 2516 on the portion of the target surface 2504. As depicted in the example of FIG. 25A, the beam overlay calibration includes a sequence of irradiations (e.g., by the second energy beam) beginning at an initial irradiation (e.g., hatch) 2512 at an initial position, and ending at irradiation (e.g., hatch) 2517. In the example of FIG. 25A the sequence of irradiations (e.g., hatches) has a step size 2525 by which the second energy beam progresses from the initial position toward the edge 2555 of the target structure. A (e.g., synchronized) detector (e.g., FIG. 25A, 2536) may monitor (e.g., thermal) emissions of the target surface that are generated by the second energy beam irradiations.

In the example of the target structure 2506 of FIG. 25A, arrows 2530 and 2532 (e.g., directed away from second energy beam irradiations) indicate a relative magnitude of heat conduction (e.g., the heat conduction from the irradiation corresponding to 2530 as depicted by the wiggly arrows is greater than the heat conduction from the irradiation corresponding to 2532, which heat irradiation is depicted by the wiggly arrows next to 2532). The feedback control system may adjust one or more energy beam parameters (e.g., a power supplied to the second energy beam) based on the detected temperature. The edge of the target structure (e.g., FIG. 25A, 2545, 2555) may be detected based on the detector (e.g., temperature) signals and/or the feedback control system (e.g., output signals). The detector signal may comprise temperature, reflectivity, or specularity. The actual (e.g., measured) distance traveled by the second energy beam may be determined based on the (e.g., calculated) distance traveled by the second energy beam from an initial position to the detected edge. The calculated distance may consider (e.g., include) the size of the irradiation (e.g., tile and/or hatch). A deviation (e.g., FIG. 25A, 2505, 2514) between the center position of the target structure (e.g., x_0) and the initial position of the second energy beam irradiation (e.g., x_i) may be determined based on a comparison of the calculated distance traveled and the expected distance traveled (e.g., based on the dimensions of the target structure and the expected initial position of the second energy beam).

FIG. 25B depicts an example of plots (e.g., of a feedback control system) used in a beam overlay calibration. In the example of FIG. 25B, an upper plot depicts temperature 2590 as a function of time 2595 (e.g., during second energy beam irradiations), having curves 2560 and 2562. The curves may correspond (e.g., respectively) to the temperature detected at a target surface by a (e.g., synchronized) detector at and/or in the vicinity of a (e.g., respective) second energy beam irradiation. As described herein, the temperature of a target surface irradiated by the (e.g., second) energy beam (e.g., at given energy beam parameters) may correspond to the material and/or heat conduction characteristics of the target surface. In the example of FIG. 25B, curve 2560 reaches a maximum value (e.g., near T₂) that is lower than the maximum value of curve 2562 (e.g., near T₃).

At times, for a feedback control system (e.g., such as described herein), one or more parameters of the energy beam (e.g., a supplied power thereto) is controlled based on one or more processing characteristics (e.g., a detected temperature of a target surface). For example, the feedback control system may output an initial power level for an energy source that generates the energy beam at the beginning of an irradiation. The (e.g., initial) power level may be reduced as a detected temperature of a target surface rises at or in the vicinity of the energy beam irradiation spot. The vicinity of the energy beam irradiation spot may extend to at most six FLS (e.g., diameters) of the energy irradiation spot, beyond the center of the energy irradiation spot. In the example of FIG. 25B a lower plot depicts power 2570 (e.g., supplied to the second energy beam) as a function of time 2575 (e.g., during second energy beam irradiations), having curves 2580 and 2582. The power curves may correspond (e.g., respectively) to the (e.g., detected) temperature curves (e.g., FIG. 25B, 2560 and 2562).

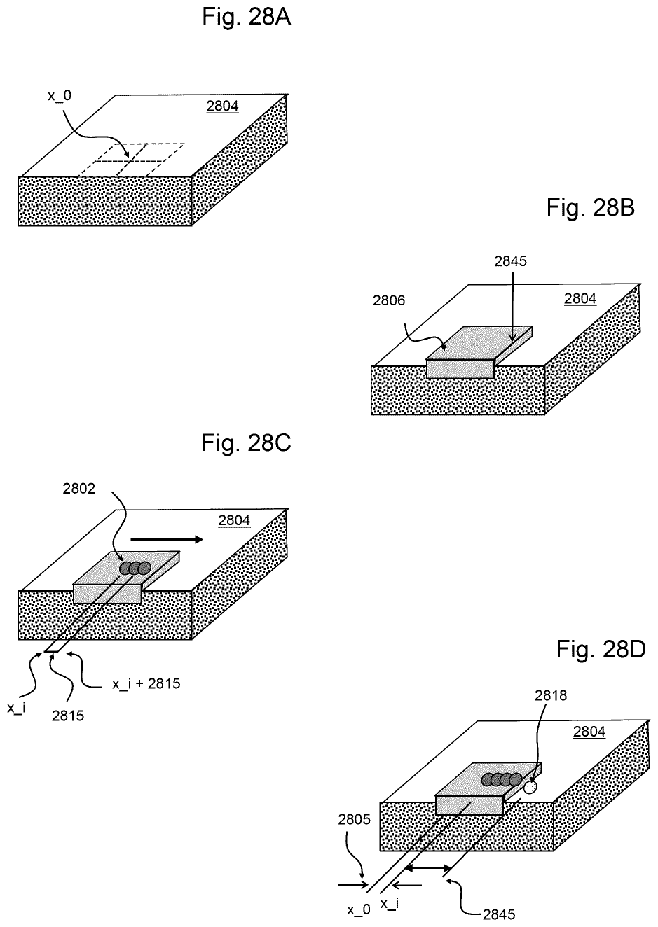

At times, a deviation guidance between at least two energy beams in an overlapping region is determined via formation of a test object (e.g., on a target surface). For example: (a) at a given location (e.g., FIG. 28A, x_0) of a target surface (e.g., FIG. 28A, 2804), a test object may be printed (e.g., FIG. 28B, 2706) having a detectable border (e.g., FIG. 28B, 2845) by using a first energy beam that is directed by a first guidance system; (b) a second energy beam that is directed by a second guidance system may be directed to irradiate a position (e.g., FIG. 28C, 2802) in the location (e.g., FIG. 28C, x_i),e.g., to form a tile; (c) the second energy beam may be directed in a sequence of steps (e.g., FIG. 28C, 2815) from the position to across the detectable border (e.g., FIG. 28D, 2818),e.g., to successively form a file tiles along a line; (d) a detector may detect a trajectory of the second energy beam from the position to the detectable border to determine a length of the trajectory (e.g., FIG. 28D, between x_i and 2845), and/or the tiles along the line; and (e) the length of the trajectory and/or the line of tiles may be used to align the first guidance system with the second guidance system to print the at least one three-dimensional object (e.g., FIG. 28D, 2805).

In some embodiments, a composition of the target surface at which the (e.g., current step of) irradiation of the energy beam occurs is determined based on a characteristic of the power output of the feedback control system. The characteristic of the power output may be, for example, a time elapse for the power output to drop beyond a threshold level. For example, when an energy beam irradiates a transformed (e.g., and hardened) material, the power output from the feedback control system may (e.g., relatively) gradually reduce (e.g., FIG. 25B, 2580) from an initial value (e.g., FIG. 25B, P₂) to a lower value (e.g., FIG. 25B, P₁) as the temperature at the target surface rises (e.g., relatively) slowly (e.g., FIG. 25B, 2560). For example, when an energy beam irradiates a pre-transformed material, the power output from the feedback control system may (e.g., relatively) sharply reduce (e.g., FIG. 25B, 2582) from an initial value (e.g., FIG. 25B, P₂) to a lower value (e.g., FIG. 25B, P₁) as the temperature at the target surface rises (e.g., relatively) quickly (e.g., FIG. 25B, 2562).

In some embodiments, a threshold level is a percentage of the initial power setpoint (e.g., from about 1% to about 10% of the initial power setpoint). A threshold level may correspond to the power output going to zero (e.g., power OFF). At times, for a given temperature setpoint of the target surface the time elapse for the power output to go to zero (e.g., power OFF) may differ for irradiation over a transformed material compared to irradiation over a pre-transformed material. For example, a threshold time elapsed (e.g., indicative of irradiation over pre-transformed material) to a power OFF output (e.g., during irradiation over the tile) may be from about 0.5 ms (milliseconds) to about 4 ms. The power output for irradiation steps of the beam overlay calibration may be plotted as a function of time. In some embodiments a bivariate plot may be used in a determination of a threshold level of power output change indicative of a transition from a first material (e.g., composition) to a second material (e.g., composition) (e.g., the edge of the target structure).

In some embodiments, the target structure is generated by irradiation of the energy beam on the target surface to transform a (e.g., pre-transformed) material. The target structure may be at a predetermined location on the target surface. The target structure may have a predetermined shape and/or size. For example, a size of about 0.5 mm to about 10 mm (e.g., FLS of a target structure). The (e.g., second) energy beam with which the overlay offset to the first energy beam is calibrated may include energy beam parameters. The energy beam parameters of the (e.g., second) energy beam may be such that a detectable signal persists at (e.g., each) step of the irradiation sequence (e.g., each irradiation tile and/or hatch) for a sufficient time for the detector to detect (e.g., thermal) signals therefrom. For example, the (e.g., thermal) signal may persist from about 1 ms to about 100 ms, or from about 100 ms to about 500 ms. The (e.g., second) energy beam parameters may comprise energy beam dwell time, intermission time, speed along the path, cross-section, power density, footprint, or step size (e.g., from irradiation-to-irradiation). For example, the energy beam may irradiate (e.g., dwell) at the predetermined location of the target surface from between about 10 ms to about 1500 ms. For example, the footprint of the energy beam may be between about 50 microns to about 600 microns (e.g., FLS of the diameter). For example, an irradiation sequence step size may be from about 2 microns to about 15 microns, or from about 15 microns to about 50 microns. For example, the energy source that generates the energy beam may output energy from between about 100 W to about 1000 W. Detector parameters may include a data capture rate of the detector and/or a translation speed (e.g., scanning speed) of the detector (e.g., a field of view thereof). For example, a data rate at which the detector generates detection data may be between about 50 kHz to about 200 kHz. For example, the detector (e.g., field of view) may translate between about 100 mm/s to about 2000 mm/s. As described herein the detector may be configured as a bore-sight detector, and/or a co-incident detector (e.g., as described herein). The detector may comprise a single pixel detector, a plurality (e.g., an array) of single pixel detectors. The detector may comprise an optical fiber. The optical fiber may be coupled to a single pixel detector.

At times, the (e.g., respective) guidance systems of the (e.g., multiplicity of) energy beams are calibrated for any build plane (e.g., processing field) distortion (e.g., as described herein) prior to the beam overlay calibration. At times, the (e.g., synchronized, respective) detectors coupled with the (e.g., multiplicity of) energy beams may be calibrated for alignment with the (respective) energy beams. At times, a beam overlay calibration may be performed for a multiplicity of energy beams (e.g., guidance systems thereof). A multiplicity of energy beam may be, for example, 2, 3, 4, 5, 6, 7, 8, 9, 10, 11, 12, 13, 14, 15, 16, 17, 18, 19, or 20 energy beams. At times, a beam overlay calibration may be performed for each (e.g., pair of) energy beams. At times, a beam overlay calibration may be performed for each energy beam of a set of energy beams having an overlapping processing region.

In some embodiments, a beam overlay calibration includes generation of correction (e.g., compensation) data for one or more overlay offsets (e.g., overlapping regions) of the energy beams across the build plane. At times, the overlay offset compensation data (e.g., of the guidance system) may be generated on target structure basis (e.g., one correction data point per target structure, across a build plane). The overlay offsets may correspond to each of two or more energy beams (e.g., guidance systems thereof). As an example, an overlay offset may provide correction data for positions (e.g., to a guidance system) of the energy beam(s) within an overlapping region. At times, characterization of the beam overlay (e.g., offset) may be generated across a build plane by a multiplicity of beam overlay calibrations (e.g., at various regions of the build plane). The beam overlay correction may be based on a comparison (e.g., evaluation) of a (e.g., measured) initial position of a second energy beam irradiation sequence versus an expected initial position. At times, the magnitude and direction of the compensation at the given (e.g., target structure) location can be based on the comparison performed between the measured initial position and the expected initial position.

At times, improved accuracy of the beam overlay calibration is attained by performing multiple beam overlay calibration steps (e.g., iteratively), e.g., to print a plurality of tiles. For example, multiple target surface calibration (e.g., cycles) may be performed. The multiple (e.g., plurality of) calibration cycles may include (i) generating a target structure by the (e.g., first) energy beam, (ii) performing the irradiation sequence of (e.g., predetermined) steps with the (e.g., second, overlapping) energy beam, (iii) determining an (e.g., actual, measured) initial position of the second energy beam, (iv) comparing the measured initial position of the (e.g., second) energy beam to a (e.g., commanded) expected initial position, and (v) generating compensation data therefrom. The overlay offset compensation data may be averaged over the multiple calibrations, and this (e.g., averaged) compensation data may be provided to the (e.g., respective) guidance systems. In some embodiments, outliers in the measurement data are removed (e.g., to improve compensation quality). An outlier may be a data value that is significantly different than data values (e.g., of neighboring correction data points) in the compensation data. For example, outliers may be identified for removal using a (e.g., median) filter. For example, outliers may be removed by (e.g., adjusting) using a smoothing filter. A modification of the compensation data may include application of a smoothing function to the data. A modification of the compensation data may include application of a filter (e.g., a median filter) to the data.

In some embodiments, the beam overlay offset correction data points (e.g. compensation) are provided to a guidance system (e.g., including and/or operatively coupled with a controller) of the energy beam(s). The compensation may be implemented at a hardware, firmware, and/or software level (e.g., of the controller). The compensation may be implemented as a lookup table. The compensation may be implemented in situ and/or in real time (e.g., during operation of the energy beam). In some embodiments, a guidance system (e.g., a scanner) controls motion along independent axes. For example, control is independent for an x-axis and a y-axis. At times, (e.g., overlay) compensation data for (e.g., each) independent axes may be provided to the guidance system. For example, first compensation data may be generated to correct for multiple energy beam overlay offset positions (e.g., in an overlapping processing region) in the x-axis, and second compensation data may be generated to correct for multiple energy beam offset positions (e.g., in the overlapping processing region) in the y-axis. The data values of the overlay offset compensation may be in distance values (e.g., distance along the processing field). The data values of the overlay offset compensation may be in angular values (e.g., rotation angle of a (e.g., scanning) mirror). The overlay offset compensation data may include a combination of distance and/or angular values.

In some embodiments, the beam overlay calibration is performed before, after, and/or during the 3D printing (e.g., when the irradiating energy is not used to form the 3D object). The guidance system may be controlled before, after, and/or during the 3D printing (e.g., when the irradiating energy is not used to form the 3D object). The control may be manual and/or automatic (e.g., using a controller).

At times, a target structure is covered (e.g., at least partially) by a material (e.g., pre-transformed material and/or contaminant(s), such as soot). In some embodiments, the beam overlay calibration comprises cleaning a (e.g., to-be irradiated) target surface (e.g., target structure) prior to directing the (e.g., second) energy beam at the target structure. The target surface can be any target surface as disclosed herein. A cleaning process may comprise directing the irradiating beam onto the covered surface (e.g., ablating) and or target structure. Cleaning may comprise material removal by means of a moving apparatus (e.g., a translating blade, a squeegee, a grinder, a polisher, and/or a rolling wheel), by directing a flow of gas (e.g., gas jet), directing a flow of particulate matter (e.g., sputtering), by a chemical process (e.g., etching), and/or by suction (e.g., vacuum). The cleaning of the target surface may comprise a portion of the benchmarking and/or subsequent beam overlay calibration processes (e.g., may comprise an initial step thereof). The cleaning of the target surface and/or structure may be performed before, during, and/or after a 3D printing process. The cleaning of the target surface and/or structure may be performed in real time (e.g., during operation of the irradiating beam). The cleaning process may be performed by a controller (e.g., automatic, computer, or manual). At times, the cleaning process may be controlled by at least one controller and/or manually. At times, the cleaning process may be performed by different controllers. The controller may be any controller described herein.

In some embodiments, a beam-to-beam processing field calibration (e.g., beam overlay calibration) includes formation of a heat source (e.g., a target heat source) by an energy beam in a 3D printing system having a multiplicity of energy beams. The 3D printing system may include synchronized detectors (e.g., boresight and/or coincident, as described herein) coupled with (e.g., each) energy beam of the multiplicity of energy beam. The synchronized detectors may be calibrated such that a detector field of view is aligned with the energy beam footprint of its respective energy beam. At times, the beam overlay calibration may include translating the multiplicity of energy beams (e.g., at zero power) across the target heat source while capturing detector signals from respective (e.g., synchronized) detectors of the multiplicity of energy beams. The target heat source can be formed at a predetermined location at a target surface (e.g., on a material bed). The target heat source can be formed by transformation of a pre-transformed material to a transformed material (e.g., via hatching).

At times, the target heat source is of a predetermined shape (e.g., an elongated line or curve) and size. For example, the FLS of a largest dimension of the target heat source may be at least about 1*, 2*, 3*, 5*, 10*, 50* or 100* the FLS of the energy beam footprint. The symbol “*” designates the mathematical operation “times.” The largest dimension of the target heat source may be of any value between the afore-mentioned values (e.g., from about 1* to about 100* from about 1* to about 50*, or from about 50* to about 100* the cross-sectional area and/or footprint of the energy beam on the target surface). A smallest dimension (e.g., size) of the target heat source may be at least about 1*, 2*, 3*, 4*, 5*, or 10* the FLS of the energy beam footprint. The smallest dimension of the target heat source may be of any value between the afore-mentioned values (e.g., from about 1* to about 10*, from about 1* to about 5*, or from about 5* to about 10* the cross-sectional area and/or footprint of the energy beam on the target surface). The target heat source may be oriented (e.g., substantially) along an x-axis or a y-axis. In some embodiments, the target structure forms well-defined edges. A well-defined edge may be a material transition (e.g., from transformed material to pre-transformed material). A well-defined edge may be a temperature transition from the target heat structure to a surrounding region (e.g., of the material bed). A well-defined edge may be characterized by a temperature (e.g., gradient) of the target heat structure at or along the edge. In some embodiments, the target heat source comprises a transformed material that does not include any support structures (e.g., within a material bed). In some embodiments, the target heat source comprises a transformed material that includes support structures (e.g., auxiliary structures). In some embodiments, the target heat source is supported on a build platform (e.g., base).

In some embodiments, a beam overlay calibration comprises monitoring (e.g., an intensity of) a detected signal of the detectors (e.g., that are synchronized with the energy beams footprint location) as a function of position and/or time. The detected signals may be monitored while translating (e.g., scanning) the energy beams (with the synchronized detectors' fields of view) across the target heat source. The detector scan may be at a predetermined speed. The detector scan orientation may be at an angle (e.g., perpendicular) to the target heat source (e.g., a larger dimension thereof). The beam overlay calibration may include determining a location (e.g., over the target heat source) and/or time (e.g., during the scan) at which a peak in a detector signal is reached during the scan. For example, a plot of detector signal as a function of a location on the target surface (e.g., including the target heat source) may be generated. The position and/or timing of the detected peak may be compared across detectors (e.g., for the associated energy beams) to determine a relative offset between the energy beam (e.g., footprint) positions. In some embodiments a (e.g., precise) starting location (e.g., on the target surface) for each energy beam (e.g., detector) is not explicitly known (e.g., any offset determined from the beam overlay calibration may provide this information). For example, the energy beams (and associated synchronized detectors) may be commanded to begin the scans at a given position (e.g., at a same y coordinate for a y-axis scan). The beam overlay calibration may determine a deviation in the actual (e.g., measured) positions of the energy beam with respect to one another based on any deviation between the detectors in the position and/or timing of the detected signal peak over the target heat source.

FIG. 26A depicts a portion of a target surface 2604 on which a beam overlay calibration is performed. As shown in the example of FIG. 26A, the target surface includes a target heat source 2602 along an x-axis (e.g., generated at a predetermined location by an energy beam 2618). As depicted in the example of FIG. 26A, detectors 2625 and 2635 (e.g., synchronized with respective energy beams) are translated across the target heat source in a (e.g., substantially) perpendicular direction along a y-axis (e.g., for a y-axis beam overlay calibration). The detectors may measure signals (e.g., heat signals) from the target surface during translation.

FIG. 26B depicts an example of detector signals 2630 and 2632 corresponding to the first and second detector scans, respectively (e.g., to FIG. 26A scans 2625 and 2635). FIG. 26B depicts a temperature detected 2610 as a function of time 2615 (e.g., during the detector scans). At times, a scan time may be correlated to a position on the target surface and/or over the target heat source (e.g., as a function of initial position and detector scan speed). At times, a (e.g., relative) difference in a detector scan time at which a peak detector signal occurs between a first detector scan (e.g., 2625) and a second detector scan (e.g., 2635) may be indicative of an offset in the (e.g., actual) position of the respective energy beams (e.g., as compared to the commanded position). In the example of FIG. 26B, a difference between the first and the second detector scans in the (e.g., respective) detector scan time at which a peak detector signal occurs is given by deviation 2605. In some embodiments, a beam overlay offset may be determined based on the offset of the detector fields of view along the given scan direction. The offset of the detector fields of view may be based on the difference in detected peak signal from the scan over the target heat source. In some embodiments, the offset may be determined as a dimension (e.g., in microns) of the detector field of view and/or the energy beam footprint at the target surface. The distance between the detectors (and the associated energy beam footprints) may be determined from the scanning speed of the detectors and the difference in peak times (e.g., FIG. 26B, t1 and t2). For example, the beam overlay offset of the detector field of view may be determined as equal to the (e.g., calculated) offset from the first detector scan and the second detector scan (e.g., FIG. 26B, 2605).

At times the overlay offset of the energy beams (e.g., based on the detector overly offset) from a first target heat source calibration is verified by a repeated target heat source calibration. A repeated target heat source calibration may include formation of a (e.g., subsequent, second) emanation source that is parallel to the first (e.g., target heat source) (e.g., FIG. 26A, 2603 parallel to 2602). The repeated calibration may include scanning the (e.g., same) detectors at an angle (e.g., in a perpendicular direction) to the second target heat source (e.g., in an anti-parallel direction to the scan over the first target heat source). The repeated calibration may include characterization of the overlay offset of the energy beams in the anti-parallel direction (e.g., based on the determined detector overlay offset in the anti-parallel direction). At times, a detector overlay offset from a repeated calibration may be equal in magnitude to that of a prior (e.g., first) beam overlay calibration, but with the order of peak detection by the detectors reversed. That is, a first detector that is leading a second detector in negative-y axis movement may lag the second detector in a positive-y axis movement. At times, a subsequent target heat source is formed in a vicinity of a prior target heat source (e.g., for beam overlay calibration in a same axis). In a vicinity of may be within about 1 mm to about 20 mm.

At times, an orthogonal beam overlay offset is determined by target heat source calibrations in an orthogonal direction. In the example of FIG. 26A, target heat sources 2606 and 2608 are formed along a y axis (e.g., for detector overlay offset determination along an x-axis). Second target heat source may be generated across which the detector field of view may be scanned in a second direction (e.g., a direction anti-parallel to the first direction). During the second detector scan the detector may generate a detector signal having a (e.g., substantially) equal magnitude to that of the first scan, but the order in which the detector peak is detected with respect to the center of scan length may reversed. Across the calibration tile may include across (e.g., substantially) a central portion of the calibration tile. The detector scan may begin and end at predetermined locations (e.g., of the target surface). Scanning the detector field of view may include a scan over the calibration tile in a first direction that is followed by one or more scans over a (e.g., different) calibration tile in a second (e.g., different) direction. For example, a (e.g., different) calibration tile may be generated for each (e.g., per) direction in which the detector field of view is scanned. Calibration tiles (e.g., for each scan direction) may be (e.g., substantially) the same (e.g., generated by the same energy beam parameters, on a same target surface) between detector field of view scans. A following (e.g., second) calibration tile may be in a vicinity of a prior (e.g., first) calibration tile. In a vicinity of may be within about 2 mm to about 20 mm.

At times, the detector (and its associated energy beam position) for which a detected peak signal occurs relatively later is positioned behind another detector (and its associated energy beam position), in the given direction of travel. In some embodiments, a first energy beam may be considered (e.g., well-) aligned with a second (e.g., overlapping) energy beam when a deviation in the time at which a peak detector signal occurs during the target heat source calibration is below a threshold level. At times, a threshold level may correspond to a distance at the target surface. For example, a deviation that is at or below a threshold level may correspond to an overlay deviation that is between about 5 microns to about 50 microns (e.g., along a given measurement axis), at the target surface.

In some embodiments, an adjustment to an overlay between a first energy beam and a second (e.g., overlapping) energy beam is from a target heat source calibration (e.g., detector overlay offset from a first detector scan and a second detector scan along a given axis). The detected deviation in the timing and/or position of the peak detector signals may be based on a detected deviation in the timing and/or position of the peak detector signals from the detector scans. The adjustment may be a correction (e.g., file) to a guidance system (e.g., scanner) configured to direct the energy beam (e.g., to which the detector is synchronized). The adjustment may be based on a calculated direction (e.g., and magnitude) of deviation between the detector fields of view (e.g., detector overlay offset, 2605).

In some embodiments, beam overlay offset correction data (e.g., of a guidance system) for two or more (e.g., 2, 4, 8, 12, 16, or 20) energy beams is based on (e.g., respective) target heat source calibrations. For example, a target heat source calibration (e.g., beam overlay offset compensation) may be performed for each of the multiple (e.g., two) energy beams (e.g., the energy beams configured to irradiate within an overlapping region of the target surface). Target heat source calibrations may be performed across various portions of a target surface (e.g., within overlapping regions). The generated beam overlay offset data points may be associated with a given location on the target surface, for example, within an overlapping region (e.g., of the processing fields of the energy beams).

In some embodiments, the beam overlay offset correction data points (e.g. compensation) are provided to a guidance system (e.g., including and/or operatively coupled with a controller) of the energy beam. The compensation may be implemented at a hardware, firmware, and/or software level (e.g., of the controller). The compensation may be implemented as a lookup table. The compensation may be implemented in situ and/or in real time (e.g., during operation of the energy beam). In some embodiments, a guidance system (e.g., a scanner) controls motion along independent axes. For example, control is independent for an x-axis and a y-axis. At times, (e.g., overlay) compensation data for (e.g., each) independent axes may be provided to the guidance system. For example, first compensation data may be generated to correct for multiple energy beam overlay offset positions (e.g., in an overlapping processing region) in the x-axis, and second compensation data may be generated to correct for multiple energy beam offset positions (e.g., in the overlapping processing region) in the y-axis. The data values of the overlay offset compensation may be in distance values (e.g., distance along the processing field). The data values of the overlay offset compensation may be in angular values (e.g., rotation angle of a (e.g., scanning) mirror). The overlay offset compensation data may include a combination of distance and angular values.

In some embodiments, the energy beam forms the target heat source with certain energy beam parameters. The energy beam parameters of the energy beam may be such that a detectable (e.g., thermal) signal persists at the target heat structure for a sufficient time for the synchronized detectors to detect (e.g., thermal) signals therefrom during the subsequent translation over the target heat source. For example, the (e.g., thermal) signal may persist from about 1 ms to about 100 ms, or from about 100 ms to about 500 ms.

In some embodiments, the energy beam parameters for generating the target heat source include energy beam dwell time (e.g., number of hatches), scale (e.g., footprint size), and/or power (e.g., power density). For example, the energy beam may (e.g., hatch) at the predetermined location of the target surface from between about 20 hatches to about 100 hatches, or from about 100 hatches to about 800 hatches. For example, the footprint of the energy beam may be between about 50 microns to about 600 microns (e.g., FLS of the diameter). For example, the energy source that generates the energy beam may output energy from between about 100 W to about 1000 W.

In some embodiments, detector parameters include a data capture rate of the detector and/or a translation speed (e.g., scanning speed) of the detector (e.g., a field of view thereof). For example, a data rate at which the detector generates detection data may be between about 50 kHz to about 200 kHz. For example, the detector (e.g., field of view) may translate between about 100 mm/s to about 2000 mm/s. As described herein the detector may be configured as a bore-sight detector, and/or a co-incident detector.

At times, improved accuracy of the beam overlay offset calibration is attained by performing multiples of the target heat source calibration steps (e.g., iteratively). For example, multiple measurements (e.g., cycles) may be performed (e.g., generating a target heat source, scanning with (e.g., at least two) detectors, comparison of position and/or timing of peak signal, generating compensation data). The compensation data may be averaged over the multiple calibrations, and this (e.g., averaged) compensation data may be provided to the (e.g., respective) guidance systems. In some embodiments, outliers in the measurement data are removed (e.g., to improve compensation quality). For example, outliers may be identified for removal using a (e.g., median) filter. For example, outliers may be removed by (e.g., adjusting) using a smoothing filter.

At times, an alignment of a detector that is arranged to follow the processing location of an energy beam on the target material requires calibration. A detector-energy beam calibration may include alignment a field of view of the detector with the energy beam (e.g., a cross section of the energy beam) position at the target surface. An alignment of the field of view may be based on bringing a center portion of the detector field of view into coincidence with a center portion of the energy beam (e.g., a cross section thereof) position on the target surface. An alignment of the field of view may be based on bringing one or more edges of the detector field of view into coincidence with one or more edges of the energy beam (e.g., a cross section thereof) position on the target surface. A detector-energy beam calibration may be performed by manual and/or automatic control. The control may be before, after, and/or during the operation of the energy beam. Controlling can be before, during, or after processing of the one or more materials.

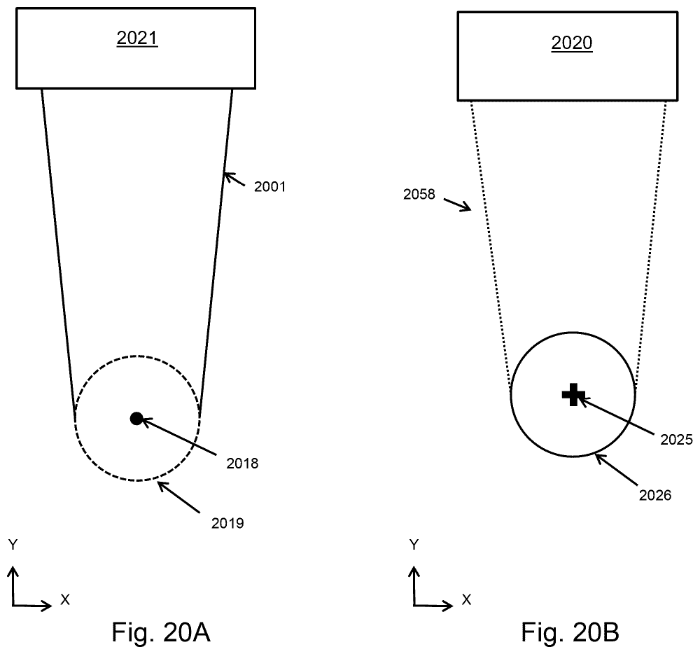

FIG. 20A depicts an example of an energy beam position (e.g., footprint) on a target surface. In the example of FIG. 20A, an energy source 2021 generates an energy (e.g., beam) 2001 that is incident on a (e.g., target) surface. A cross-section of an energy beam that is incident on a (e.g., target) surface may be referred to as a “footprint” of the energy beam. In the example of FIG. 20A, a footprint 2019 of the energy beam (depicted as a dashed line) has a center position 2018 (depicted as a solid dot). FIG. 20B depicts an example of a detector field of view position on a (e.g., target) surface. In the example of FIG. 20B, a detector 2020 receives signals within a (e.g., conical) volume 2058 that intersects a (e.g., target) surface over an area 2026. An intersection of a detector field of view at a (e.g., target) surface may be referred to as a “detector window” or simply “the field of view” of the detector. In the example of FIG. 20B, the field of view 2026 of the detector (depicted as a dashed-double dot line) has a center position 2025 (depicted as a solid cross).

A detector (e.g., detection system) may be configured to focus upon and/or follow an energy beam position on a target surface (e.g., in a synchronized manner). For example, the detector field of view may be synchronized with the energy beam footprint. Following may be during a (e.g., vectoral) translation of the energy beam (e.g., across a target surface). The energy beam may translate along a (e.g., predetermined) path. Following may be during a dwell of the energy beam on the target surface (e.g., having substantially no movement across the target surface). The detector may be disposed within the enclosure (e.g., of the 3D printing system). The detector may be disposed on a wall of the enclosure. The detector may be disposed external to the enclosure. The detector may have an optical path that is shared (e.g., at least a portion thereof) with an optical path of a guidance system (e.g., a scanner) that is configured to direct the energy beam. The detector may not (e.g., substantially) share a portion of an optical path with an optical path of a guidance system (e.g., a scanner) that is configured to direct the energy beam. A detector-energy beam arrangement that shares (e.g., at least a portion of) an optical path may be referred to as a “bore-sight” arrangement. A detector-energy beam arrangement that (e.g., substantially) does not share an optical path may be referred to as a “co-incident” arrangement.

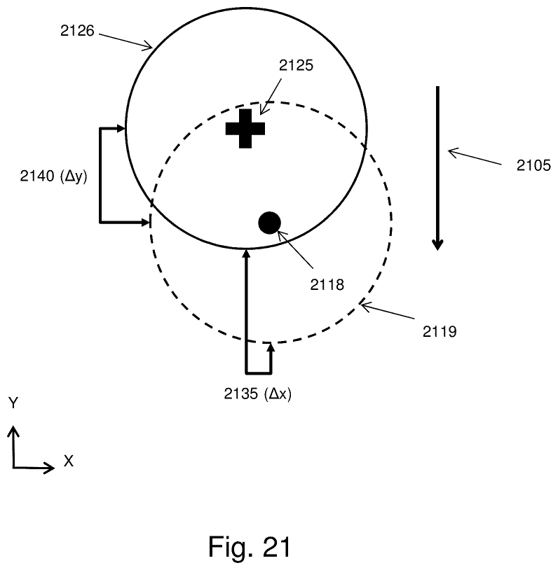

FIG. 21 shows an example of relative positions (e.g., an alignment) of a detector field of view and an energy beam footprint. In the example of FIG. 21, a detector-energy beam (e.g., co-incident and/or boresight) arrangement is translating in a direction 2105 across a (e.g., target) surface. In the example of FIG. 21, the energy beam includes a footprint 2119 having a central position 2118. As depicted in FIG. 21, the detector field of view 2126 includes a central position 2125. An alignment (e.g., deviation thereof) between the energy beam footprint and the detector field of view may be determined by a (e.g., at least one) calibration. For example, a magnitude and direction of any deviation in an x-axis direction and/or a y-axis direction may be determined. In the example of FIG. 21, the deviation between the energy beam central position 2125 and the detector field of view center position is given by an x-axis deviation 2135 and a y-axis deviation 2140.

In some embodiments, the (e.g., co-incident and/or boresight) detector is operable to measure (e.g., heat) signals generated at the target surface by the energy beam. The temperature profile of the target surface in a vicinity of the translating energy beam may be based on a path of the energy beam. For example, portions of the target surface that have (e.g., recently) been irradiated by the energy beam may be at a higher temperature than portions of the target surface that are being irradiated, and/or portions of the target surface that have yet to be irradiated. For an energy beam traveling in a (e.g., substantially) straight line, a temperature of the target surface may be relatively higher in a region behind the irradiating energy beam (e.g., with respect to the energy beam movement), as compared to a region that is (e.g., currently) being irradiated. Relatively higher may be with respect to a temperature of the target material at a (e.g., current) irradiation position of the energy beam. A temperature of the target surface may be relatively lower in a region ahead of the irradiating energy beam (e.g., with respect to the energy beam movement), as compared to a region that is (e.g., currently) being irradiated. At times, for a given irradiating energy beam, a detector having a field of view centered behind the energy beam footprint may detect a relatively higher signal than a detector having a field of view centered on the energy beam footprint. At times, for a given irradiating energy beam, a detector having a field of view centered ahead of the energy beam footprint may detect a relatively lower signal than a detector having a field of view centered on the energy beam footprint.

In some embodiments, a detector-energy beam alignment calibration comprises monitoring (e.g., an intensity of) a detected signal of the detector while translating the energy beam across a (e.g., target) surface. Translating the energy beam may include a translation in a first direction that is followed by a translation in a second (e.g., different) direction (e.g., a “zig-zag translation”). A detector-energy beam calibration including a zig-zag translation may determine an alignment of the detector field of view with the energy beam footprint along a given axis (e.g., an axis including the zig-zag translation). The second direction of the translation may be at an angle with respect to the first direction of the translation. The second direction of the translation may have a vector component in common with the first direction (e.g., along an x-axis, along a y-axis). The angle may be (e.g., substantially) 180 degrees (e.g., the second direction may be anti-parallel to the first direction). The angle of the second direction with respect to the first direction may be greater than 90 degrees. The (e.g., absolute value of the) angle of the second direction with respect to the first direction may be between about 90 degrees and about 180 degrees. The (e.g., absolute value of the) angle of the second direction with respect to the first direction may be between about 0 degrees and about 90 degrees.

For example, a zig-zag translation may include a (e.g., first) translation (e.g., a hatch) in a positive x direction along the x-axis, and a (e.g., second) translation in a negative x direction along the x-axis. For example, a zig-zag translation may include a (e.g., first) translation (e.g., a hatch) in a positive y direction along the y-axis, and a (e.g., second) translation in a negative y direction along the y-axis. While the energy beam is irradiating (e.g., heating) the target surface, the (e.g., intensity of the) signal generated by the detector in response to the (e.g., radiation from returning energy beams) irradiation is measured. The (e.g., intensity of the) detector signal (e.g., thermal signal) measured during irradiation in the first direction may be compared with the (e.g., intensity of the) detector signal measured during irradiation in the second direction. The comparison of the first direction detector signal and the second direction detector signal may form a ratio. The ratio may be based on a characteristic of the detector signal. The characteristic of the detector signal may be, for example, an average signal value or an average signal voltage. The characteristic of the detector signal may be measured over time and/or position (e.g., of the energy beam during translation along a given direction). The characteristic of the detector signal may be considered for a portion of the energy beam translation (e.g., during a constant-velocity portion of the energy beam translation).

Without wishing to be bound by theory, a detector field of view that is (e.g., substantially) aligned with (e.g., centered on) an energy beam footprint will generate a detector signal that is (e.g., substantially) direction-invariant. Direction-invariant may refer to a detector signal that does not vary based on a (e.g., synchronized) direction of movement of the detector field of view and/or the energy beam (e.g., irradiation) on the target surface. As described, a detector field of view that is behind (e.g., with respect to a direction of motion) an energy beam footprint may have a correspondingly greater detector signal as compared to a detector field of view that is centered on the energy beam footprint. As described, a detector field of view that is ahead of (e.g., with respect to a direction of motion) an energy beam footprint may have a correspondingly lesser detector signal as compared to a detector field of view that is centered on the energy beam footprint.

At times, any deviation between a detector signal corresponding to energy beam translation in a first direction compared to the detector signal corresponding to the energy beam translation in a second direction is measured. For example, a ratio between the first direction detector signal and the second direction detector signal may be indicative of an alignment of the detector field of view with the energy beam footprint. For example, a ratio that is near a value of 1 may indicate that the detector field of view is well-aligned (e.g., nearly centered) with the energy beam footprint. For a ratio that is not near 1, the detector field of view may not be well-aligned (e.g., along the axis of the first and second direction of travel). At times, the direction in which the detected signal is higher may correspond to a detector field of view that may be positioned behind the energy beam footprint, in the given direction of travel. At times, the direction in which the detected signal is lower may correspond to a detector field of view that may be positioned ahead of the energy beam footprint, in the given direction of travel. In some embodiments, a detector may be considered (e.g., well-) aligned with an energy beam when a deviation in the detector signal during a translation calibration is below a threshold level. For example, a threshold level may correspond to a signal difference that is about 10% or below. At times, a threshold level may correspond to a distance at the target surface. For example, a deviation that is at or below a threshold level may correspond to an alignment deviation that is between about 5 microns to about 50 microns (e.g., along a given measurement axis), at the target surface.

In some embodiments, an adjustment to an alignment between a detector field of view and an energy beam footprint is based on a detected deviation in the detector signal. The detected deviation in the detector signal may be from an energy beam translation calibration (e.g., a zig-zag translation). The adjustment may be to an optical element (e.g., a lens, a mirror, a beam splitter) to adjust a (e.g., relative) position of the detector field of view (e.g., with respect to the energy beam footprint). The adjustment may be based on a calculated direction (e.g., and magnitude) of deviation between the detector field of view and the energy beam footprint. For example, a higher detector signal traveling in a (e.g., positive x) direction may correspond to a detector that is aligned behind (e.g., relative to a movement of) the energy beam in that direction. An adjustment may include relative movement of the detector field of view in the same direction (e.g., positive x) to bring the detector field of view into alignment with the energy beam footprint. For example, a lower detector signal traveling in a (e.g., negative x) direction may correspond to a detector that is aligned ahead of (e.g., relative to a movement of) the energy beam in that direction. An adjustment may include relative movement of the detector field of view in the opposite direction (e.g., positive x) to bring the detector field of view into alignment with the energy beam footprint. A magnitude of the deviation may be indicative of a (e.g., relative) magnitude of mis-alignment of the detector field of view with the energy beam footprint. A magnitude of the deviation may correspond to a (e.g., relative) magnitude of adjustment to the detector field of view (e.g., relative to the energy beam footprint). The adjustment of the detector field of view may be according to an algorithm (e.g., controlled). The control may be manual and/or automatic. The control may be programmed and/or be effectuated at whim. The control may be according to an algorithm.

In some embodiments, several repetitions of the detector-energy beam alignment calibration are performed to improve the adjustment of the detector field of view with the energy beam footprint. In some embodiments, adjustment to the detector field of view is made based on an average of the detector signal after several repetitions of measuring the detector signal during the energy beam translations (e.g., the zig-zag translation). In some embodiments, the detector signal data is modified (e.g., filtered by a smoothing and/or median filter) to remove outlier data in the deviation calculation during the several repetitions. In some embodiments, adjustment to the detector field of view is made following each of several repetitions of measuring the detector signal during the energy beam translations (e.g., the zig-zag translation).

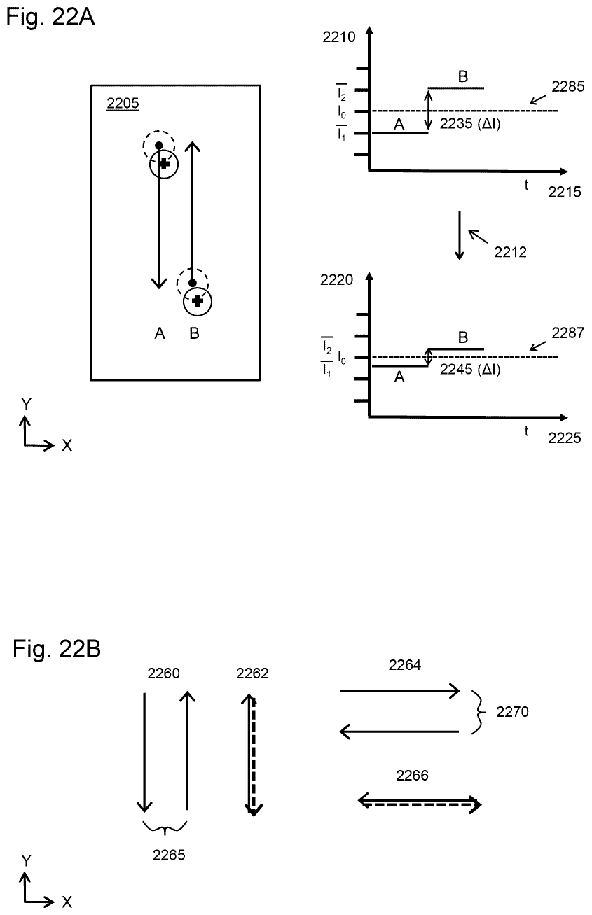

FIG. 22A shows an example of a detector-energy beam calibration including translation of the energy beam in a first and a second direction (e.g., a zig-zag translation). In the example of FIG. 22A, an energy beam translates along a target surface 2205 in a (e.g., first) path A and a (e.g., second) path B. FIG. 22A depicts an energy beam footprint (dashed circle with center dot) and a detector field of view (dash-dot circle with a center cross) having a relative alignment therebetween. In the example of FIG. 22A, the detector field of view is ahead of the energy beam footprint along the path A, and behind the energy beam footprint in the path B. Also shown in FIG. 22A is a plot of a detector signal (e.g., intensity) 2210 as a function of time (e.g., during energy beam translation). As depicted in the plot of FIG. 22A, during the energy beam translation along the path A the detector signal has a (e.g., average) value of I₁, and during the energy beam translation along the path B the detector signal has a (e.g., average) value of I₂. A comparison of the detector signals from the first and the second directions of translation may be made in a detector-energy beam alignment calibration. In the example of FIG. 22A, a deviation in the detector signal intensity between the first path A and the second path B is depicted (e.g., FIG. 22A, 2235). An expected signal for a well-aligned detector (e.g., centered on an energy beam footprint) is depicted with a dotted line (e.g., FIG. 22A, 2285).

In some embodiments, an adjustment to the position of the detector (e.g., field of view thereof) is made, based on the detected deviation in the detector signals between the first and the second translations. Because of the adjustment, the detector field of view may be brought into (e.g., closer) alignment with the energy beam (e.g., footprint). Bringing a detector field of view into closer alignment may include a corresponding increase in the detector signal along the translation direction that (e.g., pre-adjustment) had the low(er) detector signal, and/or a corresponding decrease in the detector signal along the translation direction that (e.g., pre-adjustment) had the high(er) detector signal.

FIG. 22A depicts, following an adjustment to the detector field of view (e.g., FIG. 22A, 2212), a plot of a detector signal (e.g., intensity) 2220 as a function of time 2225 (e.g., during energy beam translation). As depicted in the (after-adjustment) plot of FIG. 22A, during the energy beam translation along the path A the (e.g., adjusted) detector signal has a (e.g., average) value (e.g., a higher value) that is closer to an expected detector signal 2287. As depicted in the (after-adjustment) plot of FIG. 22A, during the energy beam translation along the path B the detector signal has a (e.g., average) value (e.g., a lower value) that is closer to an expected detector signal 2287. As depicted in the (after-adjustment) plot of FIG. 22A, an adjusted deviation 2245 between the detector signal in the path A compared to the detector signal in the path B has been reduced (e.g., compared to the pre-adjustment condition). In some embodiments, an alignment of a detector field of view with the energy beam footprint along a given axis (e.g., in an x-axis, in a y-axis) may be calibrated by the energy beam translation (e.g., zig-zag) calibration along the given axis. At times, a calibration may first be performed along one axis, and subsequently be performed along an (e.g., orthogonal) axis.

In some embodiments, the energy beam translations follow several paths. For example, the first translation may be parallel to a given processing axis (e.g., along positive x-axis), and a second (e.g., subsequent) translation may be anti-parallel (e.g., along negative x-axis). For example, the (e.g., third) translation may be parallel to a given processing axis (e.g., along positive y-axis), and a (e.g., fourth) translation may be anti-parallel (e.g., along negative y-axis). In some embodiments, a subsequent energy beam translation (e.g., second translation) follows (e.g., substantially) on the same location as the prior energy beam translation (e.g., first translation). There may exist a delay between the first energy beam translation (e.g., the zig) and the second energy beam translation (e.g., the zag) sufficient for any remaining heat in the target surface to dissipate prior to the second translation. In some embodiments, a subsequent energy beam translation (e.g., second translation) follows (e.g., substantially) at a remove from the location of the prior energy beam translation (e.g., first translation) (e.g., within about 2 mm to about 10 mm). In some embodiments, the target surface condition prior to initiation of the first energy translation and the second energy translation are (e.g., substantially) the same (e.g., a “cold” target surface).

FIG. 22B depicts examples of energy beam paths during a detector-energy beam alignment calibration. In the example of FIG. 22B, a path pair (e.g., corresponding with a first energy beam translation and a second energy beam translation) 2260 along the y-axis is depicted having a distance between the paths of 2265. In the example of FIG. 22B, a path pair 2262 along the y-axis shows paths at (e.g., substantially) the same location on the target surface. A second of the energy beam translations (e.g., the dashed line) may be performed after a sufficient time elapse such that the heat of the target surface introduced by the first energy beam translation has (e.g., substantially) dissipated. In the example of FIG. 22B, a path pair 2264 along the x-axis is depicted having a distance between the paths of 2270. In the example of FIG. 22B, a path pair 2266 along the x-axis shows paths at (e.g., substantially) the same location on the target surface.

In some embodiments, the energy beam irradiation during the detector-energy beam calibration is of sufficient power (e.g., power density) and speed to generate a heated region on the target surface that persists such that the detector detects a signal therefrom. For example, a speed of the energy beam translation may be between about 10 mm/second to about 2000 mm/second. For example, a size (e.g., FLS) of the energy beam may be between about 50 microns to about 1000 microns. For example, an energy output of an energy source generating the energy beam may be about 10 Watts (W) to about 2000 W. For example, a data rate at which the detector generates detection data may be between about 50 kHz to about 200 kHz.

At times, the energy beam irradiates a target surface that is outside of a processing area (e.g., not over the material bed) of the 3D printing system. At times, the energy beam may irradiate a target surface that is within the processing area of the 3D printing system (e.g., over the material bed comprising pre-transformed and/or transformed material). The energy beam may be directed to irradiate a target structure comprising a suitable material that has a high melting point. A high melting point may correspond to a melting point that is between about 1100 to about 3500 C. The suitable material of the target structure may have a low thermal conductivity, for example, a thermal conductivity that is between about 10 W/mK to about 200 W/mK. The suitable material of the target structure may have a coefficient of thermal expansion that is between about 0.5 micron/m*K to about 20 micron/m*K. Examples of suitable materials include graphite, tungsten carbide, and tantalum.

At times, a target surface is covered (e.g., at least partially) by a material (e.g., pre-transformed material and/or contaminant(s), such as soot). In some embodiments, the detector-energy beam alignment calibration comprises cleaning a (e.g., to-be irradiated) target surface prior to directing the (e.g., translating) energy beam at the target surface. The target surface can be any target surface as disclosed herein. A cleaning process may comprise directing the irradiating beam onto the covered surface (e.g., ablating). Cleaning may comprise material removal by means of a moving apparatus (e.g., a translating blade, a squeegee, a grinder, a polisher, and/or a rolling wheel), by directing a flow of gas (e.g., gas jet), directing a flow of particulate matter (e.g., sputtering), by a chemical process (e.g., etching), and/or by suction (e.g., vacuum). The cleaning of the target surface may comprise a portion of the benchmarking and/or subsequent detector-energy beam alignment calibration processes (e.g., may comprise an initial step thereof). The cleaning of the target surface may be performed before, during, and/or after a 3D printing process. The cleaning of the target surface may be performed in real time (e.g., during operation of the irradiating beam). The cleaning process may be performed by a controller (e.g., automatic, computer, or manual). At times, the cleaning process may be controlled by at least one controller and/or manually. At times, the cleaning process may be performed by different controllers. The controller may be any controller described herein.

In some embodiments, a detector-energy beam alignment calibration comprises generation of a heat source (e.g., a tile) at a (e.g., target) surface by an energy beam, followed by a translation (e.g., a scan) of a (e.g., synchronized) detector field of view over the heat source. Synchronized may refer to a detector field of view that is coupled with and configured to follow (e.g., a location of) an energy beam of the 3D printing system. A detector-energy alignment calibration including a generated heat source (e.g., a calibration tile) and subsequent (e.g., at least two) scans by the detector field of view may be referred to herein as a “scanned tile” calibration.

In some embodiments, the calibration tile is generated by a dwell of the energy beam on the target surface. The calibration tile may be at a predetermined location on the target surface. The calibration tile may have a predetermined shape and/or size. For example, a size of about 0.5 mm to about 5 mm (e.g., FLS of a tile diameter). The energy beam that forms the calibration tile may be the same energy beam with which the detector field of view is synchronized. The energy beam that forms the calibration tile may be a different energy beam from that with which the detector field of view is synchronized. The calibration tile may be formed with energy beam parameters such that a detectable signal persists at the tile for a sufficient time for the detector to be scanned across the calibration tile and detect (e.g., thermal) signals therefrom. For example, the (e.g., thermal) signal from the calibration tile may persist from about 1 ms to about 100 ms, or from about 100 ms to about 500 ms. The energy beam parameters may include energy beam dwell time, scale (e.g., footprint size), and/or power (e.g., power density). For example, the energy beam may dwell at the predetermined location of the target surface from between about 10 ms to about 1500 ms. For example, the footprint of the energy beam may be between about 100 microns to about 600 microns (e.g., FLS of the diameter). For example, the energy source that generates the energy beam may output energy from between about 100 W to about 1000 W. Detector parameters may include a data capture rate of the detector and/or a translation speed (e.g., scanning speed) of the detector (e.g., a field of view thereof). For example, a data rate at which the detector generates detection data may be between about 50 kHz to about 200 kHz. For example, the detector (e.g., field of view) may translate between about 100 mm/s to about 2000 mm/s. As described herein the detector may be configured as a bore-sight detector, and/or a co-incident detector (e.g., as described herein).

In some embodiments, a scanned tile calibration comprises monitoring (e.g., an intensity of) a detected signal of the detector (e.g., that is synchronized with the energy beam location) as a function of position and/or time, while translating (e.g., scanning) the detector field of view across a calibration tile in a first direction. The detector scan may be at a predetermined speed. The scanned tile calibration may include determining a location (e.g., over the calibration tile) and/or time (e.g., during the first scan) at which a peak in the detector signal is reached during the scan. For example, a plot of the detector signal as a function of a location on the target surface (e.g., including the calibration tile) may be generated. A second calibration tile may be generated across which the detector field of view may be scanned in a second direction (e.g., a direction anti-parallel to the first direction). During the second detector scan the detector may generate a detector signal having a (e.g., substantially) equal magnitude to that of the first scan, but the order in which the detector peak is detected with respect to the center of scan length may reversed. Across the calibration tile may include across (e.g., substantially) a central portion of the calibration tile. The detector scan may begin and end at predetermined locations (e.g., of the target surface). Scanning the detector field of view may include a scan over the calibration tile in a first direction that is followed by one or more scans over a (e.g., different) calibration tile in a second (e.g., different) direction. For example, a (e.g., different) calibration tile may be generated for each (e.g., per) direction in which the detector field of view is scanned. Calibration tiles (e.g., for each scan direction) may be (e.g., substantially) the same (e.g., generated by the same energy beam parameters, on a same target surface) between detector field of view scans. A following (e.g., second) calibration tile may be in a vicinity of a prior (e.g., first) calibration tile. In a vicinity of may be within about 2 mm to about 20 mm.

In some embodiments, a scanned tile calibration determines an alignment of the detector field of view with the (e.g., synchronized) energy beam footprint along a given axis (e.g., an axis including the first and second detector field of view scans). The second scan direction may be at an angle with respect to the first scan direction. The second scan direction may share a vector component with the first scan direction. The shared vector component may include an opposing direction from the first scan to the second scan. The angle may be (e.g., substantially) 180 degrees (e.g., the second scan direction may be anti-parallel to the first scan direction). The angle of the second scan direction with respect to the first scan direction may be greater than 90 degrees. The (e.g., absolute value of the) angle of the second scan direction with respect to the first scan direction may be between about 90 degrees and about 180 degrees. The (e.g., absolute value of the) angle of the second scan direction with respect to the first scan direction may be between about 0 degrees and about 90 degrees.

Without wishing to be bound by theory, a detector field of view that is (e.g., substantially) aligned with (e.g., centered on) an energy beam footprint will generate a detector signal that is (e.g., substantially) direction-invariant. An aligned detector field of view may be synchronized (e.g., moves in coordination) with an energy beam footprint. Direction-invariant may refer to a detector signal that does not vary based on a (e.g., synchronized) direction of movement of the detector field of view and/or the energy beam (e.g., irradiation) on the target surface. A detector field of view that is behind (e.g., with respect to a direction of motion) an energy beam footprint may have a corresponding peak detector signal (e.g., during a detector scan over a calibration tile) that occurs at a later time (e.g., as compared to a detector field of view that is centered on the energy beam footprint). A detector field of view that is ahead of (e.g., with respect to a direction of motion) an energy beam footprint may have a corresponding peak detector signal (e.g., during a detector scan over a calibration tile) that occurs at an earlier time (e.g., as compared to a detector field of view that is centered on the energy beam footprint).

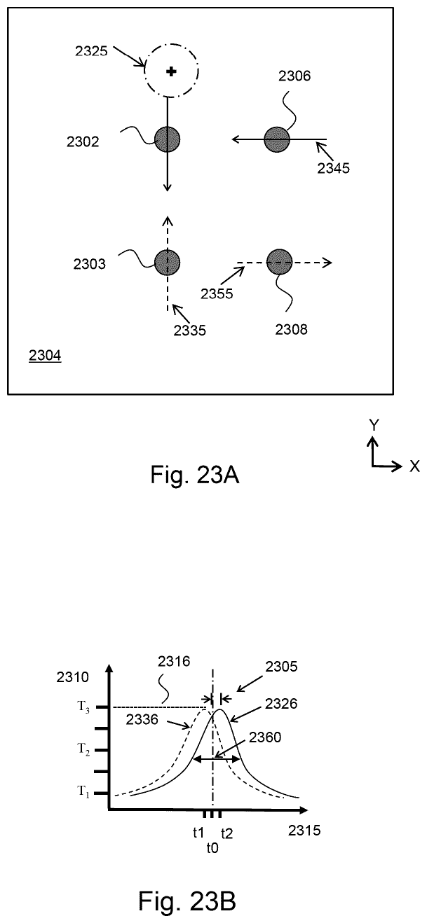

FIG. 23A depicts a portion of a target surface 2304 on which a scanned tile calibration is performed. In the example of FIG. 23A, a number of calibration tiles (2302, 2303, 2306, and 2308) are generated, each calibration tile having an associated detector scan across its surface (e.g., 2325, 2335, 2345, and 2355, respectively) along a given direction. FIG. 23A depicts in solid lines first detector scans along a given axis (e.g., 2302 and 2345 for negative y and negative x, respectively), and in dashed lines second detector scans that are anti-parallel to the first scans along the given axis (e.g., 2335 and 2355 for positive y and positive x, respectively). During a scanned tile calibration, a detector signal (e.g., corresponding to a detected temperature) may be plotted as a function of time and/or position. A time and/or position at which a detector signal peak occurs for a given detector scan (e.g., direction) over a calibration tile may be indicative of a detector alignment with an energy beam footprint. For example, a deviation between a detected detector signal peak location over a calibration tile in a first scan direction and a detected detector signal peak location over a calibration tile in a second (e.g., anti-parallel) scan direction may be determined.

For example, a comparison between a (e.g., calculated) position on the calibration tile at which a peak in the detector signal occurs may be indicative of an alignment of the detector field of view with the energy beam footprint. A calculated position at which a peak detector signal occurs may be based on a path of the detector scan across the calibration tile, including a (e.g., predetermined) starting and/or ending location of the scan and a (e.g., predetermined) scan speed of the detector field of view. For example, a detector scan may be configured such that a center position of the detector scan (e.g., along a target surface) corresponds with a center position of a calibration tile. For example, a detector scan may be configured such that a half-way point (e.g., half a total scan time) corresponds with a center position of a calibration tile.

FIG. 23B depicts an example of detector signals 2326 and 2336 corresponding to first and second detector scans, respectively (e.g., to FIG. 23A scans 2325 and 2335, or scans 2345 and 2355). FIG. 23B depicts a temperature detected 2310 as a function of time 2315 (e.g., during the detector scans). At times, a scan time may be correlated to a position on the target surface and/or over the calibration structure (e.g., as a function of initial position and detector scan speed). At times, a (e.g., relative) difference in a detector scan time at which a peak detector signal occurs between a first detector scan and a second detector scan may be indicative of a (e.g., relatively) mis-aligned detector field of view and energy beam footprint. In the example of FIG. 23B, a difference between the first and the second detector scans in the (e.g., respective) detector scan time at which a peak detector signal 2316 occurs is given by 2305. In some embodiments, an offset of the detector field of view along the given scan direction may be determined, based on the difference. In some embodiments, the offset may be determined as a dimension (e.g., in microns) of the detector field of view alignment with the energy beam footprint at the target surface. For example, the offset of the detector field of view may be determined as half of the (e.g., calculated) offset from the first detector scan and the second detector scan (e.g., FIG. 23B, 2305).

At times, the direction of scan movement having a (e.g., relatively) later detected peak signal corresponds to the detector field of view positioned behind the energy beam footprint, in the given direction of travel. At times, the direction in which the detected peak signal occurs (e.g., relatively) earlier may correspond to a detector field of view that may be positioned ahead of the energy beam footprint, in the given direction of travel. In some embodiments, a detector may be considered (e.g., well-) aligned with an energy beam when a deviation in the time at which a peak detector signal occurs during the scanned tile calibration is below a threshold level. At times, a threshold level may correspond to a distance at the target surface. For example, a deviation that is at or below a threshold level may correspond to an alignment deviation that is between about 5 microns to about 50 microns (e.g., along a given measurement axis), at the target surface.

In some embodiments, an adjustment to an alignment between a detector field of view and an energy beam footprint is from a scanned tile calibration (e.g., a first detector scan and a second (anti-parallel) detector scan along a given axis). The detected deviation in the timing and/or position of the peak detector signals may be based on a detected deviation in the timing and/or position of the peak detector signals from the detector scans. The adjustment may be to an optical element (e.g., a lens, a mirror, a beam splitter) to adjust a (e.g., relative) position of the detector field of view (e.g., with respect to the energy beam footprint). The adjustment may be based on a calculated direction (e.g., and magnitude) of deviation between the detector field of view and the energy beam footprint. For example, a detector field of view that is behind (e.g., with respect to a direction of motion) an energy beam footprint may have a corresponding peak detector signal (e.g., during a detector scan over a calibration tile) that occurs at a later time (e.g., as compared to a detector field of view that is centered on the energy beam footprint). A detector field of view that is ahead of (e.g., with respect to a direction of motion) an energy beam footprint may have a corresponding peak detector signal (e.g., during a detector scan over a calibration tile) that occurs at an earlier time (e.g., as compared to a detector field of view that is centered on the energy beam footprint). An adjustment may include a compensatory movement of the detector field of view in order to bring the detector field of view into alignment with the energy beam footprint. For example, an earlier detector signal traveling in a given (e.g., negative x) direction may correspond to a detector that is aligned ahead of (e.g., relative to a movement of) the energy beam in that direction. An adjustment may include relative movement of the detector field of view in the opposite direction (e.g., positive x) in order to bring the detector field of view into alignment with the energy beam footprint. For example, a later detector signal traveling in a given (e.g., positive x) direction may correspond to a detector that is aligned behind (e.g., relative to a movement of) the energy beam in that direction. An adjustment may include relative movement of the detector field of view in the same direction (e.g., positive x) as the lagging detector, in order to bring the detector field of view into alignment with the energy beam footprint. Orthogonal axes of the detector field of view alignment may be calibrated independently. Orthogonal axes of the detector field of view alignment may be calibrated together. A magnitude of the offset deviation (e.g., FIG. 23B, 2305) may be indicative of a (e.g., relative) magnitude of mis-alignment of the detector field of view with the energy beam footprint. A magnitude of the deviation may correspond to a (e.g., relative) magnitude of adjustment to the detector field of view (e.g., relative to the energy beam footprint). The adjustment of the detector field of view may be according to an algorithm (e.g., controlled). The control may be manual and/or automatic. The control may be programmed and/or be effectuated at whim. The control may be according to an algorithm.

In some embodiments, several repetitions of the scanned tile calibration are performed to improve the adjustment of the detector field of view with the energy beam footprint. In some embodiments, adjustment to the detector field of view is made based on an average of the detector signals after several repetitions of measuring the detector signal during the detector scans. In some embodiments, the detector signal data is modified (e.g., filtered by a smoothing and/or median filter) to remove outlier data in the deviation calculation during the several repetitions. In some embodiments, adjustment to the detector field of view is made following each of several repetitions of measuring the detector signal during the detector scans.

At times, a detector (e.g., predetermined) maximum peak signal corresponds with a detector field of view that is aligned with the energy beam footprint. For example, for an aligned detector field of view having a Gaussian signal profile, the maximum detector peak may correspond to the center of the energy beam footprint (e.g., as a maximal heated area of a target surface from the energy beam may be detected from this centered position). At times an aligned detector field of view with the energy beam footprint generates a (e.g., relatively) higher peak thermal signal (e.g., than a non-aligned detector field of view). At times, a detector that is not aligned may exhibit a (e.g., relatively) lower than peak thermal signal along an orthogonal axis to the direction of the detector scan axis (e.g., during the scanned tile calibration). That is, if the detector field of view is aligned along a first axis (e.g., an x axis) and is not aligned along an orthogonal axis (e.g., the y axis), the detector may exhibit a peak thermal signal that is shifted for the y axis detector scans, and a lower than peak thermal signal that is not shifted for the x axis detector scans. At times, a detector that is not (e.g., well-) aligned in either orthogonal axis (e.g., x and y) exhibits a lower than maximal peak thermal signal for each detector scan. At times, a detector that is not (e.g., well-) aligned in either orthogonal axis (e.g., x and y) exhibits a shifted peak thermal signal for each detector scan (e.g., a detector peak that does not correspond with a center of the respective calibration tile).

At times, a size of a detector field of view is determined by a scanned tile calibration. For example, a diameter of a detector field of view may be determined according to a measure of the detector signal, such as a width of the signal (e.g., FIG. 23B, 2360) during a detector scan (e.g., a full-width half maximum (FWHM)). A width of the detector signal (e.g., FWHM) may be at a maximum for a detector that is aligned along an orthogonal axis to an axis of movement (e.g., a detector aligned along the x axis generates a peak FWHM for movement in the y axis). At times, a plurality (e.g., multiplicity) of scanned tile calibrations are performed across several locations of the detector and/or energy beam field of view and/or processing field.

At times, the generated heat source for the scanned tile calibration is formed on a target surface that is outside of a processing area (e.g., not over the material bed) of the 3D printing system. At times, the generated heat source may be formed on a target surface that is within the processing area of the 3D printing system (e.g., over the material bed comprising pre-transformed and/or transformed material). For example, the calibration tile may be formed by transforming pre-transformed material in the material bed. In some embodiments, a calibration tile is formed during a build cycle. For example, a calibration tile may be formed on a layer during a build, at a location that does not interfere with any (e.g., forming) 3D object. In some embodiments, a calibration tile formed of transformed (e.g., hardened) material may be attached to a 3D printing system platform base. Attached to a platform base may comprise attachment by supports and/or auxiliary structures. In some embodiments, a calibration tile formed of transformed (e.g., hardened) material may not be attached to a 3D printing system platform base (e.g., the calibration tile may be anchorless in the material bed). Forming the calibration tile may include the energy beam irradiating a target structure comprising a suitable material that has a high melting point. A high melting point may correspond to a melting point that is between about 1100° C. to about 3500° C. The suitable material of the target structure may have a low thermal conductivity, for example, a thermal conductivity that is between about 10 W/mK to about 200 W/mK. The suitable material of the target structure may have a coefficient of thermal expansion that is between about 0.5 micron/m*K to about 20 micron/m*K. Examples of suitable materials include Inconel, graphite, tungsten carbide, and tantalum.

In some embodiments, the suitable material comprises any material disclosed herein. The target structure can comprise two or more elemental metals, two or more metal alloys, two or more ceramics, and/or two or more allotropes of elemental carbon. For example, an elemental metal and a metal alloy, an elemental metal and a ceramic, an elemental metal and an allotrope of elemental carbon, a metal alloy and a ceramic, a metal alloy, and an allotrope of elemental carbon, a ceramic and an allotrope of elemental carbon. The target structure may comprise one or more salts or oxides. A target structure can be formed as a regular or irregular shaped solid. The target structure material and/or shape may be any as described in patent application number PCT/US18/12250, which is incorporated herein in its entirety. The target structure may have a 3D shape. The 3D shape may comprise a cuboid (e.g., cube), or a tetrahedron. One or more (e.g., at least one) surfaces of the target structure may be substantially planar (e.g., smooth). A substantially planar surface of a target structure can be disposed (e.g., adjacent to the target surface) in a field of view of a detector.

At times, a target surface of the (e.g., scanned tile) calibration is covered (e.g., at least partially) by a material (e.g., pre-transformed material and/or contaminant(s), such as soot). In some embodiments, the scanned tile calibration comprises cleaning a (e.g., to-be irradiated) target surface prior to generation of the heat source and directing the (e.g., translating) detector field of view over the target surface. The target surface can be any target surface as disclosed herein. A cleaning process may comprise directing the irradiating beam onto the covered surface (e.g., ablating). Cleaning may comprise material removal by means of a moving apparatus (e.g., a translating blade, a squeegee, a grinder, a polisher, and/or a rolling wheel), by directing a flow of gas (e.g., gas jet), directing a flow of particulate matter (e.g., sputtering), by a chemical process (e.g., etching), and/or by suction (e.g., vacuum). The cleaning of the target surface may comprise a portion of the benchmarking and/or subsequent scanned tile calibration processes (e.g., may comprise an initial step thereof). The cleaning of the target surface may be performed before, during, and/or after a 3D printing process. The cleaning of the target surface may be performed in real time (e.g., during operation of the irradiating beam). The cleaning process may be performed by a controller (e.g., automatic, computer, or manual). At times, the cleaning process may be controlled by at least one controller and/or manually. At times, the cleaning process may be performed by different controllers. The controller may be any controller described herein.

In some embodiments, a controller is operatively coupled to at least one component of the detection system. The controller may control the amount of translation of the variable focus system. The controller may adjust the position of the optical elements to vary the cross-section of the transforming beam. The controller may adjust the position of the optical elements to vary a footprint of the transforming beam and/or its focus on the target surface. The controller may adjust at least one characteristic of the energy beam. For example, the controller may adjust the power density and/or fluence of the energy beam. Adjustments by the controller may be static (e.g., not in real-time). Adjustments by the controller may be dynamic (e.g., in real-time). Static adjustments may be done before or after 3D printing. Dynamic adjustments may be done during at least a portion of the 3D printing (e.g., during transformation of the pre-transformed material). At times, static adjustments may be done before and/or after an optical detection. At times, dynamic adjustments may be done during optical detection.

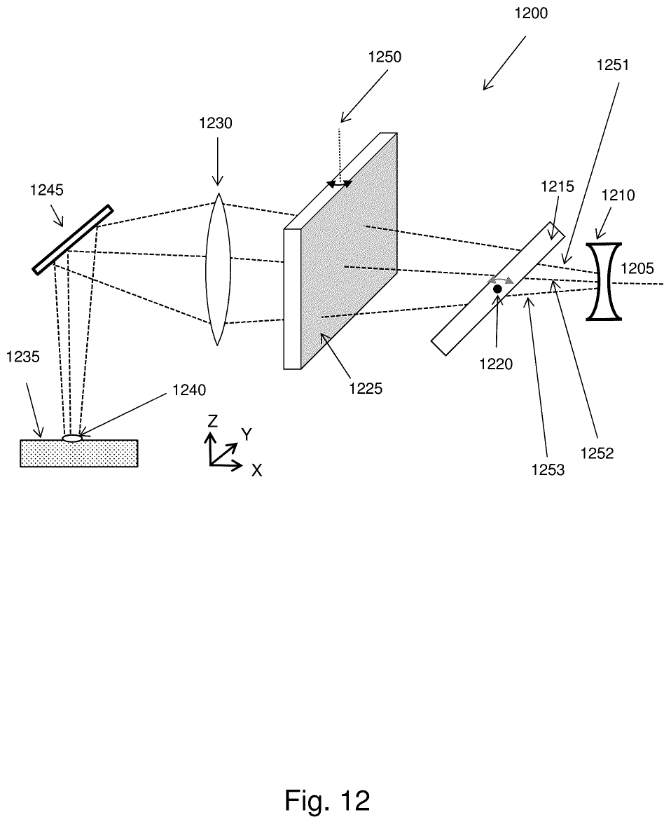

In some embodiments, an astigmatism system (e.g., FIG. 12, 1200) is coupled to the 3D printer. The astigmatism system may be disposed adjacent (e.g., inside or outside of) the processing chamber in which the irradiating energy beam is configured to generate the 3D object (e.g., FIG. 1, 126). The astigmatism system may be operatively coupled to an energy source, and/or to a controller. At least one element of the astigmatism system may be controlled before, after, and/or during at least a portion of the 3D printing (e.g., in real time). At least one element of the astigmatism system may be controlled manually and/or automatically (e.g., using a controller). The energy source may generate an energy beam (e.g., FIG. 12, 1205 depicting an energy beam). The astigmatism system may be used to form an elongated cross-sectional beam (e.g., narrow, and/or long, FIG. 12, 1240) that irradiates the target surface (e.g., 1235). The energy beam may be elongated along the X-Y plane (e.g., FIG. 12). At times, the footprint of the energy beam may be elongated by an energy beam perforation (e.g., an elongated slit) that the energy beam may be configured to pass through. At times, the movement of the energy beam may be controlled to perform a scan or a retro scan to form an elongated energy beam footprint.

In some embodiments, the astigmatism system includes two or more optical elements (e.g., lenses, FIG. 12, 1210, 1230). The optical elements may diverge or converge an irradiating energy (e.g., beam) that travels therethrough. The optical elements may have a constant focus. The optical elements may have a variable focus. At times, an optical element may converge the rays of the energy beam. At times, an optical element may diverge the rays of the energy beam. For example, the first optical element may be a diverging lens. The astigmatism system may comprise one or more media (e.g., 1215, 1225). The medium may have a high refractive index (e.g., a high refractive index relative to the wavelength of the incoming energy beam). At least one medium may be stationary, translating, or rotating (e.g., rotating along an axis, FIG. 12, 1220, 1250). Translating and/or rotating may be performed before, after, or during at least a portion of the 3D printing. The first medium may translate and/or rotate along a different axis than the second medium. The translating axes of the mediums may be different than (e.g., perpendicular to) the traveling axis of the irradiating energy. For example, the first medium (e.g., 1215) may translate and/or rotate along the Z axis (e.g., 1220), the second medium (e.g., 1225) may translate and/or rotate along the Y axis (e.g., 1250), and the irradiating energy (e.g., 1205) may travel along the X axis. The distance between the media may be such that they do not collide with each other when translating (and/or rotating) (e.g., when both media are rotating simultaneously). The irradiating energy may be directed to the second medium after it emerges from the first medium. The first optical element (e.g., 1210) may direct the energy beam to a medium (e.g., an optical window, e.g., 1215). The medium may (e.g., substantially) allow the energy beam to pass therethrough (e.g., may not absorb a substantial portion of the passing energy beam). Substantial may be relative to the intended purpose of the energy beam (e.g., to transform the pre-transformed material).

In some embodiments, the optical astigmatism of the irradiating energy refers to an elliptical cross section of the irradiating energy that differs from a circle. Without wishing to be bound to theory, the different paths (e.g., lengths thereof) of the various irradiating energy rays (e.g., 1251-1253), interacting with various thicknesses of the media (having an effective refractive index), may lead to an elongated cross section of the irradiating energy, and subsequently to an elongated footprint of the irradiating energy on the target surface. The relative position of the first media (e.g., optical window) and the second media may lead to an optical astigmatism. The degree and/or direction of the astigmatism may vary (e.g., before, after, and/or during at least a portion of the 3D printing) in relation to the relative positioning of the two media. The degree and/or direction of the astigmatism may due to the relative positioning of the two media. The angular position of the media may be controlled (e.g., manually, and/or automatically). For example, the angular position of the media may be controlled by one or more controllers. Controlling may include altering the angular position of the media relative to each other. Controlling may include altering the angular position not relative to each other (e.g., relative to the target surface and/or to the energy source). Controlling the degree of astigmatism may lead to controlling the length and/or width of the irradiating energy on the target surface. The irradiating energy may be directed to a second optical element (e.g., FIG. 12, 1230) from the (e.g., first or second) medium. The second optical element may be a converging lens. The converging lens may focus the irradiating energy after its emergence from the (e.g., first or second) medium. The converging lens may translatable (e.g., to vary the focus). The focusing power of the lens (e.g., converging lens) may be variable (e.g., electronically, magnetically, or thermally). The second optical element may be placed after the (e.g., first or second) medium. The energy beam may be directed (e.g., converged) on to a reflective element (e.g., mirror, FIG. 12, 1245) and/or a scanner. The energy beam may be directed (e.g., converged) on to a beam directing element. The beam directing (e.g., reflective) element may be translatable. The beam directing element may direct the energy beam to the target surface (e.g., material bed, FIG. 12, 1235). The directed energy beam may be an elongated energy beam. The mirror may be highly reflective mirror (e.g., Beryllium mirror).

At times, an optical system of the 3D printing system includes correction (e.g., compensation) for variation in a (e.g., cross-sectional) shape of the energy beam across the target surface. For example, a cross-sectional shape of the energy beam on the target surface may vary as a function of distance from the normal of the energy beam irradiation onto the target surface. For example, a variation in energy beam shape may vary astigmatically, in a similar manner to the shape 1401 of FIG. 14, as compared to the commanded shape 1403. At times, a circular energy beam cross section becomes more elliptical as the position of energy beam approaches an edge of the target surface. The astigmatic variation may be pre-determined (e.g., calculated). The astigmatic variation may be measured. In some embodiments, a calibration map is generated using the power density distribution measurements. In some embodiments, the circularity (e.g., astigmatism) of the energy beam footprint is measured and/or adjusted using a calibration system (e.g., in conjunction with the astigmatism system, e.g., FIG. 12). The astigmatism system may be any astigmatism system as disclosed in patent application number PCT/US17/64474. A calibration map and/or calibration system may be any as disclosed in patent application number PCT/US18/12250.

In some embodiments, a guidance system of an energy beam is operationally coupled with an optical system of a 3D printing system, such that the 3D printing system is configured to correct for astigmatic correction across a processing field of the energy beam. For example, one or more astigmatic focusing elements (e.g., as described herein) may be controlled to vary (e.g., correct) an energy beam shape according to its position on the target surface. The commanded energy beam position from the guidance system (e.g., scanner) of the energy beam may be correlated with the control of (e.g., optical element positions of) the astigmatic correction system. At times, the guidance system and the astigmatic are controlled independently (e.g., by at least two controllers). At times, the guidance system and the astigmatic are controlled by the same controller.

In some embodiments, the measured power density distribution across the footprint of the energy beam on the calibration structure (e.g., surface) is compared to a respective actual power density distribution (e.g., pre-determined, known footprint size and/or shape at the position, and/or a power density distribution determined from the calibration map). A deviation of the power density distribution as compared to the actual power density distribution may be calculated. The calculation may be done manually and/or automatically (e.g., by a controller). The calculation may be done in real-time (e.g., during build of the 3D object, e.g., during the 3D printing when the irradiating energy is not used to transform the pre-transformed material). The calculation may be done when performing calibration (e.g., before, and/or, after build of the 3D object). Based on the calculated deviation, the position, power density (e.g., distribution thereof), footprint size, focus, and/or astigmatism of the footprint of the irradiating energy may be adjusted. Adjusting may include adjusting homogenously or heterogeneously at least across the X and Y axis (e.g., narrow or broaden the spot size by adjusting one or more optical elements). Adjusting may include adjusting the footprint astigmatically (e.g., by adjusting the degree of astigmatism, adjusting the position of one or more elements of the astigmatic system, e.g., FIG. 12). Adjusting may include adjusting the position of at least one optical medium (e.g., FIG. 12, 1225 by rotating around axis 1250, and/or 1215 by rotating around axis 1220). Adjusting may be done during, before, and/or after build of the 3D object. Adjusting may be performed manually and/or automatically (e.g., by a controller). At times, calculating and adjusting may be performed by the same controller. At times, calculating and adjusting may be performed by different controllers (e.g., that are operatively coupled). The controller may comprise a control system. The controller may comprise a processing unit. The controller may be programmable. The controller may operate upon request (e.g., by a user). The controller may be any controller described herein.

In some embodiments, at least one characteristic of the energy beam (e.g., the power density distribution of the energy beam) is calibrated. The characteristics of the energy beam may comprise trajectory (e.g., path), footprint (e.g., its astigmatism, size, focus), power per unit area, fluence, Andrew Number, hatch spacing, scan speed, scan direction, or charge. The calibration system may be used to calibrate one or more optical elements (e.g., lenses) of the optical system. The calibration system may facilitate focus calibration, and focus sensitivity (e.g., resolution) study of the optical system. The calibration system may facilitate calibrating the one or more scanners of the 3D printer. The characteristics of the energy beam may be any energy beam characteristics described herein. The power density of the energy beam may change over time and/or depending on a position in the field of view. The energy beam may be projected on one or more (e.g., a plurality of) positions across the calibration structure. The plurality of positions may be equidistant from another spot. The projected position of the energy beam may produce a detectable signal (e.g., reflective radiation, e.g., reflective beam). The detectable signal may be sensed by the sensor. The detected signal may be measured for one or more positions of the calibration structure to which the energy beam is directed to. A detector may be used to detect the detectable signal. The detector may comprise an optical detector. The detector may be coupled to one or more optical fibers. The detector and/or optical fiber may be any detector and/or fiber optic described herein respectively. The measured characteristics of the energy beam (e.g., power density) may be compared to the expected respective characteristics of the energy beam (e.g., pre-determined, and/or known). The expected respective characteristics of the energy beam may be a benchmark (e.g., for comparison). A deviation of the measured characteristics of the energy beam as compared to the expected characteristics of the energy beam may be calculated. The calculation may be done manually and/or by a controller. The calculation may be done in real-time (e.g., during build of the 3D object). The calculation may be done when performing calibration (e.g., before, and/or, after build of the 3D object). Based on the calculated deviation, the characteristics of the energy beam may be adjusted. Adjusting may include adjusting one or more optical elements of the optical system and/or optical mechanism (e.g., lens, mirror, and/or optical medium, at least one element of the scanner and/or astigmatism system). Adjusting may be done during, before, or after build of the 3D object. Adjusting may be performed manually and/or by a controller. At times, calculating and adjusting may be performed by the same controller. At times, calculating and adjusting may be performed by different controllers. The controller may be any controller described herein.

The at least one sensor can be operatively coupled to a control system (e.g., computer control system). The sensor may comprise light sensor, electrical sensor, movement sensor, position sensor, distance sensor, or proximity sensor. The sensor may include temperature sensor, material (e.g., powder) level sensor, or metrology sensor. The metrology sensor may comprise a measurement sensor (e.g., height, length, width, angle, and/or volume). The metrology sensor may measure at least a portion of the layer of material. The layer of material may be a pre-transformed material (e.g., powder), transformed material, or hardened material. The metrology sensor may measure at least a portion of the 3D object. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, CCD camera). The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor.

In some embodiments, the system and/or apparatus comprises a controlling mechanism (e.g., a controller). The methods, systems, and/or apparatuses disclosed herein may incorporate a controller mechanism that controls one or more of the components described herein. The controller may comprise a computer-processing unit (e.g., a computer) coupled to any of the systems and/or apparatuses, or their respective components (e.g., the energy source(s)). The computer can be operatively coupled through a wired and/or through a wireless connection. In some cases, the computer can be on board a user device. A user device can be a laptop computer, desktop computer, tablet, smartphone, or another computing device. The controller can be in communication with a cloud computer system and/or a server. The controller can be programmed to selectively direct the energy source(s) to apply energy to the at least a portion of the target surface at a power per unit area. The controller can be in communication with the scanner configured to articulate the energy source(s) to apply energy to at least a portion of the target surface at a power per unit area.

In some embodiments, the controller may control the energy source(s). The control may comprise controlling an output power of the energy source. The energy source may be turned on and off manually and/or by the controller. The output power of the energy source may be based on feedback control (e.g., a detected and/or setpoint temperature). The controller may control (e.g., at least one element of) an optical system. The control may comprise translating or rotating the at least one element of the optical system to direct the energy beam. The controller may control the guidance system(s). The control may comprise controlling (e.g., directing) at least one element of the guidance system to direct an energy beam along a path (e.g., on a target surface). The controller may control a detection system. The control may comprise activation or deactivation of the detection system. The control may comprise coordinated movement of a detector field of view with a portion of a target surface (e.g., a footprint of the energy beam). The controller may control an image processor. The control may comprise an image capture, image modification, image analysis, or image output. The controller may control the platform. The control may comprise controlling (e.g., directing and/or regulating) the speed (velocity) of platform movement. The movement may be horizontal, vertical, and/or in an angle. The controller may control the level of pressure (e.g., vacuum, ambient, or positive pressure) in the enclosure (e.g., chamber). The pressure level (e.g., vacuum, ambient, or positive pressure) may be constant or varied. The pressure level may be turned on and off manually and/or by the controller. The controller may control the layer dispensing mechanism and/or any of its components. The control may be manual and/or automatic. The control may be programmed and/or be effectuated a whim. The control may be according to an algorithm. The algorithm may comprise a printing algorithm, or motion control algorithm. The algorithm may consider the model of the 3D object.

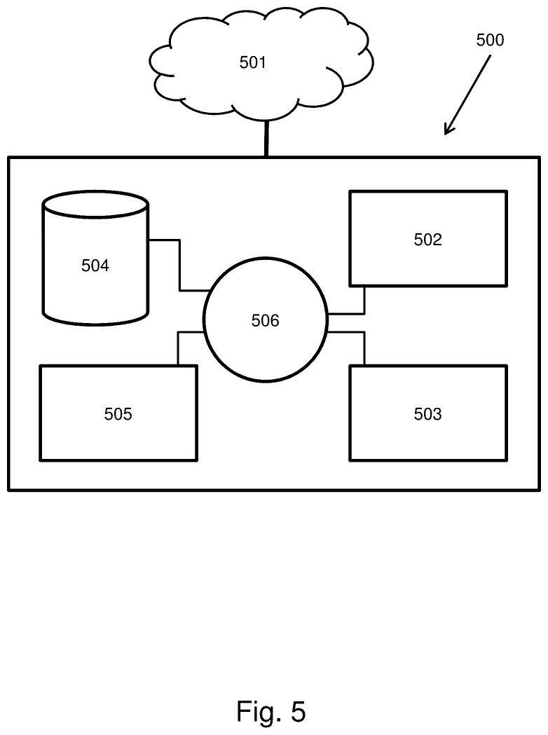

The controller may comprise a processing unit. The processing unit may be central. The processing unit may comprise a central processing unit (herein “CPU”). The controllers or control mechanisms (e.g., comprising a computer system) may be programmed to implement methods of the disclosure. The controller may control at least one component of the systems and/or apparatuses disclosed herein. FIG. 5 is a schematic example of a computer system 500 that is programmed or otherwise configured to facilitate the formation of a 3D object according to the methods provided herein. The computer system 500 can control (e.g., direct and/or regulate) various features of printing methods, apparatuses and systems of the present disclosure, such as, for example, guidance of a path of the energy source, application of an amount of energy emitted to a selected location, detection system activation and deactivation, detector field of view coordinated movement, image processing, process parameters (e.g., dispenser layer height, planarization, chamber pressure), or any combination thereof. The computer system 500 can be part of, or be in communication with, a printing system or apparatus, such as a 3D printing system or apparatus of the present disclosure. The computer may be coupled to one or more mechanisms disclosed herein, and/or any parts thereof. For example, the computer may be coupled to one or more sensors, valves, switches, motors, pumps, or any combination thereof.

The computer system 500 can include a processing unit 506 (also “processor,” “computer” and “computer processor” used herein). The computer system may include memory or memory location 502 (e.g., random-access memory, read-only memory, flash memory), electronic storage unit 504 (e.g., hard disk), communication interface 503 (e.g., network adapter) for communicating with one or more other systems, and peripheral devices 505, such as cache, other memory, data storage and/or electronic display adapters. The memory 502, storage unit 504, interface 503, and peripheral devices 505 are in communication with the processing unit 506 through a communication bus (solid lines), such as a motherboard. The storage unit can be a data storage unit (or data repository) for storing data. The computer system can be operatively coupled to a computer network (“network”) 501 with the aid of the communication interface. The network can be the Internet, an Internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 502. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 500 can be included in the circuit.

The storage unit 504 can store files, such as drivers, libraries, and saved programs. The storage unit can store user data, e.g., user preferences and user programs. The computer system in some cases can include one or more additional data storage units that are external to the computer system, such as located on a remote server that is in communication with the computer system through an intranet or the Internet.

The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory 502 or electronic storage unit 504. The machine executable or machine-readable code can be provided in the form of software. During use, the processor 506 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code, or can be compiled during runtime. The code can be supplied in a programming language that can be selected to enable the code to execute in a pre-compiled or as-compiled fashion.

The processing unit may include one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least 0.2 billion transistors (BT), 0.5 BT, 1 BT, 2 BT, 3 BT, 5 BT, 6 BT, 7 BT, 8 BT, 9 BT, 10 BT, 15 BT, 20 BT, 25 BT, 30 BT, 40 BT, 50 BT, or 100 BT. The integrated circuit chip may comprise at most 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The multiplicity of cores can be parallel cores. The multiplicity of cores can function in parallel. The multiplicity of cores may include at least 2, 10, 40, 100, 400, 1000, 2000, 3000, 4000, 5000, 6000, 7000, 8000, 9000, or 10000 cores. The multiplicity of cores may include at most 1000, 2000, 3000, 4000, 5000, 6000, 7000, 8000, 9000, 10000, or 40000 cores. The multiplicity of cores may include cores of any number between the afore-mentioned numbers (e.g., from 2 to 40000, from 2 to 400, from 400 to 4000, from 2000 to 4000, or from 4000 to 10000 cores). The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 P-FLOPS, 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, or from about 0.1 T-FLOP to about 10 EXA-FLOPS). The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), RandomAccess, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK refers to a software library for performing numerical linear algebra on a digital computer. DGEMM refers to double precision general matrix multiplication. STREAM. PTRANS. MPI refers to Message Passing Interface.

The computer system may include hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

The computer system may include an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

The computer system may include configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration.

The computing system may include an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most 0.1 microsecond (μs), 1 μs, 10 μs, 100 μs, or 1 millisecond (ms). The physical unit may produce the algorithm output in any time between the above-mentioned times (e.g., from about 0.1 μs, to about 1 ms, from about 0.1 μs, to about 100 μs, or from about 0.1 μs to about 10 μs). In some instances, the controller may use calculations, real time measurements, or any combination thereof to regulate the energy beam(s). In some instances, the real-time measurements (e.g., temperature measurements) may provide input at a rate of at least about 0.1 KHz, 1 KHz, 10 KHz, 100 KHz, 1000 KHz, or 10000 KHz). In some instances, the real-time measurements may provide input at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processing unit may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may be at most about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may any value between the aforementioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s).

Aspects of the systems, apparatuses, and/or methods provided herein, such as the computer system, can be embodied in programming. Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

The memory may comprise a random-access memory (RAM), dynamic random-access memory (DRAM), static random-access memory (SRAM), synchronous dynamic random-access memory (SDRAM), ferroelectric random-access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. The memory and/or storage may comprise a storing device external to and/or removable from device, such as a Universal Serial Bus (USB) memory stick, or a hard disk. Many of these forms of computer readable media may be involved in carrying one or more sequences of one or more instructions to a processor for execution.

The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms that have been pre-programmed. The feedback mechanisms may rely on input from sensors (described herein) that are connected to the control unit (e.g., control system or control mechanism e.g., computer). The computer system may store historical data concerning various aspects of the operation of the 3D printing system. The historical data may be retrieved at predetermined times and/or at a whim. The historical data may be accessed by an operator and/or by a user. The historical and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (e.g., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

The system and/or apparatus described herein (e.g., controller) and/or any of their components may comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen. The system and/or apparatus described herein (e.g., controller) and/or any of their components may comprise Bluetooth technology. The system and/or apparatus described herein (e.g., controller) and/or any of their components may comprise a communication port. The communication port may be a serial port or a parallel port. The communication port may be a Universal Serial Bus port (USB). The system and/or apparatus described herein (e.g., controller) and/or any of their components may comprise USB ports. The USB can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, E0h, EFh, FEh, or FFh. The system and/or apparatus described herein (e.g., controller) and/or any of their components may comprise a plug and/or a socket (e.g., electrical, AC power, DC power). The system and/or apparatus described herein (e.g., controller) and/or any of their components may comprise an adapter (e.g., AC and/or DC power adapter). The system and/or apparatus described herein (e.g., controller) and/or any of their components may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins. The controller may comprise electrical circuitry.

The systems, methods, and/or apparatuses disclosed herein may comprise receiving a request for a 3D object (e.g., from a customer). The request can include a model (e.g., CAD) of the desired 3D object. Alternatively, or additionally, a model of the desired 3D object may be generated. The model may be used to generate 3D printing instructions. The 3D printing instructions may exclude the 3D model. The 3D printing instructions may be based on the 3D model. The 3D printing instructions may take the 3D model into account. The 3D printing instructions may be based on simulations. The 3D printing instructions may use the 3D model. The 3D printing instructions may comprise using an algorithm (e.g., embedded in a software) that takes into account the 3D model.

### EXAMPLES

The following are illustrative and non-limiting examples of methods of the present disclosure.

### Example 1

In a 320 mm diameter and 400 mm maximal height container at ambient temperature, Inconel 718 powder of average particle size 35 μm was deposited in a container to form a powder bed. The container was disposed in an enclosure to separate the powder bed from the ambient environment. The enclosure was purged with Argon gas to have an inert atmosphere. A controller (e.g., FIG. 5, 500) was used to command a laser beam and a galvanometer scanner system to impinge a laser upon the powder bed to form a first set and a second set of partial alignment markers on a target surface. For each partial alignment marker, the laser was directed in a series of four (4) processing operations; e.g., FIGS. 30, 3002, 3004, 3006, and 3008, to form a first partial alignment marker; e.g., FIGS. 30, 3010, 3012, 3014, and 3016, to form a second partial alignment marker. The first set and the second set of partial alignment markers were formed to a 12×12 grid. An image of the first set of partial alignment markers was captured following its generation, and the first set of partial alignment markers was subsequently removed by a recoater. The second set of partial alignment markers was generated following removal of the first set. An image of the second set of partial alignment markers was captured following its generation, and the images of the first and second sets were combined (e.g., FIG. 30, 3040) for use in a calibration operation of the galvanometer scanner.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-15. (canceled)

16. An apparatus for calibration in printing at least one three-dimensional object, the apparatus comprising one or more controllers configured to:
(a) couple to a power source, and operationally couple to (i) a guidance system, (ii) a sensor, and (iii) a mechanism comprising a planarizer or a remover, optionally wherein the power source comprises an electrical power source;
(b) direct the guidance system to guide a transforming agent along a target surface to print a calibration mark, the target surface being supported by a platform supporting the at least one three-dimensional object during its printing;
(c) direct the sensor to sense the calibration mark and generate at least one signal;
(d) direct the mechanism to disrupt the calibration mark; and
(e) direct the guidance system to guide the transforming agent to print the at least one three-dimensional object.

17. The apparatus of claim 16, wherein the transforming agent is an optical energy beam and wherein the guidance system comprises an optical system.

18. The apparatus of claim 16, wherein the target surface comprises an exposed surface of a first material bed, and wherein the at least one three-dimensional object is printed from the first material bed or from a second material bed similar to the first material bed; and optionally wherein the sensor comprises (a) a charge-coupled device (CCD), (b) a line scan sensor, (c) a camera, (d) a single pixel detector, and/or (e) a spectrometer.

19. The apparatus of claim 16, wherein the mechanism comprises an attractive force.

20. (canceled)

21. (canceled)

22. (canceled)

23. The apparatus of claim 16, wherein the calibration mark is a first partial calibration mark, the guidance system is a first guidance system, and the transforming agent is a first transforming agent; and wherein the one or more controllers are further configured to operationally couple to a second guidance system, and to direct the second guidance system to guide a second transforming agent along the target surface to form a second partial calibration mark, the first transforming agent and the second transforming agent being utilized at least in part to print the at least one three-dimensional object.

24. (canceled)

25. The apparatus of claim 16, wherein the calibration mark is a first partial calibration mark, and wherein before printing the at least one three-dimensional object, the one or more controllers are configured to direct printing a second partial calibration mark that occupies a second area, the second area comprising at least one contact point with a first area occupied by the first partial calibration mark.

26. (canceled)

27. The apparatus of claim 25, wherein the one or more controllers are configured to print the second partial calibration mark that occupies the second area to overlap at least a portion of the first area occupied by the first partial calibration mark, to form an overlapped area.

28. The apparatus of claim 16, wherein the calibration mark is printed on an exposed surface of a material bed from which the at least one three-dimensional object is printed at least in part by the transforming agent.

29. The apparatus of claim 16, wherein the target surface comprises an exposed surface of an enclosure in which the at least one three-dimensional object is printed at least in part by the transforming agent.

30. The apparatus of claim 16, wherein the calibration mark is printed at least in part in a processing field of the guidance system.

31. The apparatus of claim 30, wherein the target surface comprises a build region for printing the at least one three-dimensional object, and wherein the processing field overlaps at least a portion of the build region.

32. The apparatus of claim 16, wherein the one or more controllers comprise a closed loop control scheme comprising a feedback control scheme, the closed loop control scheme considering at least one signal from the sensor, and wherein the at least one signal comprises a sensed property of the calibration mark, the sensed property being of a material of the calibration mark with respect to an adjacent material, the sensed property comprising (A) a luminance, (B) a reflectivity, (C) a specularity, (D) a wavelength, or (E) a contrast.

33. The apparatus of claim 16, wherein the one or more controllers are configured to consider the at least one signal, wherein the one or more controllers are configured to direct the guidance system to guide the transforming agent in (b), and to direct the sensor to sense the calibration mark in (c), at least until a threshold value of a sensed property of the calibration mark is sensed by the sensor.

34. The apparatus of claim 16, wherein the one or more controllers are configured to direct the mechanism to disrupt the calibration mark in (d) upon reaching a threshold value of a sensed property of the calibration mark being sensed by the sensor.

35. The apparatus of claim 16, wherein the one or more controllers consider the at least one signal, wherein the one or more controllers are configured to direct the mechanism to disrupt the calibration mark in (d) following reaching a threshold value of a sensed property of the calibration mark as sensed by the sensor.

36.-56. (canceled)

57. The apparatus of claim 19, wherein the attractive force comprises a vacuum force, and wherein the one or more controllers are configured to direct the mechanism to disrupt the calibration mark at least in part by direct removal of the calibration mark from the target surface; and optionally wherein the mechanism is utilized during printing of the at least one three-dimensional object.

58. The apparatus of claim 16, wherein the one or more controllers are configured to direct maintenance of an internal atmosphere in an enclosure having a positive pressure as compared to an ambient pressure external to the enclosure in which the calibration mark is printed during the printing; and optionally wherein the at least one three-dimensional object is printed in the internal atmosphere having the positive pressure.

59. The apparatus of claim 16, wherein during printing of the at least one three-dimensional object, the sensor is utilized to generate a topographical image (a) of the target surface and/or (b) of an exposed surface of a material bed from which the at least one three-dimensional object is printed.

60. A method of the printing of the at least one three-dimensional object, the method comprising: (a) providing the apparatus of claim 16, and (b) using the apparatus to print the at least one three-dimensional object.

61. Non-transitory computer readable program instructions that, when read by one or more processors operatively coupled to the apparatus of claim 16 cause the one or more processors to execute one or more operations associated with the apparatus to print the at least one three-dimensional object, the program instructions being inscribed on at least one non-transitory computer readable medium; and optionally wherein the one or more controllers comprises the one or more processors.
